(19) United States
(12) Patent Application Publication
(10) Pub. No.: US 2021/0145003 A1
(43) Pub. Date: May 20, 2021

(54) MIXTURES COMPRISING A HERBICIDE AND A NITRIFICATION INHIBITOR SUCH AS 2-(3,4-DIMETHYL-1H-PYRAZOL-1-YL)SUCCINIC ACID (DMPSA) OR 3,4-DIMETHYL PYRAZOLIUM GLOCOLATE (DMPG)

(71) Applicant: BASF SE, Ludwigshafen am Rhein (DE)

(72) Inventors: Barbara Nave, Limburgerhof (DE); Gregor Pasda, Limburgerhof (DE); Alexander Wissemeier, Limburgerhof (DE); Maarten Staal, Limburgerhof (DE); Karl-Heinrich Schneider, Limburgerhof (DE); Markus Schmid, Limburgerhof (DE); Wolfram Zerulla, Limburgerhof (DE); Daniella Lohe, Limburgerhof (DE); Sascha Shuxia Zhu, Ludwigshafen (DE)

(21) Appl. No.: 16/629,698

(22) PCT Filed: Jul. 5, 2018
(86) PCT No.: PCT/IB2018/054948

§ 371 Date: Jan. 9, 2020

(30) Foreign Application Priority Data
Jul. 10, 2017 (EP) 17180506.2

(51) Int. Cl. A01N 43/80; C05G 3/60; C05G 3/80; C05G 3/90

(52) U.S. Cl. CPC A01N 43/80; C05G 3/90; C05G 3/80; C05G 3/60

(57) ABSTRACT

The present disclosure relates to pesticidal mixtures including as active components at least one specific nitrification inhibitor (compound I) and at least one herbicide (compound II). Also disclosed is a method for controlling vegetation on non-crop areas (vegetation of weeds), or for improving the nitrification-inhibiting effect, or for increasing the health of a plant using mixtures of at least one compound I and at least one compound II. Also disclosed are uses of mixtures comprising compounds I and compounds II for controlling vegetation on non-crop areas (vegetation of weeds) or to increasing the health of a plant. Also disclosed are agrochemical compositions including these mixtures, and plant propagation material including these mixtures or these agrochemical compositions.

The present invention relates to the mixture comprising nitrification inhibitors (compound I) and herbicides (compound II). Moreover, the invention relates to the use of this combination comprising nitrification inhibitors (compound I) and herbicides (compound II) for increasing the health of a plant, and/or for providing better crop yields and/or a better quality of the plants or crops, and/or for contributing to a better resistance to stress, and/or for reducing of the quantity of pesticides used, and/or for avoiding the development of resistances against the respective pesticides. Furthermore, the present invention relates to methods for increasing the health of a plant comprising the treatment of plants, soil and/or loci with said mixture comprising the nitrification inhibitor (compound I) and a herbicide (compound II).

Nitrogen is an essential element for plant growth, plant health and reproduction. About 25% of the plant available nitrogen in soils (ammonium and nitrate) originate from decomposition processes (mineralization) of organic nitrogen compounds such as humus, plant and animal residues and organic fertilizers. Approximately 5% derive from rainfall. On a global basis, the biggest part (70%), however, are supplied to the plant by inorganic nitrogen fertilizers. The mainly used nitrogen fertilizers comprise ammonium compounds or derivatives thereof, i.e. nearly 90% of the nitrogen fertilizers applied worldwide is in the NH₄⁺ form (Subbarao et al., 2012, Advances in Agronomy, 114, 249-302) or are based on neem-extract, including various compounds such as neemoil-coated fertilizers, neem-coated fertilizers, nimin-coated fertilizers and fertilizers with neem cake from the Indian neem tree (Azadirachta indica). This is, inter alia, due to the fact that NH₄⁺ assimilation is energetically more efficient than assimilation of other nitrogen sources such as NO₃⁻.

Moreover, being a cation, NH₄⁺ is held electrostatically by the negatively charged clay surfaces and functional groups of soil organic matter. This binding is strong enough to limit NH₄⁺-loss by leaching to groundwater. By contrast, NO₃⁻, being negatively charged, does not bind to the soil and is liable to be leached out of the plants' root zone. In addition, nitrate may be lost by denitrification which is the microbiological conversion of nitrate and nitrite (NO₂) to gaseous forms of nitrogen such as nitrous oxide (N₂O) and molecular nitrogen (N₂).

However, ammonium (NH₄⁺) compounds are converted by soil microorganisms to nitrates (NO₃⁻) in a relatively short time in a process known as nitrification. The nitrification is carried out primarily by two groups of chemolithotrophic bacteria, ammonia-oxidizing bacteria (AOB) of the genus Nitrosomonas and Nitrobacter, which are ubiquitous component of soil bacteria populations. The enzyme, which is essentially responsible for nitrification is ammonia monooxygenase (AMO), which was also found in ammonia-oxidizing archaea (Subbarao et al., 2012, Advances in Agronomy, 114, 249-302).

The nitrification process typically leads to nitrogen losses and environmental pollution. As a result of the various losses, approximately 50% of the applied nitrogen fertilizers is lost during the year following fertilizer addition (see Nelson and Huber; Nitrification inhibitors for corn production (2001), National Corn Handbook, Iowa State University).

As countermeasures, the use of nitrification inhibitors, mostly together with fertilizers, was suggested. Suitable nitrification inhibitors include biological nitrification inhibitors (BNIs) such as linoleic acid, alpha-linolenic acid, methyl p-coumarate, methyl ferulate, MHPP, Karanjin, brachialacton or the p-benzoquinone sorgoleone (Subbarao et al., 2012, Advances in Agronomy, 114, 249-302). Further suitable nitrification inhibitors are synthetic chemical inhibitors such as Nitrapyrin, dicyandiamide (DCD), 3,4-dimethyl pyrazole phosphate (DMPP), 4-amino-1,2,4-triazole hydrochloride (ATC), 1-amido-2-thiourea (ASU), 2-amino-4-chloro-6-methylpyrimidine (AM), 5-ethoxy-3-trichloromethyl-1,2,4-thiodiazole (terrazole), or 2-sulfanilamidothiazole (ST) (Slangen and Kerkhoff, 1984, Fertilizer research, 5(1), 1-76).

EP 0 917 526 further mentions the use of polyacids to treat mineral fertilizers containing a nitrification inhibitor in order to improve the fixation of the nitrification inhibitors in the inorganic fertilizer. Moreover, the volatility of the nitrification inhibitor can be reduced.

However, many of these inhibitors only work sub-optimal or have undesirable side effects.

In view of this situation there is a continuous need for compositions or mixtures that increase the health of plants. Healthier plants are desirable since they result among other in better crop yields and/or a better quality of the plants or crops. Healthier plants also better resist to biotic and abiotic stress. A better resistance to stress in turn allows reducing the quantity of pesticides, which also helps avoiding the development of resistances against the respective pesticides.

One object of the present invention is to provide a composition or mixture containing a nitrification inhibitor and/or a herbicide which increases the health of plants, and/or provides better crop yields and/or a better quality of the plants or crops, and/or shows a better resistance to stress, and/or allows the reduction of the quantity of pesticides used, and/or helps avoiding the development of resistances against the respective pesticides.

Another object of the present invention is to provide a composition or mixture containing the nitrification inhibitor (compound I) and/or a herbicide (compound II) which—each preferably through a synergistic action—
(i) enhances the stability of compound I, and/or
(ii) enhances the nitrification-inhibiting effect of compound I, and/or
(iii) enhances the yield increase effect of the compound I, and/or
(iv) has a relatively long storage life, particularly before being applied to or coated on nitrogen-containing fertilizers, and/or
(v) reduces the emission of nitrous oxide from soils, and/or
(vi) reduces the ammonia emission from soils, and/or
(vii) reduces nitrate leaching, and/or
(viii) does not adversely affect the nitrification-inhibiting effect and/or the nitrification-inhibiting activity of the compound I, and/or
(ix) can be easily and safely packaged, transported and shipped, even in large quantities, and/or
(x) can be easily and safely handled and applied for soil treatment, even in large quantities, and/or
(xi) improves the nutrient use efficiency, and/or
(xii) improves the delivery of the herbicide (compound II) to the plant, and/or
(xiii) improves the plant growth (e.g. biomass, yield, root branching and length; compact growth in case of ornamental plants), and/or
(xiv) enables a better developed root system, a larger leaf area, greener leaves, stronger shoots and/or
(xv) improves the plant defense of the plants, and/or
(xvi) improves the plant health of the plants, and/or
(xvii) improves the quality of the plants, and/or
(xviii) improves the storage or survivability of the herbicide (compound II) and/or prolongs the availability of herbicides (compound II) to the plants, and/or
(xix) enhances the herbicidal effect of the herbicide (compound II), and/or
(xx) allows the reduction of the quantity of herbicides (compound II) used, and/or
(xxi) increase the survivability rate of seedlings, for example transplanted seedlings, and/or
(xxii) reduce or avoid unfavorable environmental or toxicological effects whilst still allowing effective pest control, and/or
(xxiii) enable earlier seed germination and/or blooming, and/or
(xxiv) is toxicologically unobjectionable, and/or
(xxv) enables simple handling and application of compound I and compound II.

The objects (xiii), (xiv), (xv), (xvi), (xvii) and (xxi) particularly pertains to such plants or seedlings wherein such plants or seedlings were treated with the mixture or composition, or the soil in which the such plants or seedlings were placed was subject to the application of the mixture or compositon of the present invention.

The preferred objects of the present invention are (i), (ii), (v), (vi), (vii), (xi), (xii), (xiii), (xiv), (xv), (xvi), (xvii), (xviii), (xix), (xx), (xxii), (xxiv), (xxv), the more preferred objects of the present invention are (i), (ii), (v), (vi), (vii), (xii), (xiii), (xv), (xvi), (xix), (xx), and/or (xxii), the most preferred objects of the present invention are (i), (ii), (v), (vii), (xvi), (xix), and/or (xxii), the particularly preferred objects of the present invention are (ii), (v), (vii), (xvi) and/or (xix).

The term “in a synergistic way” means that the composition or mixture comprising the nitrification inhibitor (compound I) and the herbicide (compound II) can fulfil one or more of the objects (i) to (xxiv) significantly better than the individual compounds—i.e. compound I or compound II—alone can do, and preferably, this better fulfilment of the objects by said composition or mixture compared to the individual compounds is evidenced by calculations according to Colby's formula, see Colby, S. R. (Calculating synergistic and antagonistic responses of herbicide Combinations”, Weeds, 15, pp. 20-22, 1967).

The present invention relates to a mixture comprising as active components
1) at least one active compound I (nitrification inhibitor) selected from the group consisting of:
   a) 2-(3,4-dimethyl-1H-pyrazol-1-yl)succinic acid (referred to as “DMPSA1” in the following) and/or 2-(4,5-dimethyl-1H-pyrazol-1-yl)succinic acid (referred to as “DMPSA2” in the following), and/or a derivative thereof, and/or a salt thereof,
   b) glycolic acid addition salt of 3,4-dimethyl pyrazole (3,4-dimethyl pyrazolium glycolate, referred to as “DMPG” in the following), and/or an isomer thereof, and/or a derivative thereof,
   c) citric acid addition salt of 3,4-dimethyl pyrazole (3,4-dimethyl pyrazolium citrate, referred to as “DMPC” in the following), and/or an isomer thereof, and/or a derivative thereof,
   d) lactic acid addition salt of 3,4-dimethyl pyrazole (3,4-dimethyl pyrazolium lactate, referred to as “DMPL” in the following), and/or an isomer thereof, and/or a derivative thereof,
   e) mandelic acid addition salt of 3,4-dimethyl pyrazole (3,4-dimethyl pyrazolium mandelate, referred to as “DMPM” in the following), and/or an isomer thereof, and/or a derivative thereof,
   f) 1,2,4-triazole (referred to as “TZ” in the following), and/or a derivative thereof, and/or a salt thereof,
   g) 4-Chloro-3-methylpyrazole (referred to as “CIMP” in the following), and/or an isomer thereof, and/or a derivative thereof, and/or a salt thereof,
   h) N-((3(5)-methyl-1H-pyrazole-1-yl)methyl)acetamide, and/or an isomer thereof, and/or a derivative thereof, and/or a salt thereof,
   i) N-((3(5)-methyl-1H-pyrazole-1-yl)methyl)formamide, and/or an isomer thereof, and/or a derivative thereof, and/or a salt thereof,
   j) N-((3(5),4-dimethylpyrazole-1-yl)methyl)formamide, and/or an isomer thereof, and/or a derivative thereof, and/or a salt thereof,
   k) N-((4-chloro-3(5)-methyl-pyrazole-1-yl)methyl)formamide, and/or an isomer thereof, and/or a derivative thereof, and/or a salt thereof,
   l) a reaction adduct of dicyandiamide, urea and formaldehyde, or a triazonyl-formaldehyde-dicyandiamide adduct,
   m) 2-cyano-1-((4-oxo-1,3,5-triazinan-1-yl)methyl)guanidine,
   n) 1-((2-cyanoguanidino)methyl)urea,
   o) 2-cyano-1-((2-cyanoguanidino)methyl)guanidine,
   p) 2-chloro-6-(trichloromethyl)-pyridine (nitrapyrin or N-serve),
   q) dicyandiamide (DCD, DIDIN),
   r) 3,4-dimethyl pyrazole phosphate, and/or 4,5-dimethyl pyrazole phosphate (DMPP, ENTEC), and/or an isomer thereof, and/or a derivative thereof,
   s) 3,4-dimethylpyrazole, and/or 4,5-dimethylpyrazole (DMP), and/or an isomer thereof, and/or a derivative thereof, and/or a salt thereof, and/or an acid addition salt thereof,
   t) ammoniumthiosulfate (ATU),
   u) neem, and/or products based on ingredients of neem,
   v) linoleic acid,
   w) alpha-linolenic acid,
   x) methyl p-coumarate,
   y) methyl ferulate,
   z) methyl 3-(4-hydroxyphenyl) propionate (MH PP),
   aa) Karanjin,
   bb) brachialacton,
   cc) p-benzoquinone sorgoleone,
   dd) 4-amino-1,2,4-triazole hydrochloride (ATC),
   ee) 1-amido-2-thiourea (ASU),
   ff) 2-amino-4-chloro-6-methylpyrimidine (AM),
   gg) 2-mercapto-benzothiazole (MBT),
   hh) 5-ethoxy-3-trichloromethyl-1,2,4-thiodiazole (terrazole, etridiazole),
   ii) 2-sulfanilamidothiazole (ST),
   jj) 3-methylpyrazol (3-MP),
   kk) 1,2,4-triazol thiourea (TU),
   ll) cyan amide,
   mm) melamine,
   nn) zeolite powder,
   oo) catechol,
   pp) benzoquinone,
   qq) sodium tetra borate,
   rr) allylthiourea,
   ss) chlorate salts, and
   tt) zinc sulfate;
   and
2) at least one active compound II (herbicide) selected from the groups N.1 to N.15:
   N.1 Lipid biosynthesis inhibitors: alloxydim (N.1.1), alloxydim-sodium (N.1.2), butroxydim (N.1.3), clethodim (N.1.4), clodinafop (N.1.5), clodinafop-propargyl (N.1.6), cycloxydim (N.1.7), cyhalofop (N.1.8), cyhalofop-butyl (N.1.9), diclofop (N.1.10), diclofop-methyl (N.1.11), fenoxaprop (N.1.12), fenoxaprop-ethyl (N.1.13), fenoxaprop-P (N.1.14), fenoxaprop-P-ethyl (N.1.15), fluazifop (N.1.16), fluazifop-butyl (N.1.17), fluazifop-P (N.1.18), fluazifop-P-butyl (N.1.19), haloxyfop (N.1.20), haloxyfop-methyl (N.1.21), haloxyfop-P (N.1.22), haloxyfop-P-methyl (N.1.23), metamifop (N.1.24), pinoxaden (N.1.25), profoxydim (N.1.26), propaquizafop (N.1.27), quizalofop (N.1.28), quizalofop-ethyl (N.1.29), quizalofop-tefuryl (N.1.30), quizalofop-P (N.1.31), quizalofop-P-ethyl (N.1.32), quizalofop-P-tefuryl (N.1.33), sethoxydim (N.1.34), tepraloxydim (N.1.35), tralkoxydim (N.1.36), 4-(4′-chloro-4-cyclo¬propyl-2′-fluoro[1,1-biphenyl]-3-yl)-5-hydroxy-2,2,6,6-tetramethyl-2H-pyran-3(6H)-one ((N.1.37) CAS 1312337-72-6); 4-(2′,4′-dichloro-4-cyclopropyl[1,1′-biphenyl]-3-yl)-5-hydroxy-2,2,6,6-tetramethyl-2H-pyran-3(6H)-one ((N.1.38) CAS 1312337-45-3); 4-(4′-chloro-4-ethyl-2′-fluoro[1,1′-biphenyl]-3-yl)-5-hydroxy-2,2,6,6-tetramethyl-2H-pyran-3(6H)-one ((N.1.39) CAS 1033757-93-5); 4-(2′,4′-Dichloro-4-ethyl[1,1′-biphenyl]-3-yl)-2,2,6,6-tetramethyl-2H-pyran-3,5(4H,6H)-dione ((N.1.40) CAS 1312340-84-3); 5-(acetyloxy)-4-(4′-chloro-4-cyclopropyl-2′-fluoro[1,1′-biphenyl]-3-yl)-3,6-dihydro-2,2,6,6-tetramethyl-2H-pyran-3-one ((N.1.41) CAS 1312337-48-6); 5-(acetyloxy)-4-(2′,4′-dichloro-4-cyclopropyl-[1,1′-biphenyl]-3-yl)-3,6-dihydro-2,2,6,6-tetramethyl-2H-pyran-3-one (N.1.42); 5-(acetyloxy)-4-(4′-chloro-4-ethyl-2′-fluoro[1,1-biphenyl]-3-yl)-3,6-dihydro-2,2,6,6-tetramethyl-2H-pyran-3-one ((N.1.43) CAS 1312340-82-1); 5-(acetyloxy)-4-(2′,4′-dichloro-4-ethyl[1,1′-biphenyl]-3-yl)-3,6-dihydro-2,2,6,6-tetramethyl-2H-pyran-3-one ((N.1.44) CAS 1033760-55-2); 4-(4′-chloro-4-cyclopropyl-2′-fluoro[1,1′-biphenyl]-3-yl)-5,6-dihydro-2,2,6,6-tetramethyl-5-oxo-2H-pyran-3-yl carbonic acid methyl ester ((N.1.45) CAS 1312337-51-1); 4-(2′,4′-dichloro-4-cyclopropyl-[1,1′-biphenyl]-3-yl)-5,6-dihydro-2,2,6,6-tetramethyl-5-oxo-2H-pyran-3-ylcarbonic acid methyl ester (N.1.46); 4-(4′-chloro-4-ethyl-2′-fluoro[1,1′-biphenyl]-3-yl)-5,6-dihydro-2,2,6,6-tetramethyl-5-oxo-2H-pyran-3-ylcarbonic acid methyl ester ((N.1.47) CAS 1312340-83-2); 4-(2′,4′-dichloro-4-ethyl¬[1,1-biphenyl]-3-yl)-5,6-dihydro-2,2,6,6-tetramethyl-5-oxo-2H-pyran-3-yl carbonic acid methyl ester ((N.1.48) CAS 1033760-58-5); benfuresate (N.1.49), butylate (N.1.50), cycloate (N.1.51), dalapon (N.1.52), dimepiperate (N.1.53), EPTC (N.1.54), esprocarb (N.1.55), ethofumesate (N.1.56), flupropanate (N.1.57), molinate (N.1.58), orbencarb (N.1.59), pebulate (N.1.60), prosulfocarb (N.1.61), TCA (N.1.62), thiobencarb (N.1.63), tiocarbazil (N.1.64), triallate (N.1.65) and vernolate (N.1.66);
   N.2 Acetolactate synthase inhibitors (ALS inhibitors): amidosulfuron (N.2.1), azimsulfuron (N.2.2), bensulfuron (N.2.3), bensulfuron-methyl (N.2.4), chlorimuron (N.2.5), chlorimuron-ethyl (N.2.6), chlorsulfuron (N.2.7), cinosulfuron (N.2.8), cyclosulfamuron (N.2.9), ethametsulfuron (N.2.10), ethametsulfuron-methyl (N.2.11), ethoxysulfuron (N.2.12), flazasulfuron (N.2.13), flucetosulfuron (N.2.14), flupyrsulfuron (N.2.15), flupyrsulfuron-methyl-sodium (N.2.16), foramsulfuron (N.2.17), halosulfuron (N.2.18), halosulfuron-methyl (N.2.19), imazosulfuron (N.2.20), iodosulfuron (N.2.21), iodosulfuron-methyl-sodium (N.2.22), iofensulfuron (N.2.23), iofensulfuron-sodium (N.2.24), mesosulfuron (N.2.25), metazosulfuron (N.2.26), metsulfuron (N.2.27), metsulfuron-methyl (N.2.28), nicosulfuron (N.2.29), orthosulfamuron (N.2.30), oxasulfuron (N.2.31), primisulfuron (N.2.32), primisulfuron-methyl (N.2.33), propyrisulfuron (N.2.34), prosulfuron (N.2.35), pyrazosulfuron (N.2.36), pyrazosulfuron-ethyl (N.2.37), rimsulfuron (N.2.38), sulfometuron (N.2.39), sulfometuron-methyl (N.2.40), sulfosulfuron (N.2.41), thifensulfuron (N.2.42), thifensulfuron-methyl (N.2.43), triasulfuron (N.2.44), tribenuron (N.2.45), tribenuron-methyl (N.2.46), trifloxysulfuron (N.2.47), triflusulfuron (N.2.48), triflusulfuron-methyl (N.2.49), tritosulfuron (N.2.50), imazamethabenz (N.2.51), imazamethabenz-methyl (N.2.52), imazamox (N.2.53), imazapic (N.2.54), imazapyr (N.2.55), imazaquin (N.2.56), imazethapyr (N.2.57); cloransulam (N.2.58), cloransulam-methyl (N.2.59), diclosulam (N.2.60), flumetsulam (N.2.61), florasulam (N.2.62), metosulam (N.2.63), penoxsulam (N.2.64), pyrimisulfan (N.2.65) and pyroxsulam (N.2.66); bispyribac (N.2.67), bispyribac-sodium (N.2.68), pyribenzoxim (N.2.69), pyriftalid (N.2.70), pyriminobac (N.2.71), pyriminobac-methyl (N.2.72), pyrithiobac (N.2.73), pyrithiobac-sodium (N.2.74), 4-[[[2-[(4,6-di-methoxy-2-pyrimidinyl)oxy]phenyl]methyl]amino]-benzoic acid-1-methyl¬ethyl ester ((N.2.75) CAS 420138-41-6), 4-[[[2-[(4,6-dimethoxy-2-pyrimidinyl)oxy]phenyl]¬methyl]amino]-benzoic acid propyl ester ((N.2.76) CAS 420138-40-5), N-(4-bromophenyl)-2-[(4,6-dimethoxy-2-pyrimidinyl)oxy]benzenemethanamine ((N.2.77) CAS 420138-01-8); flucarbazone (N.2.78), flucarbazone-sodium (N.2.79), propoxycarbazone (N.2.80), propoxycarbazone-sodium (N.2.81), thiencarbazone (N.2.82), thiencarbazone-methyl (N.2.83), triafamone (N.2.84);
   N.3 Photosynthesis inhibitors: amicarbazone (N.3.1); chlorotriazine (N.3.2); ametryn (N.3.3), atrazine (N.3.4), chloridazone (N.3.5), cyanazine (N.3.6), desmetryn (N.3.7), dimethametryn (N.3.8), hexazinone (N.3.9), metribuzin (N.3.10), prometon (N.3.11), prometryn (N.3.12), propazine (N.3.13), simazine (N.3.14), simetryn (N.3.15), terbumeton (N.3.16), terbuthylazin (N.3.17), terbutryn (N.3.18), trietazin (N.3.19); chlorobromuron (N.3.20), chlorotoluron (N.3.21), chloroxuron (N.3.22), dimefuron (N.3.23), diuron (N.3.24), fluometuron (N.3.25), isoproturon (N.3.26), isouron (N.3.27), linuron (N.3.28), metamitron (N.3.29), methabenzthiazuron (N.3.30), metobenzuron (N.3.31), metoxuron (N.3.32), monolinuron (N.3.33), neburon (N.3.34), siduron (N.3.35), tebuthiuron (N.3.36), thiadiazuron (N.3.37), desmedipham (N.3.38), karbutilat (N.3.39), phenmedipham (N.3.40), phenmedipham-ethyl (N.3.41), bromofenoxim (N.3.42), bromoxynil (N.3.43) and its salts and esters, ioxynil (N.3.44) and its salts and esters, bromacil (N.3.45), lenacil (N.3.46), terbacil (N.3.47), bentazon (N.3.48), bentazon-sodium (N.3.49), pyridate (N.3.50), pyridafol (N.3.51), pentanochlor (N.3.52), propanil (N.3.53); diquat (N.3.54), diquat-dibromide (N.3.55), paraquat (N.3.56), paraquat-dichloride (N.3.57), paraquat-dimetilsulfate (N.3.58); 1-(6-tert-butylpyrimidin-4-yl)-2-hydroxy-4-methoxy-3-methyl-2H-pyrrol-5-one (CAS 1654744-66-7) (N.3.59); 1-(5-tert-butylisoxazol-3-yl)-2-hydroxy-4-methoxy-3-methyl-2H-pyrrol-5-one (CAS 1637455-12-9) (N.3.60); 1-(5-tert-butylisoxazol-3-yl)-4-chloro-2-hydroxy-3-methyl-2H-pyrrol-5-one (CAS 1637453-94-1) (N.3.61); 1-(5-tert-butyl-1-methyl-pyrazol-3-yl)-4-chloro-2-hydroxy-3-methyl-2H-pyrrol-5-one (CAS 1654057-29-0) (N.3.62); 1-(5-tert-butyl-1-methyl-pyrazol-3-yl)-3-chloro-2-hydroxy-4-methyl-2H-pyrrol-5-one (CAS 1654747-80-4) (N.3.63); 4-hydroxy-1-methoxy-5-methyl-3-[4-(trifluoromethyl)-2-pyridyl]imidazolidin-2-one; (CAS 2023785-78-4) (N.3.64); 4-hydroxy-1,5-dimethyl-3-[4-(trifluoromethyl)-2-pyridyl]imidazolidin-2-one (CAS 2023785-79-5) (N.3.65); 5-ethoxy-4-hydroxy-1-methyl-3-[4-(trifluoromethyl)-2-pyridyl]imidazolidin-2-one (CAS 1701416-69-4) (N.3.66); 4-hydroxy-1-methyl-3-[4-(trifluoromethyl)-2-pyridyl]imidazolidin-2-one (CAS 1708087-22-2) (N.3.67); 4-hydroxy-1,5-dimethyl-3-[1-methyl-5-(trifluoromethyl)pyrazol-3-yl]imidazolidin-2-one (CAS 2023785-80-8) (N.3.68); 1-(5-tert-butylisoxazol-3-yl)-4-ethoxy-5-hydroxy-3-methyl-imidazolidin-2-one (CAS 1844836-64-1) (N.3.69);
   N.4 Protoporphyrinogen-IX oxidase inhibitors: acifluorfen (N.4.1), acifluorfen-sodium (N.4.2), azafenidin (N.4.3), bencarbazone (N.4.4), benzfendizone (N.4.5), bifenox (N.4.6), butafenacil (N.4.7), carfentrazone (N.4.8), carfentrazone-ethyl (N.4.9), chlormethoxyfen (N.4.10), cinidon-ethyl (N.4.11), fluazolate (N.4.12), flufenpyr (N.4.13), flufenpyr-ethyl (N.4.14), flumiclorac (N.4.15), flumiclorac-pentyl (N.4.16), flumioxazin (N.4.17), fluoroglycofen (N.4.18), fluoroglycofen-ethyl (N.4.19), fluthiacet (N.4.20), fluthiacet-methyl (N.4.21), fomesafen (N.4.22), halosafen (N.4.23), lactofen (N.4.24), oxadiargyl (N.4.25), oxadiazon (N.4.26), oxyfluorfen (N.4.27), pentoxazone (N.4.28), profluazol (N.4.29), pyraclonil (N.4.30), pyraflufen (N.4.31), pyraflufen-ethyl (N.4.32), saflufenacil (N.4.33), sulfentrazone (N.4.34), thidiazimin (N.4.35), tiafenacil (N.4.36), trifludimoxazin (N.4.37), ethyl [3-[2-chloro-4-fluoro-5-(1-methyl-6-trifluoromethyl-2,4-dioxo-1,2,3,4-tetrahydropyrimidin-3-yl)phenoxy]-2-pyridyloxy]acetate ((N.4.38) CAS 353292-31-6), N-ethyl-3-(2,6-dichloro-4-trifluoro-methylphenoxy)-5-methyl-1H-pyrazole-1-carboxamide ((N.4.39) CAS 452098-92-9), N tetrahydrofurfuryl-3-(2,6-dichloro-4-trifluoromethylphenoxy)-5-methyl-1H-pyrazole-1-carboxamide ((N.4.40) CAS 915396-43-9), N-ethyl-3-(2-chloro-6-fluoro-4-trifluoromethyl¬phenoxy)-5-methyl-1H-pyrazole-1-carboxamide ((N.4.41) CAS 452099-05-7), N tetrahydro¬furfuryl-3-(2-chloro-6-fluoro-4-trifluoro¬methylphenoxy)-5-methyl-1H-pyrazole-1-carboxamide ((N.4.42) CAS 452100-03-7), 3-[7-fluoro-3-oxo-4-(prop-2-ynyl)-3,4-dihydro-2H-benzo[1,4]oxazin-6-yl]-1,5-dimethyl-6-thioxo-[1,3,5]triazinan-2,4-dione ((N.4.43) CAS 451484-50-7), 2-(2,2,7-trifluoro-3-oxo-4-prop-2-ynyl-3,4-dihydro-2H-benzo[1,4]oxazin-6-yl)-4,5,6,7-tetrahydro-isoindole-1,3-dione ((N.4.44) CAS 1300118-96-0), 1-methyl-6-trifluoro¬methyl-3-(2,2,7-tri-fluoro-3-oxo-4-prop-2-ynyl-3,4-dihydro-2H-benzo[1,4]oxazin-6-yl)-1H-pyrimidine-2,4-dione ((N.4.45) CAS 1304113-05-0), methyl (E)-4-[2-chloro-5-[4-chloro-5-(difluoromethoxy)-1H-methyl-pyrazol-3-yl]-4-fluoro-phenoxy]-3-methoxy-but-2-enoate ((N.4.46) CAS 948893-00-3), 3-[7-chloro-5-fluoro-2-(trifluoromethyl)-1H-benzimidazol-4-yl]-1-methyl-6-(trifluoromethyl)-1H-pyrimidine-2,4-dione ((N.4.47) CAS 212754-02-4);
   N.5 Bleacher herbicides: beflubutamid (N.5.1), diflufenican (N.5.2), fluridone (N.5.3), flurochloridone (N.5.4), flurtamone (N.5.5), norflurazon (N.5.6), picolinafen (N.5.7), 4-(3-trifluoromethyl¬phenoxy)-2-(4-trifluoromethylphenyl)pyrimidine ((N.5.8) CAS 180608-33-7); benzobicyclon (N.5.9), benzofenap (N.5.10), bicyclopyrone (N.5.11), clomazone (N.5.12), fenquintrione (N.5.13), isoxaflutole (N.5.14), mesotrione (N.5.15), pyrasulfotole (N.5.16), pyrazolynate (N.5.17), pyrazoxyfen (N.5.18), sulcotrione (N.5.19), tefuryltrione (N.5.20), tembotrione (N.5.21), tolpyralate (N.5.22), topramezone (N.5.23); aclonifen (N.5.24), amitrole (N.5.25), flumeturon (N.5.26), 2-chloro-3-methylsulfanyl-N-(1-methyltetrazol-5-yl)-4-(trifluoromethyl)benzamide (CAS 1361139-71-0) (N.5.27);
   N.6 Enolpyruvyl shikimate 3-phosphate synthase inhibitors (EPSP inhibitors): glyphosate (N.6.1), glyphosate-isopropylammonium (N.6.2), glyposate-potassium (N.6.3), glyphosate-trimesium (sulfosate) (N.6.4);
   N.7 Glutamine synthase inhibitors: bilanaphos (bialaphos) (N.7.1), bilanaphos-sodium (N.7.2), glufosinate (N.7.3), glufosinate-P (N.7.4), glufosinate-ammonium (N.7.5);
   N.8 7,8-dihydropteroate synthase inhibitors (DHP inhibitors): asulam (N.8.1);
   N.9 Mitosis inhibitors: benfluralin (N.9.1), butralin (N.9.2), dinitramine (N.9.3), ethalfluralin (N.9.4), fluchloralin (N.9.5), oryzalin (N.9.6), pendimethalin (N.9.7), prodiamine (N.9.8), trifluralin (N.9.9); amiprophos (N.9.10), amiprophos-methyl (N.9.11), butamiphos (N.9.12); chlorthal (N.9.13), chlorthal-dimethyl (N.9.14), dithiopyr (N.9.15), thiazopyr (N.9.16), propyzamide (N.9.17), tebutam (N.9.18); carbetamide (N.9.19), chlorpropham (N.9.20), flamprop (N.9.21), flamprop-isopropyl (N.9.22), flamprop-methyl (N.9.23), flamprop-M-isopropyl (N.9.24), flamprop-M-methyl (N.9.25), propham (N.9.26);
   N.10 Inhibitors of the synthesis of very long chain fatty acids (VLCFA inhibitors): acetochlor (N.10.1), alachlor (N.10.2), butachlor (N.10.3), dimethachlor (N.10.4), dimethenamid (N.10.5), dimethenamid-P (N.10.6), metazachlor (N.10.7), metolachlor (N.10.8), metolachlor-S (N.10.9), pethoxamid (N.10.10), pretilachlor (N.10.11), propachlor (N.10.12), propisochlor (N.10.13), thenylchlor (N.10.14), flufenacet (N.10.15), mefenacet (N.10.16), diphenamid (N.10.17), naproanilide (N.10.18), napropamide (N.10.19), napropamide-M (N.10.20), fentrazamide (N.10.21), anilofos (N.10.22), cafenstrole (N.10.23), fenoxasulfone (N.10.24), ipfencarbazone (N.10.25), piperophos (N.10.26), pyroxasulfone (N.10.27), isoxazoline compounds of the formulae II.1 (N.10.28), II.2 (N.10.29), II.3 (N.10.30), II.4 (N.10.31), II.5 (N.10.32), II.6 (N.10.33), II.7 (N.10.34), II.8 (N.10.35) and II.9 (N.10.36)

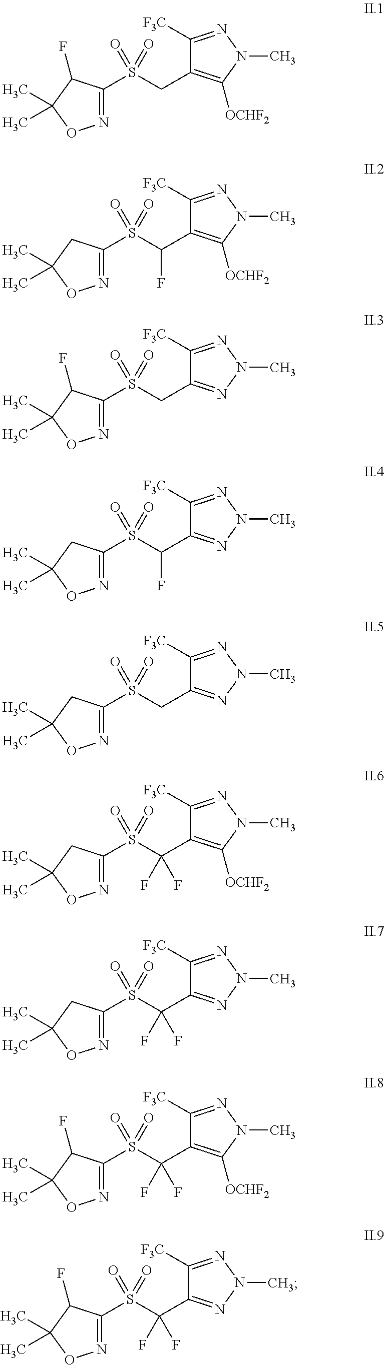

N.11 Cellulose biosynthesis inhibitors: chlorthiamid (N.11.1), dichlobenil (N.11.2), flupoxam (N.11.3), indaziflam (N.11.4), isoxaben (N.11.5), triaziflam (N.11.6), 1-cyclohexyl-5-pentafluorphenyloxy-14-[1,2,4,6]thiatriazin-3-ylamine ((N.11.7) CAS 175899-01-1);
N.12 Decoupler herbicides: dinoseb (N.12.1), dinoterb (N.12.2), DNOC (N.12.3) and its salts;
N.13 Auxinic herbicides: 2,4-D (N.13.1) and its salts and esters, clacyfos (N.13.2), 2,4-DB (N.13.3) and its salts and esters, aminocyclopyrachlor (N.13.4) and its salts and esters, aminopyralid (N.13.5) and its salts such as aminopyralid-dimethylammonium (N.13.6), aminopyralid-tris(2-hydroxypropyl)ammonium (N.13.7) and its esters, benazolin (N.13.8), benazolin-ethyl (N.13.9), chloramben (N.13.10) and its salts and esters, clomeprop (N.13.11), clopyralid (N.13.12) and its salts and esters, dicamba (N.13.13) and its salts and esters, dichlorprop (N.13.14) and its salts and esters, dichlorprop-P (N.13.15) and its salts and esters, fluroxypyr (N.13.16), fluroxypyr-butometyl (N.13.17), fluroxypyr-meptyl (N.13.18), halauxifen (N.13.19) and its salts and esters (CAS 943832-60-8); MCPA (N.13.20) and its salts and esters, MCPA-thioethyl (N.13.21), MCPB (N.13.22) and its salts and esters, mecoprop (N.13.23) and its salts and esters, mecoprop-P (N.13.24) and its salts and esters, picloram (N.13.25) and its salts and esters, quinclorac (N.13.26), quinmerac (N.13.27), TBA (2,3,6) (N.13.28) and its salts and esters, triclopyr (N.13.29) and its salts and esters, florpyrauxifen (N.13.30), florpyrauxifen-benzyl ((N.13.31) CAS 1390661-72-9), 4-amino-3-chloro-5-fluoro-6-(7-fluoro-1H-indol-6-yl)picolinic acid ((N.13.32) CAS 1629965-65-6);

N.14 Auxin transport inhibitors: diflufenzopyr (N.14.1), diflufenzopyr-sodium (N.14.2), naptalam (N.14.3) and naptalam-sodium (N.14.4);

N.15 Other herbicides: bromobutide (N.15.1), chlorflurenol (N.15.2), chlorflurenol-methyl (N.15.3), cinmethylin (N.15.4), cumyluron (N.15.5), cyclopyrimorate ((N.15.6) CAS 499223-49-3) and its salts and esters, dalapon (N.15.7), dazomet (N.15.8), difenzoquat (N.15.9), difenzoquat-metilsulfate (N.15.10), dimethipin (N.15.11), DSMA (N.15.12), dymron (N.15.13), endothal (N.15.14) and its salts, etobenzanid (N.15.15), flurenol (N.15.16), flurenol-butyl (N.15.17), flurprimidol (N.15.18), fosamine (N.15.19), fosamine-ammonium (N.15.20), indanofan (N.15.21), maleic hydrazide (N.15.22), mefluidide (N.15.23), metam (N.15.24), methiozolin ((N.15.25) CAS 403640-27-7), methyl azide (N.15.26), methyl bromide (N.15.27), methyl-dymron (N.15.28), methyl iodide (N.15.29), MSMA (N.15.30), oleic acid (N.15.31), oxaziclomefone (N.15.32), pelargonic acid (N.15.33), pyributicarb (N.15.34), quinoclamine (N.15.35), tridiphane (N.15.36),
including their agriculturally useful salts or their agriculturally acceptable derivatives.

Compounds II (herbicides) and/or safeners as described herein having a carboxyl group can be employed in the form of the acid, in the form of an agriculturally useful salt as mentioned below or else in the form of an agriculturally acceptable derivative, for example as amides, such as mono- and di-C₁-C₆-alkylamides or arylamides, as esters, for example as allyl esters, propargyl esters, C₁-C₁₀-alkyl esters, alkoxyalkyl esters, tefuryl ((tetrahydrofuran-2-yl)methyl) esters and also as thioesters, for example as C₁-C₁₀-alkylthio esters. Preferred mono- and di-C1-C6-alkylamides are the methyl and the dimethylamides. Preferred arylamides are, for example, the anilides and the 2-chloroanilides. Preferred alkyl esters are, for example, the methyl, ethyl, propyl, isopropyl, butyl, isobutyl, pentyl, mexyl (1-methylhexyl), meptyl (1-methylheptyl), heptyl, octyl or isooctyl (2-ethylhexyl) esters. Preferred C₁-C₄-alkoxy-C₁-C₄-alkyl esters are the straight-chain or branched C₁-C₄-alkoxy ethyl esters, for example the 2-methoxyethyl, 2-ethoxyethyl, 2-butoxyethyl (butotyl), 2-butoxypropyl or 3-butoxypropyl ester. An example of a straight-chain or branched C₁-C₁₀-alkylthio ester is the ethylthio ester.

The above mixture of the present invention also includes kit-of-parts comprising a nitrification inhibitor (compound I) and a herbicide (compound II). Here, the term “kit-of-parts” is to be understood to denote a kit comprising at least two separate parts wherein each of the parts can be independently removed from the kit. A kit includes a box, a tool, a vessel, a container, a bag or any kit-like equipment. Also a kit whose separate parts are only together in this one kit for a extremely short period of time are regarded as kit-of-parts. Kit-of-parts are useful for the combined application (of the contents) of the separate parts of the kit.

The present invention also relates to an agrochemical composition, comprising an auxiliary and a mixture comprising as active components at least one compound I and at least one compound II.

The present invention also relates to the use of a mixture or an agrochemical composition according to the invention for nitrification inhibition and/or for increasing the health of a plant and/or for plant growth regulation.

The present invention also relates to a method for controlling vegetation on non-crop areas, especially controlling vegetation of broad-leafed weeds and grass weeds, with an effective amount of a mixture or of an agrochemical composition according to the invention.

The present invention also relates to a method for controlling vegetation on non-crop areas, especially controlling vegetation of broad-leafed weeds and grass weeds, comprising treating the weeds, or the seed, or the soil or the plants to be protected against weeds with an effective amount of a mixture or of an agrochemical composition according to the invention.

The present invention also relates to a method for increasing the health of a plant, comprising treating the plant or the plant propagation material or the soil where the plants are to grow with an effective amount of the mixture or of an agrochemical composition according to the invention.

The present invention also relates to plant propagation material, comprising a mixture or an agrochemical composition according to the invention in an amount of from 0.1 to 10 kg active substances per 100 kg of seed.

A “pesticide” is generally a chemical or biological agent (such as a virus, bacterium, antimicrobial or disinfectant) that through its effect deters, incapacitates, kills or otherwise discourages pests. Target pests can include insects, plant pathogens, weeds, mollusks, birds, mammals, fish, nematodes (roundworms), and microbes that destroy property, cause nuisance, spread disease or are vectors for disease. The term “pesticide” includes also plant growth regulators that alter the expected growth, flowering, or reproduction rate of plants; defoliants that cause leaves or other foliage to drop from a plant, usually to facilitate harvest; desiccants that promote drying of living tissues, such as unwanted plant tops; plant activators that activate plant physiology for defense of against certain pests; safeners that reduce unwanted herbicidal action of pesticides on crop plants; and plant growth promoters that affect plant physiology e.g. to increase plant growth, biomass, yield or any other quality parameter of the harvestable goods of a crop plant.

The term “plant health” or “health of a plant” as used herein is intended to mean a condition of the plant which is determined by several aspects alone or in combination with each other. One indicator (indicator 1) for the condition of the plant is the crop yield. “Crop” and “fruit” are to be understood as any plant product which is further utilized after harvesting, e.g. fruits in the proper sense, vegetables, nuts, grains, seeds, wood (e.g. in the case of silviculture plants), flowers (e.g. in the case of gardening plants, ornamentals) etc., that is anything of economic value that is produced by the plant. Another indicator (indicator 2) for the condition of the plant is the plant vigor. The plant vigor becomes manifest in several aspects, too, some of which are visual appearance, e.g. leaf color, fruit color and aspect, amount of dead basal leaves and/or extent of leaf blades, plant weight, plant height, extent of plant verse (lodging), number, strong ness and productivity of tillers, panicles' length, extent of root system, strongness of roots, extent of nodulation, in particular of rhizobial nodulation, point of time of germination, emergence, flowering, grain maturity and/or senescence, protein content, sugar content and the like. Another indicator (indicator 3) for an increase of a plant's health is the reduction of biotic or abiotic stress factors. The three above mentioned indicators for the health condition of a plant may be interdependent and may result from each other. For example, a reduction of biotic or abiotic stress may lead to a better plant vigor, e.g. to better and bigger crops, and thus to an increased yield. Biotic stress, especially over longer terms, can have harmful effects on plants. The term “biotic stress” as used in the context of the present invention refers in particular to stress caused by living organisms. As a result, the quantity and the quality of the stressed plants, their crops and fruits decrease. As far as quality is concerned, reproductive development is usually severely affected with consequences on the crops which are important for fruits or seeds. Growth may be slowed by the stresses; polysaccharide synthesis, both structural and storage, may be reduced or modified: these effects may lead to a decrease in biomass and to changes in the nutritional value of the product. Abiotic stress includes drought, cold, increased UV, increased heat, or other changes in the environment of the plant, that leads to sub-optimal growth conditions. The term “increased yield” of a plant as used herein means that the yield of a product of the respective plant is increased by a measurable amount over the yield of the same product of the plant produced under the same conditions, but without the application of the composition of the invention. According to the present invention, it is preferred that the yield is increased by at least 2%, more preferably by at least 4%, most preferably at least 7%, particularly preferably at least 10%, more particularly preferably by at least 15%, most particularly preferably by at least 20%, particularly more preferably by at least 25%, particularly most preferably by at least 30%, particularly by at least 35%, especially more preferably by at least 40%, especially most preferably by at least 45%, especially by at least 50%, in particular preferably by at least 55%, in particular more preferably by at least 60%, in particular most preferably by at least 65%, in particular by at least 70%, for example by at least 75%. According to the present invention, it is preferred that the yield is increased—compared to the situation in which only the individual compound I or the individual compound II is used—by at least 1%, more preferably by at least 2%, most preferably at least 3%, particularly preferably at least 4%, more particularly preferably by at least 5%, most particularly preferably by at least 6%, particularly more preferably by at least 7%, particularly most preferably by at least 8%, particularly by at least 10%, especially more preferably by at least 12%, especially most preferably by at least 14%, especially by at least 16%, in particular preferably by at least 18%. An increased yield may, for example, be due to a reduction of nitrification and a corresponding improvement of uptake of nitrogen nutrients. The term “improved plant vigor” as used herein means that certain crop characteristics are increased or improved by a measurable or noticeable amount over the same factor of the plant produced under the same conditions, but without the application of the composition of the present invention. Improved plant vigor can be characterized, among others, by following improved properties of a plant:
(a) improved vitality of the plant,
(b) improved quality of the plant and/or of the plant products, e.g.
(b) enhanced protein content,
(c) improved visual appearance,
(d) delay of senescence,
(e) enhanced root growth and/or more developed root system (e.g. determined by the dry mass of the root),
(f) enhanced nodulation, in particular rhizobial nodulation,
(g) longer panicles,
(h) bigger leaf blade,
(i) less dead basal leaves,
(j) increased chlorophyll content
(k) prolonged photosynthetically active period
(l) improved nitrogen-supply within the plant
(m) improved water use efficiency

The improvement of the plant vigor according to the present invention particularly means that the improvement of anyone or several or all of the above mentioned plant characteristics are improved. It further means that if not all of the above characteristics are improved, those which are not improved are not worsened as compared to plants which were not treated according to the invention or are at least not worsened to such an extent that the negative effect exceeds the positive effect of the improved characteristic (i.e. there is always an overall positive effect which preferably results in an improved crop yield). An improved plant vigor may, for example, be due to a reduction of nitrification and, e.g. a regulation of plant growth.

Practical agricultural experience has shown that the repeated and exclusive application of an individual active component in the control of vegetation in non-crop areas, e.g. in the control of weeds, leads in many cases to a rapid selection of those weeds which have developed natural or adapted resistance against the active component in question. Effective control of these weeds with the active component in question is then no longer possible.

Another typical problem arising in the field of pest control lies in the need to reduce the dosage rates of the active ingredient to reduce or avoid unfavorable environmental or toxicological effects whilst still allowing effective pest control.

It is an object of the present invention to overcome the abovementioned disadvantages and to provide, with a view to effective resistance management and effective control of weeds or to effective plant growth regulation, at application rates which are as low as possible, compositions which, at a reduced total amount of active compounds applied, have improved activity against the weeds or improved plant growth regulating activity (synergistic mixtures) and a broadened activity spectrum, in particular for certain indications.

This is particularly visible if application rates for the beforementioned mixtures of pesticides are used where the individual components show no or virtually no activity. The invention can also result in an advantageous behavior during formulation or during use, for example during grinding, sieving, emulsifying, dissolving or dispensing; improved storage stability and light stability, advantageous residue formation, improved toxicological or ecotoxicological behaviour, improved properties of the plant, for example better growth, increased harvest yields, a better developed root system, a larger leaf area, greener leaves, stronger shoots, less seed required, lower phytotoxicity, mobilization of the defense system of the plant, good compatibility with plants. Moreover, even an enhanced systemic action of the pesticides as defined herein and/or a persistency of the herbicidal, fungicidal, insecticidal, acaricidal, nematicidal action and/or plant growth regulating activity are expected.

It was therefore also an object of the present invention to provide mixtures which solve the problems of reducing the dosage rate, and/or enhancing the spectrum of activity, and/or combining knock-down activity with prolonged control, and/or improving resistance management and/or promoting (increasing) the health of plants, and/or facilitating application on the plants or on the soil.

We have accordingly found that this object is achieved by the mixtures and compositions defined herein.

Any reference to “compound I” refers to compound I as such, or an agriculturally useful salt thereof.

Any reference to “compound II” refers to compound II as such, or an agriculturally useful salt thereof.

Any reference to “compound III” refers to compound III as such, or an agriculturally useful salt thereof.

Agriculturally useful salts of the active compounds I, II and III encompass especially the salts of those cations or the acid addition salts of those acids whose cations and anions, respectively, have no adverse effect on the herbicidal action of the active compounds. Suitable cations are thus in particular the ions of the alkali metals, preferably sodium and potassium, of the alkaline earth metals, preferably calcium, magnesium and barium, of the transition metals, preferably manganese, copper, zinc and iron, and also the ammonium ion which, if desired, may carry 1 to 4 C₁-C₄-alkyl substituents and/or one phenyl or benzyl substituent, preferably di isopropylammonium, tetramethylammonium, tetrabutylammonium, trimethylbenzylammonium, furthermore phosphonium ions, sulfonium ions, preferably tri(C₁-C₄-alkyl)sulfonium, and sulfoxonium ions, preferably tri(C₁-C₄-alkyl)sulfoxonium. Anions of useful acid addition salts are primarily chloride, bromide, fluoride, hydrogensulfate, sulfate, dihydrogenphosphate, hydrogen-phosphate, phosphate, nitrate, bicarbonate, carbonate, hexafluorosilicate, hexafluorophosphate, benzoate, and the anions of C₁-C₄-alkanoic acids, preferably formate, acetate, propionate and butyrate. They can be formed by reacting a compound I with an acid of the corresponding anion, preferably of hydrochloric acid, hydrobromic acid, sulfuric acid, phosphoric acid or nitric acid.

The scope of the present invention includes mixtures of the (R)- and (S)-isomers and the racemates of compounds I and/or II and/or III having one or more chiral centers. As a result of hindered rotation of asymmetrically substituted groups, atrope isomers of active compounds I and/or II and/or III may be present. They also form part of the subject matter of the invention.

The active compounds I and/or II and/or III of the present invention may be present in the form of their N-oxides. The term “N-oxide” includes any compound of the present invention which has at least one tertiary nitrogen atom that is oxidized to an N-oxide moiety. N-oxides of compounds of the mixtures of the present invention can in particular be prepared by oxidizing the ring nitrogen atom(s) of the pyridine ring and/or the pyrazole ring with a suitable oxidizing agent, such as peroxo carboxylic acids or other peroxides. The person skilled in the art knows if and in which positions compounds of the mixtures of the present invention, i.e. of the compounds I and/or II and/or III, may form N-oxides.

The compounds II and/or the mixtures or compositions according to the invention, respectively, are suitable as herbicides. They are suitable as such or as an appropriately formulated composition (agrochemical composition).

The mixtures or compositions according to the invention control vegetation on non-crop areas very efficiently, especially at high rates of application. They act against broad-leafed weeds and grass weeds in crops such as wheat, rice, corn, soybeans and cotton without causing any significant damage to the crop plants. This effect is mainly observed at low rates of application.

The mixtures or compositions according to the invention are applied to the plants preferably by spraying the leaves. Here, the application can be carried out using, for example, water as carrier by customary spraying techniques using spray liquor amounts of from about 100 to 1000 I/ha (for example from 300 to 400 I/ha). The mixtures or compositions may also be applied by the low-volume or the ultra-low-volume method, or in the form of microgranules. The mixtures or compositions according to the present invention can be applied pre- or post-emergence or together with the seed of a crop plant. It is also possible to apply the individual compounds and mixtures or compositions by applying seed, pretreated with a composition of the invention, of a crop plant. If the active compounds I and II and, if appropriate a further component such as a safener, are less well tolerated by certain crop plants, application techniques may be used in which the herbicidal compositions are sprayed, with the aid of the spraying equipment, in such a way that as far as possible they do not come into contact with the leaves of the sensitive crop plants, while the active compounds reach the leaves of undesirable plants growing underneath, or the bare soil surface (post-directed, lay-by).

Application of the mixtures or compositions according to the present invention can be done before, during and/or after, preferably during and/or after, the emergence of the undesirable plants.

In a further embodiment, the mixtures or compositions according to the invention can be applied by treating seed. The treatment of seed comprises essentially all procedures familiar to the person skilled in the art (seed dressing, seed coating, seed dusting, seed soaking, seed film coating, seed multilayer coating, seed encrusting, seed dripping and seed pelleting) based on the compounds II of the mixtures of the invention or the compositions prepared therefrom. Here, the mixtures or compositions can be applied diluted or undiluted.

The term “seed” comprises seed of all types, such as, for example, corns, seeds, fruits, tubers, seedlings and similar forms. Here, preferably, the term seed describes corns and seeds. The seed used can be seed of the useful plants mentioned above, but also the seed of transgenic plants or plants obtained by customary breeding methods.

Moreover, it may be advantageous to apply the mixtures or compositions of the present invention on their own or jointly in combination with other crop protection agents, for example with agents for controlling pests or phytopathogenic fungi or bacteria or with groups of active compounds which regulate growth. Also of interest is the miscibility with mineral salt solutions which are employed for treating nutritional and trace element deficiencies. Non-phytotoxic oils and oil concentrates can also be added.

As used herein, the term “metabolite” refers to any component, compound, substance or byproduct (including but not limited to small molecule secondary metabolites, polyketides, fatty acid synthase products, non-ribosomal peptides, ribosomal peptides, proteins and enzymes) produced by a microorganism (such as fungi and bacteria, in particular the strains of the invention) that has any beneficial effect as described herein such as pesticidal activity or improvement of plant growth, water use efficiency of the plant, plant health, plant appearance, or the population of beneficial microorganisms in the soil around the plant activity herein.

In another preferred embodiment, the compound II (herbicide) is a lipid biosynthesis inhibitor.

In another preferred embodiment, the compound II (herbicide) is an acetolactate synthase inhibitor (ALS inhibitor).

In another preferred embodiment, the compound II (herbicide) is a photosynthesis inhibitor.

In another preferred embodiment, the compound II (herbicide) is a protoporphyrinogen-IX oxidase inhibitor.

In another preferred embodiment, the compound II (herbicide) is a bleacher herbicide.

In another preferred embodiment, the compound II (herbicide) is an enolpyruvyl shikimate 3-phosphate synthase inhibitor (EPSP inhibitor).

In another preferred embodiment, the compound II (herbicide) is a glutamine synthetase inhibitor.

In another preferred embodiment, the compound II (herbicide) is a 7,8-dihydropteroate synthase inhibitor (DHP inhibitor).

In another preferred embodiment, the compound II (herbicide) is a mitosis inhibitor.

In another preferred embodiment, the compound II (herbicide) is an inhibitor of the synthesis of very long chain fatty acids (VLCFA inhibitor).

In another preferred embodiment, the compound II (herbicide) is a cellulose biosynthesis inhibitor.

In another preferred embodiment, the compound II (herbicide) is a decoupler herbicide.

In another preferred embodiment, the compound II (herbicide) is an auxinic herbicide.

In another preferred embodiment, the compound II (herbicide) is an auxin transport inhibitor.

In another preferred embodiment, the compound II (herbicide) is an other herbicide selected from the group consisting of bromobutide, chlorflurenol, chlorflurenol-methyl, cinmethylin, cumyluron, dalapon, dazomet, difenzoquat, difenzoquat-metilsulfate, dimethipin, DSMA, dymron, endothal and its salts, etobenzanid, flamprop, flamprop-isopropyl, flamprop-methyl, flamprop-M-isopropyl, flamprop-M-methyl, flurenol, flurenol-butyl, flurprimidol, fosamine, fosamine-ammonium, indanofan, indaziflam, maleic hydrazide, mefluidide, metam, methiozolin (CAS 403640-27-7), methyl azide, methyl bromide, methyl-dymron, methyl iodide, MSMA, oleic acid, oxaziclomefone, pelargonic acid, pyributicarb, quinoclamine, triaziflam, tridiphane and 6-chloro-3-(2-cyclopropyl-6-methylphenoxy)-4-pyridazinol (CAS 499223-49-3) and its salts and esters.

In a particularly preferred embodiment, the compound II (herbicide) is selected from the group consisting of bensulfuron-methyl, bispyribac-sodium, cyclosulfamuron, diclosulam, flumetsulam, flupyrsulfuron-methyl-sodium, foramsulfuron, imazamox, imazapic, imazapyr, imazaquin, imazethapyr, imazosulfuron, iodosulfuron, iodosulfuron-methyl-sodium, iofensulfuron, iofensulfuron-sodium, mesosulfuron, metazosulfuron, nicosulfuron, penoxsulam, propoxycarbazon-sodium, propyrisulfuron, pyrazosulfuron-ethyl, pyroxsulam, rimsulfuron, sulfosulfuron, thiencarbazon-methyl, tritosulfuron and triafamone.

In another preferred embodiment, the compound II (herbicide) is is selected from the group consisting of amitrole, bicyclopyrone, clomazone, diflufenican, fenquinotrione, flumeturon, flurochloridone, isoxaflutole, mesotrione, oxotrione (CAS 1486617-21-3), picolinafen, sulcotrione, tefuryltrione, tembotrione, tolpyralate, topramezone and 2-chloro-3-methylsulfanyl-N-(1-methyltetrazol-5-yl)-4-(trifluoromethyl)benzamide (CAS 1361139-71-0).

In another preferred embodiment, the compound II (herbicide) is selected from the group consisting of 2,4-D and its salts and esters such as clacyfos, and aminocyclopyrachlor and its salts and esters, aminopyralid and its salts and its esters, clopyralid and its salts and esters, dicamba and its salts and esters, flopyrauxifen, fluroxypyr-meptyl, halauxifen, halauxifen-methyl, quinclorac, quinmerac, florpyrauxifen, florpyrauxifen-benzyl (CAS 1390661-72-9) and 4-amino-3-chloro-5-fluoro-6-(7-fluoro-1H-indol-6-yl)picolinic acid (CAS 1629965-65-6).

In another preferred embodiment, the compound II (herbicide) is selected from the group consisting of saflufenacil (N.4.33), and glyphosate (N.6.1).

In another preferred embodiment, the compound II (herbicide) is saflufenacil (N.4.33).

In another preferred embodiment, the compound II (herbicide) is glyphosate (N.6.1).

In another preferred embodiment, the mixture or composition of the invention comprises

a) 2-(3,4-dimethyl-1H-pyrazol-1-yl)succinic acid (DMPSA1) and/or 2-(4,5-dimethyl-1H-pyrazol-1-yl)succinic acid (DMPSA2), and/or a derivative thereof, and/or a salt thereof, more preferably DMPSA1 and/or DMPSA2, most preferably DMPSA1, as active compound I (nitrification inhibitor), and
b) at least one compound selected from the group consisting of saflufenacil (N.4.33), and glyphosate (N.6.1), as compound II (herbicide).

In another preferred embodiment, the mixture or composition of the invention comprises

a) 2-(3,4-dimethyl-1H-pyrazol-1-yl)succinic acid (DMPSA1) and/or 2-(4,5-dimethyl-1H-pyrazol-1-yl)succinic acid (DMPSA2), and/or a derivative thereof, and/or a salt thereof, more preferably DMPSA1 and/or DMPSA2, most preferably DMPSA1, as active compound I (nitrification inhibitor), and
b) saflufenacil (N.4.33) as compound II (herbicide).

In another preferred embodiment, the mixture or composition of the invention comprises

a) 2-(3,4-dimethyl-1H-pyrazol-1-yl)succinic acid (DMPSA1) and/or 2-(4,5-dimethyl-1H-pyrazol-1-yl)succinic acid (DMPSA2), and/or a derivative thereof, and/or a salt thereof, more preferably DMPSA1 and/or DMPSA2, most preferably DMPSA1, as active compound I (nitrification inhibitor), and
b) glyphosate (N.6.1) as compound II (herbicide).

In another preferred embodiment, the mixture or composition of the invention comprises a compound I (nitrification inhibitor), and glyphosate (N.6.1) as compound II (herbicide), wherein compound I and compound II are present preferably in a weight ratio of from 200:1 to 1:25, more preferably in a weight ratio of from 120:1 to 1:15, most preferably in a weight ratio of from 70:1 to 1:8, particularly preferably in a weight ratio of from 45:1 to 1:4, particularly more preferably in a weight ratio of from 30:1 to 1:2, particularly most preferably in a weight ratio of from 28:1 to 1:1, particularly in a weight ratio of from 20:1 to 3:1, for instance preferably in a weight ratio of from 16:1 to 5:1, for instance in a weight ratio of from 12:1 to 6:1.

In another preferred embodiment, the mixture or composition of the invention comprises a compound I (nitrification inhibitor), and saflufenacil (N.4.33) as compound II (herbicide), wherein compound I and compound II are present preferably in a weight ratio of from 1000:1 to 1:20, more preferably in a weight ratio of from 800:1 to 1:10, most preferably in a weight ratio of from 600:1 to 1:1, particularly preferably in a weight ratio of from 400:1 to 10:1, particularly more preferably in a weight ratio of from 300:1 to 30:1, particularly most preferably in a weight ratio of from 250:1 to 50:1, particularly in a weight ratio of from 200:1 to 70:1, for instance preferably in a weight ratio of from 170:1 to 90:1, for instance in a weight ratio of from 150:1 to 100:1.

Particularly preferred compounds II (herbicides) that can be used in combination with the compound I (nitrification inhibitor) according to the present invention are:

b1) from the group of the lipid biosynthesis inhibitors: clodinafop-propargyl, cycloxydim, cyhalofop-butyl, fenoxaprop-P-ethyl, pinoxaden, profoxydim, tepraloxydim, tralkoxydim, 4-(4′-Chloro-4-cyclopropyl-2′-fluoro[1,11-biphenyl]-3-yl)-5-hydroxy-2,2,6,6-tetramethyl-2H-pyran-3(6H)-one (CAS 1312337-72-6); 4-(2′,4′-Dichloro-4-cyclopropyl[1,1-biphenyl]-3-yl)-5-hydroxy-2,2,6,6-tetramethyl-2H-pyran-3(6H)-one (CAS 1312337-45-3); 4-(4′-Chloro-4-ethyl-2′-fluoro[1,1′-biphenyl]-3-yl)-5-hydroxy-2,2,6,6-tetramethyl-2H-pyran-3(6H)-one (CAS 1033757-93-5); 4-(2′,4′-Dichloro-4-ethyl[1,1′-biphenyl]-3-yl)-2,2,6,6-tetramethyl-2H-pyran-3,5(4H,6H)-dione (CAS 1312340-84-3); 5-(Acetyloxy)-4-(4′-chloro-4-cyclopropyl-2′-fluoro[1,1′-biphenyl]-3-yl)-3,6-dihydro-2,2,6,6-tetramethyl-2H-pyran-3-one (CAS 1312337-48-6); 5-(Acetyloxy)-4-(2″,4′-dichloro-4-cyclopropyl-[1,1′-biphenyl]-3-yl)-3,6-dihydro-2,2,6,6-tetramethyl-2H-pyran-3-one; 5-(Acetyloxy)-4-(4′-chloro-4-ethyl-2′-fluoro[1,1′-biphenyl]-3-yl)-3,6-dihydro-2,2,6,6-tetramethyl-2H-pyran-3-one (CAS 1312340-82-1); 5-(Acetyloxy)-4-(2′,4′-dichloro-4-ethyl[1,1′-biphenyl]-3-yl)-3,6-dihydro-2,2,6,6-tetramethyl-2H-pyran-3-one (CAS 1033760-55-2); 4-(4′-Chloro-4-cyclopropyl-2′-fluoro[1,1′-biphenyl]-3-yl)-5,6-dihydro-2,2,6,6-tetramethyl-5-oxo-2H-pyran-3-yl carbonic acid methyl ester (CAS 1312337-51-1); 4-(2″,4′-Dichloro-4-cyclopropyl-[1,1-biphenyl]-3-yl)-5,6-dihydro-2,2,6,6-tetramethyl-5-oxo-2H-pyran-3-ylcarbonic acid methyl ester; 4-(4′-Chloro-4-ethyl-2′-fluoro[1,1′-biphenyl]-3-yl)-5,6-dihydro-2,2,6,6-tetramethyl-5-oxo-2H-pyran-3-ylcarbonic acid methyl ester (CAS 1312340-83-2); 4-(2′,4′-Dichloro-4-ethyl[1,1′-biphenyl]-3-yl)-5,6-dihydro-2,2,6,6-tetramethyl-5-oxo-2H-pyran-3-yl carbonic acid methyl ester (CAS 1033760-58-5); esprocarb, prosulfocarb, thiobencarb and triallate;
b2) from the group of the ALS inhibitors: bensulfuron-methyl, bispyribac-sodium, cyclosulfamuron, diclosulam, flumetsulam, flupyrsulfuron-methyl-sodium, foramsulfuron, imazamox, imazapic, imazapyr, imazaquin, imazethapyr, imazosulfuron, iodosulfuron, iodosulfuron-methyl-sodium, iofensulfuron, iofensulfuron-sodium, mesosulfuron, metazosulfuron, nicosulfuron, penoxsulam, propoxycarbazon-sodium, propyrisulfuron, pyrazosulfuron-ethyl, pyroxsulam, rimsulfuron, sulfosulfuron, thiencarbazon-methyl, tritosulfuron and triafamone;
b3) from the group of the photosynthesis inhibitors: ametryn, atrazine, diuron, fluometuron, hexazinone, isoproturon, linuron, metribuzin, paraquat, paraquat-dichloride, propanil, terbutryn, terbuthylazine, 1-(5-tert-butylisoxazol-3-yl)-2-hydroxy-4-methoxy-3-methyl-2H-pyrrol-5-one (CAS 1637455-12-9), 1-(5-tert-butylisoxazol-3-yl)-4-chloro-2-hydroxy-3-methyl-2H-pyrrol-5-one (CAS 1637453-94-1), 1-(5-tert-butylisoxazol-3-yl)-4-ethoxy-5-hydroxy-3-methyl-imidazolidin-2-one (CAS 1844836-64-1);
b4) from the group of the protoporphyrinogen-IX oxidase inhibitors: flumioxazin, oxyfluorfen, pyraflufen, pyraflufen-ethyl, saflufenacil, sulfentrazone, trifludimoxazin, ethyl [3-[2-chloro-4-fluoro-5-(1-methyl-6-trifluoromethyl-2,4-dioxo-1,2,3,4-tetrahydropyrimidin-3-yl)phenoxy]-2-pyridyloxy]acetate (CAS 353292-31-6; S-3100), 3-[7-fluoro-3-oxo-4-(prop-2-ynyl)-3,4-dihydro-2H-benzo[1,4]oxazin-6-yl]-1,5-dimethyl-6-thioxo-[1,3,5]triazinan-2,4-dione (CAS 451484-50-7), 2-(2,2,7-trifluoro-3-oxo-4-prop-2-ynyl-3,4-dihydro-2H-benzo[1,4]oxazin-6-yl)-4,5,6,7-tetrahydro-isoindole-1,3-dione (CAS 1300118-96-0), and 1-methyl-6-trifluoromethyl-3-(2,2,7-trifluoro-3-oxo-4-prop-2-ynyl-3,4-dihydro-2H-benzo[1,4]oxazin-6-yl)-1H-pyrimidine-2,4-dione (CAS 1304113-05-0);
b5) from the group of the bleacher herbicides: amitrole, bicyclopyrone, clomazone, diflufenican, fenquinotrione, flumeturon, flurochloridone, isoxaflutole, mesotrione, oxotrione (CAS 1486617-21-3), picolinafen, sulcotrione, tefuryltrione, tembotrione, tolpyralate, topramezone and 2-chloro-3-methylsulfanyl-N-(1-methyltetrazol-5-yl)-4-(trifluoromethyl)benzamide (CAS 1361139-71-0);
b6) from the group of the EPSP synthase inhibitors: glyphosate, glyphosate-isopropylammonium and glyphosate-trimesium (sulfosate);
b7) from the group of the glutamine synthase inhibitors: glufosinate, glufosinate-P and glufosinate-ammonium;
b9) from the group of the mitosis inhibitors: pendimethalin and trifluralin;
b10) from the group of the VLCFA inhibitors: acetochlor, cafenstrole, dimethenamid-P, fentrazamide, flufenacet, mefenacet, metazachlor, metolachlor, S-metolachlor, fenoxasulfone, ipfencarbazone and pyroxasulfone; likewise, preference is given to isoxazoline compounds of the formulae II.1, II.2, II.3, II.4, II.5, II.6, II.7, II.8 and II.9 as mentioned above;
b11) from the group of the cellulose biosynthesis inhibitors: indaziflam, isoxaben and triaziflam;
b13) from the group of the auxinic herbicides: 2,4-D and its salts and esters such as clacyfos, and aminocyclopyrachlor and its salts and esters, aminopyralid and its salts and its esters, clopyralid and its salts and esters, dicamba and its salts and esters, flopyrauxifen, fluroxypyr-meptyl, halauxifen, halauxifen-methyl, quinclorac, quinmerac, florpyrauxifen, florpyrauxifen-benzyl (CAS 1390661-72-9) and 4-amino-3-chloro-5-fluoro-6-(7-fluoro-1H-indol-6-yl)picolinic acid (CAS 1629965-65-6);
b14) from the group of the auxin transport inhibitors: diflufenzopyr and diflufenzopyr-sodium,
b15) from the group of the other herbicides: cinmethylin, dymon (=daimuron), indanofan, oxaziclomefone.

Active compounds B and C having a carboxyl group can be employed in the form of the acid, in the form of an agriculturally useful salt as mentioned above or else in the form of an agriculturally acceptable derivative in the compositions according to the invention.

In the case of dicamba, agriculturally useful salts include those, where the counterion is an agriculturally acceptable cation. For example, agriculturally useful salts of dicamba are dicamba-sodium, dicamba-potassium, dicamba-methylammonium, dicamba-dimethylammonium, dicamba-isopropylammonium, dicamba-diglycolamine, dicamba-olamine, dicamba-diolamine, dicamba-trolamine, dicamba-N,N-bis-(3-aminopropyl)methylamine and dicamba-diethylenetriamine. Examples of an agriculturally useful ester are dicamba-methyl and dicamba-butotyl.

Agriculturally useful salts of 2,4-D are 2,4-D-ammonium, 2,4-D-dimethylammonium, 2,4-D-diethylammonium, 2,4-D-diethanolammonium (2,4-D-diolamine), 2,4-D-triethanolammonium, 2,4-D-isopropylammonium, 2,4-D-triisopropanolammonium, 2,4-D-heptylammonium, 2,4-D-dodecylammonium, 2,4-D-tetradecylammonium, 2,4-D-triethylammonium, 2,4-D-tris(2-hydroxypropyl)ammonium, 2,4-D-tris(isopropyl)ammonium, 2,4-D-trolamine, 2,4-D-lithium, 2,4-D-sodium. Examples of agriculturally useful esters of 2,4-D are 2,4-D-butotyl, 2,4-D-2-butoxypropyl, 2,4-D-3-butoxypropyl, 2,4-D-butyl, 2,4-D-ethyl, 2,4-D-ethylhexyl, 2,4-D-isobutyl, 2,4-D-isooctyl, 2,4-D-isopropyl, 2,4-D-meptyl, 2,4-D-methyl, 2,4-D-octyl, 2,4-D-pentyl, 2,4-D-propyl, 2,4-D-tefuryl and clacyfos.

Agriculturally useful salts of 2,4-DB are for example 2,4-DB-sodium, 2,4-DB-potassium and 2,4-DB-dimethylammonium. Agriculturally useful esters of 2,4-DB are for example 2,4-DB-butyl and 2,4-DB-isoctyl.

Agriculturally useful salts of dichlorprop are for example dichlorprop-sodium, dichlorprop-potassium and dichlorprop-dimethylammonium. Examples of agriculturally useful esters of dichlorprop are dichlorprop-butotyl and dichlorprop-isoctyl.

Agriculturally useful salts and esters of MCPA include MCPA-butotyl, MCPA-butyl, MCPA-dimethylammonium, MCPA-diolamine, MCPA-ethyl, MCPA-thioethyl, MCPA-2-ethylhexyl, MCPA-isobutyl, MCPA-isoctyl, MCPA-isopropyl, MCPA-isopropylannnnoniunn, MCPA-methyl, MCPA-olamine, MCPA-potassium, MCPA-sodium and MCPA-trolamine.

An agriculturally useful salt of MCPB is MCPB sodium. An agriculturally useful ester of MCPB is MCPB-ethyl.

Agriculturally useful salts of clopyralid are clopyralid-potassium, clopyralid-olamine and clopyralid-tris-(2-hydroxypropyl)ammonium. Example of agriculturally useful esters of clopyralid is clopyralid-methyl.

Examples of an agriculturally useful ester of fluroxypyr are fluroxypyr-meptyl and fluroxypyr-2-butoxy-1-methylethyl, wherein fluroxypyr-meptyl is preferred.

Agriculturally useful salts of picloram are picloram-dimethylammonium, picloram-potassium, picloram-triisopropanolammonium, picloram-triisopropylammonium and picloram-trolamine. An agriculturally useful ester of picloram is picloram-isoctyl.

An agriculturally useful salt of triclopyr is triclopyr-triethylammonium. Agriculturally useful esters of triclopyr are for example triclopyr-ethyl and triclopyr-butotyl.

Agriculturally useful salts and esters of chloramben include chloramben-ammonium, chloramben-diolamine, chloramben-methyl, chloramben-methylammonium and chloramben-sodium. Agriculturally useful salts and esters of 2,3,6-TBA include 2,3,6-TBA-dimethylammonium, 2,3,6-TBA-lithium, 2,3,6-TBA-potassium and 2,3,6-TBA-sodium.

Agriculturally useful salts and esters of aminopyralid include aminopyralid-potassium, aminopyralid-dimethylammonium, and aminopyralid-tris(2-hydroxypropyl)ammonium.

Agriculturally useful salts of glyphosate are for example glyphosate-ammonium, glyphosate-diammonium, glyphoste-dimethylammonium, glyphosate-isopropylammonium, glyphosate-potassium, glyphosate-sodium, glyphosate-trimesium as well as the ethanolamine and diethanolamine salts, preferably glyphosate-diammonium, glyphosate-isopropylammonium and glyphosate-trimesium (sulfosate).

An agriculturally useful salt of glufosinate is for example glufosinate-ammonium.

An agriculturally useful salt of glufosinate-P is for example glufosinate-P-ammonium.

Agriculturally useful salts and esters of bromoxynil are for example bromoxynil-butyrate, bromoxynil-heptanoate, bromoxynil-octanoate, bromoxynil-potassium and bromoxynil-sodium.

Agriculturally useful salts and esters of ioxonil are for example ioxonil-octanoate, ioxonil-potassium and ioxonil-sodium.

Agriculturally useful salts and esters of mecoprop include mecoprop-butotyl, mecoprop-dimethylammonium, mecoprop-diolamine, mecoprop-ethadyl, mecoprop-2-ethylhexyl, mecoprop-isoctyl, mecoprop-methyl, mecoprop-potassium, mecoprop-sodium and mecoprop-trolamine.

Agriculturally useful salts of mecoprop-P are for example mecoprop-P-butotyl, mecoprop-P-dimethylammonium, mecoprop-P-2-ethylhexyl, mecoprop-P-isobutyl, mecoprop-P-potassium and mecoprop-P-sodium.

An agriculturally useful salt of diflufenzopyr is for example diflufenzopyr-sodium.

An agriculturally useful salt of naptalam is for example naptalam-sodium.

Agriculturally useful salts and esters of aminocyclopyrachlor are for example aminocyclopyrachlor-dimethylammonium, ami nocyclopyrachlor-methyl, aminocyclopyrachlor-triisopropanolammonium, aminocyclopyrachlor-sodium and aminocyclopyrachlor-potassium.

An agriculturally useful salt salt of quinclorac is for example quinclorac-dimethylammonium.

An agriculturally useful salt salt of quinmerac is for example quinmerac-dimethylammonium.

An agriculturally useful salt salt of imazamox is for example imazamox-ammonium.

Agriculturally useful salts of imazapic are for example imazapic-ammonium and imazapic-isopropylammonium.

Agriculturally useful salts of imazapyr are for example imazapyr-ammonium and imazapyr-isopropylammonium.

An agriculturally useful salt of imazaquin is for example imazaquin-ammonium.

Agriculturally useful salts of imazethapyr are for example imazethapyr-ammonium and imazethapyr-isopropylammonium.

An agriculturally useful salt of topramezone is for example topramezone-sodium.

Regarding the Compounds I, the compound and preparation of DMPSA1 or DMPSA2 have been described for example in WO 2015/086823 A2. DMPSA1 is described in the formula I below, and DMPSA2 is described in formula II below. The compound and preparation of DMPG, DMPC, DMPL, and DMPM have been described for example in AU 2015/227487 B1. The compound and preparation of N-((3(5)-methyl-1H-pyrazole-1-yl)methyl)acetamide have been described for example in DE 102013022031 B3, The compound and preparation of N-((3(5)-methyl-1H-pyrazole-1-yl)methyl)formamide, N-((4-chloro-3(5)-methyl-pyrazole-1-yl)methyl)formamide, and N-a3(5),4-dimethylpyrazole-1-yl)methyl)formamide have been described for example in EP 2785697 B1. A reaction adduct of dicyandiamide, urea and formaldehyde, a triazonyl-formaldehyde-dicyandiamide adduct, 2-cyano-1-((4-oxo-1,3,5-triazinan-1-yl)methyl)guanidine, 1-((2-cyanoguanidino)methyl)urea, and 2-cyano-1-((2-cyanoguanidino)methyl)guanidine have been described in US 2016/0060184 A1. 2-cyano-1-((4-oxo-1,3,5-triazinan-1-yl)methyl)guanidine has the structure as described in formula III below, and 1-((2-cyanoguanidino)methyl)urea has the structure as described in formula IV below, and 2-cyano-1-((2-cyanoguanidino)methyl)guanidine has the structure as described in formula V below.

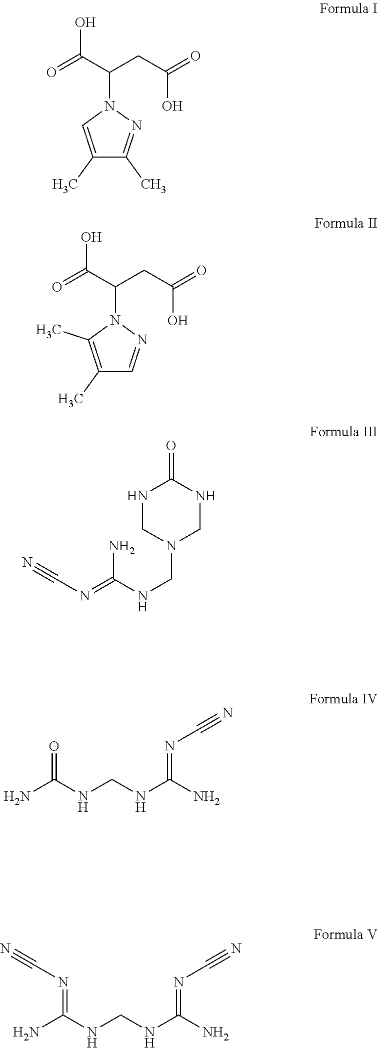

In one preferred embodiment, the present invention relates to mixtures comprising at least one active compound I, wherein the active compound I is 2-(3,4-dimethyl-1H-pyrazol-1-yl)succinic acid (DMPSA1) and/or 2-(4,5-dimethyl-1H-pyrazol-1-yl)succinic acid (DMPSA2), and/or a derivative thereof, and/or a salt thereof, more preferably DMPSA1 and/or DMPSA2, most preferably DMPSA1.

In another preferred embodiment, the present invention relates to mixtures comprising at least one active compound I, wherein the active compound I is a salt of DMPSA1 and/or DMPSA2, more preferably an alkali salt, an earth alkali salt, or an ammonium salt of DMPSA1 and/or DMPSA2, most preferably a potassium salt, sodium salt, magnesium salt, or an ammonium salt of DMPSA1 and/or DMPSA2, particularly a potassium salt of DMPSA1 and/or DMPSA2.

In another preferred embodiment, the present invention relates to mixtures comprising at least one active compound I, wherein the active compound I is an alkali salt of DMPSA1 and/or DMPSA2.

In another preferred embodiment, the present invention relates to mixtures comprising at least one active compound I, wherein the active compound I is an earth alkali salt of DMPSA1 and/or DMPSA2.

In another preferred embodiment, the present invention relates to mixtures comprising at least one active compound I, wherein the active compound I is an ammonium salt of DMPSA1 and/or DMPSA2.

In another preferred embodiment, the present invention relates to mixtures comprising at least one active compound I, wherein the active compound I is a sodium salt of DMPSA1 and/or DMPSA2.

In another preferred embodiment, the present invention relates to mixtures comprising at least one active compound I, wherein the active compound I is a magnesium salt of DMPSA1 and/or DMPSA2.

In another preferred embodiment, the present invention relates to mixtures comprising at least one active compound I, wherein the active compound I is the glycolic acid addition salt of 3,4-dimethyl pyrazole (3,4-dimethyl pyrazolium glycolate, referred to as “DMPG” in the following), and/or an isomer thereof, and/or a derivative thereof, most preferably DMPG.

In another preferred embodiment, the present invention relates to mixtures comprising at least one active compound I, wherein the active compound I is the citric acid addition salt of 3,4-dimethyl pyrazole (3,4-dimethyl pyrazolium citrate, referred to as “DMPC” in the following), and/or an isomer thereof, and/or a derivative thereof, most preferably DMPC.

In another preferred embodiment, the present invention relates to mixtures comprising at least one active compound I, wherein the active compound I is the lactic acid addition salt of 3,4-dimethyl pyrazole (3,4-dimethyl pyrazolium lactate, referred to as “DMPL” in the following), and/or an isomer thereof, and/or a derivative thereof, most preferably DMPL.

In another preferred embodiment, the present invention relates to mixtures comprising at least one active compound I, wherein the active compound I is the mandelic acid addition salt of 3,4-dimethyl pyrazole (3,4-dimethyl pyrazolium mandelate, referred to as “DMPM” in the following), and/or an isomer thereof, and/or a derivative thereof, most preferably DMPM.

In another preferred embodiment, the present invention relates to mixtures comprising at least one active compound I, wherein the active compound I is 1,2,4-triazole (referred to as “TZ” in the following), and/or a derivative thereof, and/or a salt thereof, most preferably TZ.

In another preferred embodiment, the present invention relates to mixtures comprising at least one active compound I, wherein the active compound I is 4-Chloro-3-methylpyrazole (referred to as “CIMP” in the following), and/or an isomer thereof, and/or a derivative thereof, and/or a salt thereof, most preferably CIMP.

In another preferred embodiment, the present invention relates to mixtures comprising at least one active compound I, wherein the active compound I is N-((3(5)-methyl-1H-pyrazole-1-yl)methyl)acetamide, and/or an isomer thereof, and/or a derivative thereof, and/or a salt thereof, most preferably N-((3-methyl-1H-pyrazole-1-yl)methyl)acetamide, and/or N-((5-methyl-1H-pyrazole-1-yl)methyl)acetamide.

In another preferred embodiment, the present invention relates to mixtures comprising at least one active compound I, wherein the active compound I is N-((3(5)-methyl-1H-pyrazole-1-yl)methyl)formamide, and/or an isomer thereof, and/or a derivative thereof, and/or a salt thereof, most preferably N-((3-methyl-1H-pyrazole-1-yl)methyl)formamide, and/or N-((5-methyl-1H-pyrazole-1-yl)methyl)formamide.

In another preferred embodiment, the present invention relates to mixtures comprising at least one active compound I, wherein the active compound I is N-((3(5),4-dimethylpyrazole-1-yl)methyl)formamide, and/or an isomer thereof, and/or a derivative thereof, and/or a salt thereof, most preferably N-((3,4-dimethyl-1H-pyrazole-1-yl)methyl)formamide, and/or N-((4,5-dimethyl-1H-pyrazole-1-yl)methyl)formamide.

In another preferred embodiment, the present invention relates to mixtures comprising at least one active compound I, wherein the active compound I is N-((4-chloro-3(5)-methyl-pyrazole-1-yl)methyl)formamide, and/or an isomer thereof, and/or a derivative thereof, and/or a salt thereof, most preferably N-((4-chloro-3-methyl-pyrazole-1-yl)methyl)formamide, and/or N-((4-chloro-5-methyl-pyrazole-1-yl)methyl)formamide.

In another preferred embodiment, the present invention relates to mixtures comprising at least one active compound I, wherein the active compound I is a reaction adduct of dicyandiamide, urea and formaldehyde, preferably a reaction adduct of dicyandiamide, urea and formaldehyde as described in US 2016/0060184 A1.

In another preferred embodiment, the present invention relates to mixtures comprising at least one active compound I, wherein the active compound I is a triazonyl-formaldehyde-dicyandiamide adducte, preferably a triazonyl-formaldehyde-dicyandiamide adduct as described in US 2016/0060184 A1.

In another preferred embodiment, the present invention relates to mixtures comprising at least one active compound I, wherein the active compound I is 2-cyano-1-((4-oxo-1,3,5-triazinan-1-yl)methyl)guanidine.

In another preferred embodiment, the present invention relates to mixtures comprising at least one active compound I, wherein the active compound I is 1-((2-cyanoguanidino)methyl)urea.

Particularly preferred are mixtures wherein compound I is selected from the group consisting of compounds I.A to I.AU:
I.A: 2-(3,4-dimethyl-1H-pyrazol-1-yl)succinic acid (DMPSA1) and/or 2-(4,5-dimethyl-1H-pyrazol-1-yl)succinic acid (DMPSA2),
I.B: a salt of DMPSA1 and/or DMPSA2,
I.C: a potassium salt of DMPSA1 and/or DMPSA2,
I.D: an ammonium salt of DMPSA1 and/or DMPSA2,
I.E a sodium salt of DMPSA1 and/or DMPSA2,
I.F: 3,4-dimethyl pyrazolium glycolate (DMPG),
I.G: 3,4-dimethyl pyrazolium citrate (DMPC),
I.H: 3,4-dimethyl pyrazolium lactate (DMPL),
I.J: 3,4-dimethyl pyrazolium lactate (DMPM),
I.K: 1,2,4-triazole (TZ),
I.L: 4-Chloro-3-methylpyrazole (CIMP),
I.M N-((3(5)-methyl-1H-pyrazole-1-yl)methyl)acetamide,
I.N N-((3(5)-methyl-1H-pyrazole-1-yl)methyl)formamide,
I.O N-((3(5),4-dimethyl pyrazole-1-yl)methyl)formamide,
I.P N-((4-chloro-3(5)-methyl-pyrazole-1-yl)methyl)formamide,
I.Q reaction adduct of dicyandiamide, urea and formaldehyde, or a triazonyl-formaldehyde-dicyandiamide adduct
I.R 2-cyano-1-((4-oxo-1,3,5-triazinan-1-yl)methyl)guanidine,
I.S 1-((2-cyanoguanidino)methyl)urea,
I.T 2-cyano-1-((2-cyanoguanidino)methyl)guanidine,
I.U 2-chloro-6-(trichloromethyl)-pyridine (nitrapyrin or N-serve),
I.V dicyandiamide (DCD, DIDIN),
I.W 3,4-dimethyl pyrazole phosphate, and/or 4,5-dimethyl pyrazole phosphate (DMPP, ENTEC), and/or an isomer thereof, and/or a derivative thereof,
I.X 3,4-dimethylpyrazole, and/or 4,5-dimethylpyrazole (DMP), and/or an isomer thereof, and/or a derivative thereof, and/or a salt thereof, and/or an acid addition salt thereof,
I.Y ammoniumthiosulfate (ATU),
I.Z neem,
I.AA linoleic acid,
I.AB alpha-linolenic acid,
I.AC methyl p-coumarate,
I.AD methyl ferulate,
I.AE methyl 3-(4-hydroxyphenyl) propionate (MHPP),
I.AF brachialacton,
I.AG p-benzoquinone sorgoleone,
I.AH 4-amino-1,2,4-triazole hydrochloride (ATC),
I.AI 1-amido-2-thiourea (ASU),
I.AJ 2-amino-4-chloro-6-methylpyrimidine (AM),
I.AK 2-mercapto-benzothiazole (MBT),
I.AL 5-ethoxy-3-trichloromethyl-1,2,4-thiodiazole (terrazole, etridiazole),
I.AM 2-sulfanilamidothiazole (ST),
I.AN 3-methylpyrazol (3-MP),
I.AO 1,2,4-triazol thiourea (TU),
I.AP cyan amide,
I.AQ melamine,
I.AR zeolite powder,
I.AS catechol,
I.AT benzoquinone,
I.AU sodium tetra borate,
I.AV allylthiourea,
I.AW chlorate salts, or
I.AX zinc sulfate.

In one aspect of the invention, compound I is selected from the group of compounds consisting of I.A, I.B, I.C, I.D, I.E, I.L, I.M, I.N, I.O, I.P, I.Q, I.R, I.S., I.T, I.U, I.V, I.W, I.X, I.Y, I.Z, I.AA, I.AB, I.AC, I.AD, I.AE, I.AF, I.AG, I.AH, I.AI, I.AJ, I.AK, I.AL, I.AM, I.AN, I.AO, I.AP, I.AQ, I.AR, I.AS, I.AT, I.AU, I.AV, I.AW, or I.AX, more preferably selected from the group of compounds consisting of I.A, I.B, I.C, I.D, I.E, I.L, I.M, I.N, I.O, I.P, I.Q, I.R, I.S., I.T, I.U, I.V, I.W, I.X, I.Y, I.AX, most preferably selected from the group of compounds consisting of I.A, I.B, I.C, I.D, I.E, I.L, I.M, I.N, I.O, I.P, I.Q, I.R, I.S.

With respect to their intended use in the methods of the present invention, the following binary mixtures (A) listed in tables 1 to 49 comprising one compound (I) and one compound (II) are a preferred embodiment of the present invention.

According to the present invention and/or with respect to their intended use in the methods of the present invention, the following binary mixtures (B) listed in tables 1 to 49 comprising one compound (I) and one compound (II) are a preferred embodiment of the present invention.

TABLE 1
B = Mixture; I = compound; II = compound II

| B | I | II |
|---|---|---|
| B1 | (I.A) | N.1.1 |
| B2 | (I.A) | N.1.2 |
| B3 | (I.A) | N.1.3 |
| B4 | (I.A) | N.1.4 |
| B5 | (I.A) | N.1.5 |
| B6 | (I.A) | N.1.6 |
| B7 | (I.A) | N.1.7 |
| B8 | (I.A) | N.1.8 |
| B9 | (I.A) | N.1.9 |
| B10 | (I.A) | N.1.10 |
| B11 | (I.A) | N.1.11 |
| B12 | (I.A) | N.1.12 |
| B13 | (I.A) | N.1.13 |
| B14 | (I.A) | N.1.14 |
| B15 | (I.A) | N.1.15 |
| B16 | (I.A) | N.1.16 |
| B17 | (I.A) | N.1.17 |
| B18 | (I.A) | N.1.18 |
| B19 | (I.A) | N.1.19 |
| B20 | (I.A) | N.1.20 |
| B21 | (I.A) | N.1.21 |
| B22 | (I.A) | N.1.22 |
| B23 | (I.A) | N.1.23 |
| B24 | (I.A) | N.1.24 |
| B25 | (I.A) | N.1.25 |
| B26 | (I.A) | N.1.26 |
| B27 | (I.A) | N.1.27 |
| B28 | (I.A) | N.1.28 |
| B29 | (I.A) | N.1.29 |
| B30 | (I.A) | N.1.30 |
| B31 | (I.A) | N.1.31 |
| B32 | (I.A) | N.1.32 |
| B33 | (I.A) | N.1.33 |
| B34 | (I.A) | N.1.34 |
| B35 | (I.A) | N.1.35 |
| B36 | (I.A) | N.1.36 |
| B37 | (I.A) | N.1.37 |
| B38 | (I.A) | N.1.38 |
| B39 | (I.A) | N.1.39 |
| B40 | (I.A) | N.1.40 |
| B41 | (I.A) | N.1.41 |
| B42 | (I.A) | N.1.42 |
| B43 | (I.A) | N.1.43 |
| B44 | (I.A) | N.1.44 |
| B45 | (I.A) | N.1.45 |
| B46 | (I.A) | N.1.46 |
| B47 | (I.A) | N.1.47 |
| B48 | (I.A) | N.1.48 |
| B49 | (I.A) | N.1.49 |
| B50 | (I.A) | N.1.50 |
| B51 | (I.A) | N.1.51 |
| B52 | (I.A) | N.1.52 |
| B53 | (I.A) | N.1.53 |
| B54 | (I.A) | N.1.54 |
| B55 | (I.A) | N.1.55 |
| B56 | (I.A) | N.1.56 |
| B57 | (I.A) | N.1.57 |
| B58 | (I.A) | N.1.58 |
| B59 | (I.A) | N.1.59 |
| B60 | (I.A) | N.1.60 |
| B61 | (I.A) | N.1.61 |
| B62 | (I.A) | N.1.62 |
| B63 | (I.A) | N.1.63 |
| B64 | (I.A) | N.1.64 |
| B65 | (I.A) | N.1.65 |
| B66 | (I.A) | N.1.66 |
| B67 | (I.A) | N.2.1 |
| B68 | (I.A) | N.2.2 |
| B69 | (I.A) | N.2.3 |
| B70 | (I.A) | N.2.4 |
| B71 | (I.A) | N.2.5 |
| B72 | (I.A) | N.2.6 |
| B73 | (I.A) | N.2.7 |
| B74 | (I.A) | N.2.8 |
| B75 | (I.A) | N.2.9 |
| B76 | (I.A) | N.2.10 |
| B77 | (I.A) | N.2.11 |
| B78 | (I.A) | N.2.12 |
| B79 | (I.A) | N.2.13 |
| B80 | (I.A) | N.2.14 |
| B81 | (I.A) | N.2.15 |
| B82 | (I.A) | N.2.16 |
| B83 | (I.A) | N.2.17 |
| B84 | (I.A) | N.2.18 |
| B85 | (I.A) | N.2.19 |
| B86 | (I.A) | N.2.20 |
| B87 | (I.A) | N.2.21 |
| B88 | (I.A) | N.2.22 |
| B89 | (I.A) | N.2.23 |
| B90 | (I.A) | N.2.24 |
| B91 | (I.A) | N.2.25 |
| B92 | (I.A) | N.2.26 |
| B93 | (I.A) | N.2.27 |
| B94 | (I.A) | N.2.28 |
| B95 | (I.A) | N.2.29 |
| B96 | (I.A) | N.2.30 |
| B97 | (I.A) | N.2.31 |
| B98 | (I.A) | N.2.32 |
| B99 | (I.A) | N.2.33 |
| B100 | (I.A) | N.2.34 |
| B101 | (I.A) | N.2.35 |
| B102 | (I.A) | N.2.36 |
| B103 | (I.A) | N.2.37 |
| B104 | (I.A) | N.2.38 |
| B105 | (I.A) | N.2.39 |
| B106 | (I.A) | N.2.40 |
| B107 | (I.A) | N.2.41 |
| B108 | (I.A) | N.2.42 |
| B109 | (I.A) | N.2.43 |
| B110 | (I.A) | N.2.44 |
| B111 | (I.A) | N.2.45 |
| B112 | (I.A) | N.2.46 |
| B113 | (I.A) | N.2.47 |
| B114 | (I.A) | N.2.48 |
| B115 | (I.A) | N.2.49 |
| B116 | (I.A) | N.2.50 |
| B117 | (I.A) | N.2.51 |
| B118 | (I.A) | N.2.52 |
| B119 | (I.A) | N.2.53 |
| B120 | (I.A) | N.2.54 |
| B121 | (I.A) | N.2.55 |
| B122 | (I.A) | N.2.56 |
| B123 | (I.A) | N.2.57 |
| B124 | (I.A) | N.2.58 |
| B125 | (I.A) | N.2.59 |
| B126 | (I.A) | N.2.60 |
| B127 | (I.A) | N.2.61 |
| B128 | (I.A) | N.2.62 |
| B129 | (I.A) | N.2.63 |
| B130 | (I.A) | N.2.64 |
| B131 | (I.A) | N.2.65 |
| B132 | (I.A) | N.2.66 |
| B133 | (I.A) | N.2.67 |
| B134 | (I.A) | N.2.68 |
| B135 | (I.A) | N.2.69 |
| B136 | (I.A) | N.2.70 |
| B137 | (I.A) | N.2.71 |
| B138 | (I.A) | N.2.72 |
| B139 | (I.A) | N.2.73 |
| B140 | (I.A) | N.2.74 |
| B141 | (I.A) | N.2.75 |
| B142 | (I.A) | N.2.76 |
| B143 | (I.A) | N.2.77 |
| B144 | (I.A) | N.2.78 |
| B145 | (I.A) | N.2.79 |
| B146 | (I.A) | N.2.80 |
| B147 | (I.A) | N.2.81 |
| B148 | (I.A) | N.2.82 |
| B149 | (I.A) | N.2.83 |
| B150 | (I.A) | N.2.84 |
| B151 | (I.A) | N.3.1 |
| B152 | (I.A) | N.3.2 |
| B153 | (I.A) | N.3.3 |
| B154 | (I.A) | N.3.4 |
| B155 | (I.A) | N.3.5 |
| B156 | (I.A) | N.3.6 |
| B157 | (I.A) | N.3.7 |
| B158 | (I.A) | N.3.8 |
| B159 | (I.A) | N.3.9 |
| B160 | (I.A) | N.3.10 |
| B161 | (I.A) | N.3.11 |
| B162 | (I.A) | N.3.12 |
| B163 | (I.A) | N.3.13 |
| B164 | (I.A) | N.3.14 |
| B165 | (I.A) | N.3.15 |
| B166 | (I.A) | N.3.16 |
| B167 | (I.A) | N.3.17 |
| B168 | (I.A) | N.3.18 |
| B169 | (I.A) | N.3.19 |
| B170 | (I.A) | N.3.20 |
| B171 | (I.A) | N.3.21 |
| B172 | (I.A) | N.3.22 |
| B173 | (I.A) | N.3.23 |
| B174 | (I.A) | N.3.24 |
| B175 | (I.A) | N.3.25 |
| B176 | (I.A) | N.3.26 |
| B177 | (I.A) | N.3.27 |
| B178 | (I.A) | N.3.28 |
| B179 | (I.A) | N.3.29 |
| B180 | (I.A) | N.3.30 |
| B181 | (I.A) | N.3.31 |
| B182 | (I.A) | N.3.32 |
| B183 | (I.A) | N.3.33 |
| B184 | (I.A) | N.3.34 |
| B185 | (I.A) | N.3.35 |
| B186 | (I.A) | N.3.36 |
| B187 | (I.A) | N.3.37 |
| B188 | (I.A) | N.3.38 |
| B189 | (I.A) | N.3.39 |
| B190 | (I.A) | N.3.40 |
| B191 | (I.A) | N.3.41 |
| B192 | (I.A) | N.3.42 |
| B193 | (I.A) | N.3.43 |
| B194 | (I.A) | N.3.44 |
| B195 | (I.A) | N.3.45 |
| B196 | (I.A) | N.3.46 |
| B197 | (I.A) | N.3.47 |
| B198 | (I.A) | N.3.48 |
| B199 | (I.A) | N.3.49 |
| B200 | (I.A) | N.3.50 |
| B201 | (I.A) | N.3.51 |
| B202 | (I.A) | N.3.52 |
| B203 | (I.A) | N.3.53 |
| B204 | (I.A) | N.3.54 |
| B205 | (I.A) | N.3.55 |
| B206 | (I.A) | N.3.56 |
| B207 | (I.A) | N.3.57 |
| B208 | (I.A) | N.3.58 |
| B209 | (I.A) | N.3.59 |
| B210 | (I.A) | N.3.60 |
| B211 | (I.A) | N.3.61 |
| B212 | (I.A) | N.3.62 |
| B213 | (I.A) | N.3.63 |
| B214 | (I.A) | N.3.64 |
| B215 | (I.A) | N.3.65 |
| B216 | (I.A) | N.3.66 |
| B217 | (I.A) | N.3.67 |
| B218 | (I.A) | N.3.68 |
| B219 | (I.A) | N.3.69 |
| B220 | (I.A) | N.4.1 |
| B221 | (I.A) | N.4.2 |
| B222 | (I.A) | N.4.3 |
| B223 | (I.A) | N.4.4 |
| B224 | (I.A) | N.4.5 |
| B225 | (I.A) | N.4.6 |
| B226 | (I.A) | N.4.7 |
| B227 | (I.A) | N.4.8 |
| B228 | (I.A) | N.4.9 |
| B229 | (I.A) | N.4.10 |
| B230 | (I.A) | N.4.11 |
| B231 | (I.A) | N.4.12 |
| B232 | (I.A) | N.4.13 |
| B233 | (I.A) | N.4.14 |
| B234 | (I.A) | N.4.15 |
| B235 | (I.A) | N.4.16 |
| B236 | (I.A) | N.4.17 |
| B237 | (I.A) | N.4.18 |
| B238 | (I.A) | N.4.19 |
| B239 | (I.A) | N.4.20 |
| B240 | (I.A) | N.4.21 |
| B241 | (I.A) | N.4.22 |
| B242 | (I.A) | N.4.23 |
| B243 | (I.A) | N.4.24 |
| B244 | (I.A) | N.4.25 |
| B245 | (I.A) | N.4.26 |
| B246 | (I.A) | N.4.27 |
| B247 | (I.A) | N.4.28 |
| B248 | (I.A) | N.4.29 |
| B249 | (I.A) | N.4.30 |
| 6250 | (I.A) | N.4.31 |
| 6251 | (I.A) | N.4.32 |
| B252 | (I.A) | N.4.33 |
| B253 | (I.A) | N.4.34 |
| B254 | (I.A) | N.4.35 |
| B255 | (I.A) | N.4.36 |
| B256 | (I.A) | N.4.37 |
| 6257 | (I.A) | N.4.38 |
| 6258 | (I.A) | N.4.39 |
| 6259 | (I.A) | N.4.40 |
| B260 | (I.A) | N.4.41 |
| B261 | (I.A) | N.4.42 |
| B262 | (I.A) | N.4.43 |
| B263 | (I.A) | N.4.44 |
| B264 | (I.A) | N.4.45 |
| B265 | (I.A) | N.4.46 |
| B266 | (I.A) | N.4.47 |
| B267 | (I.A) | N.5.1 |
| B268 | (I.A) | N.5.2 |
| B269 | (I.A) | N.5.3 |
| B270 | (I.A) | N.5.4 |
| B271 | (I.A) | N.5.5 |
| B272 | (I.A) | N.5.6 |
| B273 | (I.A) | N.5.7 |
| B274 | (I.A) | N.5.8 |
| B275 | (I.A) | N.5.9 |
| B276 | (I.A) | N.5.10 |
| B277 | (I.A) | N.5.11 |
| B278 | (I.A) | N.5.12 |
| B279 | (I.A) | N.5.13 |
| B280 | (I.A) | N.5.14 |
| B281 | (I.A) | N.5.15 |
| B282 | (I.A) | N.5.16 |
| B283 | (I.A) | N.5.17 |
| B284 | (I.A) | N.5.18 |
| B285 | (I.A) | N.5.19 |
| B286 | (I.A) | N.5.20 |
| B287 | (I.A) | N.5.21 |
| B288 | (I.A) | N.5.22 |
| B289 | (I.A) | N.5.23 |
| B290 | (I.A) | N.5.24 |
| B291 | (I.A) | N.5.25 |
| B292 | (I.A) | N.5.26 |
| B293 | (I.A) | N.5.27 |
| B294 | (I.A) | N.6.1 |
| B295 | (I.A) | N.6.2 |
| B296 | (I.A) | N.6.3 |
| B297 | (I.A) | N.6.4 |
| B298 | (I.A) | N.7.1 |
| B299 | (I.A) | N.7.2 |
| B300 | (I.A) | N.7.3 |
| B301 | (I.A) | N.7.4 |
| B302 | (I.A) | N.7.5 |
| B303 | (I.A) | N.8.1 |
| B304 | (I.A) | N.9.1 |
| B305 | (I.A) | N.9.2 |
| B306 | (I.A) | N.9.3 |
| B307 | (I.A) | N.9.4 |
| B308 | (I.A) | N.9.5 |
| B309 | (I.A) | N.9.6 |
| B310 | (I.A) | N.9.7 |
| B311 | (I.A) | N.9.8 |
| B312 | (I.A) | N.9.9 |
| B313 | (I.A) | N.9.10 |
| B314 | (I.A) | N.9.11 |
| B315 | (I.A) | N.9.12 |
| B316 | (I.A) | N.9.13 |
| B317 | (I.A) | N.9.14 |
| B318 | (I.A) | N.9.15 |
| B319 | (I.A) | N.9.16 |
| B320 | (I.A) | N.9.17 |
| B321 | (I.A) | N.9.18 |
| B322 | (I.A) | N.9.19 |
| B323 | (I.A) | N.9.20 |
| B324 | (I.A) | N.9.21 |
| B325 | (I.A) | N.9.22 |
| B326 | (I.A) | N.9.23 |
| B327 | (I.A) | N.9.24 |
| B328 | (I.A) | N.9.25 |
| B329 | (I.A) | N.9.26 |
| B330 | (I.A) | N.10.1 |
| B331 | (I.A) | N.10.2 |
| B332 | (I.A) | N.10.3 |
| B333 | (I.A) | N.10.4 |
| B334 | (I.A) | N.10.5 |
| B335 | (I.A) | N.10.6 |
| B336 | (I.A) | N.10.7 |
| B337 | (I.A) | N.10.8 |
| B338 | (I.A) | N.10.9 |
| B339 | (I.A) | N.10.10 |
| B340 | (I.A) | N.10.12 |
| B341 | (I.A) | N.10.13 |
| B342 | (I.A) | N.10.14 |
| B343 | (I.A) | N.10.15 |
| B344 | (I.A) | N.10.16 |
| B345 | (I.A) | N.10.17 |
| B346 | (I.A) | N.10.18 |
| B347 | (I.A) | N.10.19 |
| B348 | (I.A) | N.10.20 |
| B349 | (I.A) | N.10.21 |
| B350 | (I.A) | N.10.22 |
| B351 | (I.A) | N.10.23 |
| B352 | (I.A) | N.10.24 |
| B353 | (I.A) | N.10.25 |
| B354 | (I.A) | N.10.26 |
| B355 | (I.A) | N.10.27 |
| B356 | (I.A) | N.10.28 |
| B357 | (I.A) | N.10.29 |
| B358 | (I.A) | N.10.30 |
| B359 | (I.A) | N.10.31 |
| B360 | (I.A) | N.10.32 |
| B361 | (I.A) | N.10.33 |
| B362 | (I.A) | N.10.34 |
| B363 | (I.A) | N.10.35 |
| B364 | (I.A) | N.10.36 |
| B365 | (I.A) | N.11.1 |
| B366 | (I.A) | N.11.2 |
| B367 | (I.A) | N.11.3 |
| B368 | (I.A) | N.11.4 |
| B369 | (I.A) | N.11.5 |
| B370 | (I.A) | N.11.6 |
| B371 | (I.A) | N.11.7 |
| B372 | (I.A) | N.12.1 |
| B373 | (I.A) | N.12.2 |
| B374 | (I.A) | N.12.3 |
| B375 | (I.A) | N.13.1 |
| B376 | (I.A) | N.13.2 |
| B377 | (I.A) | N.13.3 |
| B378 | (I.A) | N.13.4 |
| B379 | (I.A) | N.13.5 |
| B380 | (I.A) | N.13.6 |
| B381 | (I.A) | N.13.7 |
| B382 | (I.A) | N.13.8 |
| B383 | (I.A) | N.13.9 |
| B384 | (I.A) | N.13.10 |
| B385 | (I.A) | N.13.11 |
| B386 | (I.A) | N.13.12 |
| B387 | (I.A) | N.13.13 |
| B388 | (I.A) | N.13.14 |
| B389 | (I.A) | N.13.15 |
| B390 | (I.A) | N.13.16 |
| B391 | (I.A) | N.13.17 |
| B392 | (I.A) | N.13.18 |
| B393 | (I.A) | N.13.19 |
| B394 | (I.A) | N.13.20 |
| B395 | (I.A) | N.13.21 |
| B396 | (I.A) | N.13.22 |
| B397 | (I.A) | N.13.23 |
| B398 | (I.A) | N.13.24 |
| B399 | (I.A) | N.13.25 |
| B400 | (I.A) | N.13.26 |
| B401 | (I.A) | N.13.27 |
| B402 | (I.A) | N.13.28 |
| B403 | (I.A) | N.13.29 |
| B404 | (I.A) | N.13.30 |
| B405 | (I.A) | N.13.31 |
| B406 | (I.A) | N.13.32 |
| B407 | (I.A) | N.14.1 |
| B408 | (I.A) | N.14.2 |
| B409 | (I.A) | N.14.3 |
| B410 | (I.A) | N.14.4 |
| B411 | (I.A) | N.15.1 |
| B412 | (I.A) | N.15.2 |
| B413 | (I.A) | N.15.3 |
| B414 | (I.A) | N.15.4 |
| B415 | (I.A) | N.15.5 |
| B416 | (I.A) | N.15.6 |
| B417 | (I.A) | N.15.7 |
| B418 | (I.A) | N.15.8 |
| B419 | (I.A) | N.15.9 |
| B420 | (I.A) | N.15.10 |
| B421 | (I.A) | N.15.11 |
| B422 | (I.A) | N.15.12 |
| B423 | (I.A) | N.15.13 |
| B424 | (I.A) | N.15.14 |
| B425 | (I.A) | N.15.15 |
| B426 | (I.A) | N.15.16 |
| B427 | (I.A) | N.15.17 |
| B428 | (I.A) | N.15.18 |
| B429 | (I.A) | N.15.19 |
| B430 | (I.A) | N.15.20 |
| B431 | (I.A) | N.15.21 |
| B432 | (I.A) | N.15.22 |
| B433 | (I.A) | N.15.23 |
| B434 | (I.A) | N.15.24 |
| B435 | (I.A) | N.15.25 |
| B436 | (I.A) | N.15.26 |
| B437 | (I.A) | N.15.27 |
| B438 | (I.A) | N.15.28 |
| B439 | (I.A) | N.15.29 |
| B440 | (I.A) | N.15.30 |
| B441 | (I.A) | N.15.31 |
| B442 | (I.A) | N.15.32 |
| B443 | (I.A) | N.15.33 |
| B444 | (I.A) | N.15.34 |
| B445 | (I.A) | N.15.35 |
| B446 | (I.A) | N.15.36 |

TABLE 2
B = Mixture; I = compound; II = compound II

| B | I | II |
|---|---|---|
| B447 | (I.B) | N.1.1 |
| B448 | (I.B) | N.1.2 |
| B449 | (I.B) | N.1.3 |
| B450 | (I.B) | N.1.4 |
| B451 | (I.B) | N.1.5 |
| B452 | (I.B) | N.1.6 |
| B453 | (I.B) | N.1.7 |
| B454 | (I.B) | N.1.8 |
| B455 | (I.B) | N.1.9 |
| B456 | (I.B) | N.1.10 |
| B457 | (I.B) | N.1.11 |
| B458 | (I.B) | N.1.12 |
| B459 | (I.B) | N.1.13 |
| B460 | (I.B) | N.1.14 |
| B461 | (I.B) | N.1.15 |
| B462 | (I.B) | N.1.16 |
| B463 | (I.B) | N.1.17 |
| B464 | (I.B) | N.1.18 |
| B465 | (I.B) | N.1.19 |
| B466 | (I.B) | N.1.20 |
| B467 | (I.B) | N.1.21 |
| B468 | (I.B) | N.1.22 |
| B469 | (I.B) | N.1.23 |
| B470 | (I.B) | N.1.24 |
| B471 | (I.B) | N.1.25 |
| B472 | (I.B) | N.1.26 |
| B473 | (I.B) | N.1.27 |
| B474 | (I.B) | N.1.28 |
| B475 | (I.B) | N.1.29 |
| B476 | (I.B) | N.1.30 |
| B477 | (I.B) | N.1.31 |
| B478 | (I.B) | N.1.32 |
| B479 | (I.B) | N.1.33 |
| B480 | (I.B) | N.1.34 |
| B481 | (I.B) | N.1.35 |
| B482 | (I.B) | N.1.36 |
| B483 | (I.B) | N.1.37 |
| B484 | (I.B) | N.1.38 |
| B485 | (I.B) | N.1.39 |
| B486 | (I.B) | N.1.40 |
| B487 | (I.B) | N.1.41 |
| B488 | (I.B) | N.1.42 |
| B489 | (I.B) | N.1.43 |
| B490 | (I.B) | N.1.44 |
| B491 | (I.B) | N.1.45 |
| B492 | (I.B) | N.1.46 |
| B493 | (I.B) | N.1.47 |
| B494 | (I.B) | N.1.48 |
| B495 | (I.B) | N.1.49 |
| B496 | (I.B) | N.1.50 |
| B497 | (I.B) | N.1.51 |
| B498 | (I.B) | N.1.52 |
| B499 | (I.B) | N.1.53 |
| B500 | (I.B) | N.1.54 |
| B501 | (I.B) | N.1.55 |
| B502 | (I.B) | N.1.56 |
| B503 | (I.B) | N.1.57 |
| B504 | (I.B) | N.1.58 |
| B505 | (I.B) | N.1.59 |
| B506 | (I.B) | N.1.60 |
| B507 | (I.B) | N.1.61 |
| B508 | (I.B) | N.1.62 |
| B509 | (I.B) | N.1.63 |
| B510 | (I.B) | N.1.64 |
| B511 | (I.B) | N.1.65 |
| B512 | (I.B) | N.1.66 |
| B513 | (I.B) | N.2.1 |
| B514 | (I.B) | N.2.2 |
| B515 | (I.B) | N.2.3 |
| B516 | (I.B) | N.2.4 |
| B517 | (I.B) | N.2.5 |
| B518 | (I.B) | N.2.6 |
| B519 | (I.B) | N.2.7 |
| B520 | (I.B) | N.2.8 |
| B521 | (I.B) | N.2.9 |
| B522 | (I.B) | N.2.10 |
| B523 | (I.B) | N.2.11 |
| B524 | (I.B) | N.2.12 |
| B525 | (I.B) | N.2.13 |
| B526 | (I.B) | N.2.14 |
| B527 | (I.B) | N.2.15 |
| B528 | (I.B) | N.2.16 |
| B529 | (I.B) | N.2.17 |
| B530 | (I.B) | N.2.18 |
| B531 | (I.B) | N.2.19 |
| B532 | (I.B) | N.2.20 |
| B533 | (I.B) | N.2.21 |
| B534 | (I.B) | N.2.22 |
| B535 | (I.B) | N.2.23 |
| B536 | (I.B) | N.2.24 |
| B537 | (I.B) | N.2.25 |
| B538 | (I.B) | N.2.26 |
| B539 | (I.B) | N.2.27 |
| B540 | (I.B) | N.2.28 |
| B541 | (I.B) | N.2.29 |
| B542 | (I.B) | N.2.30 |
| B543 | (I.B) | N.2.31 |
| B544 | (I.B) | N.2.32 |
| B545 | (I.B) | N.2.33 |
| B546 | (I.B) | N.2.34 |
| B547 | (I.B) | N.2.35 |
| B548 | (I.B) | N.2.36 |
| B549 | (I.B) | N.2.37 |
| B550 | (I.B) | N.2.38 |
| B551 | (I.B) | N.2.39 |
| B552 | (I.B) | N.2.40 |
| B553 | (I.B) | N.2.41 |
| B554 | (I.B) | N.2.42 |
| B555 | (I.B) | N.2.43 |
| B556 | (I.B) | N.2.44 |
| B557 | (I.B) | N.2.45 |
| B558 | (I.B) | N.2.46 |
| B559 | (I.B) | N.2.47 |
| B560 | (I.B) | N.2.48 |
| B561 | (I.B) | N.2.49 |
| B562 | (I.B) | N.2.50 |
| B563 | (I.B) | N.2.51 |
| B564 | (I.B) | N.2.52 |
| B565 | (I.B) | N.2.53 |
| B566 | (I.B) | N.2.54 |
| B567 | (I.B) | N.2.55 |
| B568 | (I.B) | N.2.56 |
| B569 | (I.B) | N.2.57 |
| B570 | (I.B) | N.2.58 |
| B571 | (I.B) | N.2.59 |
| B572 | (I.B) | N.2.60 |
| B573 | (I.B) | N.2.61 |
| B574 | (I.B) | N.2.62 |
| B575 | (I.B) | N.2.63 |
| B576 | (I.B) | N.2.64 |
| B577 | (I.B) | N.2.65 |
| B578 | (I.B) | N.2.66 |
| B579 | (I.B) | N.2.67 |
| B580 | (I.B) | N.2.68 |
| B581 | (I.B) | N.2.69 |
| B582 | (I.B) | N.2.70 |
| B583 | (I.B) | N.2.71 |
| B584 | (I.B) | N.2.72 |
| B585 | (I.B) | N.2.73 |
| B586 | (I.B) | N.2.74 |
| B587 | (I.B) | N.2.75 |
| B588 | (I.B) | N.2.76 |
| B589 | (I.B) | N.2.77 |
| B590 | (I.B) | N.2.78 |
| B591 | (I.B) | N.2.79 |
| B592 | (I.B) | N.2.80 |
| B593 | (I.B) | N.2.81 |
| B594 | (I.B) | N.2.82 |
| B595 | (I.B) | N.2.83 |
| B596 | (I.B) | N.2.84 |
| B597 | (I.B) | N.3.1 |
| B598 | (I.B) | N.3.2 |
| B599 | (I.B) | N.3.3 |
| B600 | (I.B) | N.3.4 |
| B601 | (I.B) | N.3.5 |
| B602 | (I.B) | N.3.6 |
| B603 | (I.B) | N.3.7 |
| B604 | (I.B) | N.3.8 |
| B605 | (I.B) | N.3.9 |
| B606 | (I.B) | N.3.10 |
| B607 | (I.B) | N.3.11 |
| B608 | (I.B) | N.3.12 |
| B609 | (I.B) | N.3.13 |
| B610 | (I.B) | N.3.14 |
| B611 | (I.B) | N.3.15 |
| B612 | (I.B) | N.3.16 |
| B613 | (I.B) | N.3.17 |
| B614 | (I.B) | N.3.18 |
| B615 | (I.B) | N.3.19 |
| B616 | (I.B) | N.3.20 |
| B617 | (I.B) | N.3.21 |
| B618 | (I.B) | N.3.22 |
| B619 | (I.B) | N.3.23 |
| B620 | (I.B) | N.3.24 |
| B621 | (I.B) | N.3.25 |
| B622 | (I.B) | N.3.26 |
| B623 | (I.B) | N.3.27 |
| B624 | (I.B) | N.3.28 |
| B625 | (I.B) | N.3.29 |
| B626 | (I.B) | N.3.30 |
| B627 | (I.B) | N.3.31 |
| B628 | (I.B) | N.3.32 |
| B629 | (I.B) | N.3.33 |
| B630 | (I.B) | N.3.34 |
| B631 | (I.B) | N.3.35 |
| B632 | (I.B) | N.3.36 |
| B633 | (I.B) | N.3.37 |
| B634 | (I.B) | N.3.38 |
| B635 | (I.B) | N.3.39 |
| B636 | (I.B) | N.3.40 |
| B637 | (I.B) | N.3.41 |
| B638 | (I.B) | N.3.42 |
| B639 | (I.B) | N.3.43 |
| B640 | (I.B) | N.3.44 |
| B641 | (I.B) | N.3.45 |
| B642 | (I.B) | N.3.46 |
| B643 | (I.B) | N.3.47 |
| B644 | (I.B) | N.3.48 |
| B645 | (I.B) | N.3.49 |
| B646 | (I.B) | N.3.50 |
| B647 | (I.B) | N.3.51 |
| B648 | (I.B) | N.3.52 |
| B649 | (I.B) | N.3.53 |
| B650 | (I.B) | N.3.54 |
| B651 | (I.B) | N.3.55 |
| B652 | (I.B) | N.3.56 |
| B653 | (I.B) | N.3.57 |
| B654 | (I.B) | N.3.58 |
| B655 | (I.B) | N.3.59 |
| B656 | (I.B) | N.3.60 |
| B657 | (I.B) | N.3.61 |
| B658 | (I.B) | N.3.62 |
| B659 | (I.B) | N.3.63 |
| B660 | (I.B) | N.3.64 |
| B661 | (I.B) | N.3.65 |
| B662 | (I.B) | N.3.66 |
| B663 | (I.B) | N.3.67 |
| B664 | (I.B) | N.3.68 |
| B665 | (I.B) | N.3.69 |
| B666 | (I.B) | N.4.1 |
| B667 | (I.B) | N.4.2 |
| B668 | (I.B) | N.4.3 |
| B669 | (I.B) | N.4.4 |
| B670 | (I.B) | N.4.5 |
| B671 | (I.B) | N.4.6 |
| B672 | (I.B) | N.4.7 |
| B673 | (I.B) | N.4.8 |
| B674 | (I.B) | N.4.9 |
| B675 | (I.B) | N.4.10 |
| B676 | (I.B) | N.4.11 |
| B677 | (I.B) | N.4.12 |
| B678 | (I.B) | N.4.13 |
| B679 | (I.B) | N.4.14 |
| B680 | (I.B) | N.4.15 |
| B681 | (I.B) | N.4.16 |
| B682 | (I.B) | N.4.17 |
| B683 | (I.B) | N.4.18 |
| B684 | (I.B) | N.4.19 |
| B685 | (I.B) | N.4.20 |
| B686 | (I.B) | N.4.21 |
| B687 | (I.B) | N.4.22 |
| B688 | (I.B) | N.4.23 |
| B689 | (I.B) | N.4.24 |
| B690 | (I.B) | N.4.25 |
| B691 | (I.B) | N.4.26 |
| B692 | (I.B) | N.4.27 |
| B693 | (I.B) | N.4.28 |
| B694 | (I.B) | N.4.29 |
| B695 | (I.B) | N.4.30 |
| B696 | (I.B) | N.4.31 |
| B697 | (I.B) | N.4.32 |
| B698 | (I.B) | N.4.33 |
| B699 | (I.B) | N.4.34 |
| B700 | (I.B) | N.4.35 |
| B701 | (I.B) | N.4.36 |
| B702 | (I.B) | N.4.37 |
| B703 | (I.B) | N.4.38 |
| B704 | (I.B) | N.4.39 |
| B705 | (I.B) | N.4.40 |
| B706 | (I.B) | N.4.41 |
| B707 | (I.B) | N.4.42 |
| B708 | (I.B) | N.4.43 |
| B709 | (I.B) | N.4.44 |
| B710 | (I.B) | N.4.45 |
| B711 | (I.B) | N.4.46 |
| B712 | (I.B) | N.4.47 |
| B713 | (I.B) | N.5.1 |
| B714 | (I.B) | N.5.2 |
| B715 | (I.B) | N.5.3 |
| B716 | (I.B) | N.5.4 |
| B717 | (I.B) | N.5.5 |
| B718 | (I.B) | N.5.6 |
| B719 | (I.B) | N.5.7 |
| B720 | (I.B) | N.5.8 |
| B721 | (I.B) | N.5.9 |
| B722 | (I.B) | N.5.10 |
| B723 | (I.B) | N.5.11 |
| B724 | (I.B) | N.5.12 |
| B725 | (I.B) | N.5.13 |
| B726 | (I.B) | N.5.14 |
| B727 | (I.B) | N.5.15 |
| B728 | (I.B) | N.5.16 |
| B729 | (I.B) | N.5.17 |
| B730 | (I.B) | N.5.18 |
| B731 | (I.B) | N.5.19 |
| B732 | (I.B) | N.5.20 |
| B733 | (I.B) | N.5.21 |
| B734 | (I.B) | N.5.22 |
| B735 | (I.B) | N.5.23 |
| B736 | (I.B) | N.5.24 |
| B737 | (I.B) | N.5.25 |
| B738 | (I.B) | N.5.26 |
| B739 | (I.B) | N.5.27 |
| B740 | (I.B) | N.6.1 |
| B741 | (I.B) | N.6.2 |
| B742 | (I.B) | N.6.3 |
| B743 | (I.B) | N.6.4 |
| B744 | (I.B) | N.7.1 |
| B745 | (I.B) | N.7.2 |
| B746 | (I.B) | N.7.3 |
| B747 | (I.B) | N.7.4 |
| B748 | (I.B) | N.7.5 |
| B749 | (I.B) | N.8.1 |
| B750 | (I.B) | N.9.1 |
| B751 | (I.B) | N.9.2 |
| B752 | (I.B) | N.9.3 |
| B753 | (I.B) | N.9.4 |
| B754 | (I.B) | N.9.5 |
| B755 | (I.B) | N.9.6 |
| B756 | (I.B) | N.9.7 |
| B757 | (I.B) | N.9.8 |
| B758 | (I.B) | N.9.9 |
| B759 | (I.B) | N.9.10 |
| B760 | (I.B) | N.9.11 |
| B761 | (I.B) | N.9.12 |
| B762 | (I.B) | N.9.13 |
| B763 | (I.B) | N.9.14 |
| B764 | (I.B) | N.9.15 |
| B765 | (I.B) | N.9.16 |
| B766 | (I.B) | N.9.17 |
| B767 | (I.B) | N.9.18 |
| B768 | (I.B) | N.9.19 |
| B769 | (I.B) | N.9.20 |
| B770 | (I.B) | N.9.21 |
| B771 | (I.B) | N.9.22 |
| B772 | (I.B) | N.9.23 |
| B773 | (I.B) | N.9.24 |
| B774 | (I.B) | N.9.25 |
| B775 | (I.B) | N.9.26 |
| B776 | (I.B) | N.10.1 |
| B777 | (I.B) | N.10.2 |
| B778 | (I.B) | N.10.3 |
| B779 | (I.B) | N.10.4 |
| B780 | (I.B) | N.10.5 |
| B781 | (I.B) | N.10.6 |
| B782 | (I.B) | N.10.7 |
| B783 | (I.B) | N.10.8 |
| B784 | (I.B) | N.10.9 |
| B785 | (I.B) | N.10.10 |
| B786 | (I.B) | N.10.12 |
| B787 | (I.B) | N.10.13 |
| B788 | (I.B) | N.10.14 |
| B789 | (I.B) | N.10.15 |
| B790 | (I.B) | N.10.16 |
| B791 | (I.B) | N.10.17 |
| B792 | (I.B) | N.10.18 |
| B793 | (I.B) | N.10.19 |
| B794 | (I.B) | N.10.20 |
| B795 | (I.B) | N.10.21 |
| B796 | (I.B) | N.10.22 |
| B797 | (I.B) | N.10.23 |
| B798 | (I.B) | N.10.24 |
| B799 | (I.B) | N.10.25 |
| B800 | (I.B) | N.10.26 |
| B801 | (I.B) | N.10.27 |
| B802 | (I.B) | N.10.28 |
| B803 | (I.B) | N.10.29 |
| B804 | (I.B) | N.10.30 |
| B805 | (I.B) | N.10.31 |
| B806 | (I.B) | N.10.32 |
| B807 | (I.B) | N.10.33 |
| B808 | (I.B) | N.10.34 |
| B809 | (I.B) | N.10.35 |
| B810 | (I.B) | N.10.36 |
| B811 | (I.B) | N.11.1 |
| B812 | (I.B) | N.11.2 |
| B813 | (I.B) | N.11.3 |
| B814 | (I.B) | N.11.4 |
| B815 | (I.B) | N.11.5 |
| B816 | (I.B) | N.11.6 |
| B817 | (I.B) | N.11.7 |
| B818 | (I.B) | N.12.1 |
| B819 | (I.B) | N.12.2 |
| B820 | (I.B) | N.12.3 |
| B821 | (I.B) | N.13.1 |
| B822 | (I.B) | N.13.2 |
| B823 | (I.B) | N.13.3 |
| B824 | (I.B) | N.13.4 |
| B825 | (I.B) | N.13.5 |
| B826 | (I.B) | N.13.6 |
| B827 | (I.B) | N.13.7 |
| B828 | (I.B) | N.13.8 |
| B829 | (I.B) | N.13.9 |
| B830 | (I.B) | N.13.10 |
| B831 | (I.B) | N.13.11 |
| B832 | (I.B) | N.13.12 |
| B833 | (I.B) | N.13.13 |
| B834 | (I.B) | N.13.14 |
| B835 | (I.B) | N.13.15 |
| B836 | (I.B) | N.13.16 |
| B837 | (I.B) | N.13.17 |
| B838 | (I.B) | N.13.18 |
| B839 | (I.B) | N.13.19 |
| B840 | (I.B) | N.13.20 |
| B841 | (I.B) | N.13.21 |
| B842 | (I.B) | N.13.22 |
| B843 | (I.B) | N.13.23 |
| B844 | (I.B) | N.13.24 |
| B845 | (I.B) | N.13.25 |
| B846 | (I.B) | N.13.26 |
| B847 | (I.B) | N.13.27 |
| B848 | (I.B) | N.13.28 |
| B849 | (I.B) | N.13.29 |
| B850 | (I.B) | N.13.30 |
| B851 | (I.B) | N.13.31 |
| B852 | (I.B) | N.13.32 |
| B853 | (I.B) | N.14.1 |
| B854 | (I.B) | N.14.2 |
| B855 | (I.B) | N.14.3 |
| B856 | (I.B) | N.14.4 |
| B857 | (I.B) | N.15.1 |
| B858 | (I.B) | N.15.2 |
| B859 | (I.B) | N.15.3 |
| B860 | (I.B) | N.15.4 |
| B861 | (I.B) | N.15.5 |
| B862 | (I.B) | N.15.6 |
| B863 | (I.B) | N.15.7 |
| B864 | (I.B) | N.15.8 |
| B865 | (I.B) | N.15.9 |
| B866 | (I.B) | N.15.10 |
| B867 | (I.B) | N.15.11 |
| B868 | (I.B) | N.15.12 |
| B869 | (I.B) | N.15.13 |
| B870 | (I.B) | N.15.14 |
| B871 | (I.B) | N.15.15 |
| B872 | (I.B) | N.15.16 |
| B873 | (I.B) | N.15.17 |
| B874 | (I.B) | N.15.18 |
| B875 | (I.B) | N.15.19 |
| B876 | (I.B) | N.15.20 |
| B877 | (I.B) | N.15.21 |
| B878 | (I.B) | N.15.22 |
| B879 | (I.B) | N.15.23 |
| B880 | (I.B) | N.15.24 |
| B881 | (I.B) | N.15.25 |
| B882 | (I.B) | N.15.26 |
| B883 | (I.B) | N.15.27 |
| B884 | (I.B) | N.15.28 |
| B885 | (I.B) | N.15.29 |
| B886 | (I.B) | N.15.30 |
| B887 | (I.B) | N.15.31 |
| B888 | (I.B) | N.15.32 |
| B889 | (I.B) | N.15.33 |
| B890 | (I.B) | N.15.34 |
| B891 | (I.B) | N.15.35 |
| B892 | (I.B) | N.15.36 |

TABLE 3
B = Mixture; I = compound; II = compound II

| B | I | II |
|---|---|---|
| B893 | (I.C) | N.1.1 |
| B894 | (I.C) | N.1.2 |
| B895 | (I.C) | N.1.3 |
| B896 | (I.C) | N.1.4 |
| B897 | (I.C) | N.1.5 |
| B898 | (I.C) | N.1.6 |
| B899 | (I.C) | N.1.7 |
| B900 | (I.C) | N.1.8 |
| B901 | (I.C) | N.1.9 |
| B902 | (I.C) | N.1.10 |
| B903 | (I.C) | N.1.11 |
| B904 | (I.C) | N.1.12 |
| B905 | (I.C) | N.1.13 |
| B906 | (I.C) | N.1.14 |
| B907 | (I.C) | N.1.15 |
| B908 | (I.C) | N.1.16 |
| B909 | (I.C) | N.1.17 |
| B910 | (I.C) | N.1.18 |
| B911 | (I.C) | N.1.19 |
| B912 | (I.C) | N.1.20 |
| B913 | (I.C) | N.1.21 |
| B914 | (I.C) | N.1.22 |
| B915 | (I.C) | N.1.23 |
| B916 | (I.C) | N.1.24 |
| B917 | (I.C) | N.1.25 |
| B918 | (I.C) | N.1.26 |
| B919 | (I.C) | N.1.27 |
| B920 | (I.C) | N.1.28 |
| B921 | (I.C) | N.1.29 |
| B922 | (I.C) | N.1.30 |
| B923 | (I.C) | N.1.31 |
| B924 | (I.C) | N.1.32 |
| B925 | (I.C) | N.1.33 |
| B926 | (I.C) | N.1.34 |
| B927 | (I.C) | N.1.35 |
| B928 | (I.C) | N.1.36 |
| B929 | (I.C) | N.1.37 |
| B930 | (I.C) | N.1.38 |
| B931 | (I.C) | N.1.39 |
| B932 | (I.C) | N.1.40 |
| B933 | (I.C) | N.1.41 |
| B934 | (I.C) | N.1.42 |
| B935 | (I.C) | N.1.43 |
| B936 | (I.C) | N.1.44 |
| B937 | (I.C) | N.1.45 |
| B938 | (I.C) | N.1.46 |
| B939 | (I.C) | N.1.47 |
| B940 | (I.C) | N.1.48 |
| B941 | (I.C) | N.1.49 |
| B942 | (I.C) | N.1.50 |
| B943 | (I.C) | N.1.51 |
| B944 | (I.C) | N.1.52 |
| B945 | (I.C) | N.1.53 |
| B946 | (I.C) | N.1.54 |
| B947 | (I.C) | N.1.55 |
| B948 | (I.C) | N.1.56 |
| B949 | (I.C) | N.1.57 |
| B950 | (I.C) | N.1.58 |
| B951 | (I.C) | N.1.59 |
| B952 | (I.C) | N.1.60 |
| B953 | (I.C) | N.1.61 |
| B954 | (I.C) | N.1.62 |
| B955 | (I.C) | N.1.63 |
| B956 | (I.C) | N.1.64 |
| B957 | (I.C) | N.1.65 |
| B958 | (I.C) | N.1.66 |
| B959 | (I.C) | N.2.1 |
| B960 | (I.C) | N.2.2 |
| B961 | (I.C) | N.2.3 |
| B962 | (I.C) | N.2.4 |
| B963 | (I.C) | N.2.5 |
| B964 | (I.C) | N.2.6 |
| B965 | (I.C) | N.2.7 |
| B966 | (I.C) | N.2.8 |
| B967 | (I.C) | N.2.9 |
| B968 | (I.C) | N.2.10 |
| B969 | (I.C) | N.2.11 |
| B970 | (I.C) | N.2.12 |
| B971 | (I.C) | N.2.13 |
| B972 | (I.C) | N.2.14 |
| B973 | (I.C) | N.2.15 |
| B974 | (I.C) | N.2.16 |
| B975 | (I.C) | N.2.17 |
| B976 | (I.C) | N.2.18 |
| B977 | (I.C) | N.2.19 |
| B978 | (I.C) | N.2.20 |
| B979 | (I.C) | N.2.21 |
| B980 | (I.C) | N.2.22 |
| B981 | (I.C) | N.2.23 |
| B982 | (I.C) | N.2.24 |
| B983 | (I.C) | N.2.25 |
| B984 | (I.C) | N.2.26 |
| B985 | (I.C) | N.2.27 |
| B986 | (I.C) | N.2.28 |
| B987 | (I.C) | N.2.29 |
| B988 | (I.C) | N.2.30 |
| B989 | (I.C) | N.2.31 |
| B990 | (I.C) | N.2.32 |
| B991 | (I.C) | N.2.33 |
| B992 | (I.C) | N.2.34 |
| B993 | (I.C) | N.2.35 |
| B994 | (I.C) | N.2.36 |
| B995 | (I.C) | N.2.37 |
| B996 | (I.C) | N.2.38 |
| B997 | (I.C) | N.2.39 |
| B998 | (I.C) | N.2.40 |
| B999 | (I.C) | N.2.41 |
| B1000 | (I.C) | N.2.42 |
| B1001 | (I.C) | N.2.43 |
| B1002 | (I.C) | N.2.44 |
| B1003 | (I.C) | N.2.45 |
| B1004 | (I.C) | N.2.46 |
| B1005 | (I.C) | N.2.47 |
| B1006 | (I.C) | N.2.48 |
| B1007 | (I.C) | N.2.49 |
| B1008 | (I.C) | N.2.50 |
| B1009 | (I.C) | N.2.51 |
| B1010 | (I.C) | N.2.52 |
| B1011 | (I.C) | N.2.53 |
| B1012 | (I.C) | N.2.54 |
| B1013 | (I.C) | N.2.55 |
| B1014 | (I.C) | N.2.56 |
| B1015 | (I.C) | N.2.57 |
| B1016 | (I.C) | N.2.58 |
| B1017 | (I.C) | N.2.59 |
| B1018 | (I.C) | N.2.60 |
| B1019 | (I.C) | N.2.61 |
| B1020 | (I.C) | N.2.62 |
| B1021 | (I.C) | N.2.63 |
| B1022 | (I.C) | N.2.64 |
| B1023 | (I.C) | N.2.65 |
| B1024 | (I.C) | N.2.66 |
| B1025 | (I.C) | N.2.67 |
| B1026 | (I.C) | N.2.68 |
| B1027 | (I.C) | N.2.69 |
| B1028 | (I.C) | N.2.70 |
| B1029 | (I.C) | N.2.71 |
| B1030 | (I.C) | N.2.72 |
| B1031 | (I.C) | N.2.73 |
| B1032 | (I.C) | N.2.74 |
| B1033 | (I.C) | N.2.75 |
| B1034 | (I.C) | N.2.76 |
| B1035 | (I.C) | N.2.77 |
| B1036 | (I.C) | N.2.78 |
| B1037 | (I.C) | N.2.79 |
| B1038 | (I.C) | N.2.80 |
| B1039 | (I.C) | N.2.81 |
| B1040 | (I.C) | N.2.82 |
| B1041 | (I.C) | N.2.83 |
| B1042 | (I.C) | N.2.84 |
| B1043 | (I.C) | N.3.1 |
| B1044 | (I.C) | N.3.2 |
| B1045 | (I.C) | N.3.3 |
| B1046 | (I.C) | N.3.4 |
| B1047 | (I.C) | N.3.5 |
| B1048 | (I.C) | N.3.6 |
| B1049 | (I.C) | N.3.7 |
| B1050 | (I.C) | N.3.8 |
| B1051 | (I.C) | N.3.9 |
| B1052 | (I.C) | N.3.10 |
| B1053 | (I.C) | N.3.11 |
| B1054 | (I.C) | N.3.12 |
| B1055 | (I.C) | N.3.13 |
| B1056 | (I.C) | N.3.14 |
| B1057 | (I.C) | N.3.15 |
| B1058 | (I.C) | N.3.16 |
| B1059 | (I.C) | N.3.17 |
| B1060 | (I.C) | N.3.18 |
| B1061 | (I.C) | N.3.19 |
| B1062 | (I.C) | N.3.20 |
| B1063 | (I.C) | N.3.21 |
| B1064 | (I.C) | N.3.22 |
| B1065 | (I.C) | N.3.23 |
| B1066 | (I.C) | N.3.24 |
| B1067 | (I.C) | N.3.25 |
| B1068 | (I.C) | N.3.26 |
| B1069 | (I.C) | N.3.27 |
| B1070 | (I.C) | N.3.28 |
| B1071 | (I.C) | N.3.29 |
| B1072 | (I.C) | N.3.30 |
| B1073 | (I.C) | N.3.31 |
| B1074 | (I.C) | N.3.32 |
| B1075 | (I.C) | N.3.33 |
| B1076 | (I.C) | N.3.34 |
| B1077 | (I.C) | N.3.35 |
| B1078 | (I.C) | N.3.36 |
| B1079 | (I.C) | N.3.37 |
| B1080 | (I.C) | N.3.38 |
| B1081 | (I.C) | N.3.39 |
| B1082 | (I.C) | N.3.40 |
| B1083 | (I.C) | N.3.41 |
| B1084 | (I.C) | N.3.42 |
| B1085 | (I.C) | N.3.43 |
| B1086 | (I.C) | N.3.44 |
| B1087 | (I.C) | N.3.45 |
| B1088 | (I.C) | N.3.46 |
| B1089 | (I.C) | N.3.47 |
| B1090 | (I.C) | N.3.48 |
| B1091 | (I.C) | N.3.49 |
| B1092 | (I.C) | N.3.50 |
| B1093 | (I.C) | N.3.51 |
| B1094 | (I.C) | N.3.52 |
| B1095 | (I.C) | N.3.53 |
| B1096 | (I.C) | N.3.54 |
| B1097 | (I.C) | N.3.55 |
| B1098 | (I.C) | N.3.56 |
| B1099 | (I.C) | N.3.57 |
| B1100 | (I.C) | N.3.58 |
| B1101 | (I.C) | N.3.59 |
| B1102 | (I.C) | N.3.60 |
| B1103 | (I.C) | N.3.61 |
| B1104 | (I.C) | N.3.62 |
| B1105 | (I.C) | N.3.63 |
| B1106 | (I.C) | N.3.64 |
| B1107 | (I.C) | N.3.65 |
| B1108 | (I.C) | N.3.66 |
| B1109 | (I.C) | N.3.67 |
| B1110 | (I.C) | N.3.68 |
| B1111 | (I.C) | N.3.69 |
| B1112 | (I.C) | N.4.1 |
| B1113 | (I.C) | N.4.2 |
| B1114 | (I.C) | N.4.3 |
| B1115 | (I.C) | N.4.4 |
| B1116 | (I.C) | N.4.5 |
| B1117 | (I.C) | N.4.6 |
| B1118 | (I.C) | N.4.7 |
| B1119 | (I.C) | N.4.8 |
| B1120 | (I.C) | N.4.9 |
| B1121 | (I.C) | N.4.10 |
| B1122 | (I.C) | N.4.11 |
| B1123 | (I.C) | N.4.12 |
| B1124 | (I.C) | N.4.13 |
| B1125 | (I.C) | N.4.14 |
| B1126 | (I.C) | N.4.15 |
| B1127 | (I.C) | N.4.16 |
| B1128 | (I.C) | N.4.17 |
| B1129 | (I.C) | N.4.18 |
| B1130 | (I.C) | N.4.19 |
| B1131 | (I.C) | N.4.20 |
| B1132 | (I.C) | N.4.21 |
| B1133 | (I.C) | N.4.22 |
| B1134 | (I.C) | N.4.23 |
| B1135 | (I.C) | N.4.24 |
| B1136 | (I.C) | N.4.25 |
| B1137 | (I.C) | N.4.26 |
| B1138 | (I.C) | N.4.27 |
| B1139 | (I.C) | N.4.28 |
| B1140 | (I.C) | N.4.29 |
| B1141 | (I.C) | N.4.30 |
| B1142 | (I.C) | N.4.31 |
| B1143 | (I.C) | N.4.32 |
| B1144 | (I.C) | N.4.33 |
| B1145 | (I.C) | N.4.34 |
| B1146 | (I.C) | N.4.35 |
| B1147 | (I.C) | N.4.36 |
| B1148 | (I.C) | N.4.37 |
| B1149 | (I.C) | N.4.38 |
| B1150 | (I.C) | N.4.39 |
| B1151 | (I.C) | N.4.40 |
| B1152 | (I.C) | N.4.41 |
| B1153 | (I.C) | N.4.42 |
| B1154 | (I.C) | N.4.43 |
| B1155 | (I.C) | N.4.44 |
| B1156 | (I.C) | N.4.45 |
| B1157 | (I.C) | N.4.46 |
| B1158 | (I.C) | N.4.47 |
| B1159 | (I.C) | N.5.1 |
| B1160 | (I.C) | N.5.2 |
| B1161 | (I.C) | N.5.3 |
| B1162 | (I.C) | N.5.4 |
| B1163 | (I.C) | N.5.5 |
| B1164 | (I.C) | N.5.6 |
| B1165 | (I.C) | N.5.7 |
| B1166 | (I.C) | N.5.8 |
| B1167 | (I.C) | N.5.9 |
| B1168 | (I.C) | N.5.10 |
| B1169 | (I.C) | N.5.11 |
| B1170 | (I.C) | N.5.12 |
| B1171 | (I.C) | N.5.13 |
| B1172 | (I.C) | N.5.14 |
| B1173 | (I.C) | N.5.15 |
| B1174 | (I.C) | N.5.16 |
| B1175 | (I.C) | N.5.17 |
| B1176 | (I.C) | N.5.18 |
| B1177 | (I.C) | N.5.19 |
| B1178 | (I.C) | N.5.20 |
| B1179 | (I.C) | N.5.21 |
| B1180 | (I.C) | N.5.22 |
| B1181 | (I.C) | N.5.23 |
| B1182 | (I.C) | N.5.24 |
| B1183 | (I.C) | N.5.25 |
| B1184 | (I.C) | N.5.26 |
| B1185 | (I.C) | N.5.27 |
| B1186 | (I.C) | N.6.1 |
| B1187 | (I.C) | N.6.2 |
| B1188 | (I.C) | N.6.3 |
| B1189 | (I.C) | N.6.4 |
| B1190 | (I.C) | N.7.1 |
| B1191 | (I.C) | N.7.2 |
| B1192 | (I.C) | N.7.3 |
| B1193 | (I.C) | N.7.4 |
| B1194 | (I.C) | N.7.5 |
| B1195 | (I.C) | N.8.1 |
| B1196 | (I.C) | N.9.1 |
| B1197 | (I.C) | N.9.2 |
| B1198 | (I.C) | N.9.3 |
| B1199 | (I.C) | N.9.4 |
| B1200 | (I.C) | N.9.5 |
| B1201 | (I.C) | N.9.6 |
| B1202 | (I.C) | N.9.7 |
| B1203 | (I.C) | N.9.8 |
| B1204 | (I.C) | N.9.9 |
| B1205 | (I.C) | N.9.10 |
| B1206 | (I.C) | N.9.11 |
| B1207 | (I.C) | N.9.12 |
| B1208 | (I.C) | N.9.13 |
| B1209 | (I.C) | N.9.14 |
| B1210 | (I.C) | N.9.15 |
| B1211 | (I.C) | N.9.16 |
| B1212 | (I.C) | N.9.17 |
| B1213 | (I.C) | N.9.18 |
| B1214 | (I.C) | N.9.19 |
| B1215 | (I.C) | N.9.20 |
| B1216 | (I.C) | N.9.21 |
| B1217 | (I.C) | N.9.22 |
| B1218 | (I.C) | N.9.23 |
| B1219 | (I.C) | N.9.24 |
| B1220 | (I.C) | N.9.25 |
| B1221 | (I.C) | N.9.26 |
| B1222 | (I.C) | N.10.1 |
| B1223 | (I.C) | N.10.2 |
| B1224 | (I.C) | N.10.3 |
| B1225 | (I.C) | N.10.4 |
| B1226 | (I.C) | N.10.5 |
| B1227 | (I.C) | N.10.6 |
| B1228 | (I.C) | N.10.7 |
| B1229 | (I.C) | N.10.8 |
| B1230 | (I.C) | N.10.9 |
| B1231 | (I.C) | N.10.10 |
| B1232 | (I.C) | N.10.12 |
| B1233 | (I.C) | N.10.13 |
| B1234 | (I.C) | N.10.14 |
| B1235 | (I.C) | N.10.15 |
| B1236 | (I.C) | N.10.16 |
| B1237 | (I.C) | N.10.17 |
| B1238 | (I.C) | N.10.18 |
| B1239 | (I.C) | N.10.19 |
| B1240 | (I.C) | N.10.20 |
| B1241 | (I.C) | N.10.21 |
| B1242 | (I.C) | N.10.22 |
| B1243 | (I.C) | N.10.23 |
| B1244 | (I.C) | N.10.24 |
| B1245 | (I.C) | N.10.25 |
| B1246 | (I.C) | N.10.26 |
| B1247 | (I.C) | N.10.27 |
| B1248 | (I.C) | N.10.28 |
| B1249 | (I.C) | N.10.29 |
| B1250 | (I.C) | N.10.30 |
| B1251 | (I.C) | N.10.31 |
| B1252 | (I.C) | N.10.32 |
| B1253 | (I.C) | N.10.33 |
| B1254 | (I.C) | N.10.34 |
| B1255 | (I.C) | N.10.35 |
| B1256 | (I.C) | N.10.36 |
| B1257 | (I.C) | N.11.1 |
| B1258 | (I.C) | N.11.2 |
| B1259 | (I.C) | N.11.3 |
| B1260 | (I.C) | N.11.4 |
| B1261 | (I.C) | N.11.5 |
| B1262 | (I.C) | N.11.6 |
| B1263 | (I.C) | N.11.7 |
| B1264 | (I.C) | N.12.1 |
| B1265 | (I.C) | N.12.2 |
| B1266 | (I.C) | N.12.3 |
| B1267 | (I.C) | N.13.1 |
| B1268 | (I.C) | N.13.2 |
| B1269 | (I.C) | N.13.3 |
| B1270 | (I.C) | N.13.4 |
| B1271 | (I.C) | N.13.5 |
| B1272 | (I.C) | N.13.6 |
| B1273 | (I.C) | N.13.7 |
| B1274 | (I.C) | N.13.8 |
| B1275 | (I.C) | N.13.9 |
| B1276 | (I.C) | N.13.10 |
| B1277 | (I.C) | N.13.11 |
| B1278 | (I.C) | N.13.12 |
| B1279 | (I.C) | N.13.13 |
| B1280 | (I.C) | N.13.14 |
| B1281 | (I.C) | N.13.15 |
| B1282 | (I.C) | N.13.16 |
| B1283 | (I.C) | N.13.17 |
| B1284 | (I.C) | N.13.18 |
| B1285 | (I.C) | N.13.19 |
| B1286 | (I.C) | N.13.20 |
| B1287 | (I.C) | N.13.21 |
| B1288 | (I.C) | N.13.22 |
| B1289 | (I.C) | N.13.23 |
| B1290 | (I.C) | N.13.24 |
| B1291 | (I.C) | N.13.25 |
| B1292 | (I.C) | N.13.26 |
| B1293 | (I.C) | N.13.27 |
| B1294 | (I.C) | N.13.28 |
| B1295 | (I.C) | N.13.29 |
| B1296 | (I.C) | N.13.30 |
| B1297 | (I.C) | N.13.31 |
| B1298 | (I.C) | N.13.32 |
| B1299 | (I.C) | N.14.1 |
| B1300 | (I.C) | N.14.2 |
| B1301 | (I.C) | N.14.3 |
| B1302 | (I.C) | N.14.4 |
| B1303 | (I.C) | N.15.1 |
| B1304 | (I.C) | N.15.2 |
| B1305 | (I.C) | N.15.3 |
| B1306 | (I.C) | N.15.4 |
| B1307 | (I.C) | N.15.5 |
| B1308 | (I.C) | N.15.6 |
| B1309 | (I.C) | N.15.7 |
| B1310 | (I.C) | N.15.8 |
| B1311 | (I.C) | N.15.9 |
| B1312 | (I.C) | N.15.10 |
| B1313 | (I.C) | N.15.11 |
| B1314 | (I.C) | N.15.12 |
| B1315 | (I.C) | N.15.13 |
| B1316 | (I.C) | N.15.14 |
| B1317 | (I.C) | N.15.15 |
| B1318 | (I.C) | N.15.16 |
| B1319 | (I.C) | N.15.17 |
| B1320 | (I.C) | N.15.18 |
| B1321 | (I.C) | N.15.19 |
| B1322 | (I.C) | N.15.20 |
| B1323 | (I.C) | N.15.21 |
| B1324 | (I.C) | N.15.22 |
| B1325 | (I.C) | N.15.23 |
| B1326 | (I.C) | N.15.24 |
| B1327 | (I.C) | N.15.25 |
| B1328 | (I.C) | N.15.26 |
| B1329 | (I.C) | N.15.27 |
| B1330 | (I.C) | N.15.28 |
| B1331 | (I.C) | N.15.29 |
| B1332 | (I.C) | N.15.30 |
| B1333 | (I.C) | N.15.31 |
| B1334 | (I.C) | N.15.32 |
| B1335 | (I.C) | N.15.33 |
| B1336 | (I.C) | N.15.34 |
| B1337 | (I.C) | N.15.35 |
| B1338 | (I.C) | N.15.36 |

TABLE 4
B = Mixture; I = compound; II = compound II

| B | I | II |
|---|---|---|
| B1339 | (I.D) | N.1.1 |
| B1340 | (I.D) | N.1.2 |
| B1341 | (I.D) | N.1.3 |
| B1342 | (I.D) | N.1.4 |
| B1343 | (I.D) | N.1.5 |
| B1344 | (I.D) | N.1.6 |
| B1345 | (I.D) | N.1.7 |
| B1346 | (I.D) | N.1.8 |
| B1347 | (I.D) | N.1.9 |
| B1348 | (I.D) | N.1.10 |
| B1349 | (I.D) | N.1.11 |
| B1350 | (I.D) | N.1.12 |
| B1351 | (I.D) | N.1.13 |
| B1352 | (I.D) | N.1.14 |
| B1353 | (I.D) | N.1.15 |
| B1354 | (I.D) | N.1.16 |
| B1355 | (I.D) | N.1.17 |
| B1356 | (I.D) | N.1.18 |
| B1357 | (I.D) | N.1.19 |
| B1358 | (I.D) | N.1.20 |
| B1359 | (I.D) | N.1.21 |
| B1360 | (I.D) | N.1.22 |
| B1361 | (I.D) | N.1.23 |
| B1362 | (I.D) | N.1.24 |
| B1363 | (I.D) | N.1.25 |
| B1364 | (I.D) | N.1.26 |
| B1365 | (I.D) | N.1.27 |
| B1366 | (I.D) | N.1.28 |
| B1367 | (I.D) | N.1.29 |
| B1368 | (I.D) | N.1.30 |
| B1369 | (I.D) | N.1.31 |
| B1370 | (I.D) | N.1.32 |
| B1371 | (I.D) | N.1.33 |
| B1372 | (I.D) | N.1.34 |
| B1373 | (I.D) | N.1.35 |
| B1374 | (I.D) | N.1.36 |
| B1375 | (I.D) | N.1.37 |
| B1376 | (I.D) | N.1.38 |
| B1377 | (I.D) | N.1.39 |
| B1378 | (I.D) | N.1.40 |
| B1379 | (I.D) | N.1.41 |
| B1380 | (I.D) | N.1.42 |
| B1381 | (I.D) | N.1.43 |
| B1382 | (I.D) | N.1.44 |
| B1383 | (I.D) | N.1.45 |
| B1384 | (I.D) | N.1.46 |
| B1385 | (I.D) | N.1.47 |
| B1386 | (I.D) | N.1.48 |
| B1387 | (I.D) | N.1.49 |
| B1388 | (I.D) | N.1.50 |
| B1389 | (I.D) | N.1.51 |
| B1390 | (I.D) | N.1.52 |
| B1391 | (I.D) | N.1.53 |
| B1392 | (I.D) | N.1.54 |
| B1393 | (I.D) | N.1.55 |
| B1394 | (I.D) | N.1.56 |
| B1395 | (I.D) | N.1.57 |
| B1396 | (I.D) | N.1.58 |
| B1397 | (I.D) | N.1.59 |
| B1398 | (I.D) | N.1.60 |
| B1399 | (I.D) | N.1.61 |
| B1400 | (I.D) | N.1.62 |
| B1401 | (I.D) | N.1.63 |
| B1402 | (I.D) | N.1.64 |
| B1403 | (I.D) | N.1.65 |
| B1404 | (I.D) | N.1.66 |
| B1405 | (I.D) | N.2.1 |
| B1406 | (I.D) | N.2.2 |
| B1407 | (I.D) | N.2.3 |
| B1408 | (I.D) | N.2.4 |
| B1409 | (I.D) | N.2.5 |
| B1410 | (I.D) | N.2.6 |
| B1411 | (I.D) | N.2.7 |
| B1412 | (I.D) | N.2.8 |
| B1413 | (I.D) | N.2.9 |
| B1414 | (I.D) | N.2.10 |
| B1415 | (I.D) | N.2.11 |
| B1416 | (I.D) | N.2.12 |
| B1417 | (I.D) | N.2.13 |
| B1418 | (I.D) | N.2.14 |
| B1419 | (I.D) | N.2.15 |
| B1420 | (I.D) | N.2.16 |
| B1421 | (I.D) | N.2.17 |
| B1422 | (I.D) | N.2.18 |
| B1423 | (I.D) | N.2.19 |
| B1424 | (I.D) | N.2.20 |
| B1425 | (I.D) | N.2.21 |
| B1426 | (I.D) | N.2.22 |
| B1427 | (I.D) | N.2.23 |
| B1428 | (I.D) | N.2.24 |
| B1429 | (I.D) | N.2.25 |
| B1430 | (I.D) | N.2.26 |
| B1431 | (I.D) | N.2.27 |
| B1432 | (I.D) | N.2.28 |
| B1433 | (I.D) | N.2.29 |
| B1434 | (I.D) | N.2.30 |
| B1435 | (I.D) | N.2.31 |
| B1436 | (I.D) | N.2.32 |
| B1437 | (I.D) | N.2.33 |
| B1438 | (I.D) | N.2.34 |
| B1439 | (I.D) | N.2.35 |
| B1440 | (I.D) | N.2.36 |
| B1441 | (I.D) | N.2.37 |
| B1442 | (I.D) | N.2.38 |
| B1443 | (I.D) | N.2.39 |
| B1444 | (I.D) | N.2.40 |
| B1445 | (I.D) | N.2.41 |
| B1446 | (I.D) | N.2.42 |
| B1447 | (I.D) | N.2.43 |
| B1448 | (I.D) | N.2.44 |
| B1449 | (I.D) | N.2.45 |
| B1450 | (I.D) | N.2.46 |
| B1451 | (I.D) | N.2.47 |
| B1452 | (I.D) | N.2.48 |
| B1453 | (I.D) | N.2.49 |
| B1454 | (I.D) | N.2.50 |
| B1455 | (I.D) | N.2.51 |
| B1456 | (I.D) | N.2.52 |
| B1457 | (I.D) | N.2.53 |
| B1458 | (I.D) | N.2.54 |
| B1459 | (I.D) | N.2.55 |
| B1460 | (I.D) | N.2.56 |
| B1461 | (I.D) | N.2.57 |
| B1462 | (I.D) | N.2.58 |
| B1463 | (I.D) | N.2.59 |
| B1464 | (I.D) | N.2.60 |
| B1465 | (I.D) | N.2.61 |
| B1466 | (I.D) | N.2.62 |
| B1467 | (I.D) | N.2.63 |
| B1468 | (I.D) | N.2.64 |
| B1469 | (I.D) | N.2.65 |
| B1470 | (I.D) | N.2.66 |
| B1471 | (I.D) | N.2.67 |
| B1472 | (I.D) | N.2.68 |
| B1473 | (I.D) | N.2.69 |
| B1474 | (I.D) | N.2.70 |
| B1475 | (I.D) | N.2.71 |
| B1476 | (I.D) | N.2.72 |
| B1477 | (I.D) | N.2.73 |
| B1478 | (I.D) | N.2.74 |
| B1479 | (I.D) | N.2.75 |
| B1480 | (I.D) | N.2.76 |
| B1481 | (I.D) | N.2.77 |
| B1482 | (I.D) | N.2.78 |
| B1483 | (I.D) | N.2.79 |
| B1484 | (I.D) | N.2.80 |
| B1485 | (I.D) | N.2.81 |
| B1486 | (I.D) | N.2.82 |
| B1487 | (I.D) | N.2.83 |
| B1488 | (I.D) | N.2.84 |
| B1489 | (I.D) | N.3.1 |
| B1490 | (I.D) | N.3.2 |
| B1491 | (I.D) | N.3.3 |
| B1492 | (I.D) | N.3.4 |
| B1493 | (I.D) | N.3.5 |
| B1494 | (I.D) | N.3.6 |
| B1495 | (I.D) | N.3.7 |
| B1496 | (I.D) | N.3.8 |
| B1497 | (I.D) | N.3.9 |
| B1498 | (I.D) | N.3.10 |
| B1499 | (I.D) | N.3.11 |
| B1500 | (I.D) | N.3.12 |
| B1501 | (I.D) | N.3.13 |
| B1502 | (I.D) | N.3.14 |
| B1503 | (I.D) | N.3.15 |
| B1504 | (I.D) | N.3.16 |
| B1505 | (I.D) | N.3.17 |
| B1506 | (I.D) | N.3.18 |
| B1507 | (I.D) | N.3.19 |
| B1508 | (I.D) | N.3.20 |
| B1509 | (I.D) | N.3.21 |
| B1510 | (I.D) | N.3.22 |
| B1511 | (I.D) | N.3.23 |
| B1512 | (I.D) | N.3.24 |
| B1513 | (I.D) | N.3.25 |
| B1514 | (I.D) | N.3.26 |
| B1515 | (I.D) | N.3.27 |
| B1516 | (I.D) | N.3.28 |
| B1517 | (I.D) | N.3.29 |
| B1518 | (I.D) | N.3.30 |
| B1519 | (I.D) | N.3.31 |
| B1520 | (I.D) | N.3.32 |
| B1521 | (I.D) | N.3.33 |
| B1522 | (I.D) | N.3.34 |
| B1523 | (I.D) | N.3.35 |
| B1524 | (I.D) | N.3.36 |
| B1525 | (I.D) | N.3.37 |
| B1526 | (I.D) | N.3.38 |
| B1527 | (I.D) | N.3.39 |
| B1528 | (I.D) | N.3.40 |
| B1529 | (I.D) | N.3.41 |
| B1530 | (I.D) | N.3.42 |
| B1531 | (I.D) | N.3.43 |
| B1532 | (I.D) | N.3.44 |
| B1533 | (I.D) | N.3.45 |
| B1534 | (I.D) | N.3.46 |
| B1535 | (I.D) | N.3.47 |
| B1536 | (I.D) | N.3.48 |
| B1537 | (I.D) | N.3.49 |
| B1538 | (I.D) | N.3.50 |
| B1539 | (I.D) | N.3.51 |
| B1540 | (I.D) | N.3.52 |
| B1541 | (I.D) | N.3.53 |
| B1542 | (I.D) | N.3.54 |
| B1543 | (I.D) | N.3.55 |
| B1544 | (I.D) | N.3.56 |
| B1545 | (I.D) | N.3.57 |
| B1546 | (I.D) | N.3.58 |
| B1547 | (I.D) | N.3.59 |
| B1548 | (I.D) | N.3.60 |
| B1549 | (I.D) | N.3.61 |
| B1550 | (I.D) | N.3.62 |
| B1551 | (I.D) | N.3.63 |
| B1552 | (I.D) | N.3.64 |
| B1553 | (I.D) | N.3.65 |
| B1554 | (I.D) | N.3.66 |
| B1555 | (I.D) | N.3.67 |
| B1556 | (I.D) | N.3.68 |
| B1557 | (I.D) | N.3.69 |
| B1558 | (I.D) | N.4.1 |
| B1559 | (I.D) | N.4.2 |
| B1560 | (I.D) | N.4.3 |
| B1561 | (I.D) | N.4.4 |
| B1562 | (I.D) | N.4.5 |
| B1563 | (I.D) | N.4.6 |
| B1564 | (I.D) | N.4.7 |
| B1565 | (I.D) | N.4.8 |
| B1566 | (I.D) | N.4.9 |
| B1567 | (I.D) | N.4.10 |
| B1568 | (I.D) | N.4.11 |
| B1569 | (I.D) | N.4.12 |
| B1570 | (I.D) | N.4.13 |
| B1571 | (I.D) | N.4.14 |
| B1572 | (I.D) | N.4.15 |
| B1573 | (I.D) | N.4.16 |
| B1574 | (I.D) | N.4.17 |
| B1575 | (I.D) | N.4.18 |
| B1576 | (I.D) | N.4.19 |
| B1577 | (I.D) | N.4.20 |
| B1578 | (I.D) | N.4.21 |
| B1579 | (I.D) | N.4.22 |
| B1580 | (I.D) | N.4.23 |
| B1581 | (I.D) | N.4.24 |
| B1582 | (I.D) | N.4.25 |
| B1583 | (I.D) | N.4.26 |
| B1584 | (I.D) | N.4.27 |
| B1585 | (I.D) | N.4.28 |
| B1586 | (I.D) | N.4.29 |
| B1587 | (I.D) | N.4.30 |
| B1588 | (I.D) | N.4.31 |
| B1589 | (I.D) | N.4.32 |
| B1590 | (I.D) | N.4.33 |
| B1591 | (I.D) | N.4.34 |
| B1592 | (I.D) | N.4.35 |
| B1593 | (I.D) | N.4.36 |
| B1594 | (I.D) | N.4.37 |
| B1595 | (I.D) | N.4.38 |
| B1596 | (I.D) | N.4.39 |
| B1597 | (I.D) | N.4.40 |
| B1598 | (I.D) | N.4.41 |
| B1599 | (I.D) | N.4.42 |
| B1600 | (I.D) | N.4.43 |
| B1601 | (I.D) | N.4.44 |
| B1602 | (I.D) | N.4.45 |
| B1603 | (I.D) | N.4.46 |
| B1604 | (I.D) | N.4.47 |
| B1605 | (I.D) | N.5.1 |
| B1606 | (I.D) | N.5.2 |
| B1607 | (I.D) | N.5.3 |
| B1608 | (I.D) | N.5.4 |
| B1609 | (I.D) | N.5.5 |
| B1610 | (I.D) | N.5.6 |
| B1611 | (I.D) | N.5.7 |
| B1612 | (I.D) | N.5.8 |
| B1613 | (I.D) | N.5.9 |
| B1614 | (I.D) | N.5.10 |
| B1615 | (I.D) | N.5.11 |
| B1616 | (I.D) | N.5.12 |
| B1617 | (I.D) | N.5.13 |
| B1618 | (I.D) | N.5.14 |
| B1619 | (I.D) | N.5.15 |
| B1620 | (I.D) | N.5.16 |
| B1621 | (I.D) | N.5.17 |
| B1622 | (I.D) | N.5.18 |
| B1623 | (I.D) | N.5.19 |
| B1624 | (I.D) | N.5.20 |
| B1625 | (I.D) | N.5.21 |
| B1626 | (I.D) | N.5.22 |
| B1627 | (I.D) | N.5.23 |
| B1628 | (I.D) | N.5.24 |
| B1629 | (I.D) | N.5.25 |
| B1630 | (I.D) | N.5.26 |
| B1631 | (I.D) | N.5.27 |
| B1632 | (I.D) | N.6.1 |
| B1633 | (I.D) | N.6.2 |
| B1634 | (I.D) | N.6.3 |
| B1635 | (I.D) | N.6.4 |
| B1636 | (I.D) | N.7.1 |
| B1637 | (I.D) | N.7.2 |
| B1638 | (I.D) | N.7.3 |
| B1639 | (I.D) | N.7.4 |
| B1640 | (I.D) | N.7.5 |
| B1641 | (I.D) | N.8.1 |
| B1642 | (I.D) | N.9.1 |
| B1643 | (I.D) | N.9.2 |
| B1644 | (I.D) | N.9.3 |
| B1645 | (I.D) | N.9.4 |
| B1646 | (I.D) | N.9.5 |
| B1647 | (I.D) | N.9.6 |
| B1648 | (I.D) | N.9.7 |
| B1649 | (I.D) | N.9.8 |
| B1650 | (I.D) | N.9.9 |
| B1651 | (I.D) | N.9.10 |
| B1652 | (I.D) | N.9.11 |
| B1653 | (I.D) | N.9.12 |
| B1654 | (I.D) | N.9.13 |
| B1655 | (I.D) | N.9.14 |
| B1656 | (I.D) | N.9.15 |
| B1657 | (I.D) | N.9.16 |
| B1658 | (I.D) | N.9.17 |
| B1659 | (I.D) | N.9.18 |
| B1660 | (I.D) | N.9.19 |
| B1661 | (I.D) | N.9.20 |
| B1662 | (I.D) | N.9.21 |
| B1663 | (I.D) | N.9.22 |
| B1664 | (I.D) | N.9.23 |
| B1665 | (I.D) | N.9.24 |
| B1666 | (I.D) | N.9.25 |
| B1667 | (I.D) | N.9.26 |
| B1668 | (I.D) | N.10.1 |
| B1669 | (I.D) | N.10.2 |
| B1670 | (I.D) | N.10.3 |
| B1671 | (I.D) | N.10.4 |
| B1672 | (I.D) | N.10.5 |
| B1673 | (I.D) | N.10.6 |
| B1674 | (I.D) | N.10.7 |
| B1675 | (I.D) | N.10.8 |
| B1676 | (I.D) | N.10.9 |
| B1677 | (I.D) | N.10.10 |
| B1678 | (I.D) | N.10.12 |
| B1679 | (I.D) | N.10.13 |
| B1680 | (I.D) | N.10.14 |
| B1681 | (I.D) | N.10.15 |
| B1682 | (I.D) | N.10.16 |
| B1683 | (I.D) | N.10.17 |
| B1684 | (I.D) | N.10.18 |
| B1685 | (I.D) | N.10.19 |
| B1686 | (I.D) | N.10.20 |
| B1687 | (I.D) | N.10.21 |
| B1688 | (I.D) | N.10.22 |
| B1689 | (I.D) | N.10.23 |
| B1690 | (I.D) | N.10.24 |
| B1691 | (I.D) | N.10.25 |
| B1692 | (I.D) | N.10.26 |
| B1693 | (I.D) | N.10.27 |
| B1694 | (I.D) | N.10.28 |
| B1695 | (I.D) | N.10.29 |
| B1696 | (I.D) | N.10.30 |
| B1697 | (I.D) | N.10.31 |
| B1698 | (I.D) | N.10.32 |
| B1699 | (I.D) | N.10.33 |
| B1700 | (I.D) | N.10.34 |
| B1701 | (I.D) | N.10.35 |
| B1702 | (I.D) | N.10.36 |
| B1703 | (I.D) | N.11.1 |
| B1704 | (I.D) | N.11.2 |
| B1705 | (I.D) | N.11.3 |
| B1706 | (I.D) | N.11.4 |
| B1707 | (I.D) | N.11.5 |
| B1708 | (I.D) | N.11.6 |
| B1709 | (I.D) | N.11.7 |
| B1710 | (I.D) | N.12.1 |
| B1711 | (I.D) | N.12.2 |
| B1712 | (I.D) | N.12.3 |
| B1713 | (I.D) | N.13.1 |
| B1714 | (I.D) | N.13.2 |
| B1715 | (I.D) | N.13.3 |
| B1716 | (I.D) | N.13.4 |
| B1717 | (I.D) | N.13.5 |
| B1718 | (I.D) | N.13.6 |
| B1719 | (I.D) | N.13.7 |
| B1720 | (I.D) | N.13.8 |
| B1721 | (I.D) | N.13.9 |
| B1722 | (I.D) | N.13.10 |
| B1723 | (I.D) | N.13.11 |
| B1724 | (I.D) | N.13.12 |
| B1725 | (I.D) | N.13.13 |
| B1726 | (I.D) | N.13.14 |
| B1727 | (I.D) | N.13.15 |
| B1728 | (I.D) | N.13.16 |
| B1729 | (I.D) | N.13.17 |
| B1730 | (I.D) | N.13.18 |
| B1731 | (I.D) | N.13.19 |
| B1732 | (I.D) | N.13.20 |
| B1733 | (I.D) | N.13.21 |
| B1734 | (I.D) | N.13.22 |
| B1735 | (I.D) | N.13.23 |
| B1736 | (I.D) | N.13.24 |
| B1737 | (I.D) | N.13.25 |
| B1738 | (I.D) | N.13.26 |
| B1739 | (I.D) | N.13.27 |
| B1740 | (I.D) | N.13.28 |
| B1741 | (I.D) | N.13.29 |
| B1742 | (I.D) | N.13.30 |
| B1743 | (I.D) | N.13.31 |
| B1744 | (I.D) | N.13.32 |
| B1745 | (I.D) | N.14.1 |
| B1746 | (I.D) | N.14.2 |
| B1747 | (I.D) | N.14.3 |
| B1748 | (I.D) | N.14.4 |
| B1749 | (I.D) | N.15.1 |
| B1750 | (I.D) | N.15.2 |
| B1751 | (I.D) | N.15.3 |
| B1752 | (I.D) | N.15.4 |
| B1753 | (I.D) | N.15.5 |
| B1754 | (I.D) | N.15.6 |
| B1755 | (I.D) | N.15.7 |
| B1756 | (I.D) | N.15.8 |
| B1757 | (I.D) | N.15.9 |
| B1758 | (I.D) | N.15.10 |
| B1759 | (I.D) | N.15.11 |
| B1760 | (I.D) | N.15.12 |
| B1761 | (I.D) | N.15.13 |
| B1762 | (I.D) | N.15.14 |
| B1763 | (I.D) | N.15.15 |
| B1764 | (I.D) | N.15.16 |
| B1765 | (I.D) | N.15.17 |
| B1766 | (I.D) | N.15.18 |
| B1767 | (I.D) | N.15.19 |
| B1768 | (I.D) | N.15.20 |
| B1769 | (I.D) | N.15.21 |
| B1770 | (I.D) | N.15.22 |
| B1771 | (I.D) | N.15.23 |
| B1772 | (I.D) | N.15.24 |
| B1773 | (I.D) | N.15.25 |
| B1774 | (I.D) | N.15.26 |
| B1775 | (I.D) | N.15.27 |
| B1776 | (I.D) | N.15.28 |
| B1777 | (I.D) | N.15.29 |
| B1778 | (I.D) | N.15.30 |
| B1779 | (I.D) | N.15.31 |
| B1780 | (I.D) | N.15.32 |
| B1781 | (I.D) | N.15.33 |
| B1782 | (I.D) | N.15.34 |
| B1783 | (I.D) | N.15.35 |
| B1784 | (I.D) | N.15.36 |

TABLE 5
B = Mixture; I = compound; II = compound II

| B | I | II |
|---|---|---|
| B1785 | (I.E) | N.1.1 |
| B1786 | (I.E) | N.1.2 |
| B1787 | (I.E) | N.1.3 |
| B1788 | (I.E) | N.1.4 |
| B1789 | (I.E) | N.1.5 |
| B1790 | (I.E) | N.1.6 |
| B1791 | (I.E) | N.1.7 |
| B1792 | (I.E) | N.1.8 |
| B1793 | (I.E) | N.1.9 |
| B1794 | (I.E) | N.1.10 |
| B1795 | (I.E) | N.1.11 |
| B1796 | (I.E) | N.1.12 |
| B1797 | (I.E) | N.1.13 |
| B1798 | (I.E) | N.1.14 |
| B1799 | (I.E) | N.1.15 |
| B1800 | (I.E) | N.1.16 |
| B1801 | (I.E) | N.1.17 |
| B1802 | (I.E) | N.1.18 |
| B1803 | (I.E) | N.1.19 |
| B1804 | (I.E) | N.1.20 |
| B1805 | (I.E) | N.1.21 |
| B1806 | (I.E) | N.1.22 |
| B1807 | (I.E) | N.1.23 |
| B1808 | (I.E) | N.1.24 |
| B1809 | (I.E) | N.1.25 |
| B1810 | (I.E) | N.1.26 |
| B1811 | (I.E) | N.1.27 |
| B1812 | (I.E) | N.1.28 |
| B1813 | (I.E) | N.1.29 |
| B1814 | (I.E) | N.1.30 |
| B1815 | (I.E) | N.1.31 |
| B1816 | (I.E) | N.1.32 |
| B1817 | (I.E) | N.1.33 |
| B1818 | (I.E) | N.1.34 |
| B1819 | (I.E) | N.1.35 |
| B1820 | (I.E) | N.1.36 |
| B1821 | (I.E) | N.1.37 |
| B1822 | (I.E) | N.1.38 |
| B1823 | (I.E) | N.1.39 |
| B1824 | (I.E) | N.1.40 |
| B1825 | (I.E) | N.1.41 |
| B1826 | (I.E) | N.1.42 |
| B1827 | (I.E) | N.1.43 |
| B1828 | (I.E) | N.1.44 |
| B1829 | (I.E) | N.1.45 |
| B1830 | (I.E) | N.1.46 |
| B1831 | (I.E) | N.1.47 |
| B1832 | (I.E) | N.1.48 |
| B1833 | (I.E) | N.1.49 |
| B1834 | (I.E) | N.1.50 |
| B1835 | (I.E) | N.1.51 |
| B1836 | (I.E) | N.1.52 |
| B1837 | (I.E) | N.1.53 |
| B1838 | (I.E) | N.1.54 |
| B1839 | (I.E) | N.1.55 |
| B1840 | (I.E) | N.1.56 |
| B1841 | (I.E) | N.1.57 |
| B1842 | (I.E) | N.1.58 |
| B1843 | (I.E) | N.1.59 |
| B1844 | (I.E) | N.1.60 |
| B1845 | (I.E) | N.1.61 |
| B1846 | (I.E) | N.1.62 |
| B1847 | (I.E) | N.1.63 |
| B1848 | (I.E) | N.1.64 |
| B1849 | (I.E) | N.1.65 |
| B1850 | (I.E) | N.1.66 |
| B1851 | (I.E) | N.2.1 |
| B1852 | (I.E) | N.2.2 |
| B1853 | (I.E) | N.2.3 |
| B1854 | (I.E) | N.2.4 |
| B1855 | (I.E) | N.2.5 |
| B1856 | (I.E) | N.2.6 |
| B1857 | (I.E) | N.2.7 |
| B1858 | (I.E) | N.2.8 |
| B1859 | (I.E) | N.2.9 |
| B1860 | (I.E) | N.2.10 |
| B1861 | (I.E) | N.2.11 |
| B1862 | (I.E) | N.2.12 |
| B1863 | (I.E) | N.2.13 |
| B1864 | (I.E) | N.2.14 |
| B1865 | (I.E) | N.2.15 |
| B1866 | (I.E) | N.2.16 |
| B1867 | (I.E) | N.2.17 |
| B1868 | (I.E) | N.2.18 |
| B1869 | (I.E) | N.2.19 |
| B1870 | (I.E) | N.2.20 |
| B1871 | (I.E) | N.2.21 |
| B1872 | (I.E) | N.2.22 |
| B1873 | (I.E) | N.2.23 |
| B1874 | (I.E) | N.2.24 |
| B1875 | (I.E) | N.2.25 |
| B1876 | (I.E) | N.2.26 |
| B1877 | (I.E) | N.2.27 |
| B1878 | (I.E) | N.2.28 |
| B1879 | (I.E) | N.2.29 |
| B1880 | (I.E) | N.2.30 |
| B1881 | (I.E) | N.2.31 |
| B1882 | (I.E) | N.2.32 |
| B1883 | (I.E) | N.2.33 |
| B1884 | (I.E) | N.2.34 |
| B1885 | (I.E) | N.2.35 |
| B1886 | (I.E) | N.2.36 |
| B1887 | (I.E) | N.2.37 |
| B1888 | (I.E) | N.2.38 |
| B1889 | (I.E) | N.2.39 |
| B1890 | (I.E) | N.2.40 |
| B1891 | (I.E) | N.2.41 |
| B1892 | (I.E) | N.2.42 |
| B1893 | (I.E) | N.2.43 |
| B1894 | (I.E) | N.2.44 |
| B1895 | (I.E) | N.2.45 |
| B1896 | (I.E) | N.2.46 |
| B1897 | (I.E) | N.2.47 |
| B1898 | (I.E) | N.2.48 |
| B1899 | (I.E) | N.2.49 |
| B1900 | (I.E) | N.2.50 |
| B1901 | (I.E) | N.2.51 |
| B1902 | (I.E) | N.2.52 |
| B1903 | (I.E) | N.2.53 |
| B1904 | (I.E) | N.2.54 |
| B1905 | (I.E) | N.2.55 |
| B1906 | (I.E) | N.2.56 |
| B1907 | (I.E) | N.2.57 |
| B1908 | (I.E) | N.2.58 |
| B1909 | (I.E) | N.2.59 |
| B1910 | (I.E) | N.2.60 |
| B1911 | (I.E) | N.2.61 |
| B1912 | (I.E) | N.2.62 |
| B1913 | (I.E) | N.2.63 |
| B1914 | (I.E) | N.2.64 |
| B1915 | (I.E) | N.2.65 |
| B1916 | (I.E) | N.2.66 |
| B1917 | (I.E) | N.2.67 |
| B1918 | (I.E) | N.2.68 |
| B1919 | (I.E) | N.2.69 |
| B1920 | (I.E) | N.2.70 |
| B1921 | (I.E) | N.2.71 |
| B1922 | (I.E) | N.2.72 |
| B1923 | (I.E) | N.2.73 |
| B1924 | (I.E) | N.2.74 |
| B1925 | (I.E) | N.2.75 |
| B1926 | (I.E) | N.2.76 |
| B1927 | (I.E) | N.2.77 |
| B1928 | (I.E) | N.2.78 |
| B1929 | (I.E) | N.2.79 |
| B1930 | (I.E) | N.2.80 |
| B1931 | (I.E) | N.2.81 |
| B1932 | (I.E) | N.2.82 |
| B1933 | (I.E) | N.2.83 |
| B1934 | (I.E) | N.2.84 |
| B1935 | (I.E) | N.3.1 |
| B1936 | (I.E) | N.3.2 |
| B1937 | (I.E) | N.3.3 |
| B1938 | (I.E) | N.3.4 |
| B1939 | (I.E) | N.3.5 |
| B1940 | (I.E) | N.3.6 |
| B1941 | (I.E) | N.3.7 |
| B1942 | (I.E) | N.3.8 |
| B1943 | (I.E) | N.3.9 |
| B1944 | (I.E) | N.3.10 |
| B1945 | (I.E) | N.3.11 |
| B1946 | (I.E) | N.3.12 |
| B1947 | (I.E) | N.3.13 |
| B1948 | (I.E) | N.3.14 |
| B1949 | (I.E) | N.3.15 |
| B1950 | (I.E) | N.3.16 |
| B1951 | (I.E) | N.3.17 |
| B1952 | (I.E) | N.3.18 |
| B1953 | (I.E) | N.3.19 |
| B1954 | (I.E) | N.3.20 |
| B1955 | (I.E) | N.3.21 |
| B1956 | (I.E) | N.3.22 |
| B1957 | (I.E) | N.3.23 |
| B1958 | (I.E) | N.3.24 |
| B1959 | (I.E) | N.3.25 |
| B1960 | (I.E) | N.3.26 |
| B1961 | (I.E) | N.3.27 |
| B1962 | (I.E) | N.3.28 |
| B1963 | (I.E) | N.3.29 |
| B1964 | (I.E) | N.3.30 |
| B1965 | (I.E) | N.3.31 |
| B1966 | (I.E) | N.3.32 |
| B1967 | (I.E) | N.3.33 |
| B1968 | (I.E) | N.3.34 |
| B1969 | (I.E) | N.3.35 |
| B1970 | (I.E) | N.3.36 |
| B1971 | (I.E) | N.3.37 |
| B1972 | (I.E) | N.3.38 |
| B1973 | (I.E) | N.3.39 |
| B1974 | (I.E) | N.3.40 |
| B1975 | (I.E) | N.3.41 |
| B1976 | (I.E) | N.3.42 |
| B1977 | (I.E) | N.3.43 |
| B1978 | (I.E) | N.3.44 |
| B1979 | (I.E) | N.3.45 |
| B1980 | (I.E) | N.3.46 |
| B1981 | (I.E) | N.3.47 |
| B1982 | (I.E) | N.3.48 |
| B1983 | (I.E) | N.3.49 |
| B1984 | (I.E) | N.3.50 |
| B1985 | (I.E) | N.3.51 |
| B1986 | (I.E) | N.3.52 |
| B1987 | (I.E) | N.3.53 |
| B1988 | (I.E) | N.3.54 |
| B1989 | (I.E) | N.3.55 |
| B1990 | (I.E) | N.3.56 |
| B1991 | (I.E) | N.3.57 |
| B1992 | (I.E) | N.3.58 |
| B1993 | (I.E) | N.3.59 |
| B1994 | (I.E) | N.3.60 |
| B1995 | (I.E) | N.3.61 |
| B1996 | (I.E) | N.3.62 |
| B1997 | (I.E) | N.3.63 |
| B1998 | (I.E) | N.3.64 |
| B1999 | (I.E) | N.3.65 |
| B2000 | (I.E) | N.3.66 |
| B2001 | (I.E) | N.3.67 |
| B2002 | (I.E) | N.3.68 |
| B2003 | (I.E) | N.3.69 |
| B2004 | (I.E) | N.4.1 |
| B2005 | (I.E) | N.4.2 |
| B2006 | (I.E) | N.4.3 |
| B2007 | (I.E) | N.4.4 |
| B2008 | (I.E) | N.4.5 |
| B2009 | (I.E) | N.4.6 |
| B2010 | (I.E) | N.4.7 |
| B2011 | (I.E) | N.4.8 |
| B2012 | (I.E) | N.4.9 |
| B2013 | (I.E) | N.4.10 |
| B2014 | (I.E) | N.4.11 |
| B2015 | (I.E) | N.4.12 |
| B2016 | (I.E) | N.4.13 |
| B2017 | (I.E) | N.4.14 |
| B2018 | (I.E) | N.4.15 |
| B2019 | (I.E) | N.4.16 |
| B2020 | (I.E) | N.4.17 |
| B2021 | (I.E) | N.4.18 |
| B2022 | (I.E) | N.4.19 |
| B2023 | (I.E) | N.4.20 |
| B2024 | (I.E) | N.4.21 |
| B2025 | (I.E) | N.4.22 |
| B2026 | (I.E) | N.4.23 |
| B2027 | (I.E) | N.4.24 |
| B2028 | (I.E) | N.4.25 |
| B2029 | (I.E) | N.4.26 |
| B2030 | (I.E) | N.4.27 |
| B2031 | (I.E) | N.4.28 |
| B2032 | (I.E) | N.4.29 |
| B2033 | (I.E) | N.4.30 |
| B2034 | (I.E) | N.4.31 |
| B2035 | (I.E) | N.4.32 |
| B2036 | (I.E) | N.4.33 |
| B2037 | (I.E) | N.4.34 |
| B2038 | (I.E) | N.4.35 |
| B2039 | (I.E) | N.4.36 |
| B2040 | (I.E) | N.4.37 |
| B2041 | (I.E) | N.4.38 |
| B2042 | (I.E) | N.4.39 |
| B2043 | (I.E) | N.4.40 |
| B2044 | (I.E) | N.4.41 |
| B2045 | (I.E) | N.4.42 |
| B2046 | (I.E) | N.4.43 |
| B2047 | (I.E) | N.4.44 |
| B2048 | (I.E) | N.4.45 |
| B2049 | (I.E) | N.4.46 |
| B2050 | (I.E) | N.4.47 |
| B2051 | (I.E) | N.5.1 |
| B2052 | (I.E) | N.5.2 |
| B2053 | (I.E) | N.5.3 |
| B2054 | (I.E) | N.5.4 |
| B2055 | (I.E) | N.5.5 |
| B2056 | (I.E) | N.5.6 |
| B2057 | (I.E) | N.5.7 |
| B2058 | (I.E) | N.5.8 |
| B2059 | (I.E) | N.5.9 |
| B2060 | (I.E) | N.5.10 |
| B2061 | (I.E) | N.5.11 |
| B2062 | (I.E) | N.5.12 |
| B2063 | (I.E) | N.5.13 |
| B2064 | (I.E) | N.5.14 |
| B2065 | (I.E) | N.5.15 |
| B2066 | (I.E) | N.5.16 |
| B2067 | (I.E) | N.5.17 |
| B2068 | (I.E) | N.5.18 |
| B2069 | (I.E) | N.5.19 |
| B2070 | (I.E) | N.5.20 |
| B2071 | (I.E) | N.5.21 |
| B2072 | (I.E) | N.5.22 |
| B2073 | (I.E) | N.5.23 |
| B2074 | (I.E) | N.5.24 |
| B2075 | (I.E) | N.5.25 |
| B2076 | (I.E) | N.5.26 |
| B2077 | (I.E) | N.5.27 |
| B2078 | (I.E) | N.6.1 |
| B2079 | (I.E) | N.6.2 |
| B2080 | (I.E) | N.6.3 |
| B2081 | (I.E) | N.6.4 |
| B2082 | (I.E) | N.7.1 |
| B2083 | (I.E) | N.7.2 |
| B2084 | (I.E) | N.7.3 |
| B2085 | (I.E) | N.7.4 |
| B2086 | (I.E) | N.7.5 |
| B2087 | (I.E) | N.8.1 |
| B2088 | (I.E) | N.9.1 |
| B2089 | (I.E) | N.9.2 |
| B2090 | (I.E) | N.9.3 |
| B2091 | (I.E) | N.9.4 |
| B2092 | (I.E) | N.9.5 |
| B2093 | (I.E) | N.9.6 |
| B2094 | (I.E) | N.9.7 |
| B2095 | (I.E) | N.9.8 |
| B2096 | (I.E) | N.9.9 |
| B2097 | (I.E) | N.9.10 |
| B2098 | (I.E) | N.9.11 |
| B2099 | (I.E) | N.9.12 |
| B2100 | (I.E) | N.9.13 |
| B2101 | (I.E) | N.9.14 |
| B2102 | (I.E) | N.9.15 |
| B2103 | (I.E) | N.9.16 |
| B2104 | (I.E) | N.9.17 |
| B2105 | (I.E) | N.9.18 |
| B2106 | (I.E) | N.9.19 |
| B2107 | (I.E) | N.9.20 |
| B2108 | (I.E) | N.9.21 |
| B2109 | (I.E) | N.9.22 |
| B2110 | (I.E) | N.9.23 |
| B2111 | (I.E) | N.9.24 |
| B2112 | (I.E) | N.9.25 |
| B2113 | (I.E) | N.9.26 |
| B2114 | (I.E) | N.10.1 |
| B2115 | (I.E) | N.10.2 |
| B2116 | (I.E) | N.10.3 |
| B2117 | (I.E) | N.10.4 |
| B2118 | (I.E) | N.10.5 |
| B2119 | (I.E) | N.10.6 |
| B2120 | (I.E) | N.10.7 |
| B2121 | (I.E) | N.10.8 |
| B2122 | (I.E) | N.10.9 |
| B2123 | (I.E) | N.10.10 |
| B2124 | (I.E) | N.10.12 |
| B2125 | (I.E) | N.10.13 |
| B2126 | (I.E) | N.10.14 |
| B2127 | (I.E) | N.10.15 |
| B2128 | (I.E) | N.10.16 |
| B2129 | (I.E) | N.10.17 |
| B2130 | (I.E) | N.10.18 |
| B2131 | (I.E) | N.10.19 |
| B2132 | (I.E) | N.10.20 |
| B2133 | (I.E) | N.10.21 |
| B2134 | (I.E) | N.10.22 |
| B2135 | (I.E) | N.10.23 |
| B2136 | (I.E) | N.10.24 |
| B2137 | (I.E) | N.10.25 |
| B2138 | (I.E) | N.10.26 |
| B2139 | (I.E) | N.10.27 |
| B2140 | (I.E) | N.10.28 |
| B2141 | (I.E) | N.10.29 |
| B2142 | (I.E) | N.10.30 |
| B2143 | (I.E) | N.10.31 |
| B2144 | (I.E) | N.10.32 |
| B2145 | (I.E) | N.10.33 |
| B2146 | (I.E) | N.10.34 |
| B2147 | (I.E) | N.10.35 |
| B2148 | (I.E) | N.10.36 |
| B2149 | (I.E) | N.11.1 |
| B2150 | (I.E) | N.11.2 |
| B2151 | (I.E) | N.11.3 |
| B2152 | (I.E) | N.11.4 |
| B2153 | (I.E) | N.11.5 |
| B2154 | (I.E) | N.11.6 |
| B2155 | (I.E) | N.11.7 |
| B2156 | (I.E) | N.12.1 |
| B2157 | (I.E) | N.12.2 |
| B2158 | (I.E) | N.12.3 |
| B2159 | (I.E) | N.13.1 |
| B2160 | (I.E) | N.13.2 |
| B2161 | (I.E) | N.13.3 |
| B2162 | (I.E) | N.13.4 |
| B2163 | (I.E) | N.13.5 |
| B2164 | (I.E) | N.13.6 |
| B2165 | (I.E) | N.13.7 |
| B2166 | (I.E) | N.13.8 |
| B2167 | (I.E) | N.13.9 |
| B2168 | (I.E) | N.13.10 |
| B2169 | (I.E) | N.13.11 |
| B2170 | (I.E) | N.13.12 |
| B2171 | (I.E) | N.13.13 |
| B2172 | (I.E) | N.13.14 |
| B2173 | (I.E) | N.13.15 |
| B2174 | (I.E) | N.13.16 |
| B2175 | (I.E) | N.13.17 |
| B2176 | (I.E) | N.13.18 |
| B2177 | (I.E) | N.13.19 |
| B2178 | (I.E) | N.13.20 |
| B2179 | (I.E) | N.13.21 |
| B2180 | (I.E) | N.13.22 |
| B2181 | (I.E) | N.13.23 |
| B2182 | (I.E) | N.13.24 |
| B2183 | (I.E) | N.13.25 |
| B2184 | (I.E) | N.13.26 |
| B2185 | (I.E) | N.13.27 |
| B2186 | (I.E) | N.13.28 |
| B2187 | (I.E) | N.13.29 |
| B2188 | (I.E) | N.13.30 |
| B2189 | (I.E) | N.13.31 |
| B2190 | (I.E) | N.13.32 |
| B2191 | (I.E) | N.14.1 |
| B2192 | (I.E) | N.14.2 |
| B2193 | (I.E) | N.14.3 |
| B2194 | (I.E) | N.14.4 |
| B2195 | (I.E) | N.15.1 |
| B2196 | (I.E) | N.15.2 |
| B2197 | (I.E) | N.15.3 |
| B2198 | (I.E) | N.15.4 |
| B2199 | (I.E) | N.15.5 |
| B2200 | (I.E) | N.15.6 |
| B2201 | (I.E) | N.15.7 |
| B2202 | (I.E) | N.15.8 |
| B2203 | (I.E) | N.15.9 |
| B2204 | (I.E) | N.15.10 |
| B2205 | (I.E) | N.15.11 |
| B2206 | (I.E) | N.15.12 |
| B2207 | (I.E) | N.15.13 |
| B2208 | (I.E) | N.15.14 |
| B2209 | (I.E) | N.15.15 |
| B2210 | (I.E) | N.15.16 |
| B2211 | (I.E) | N.15.17 |
| B2212 | (I.E) | N.15.18 |
| B2213 | (I.E) | N.15.19 |
| B2214 | (I.E) | N.15.20 |
| B2215 | (I.E) | N.15.21 |
| B2216 | (I.E) | N.15.22 |
| B2217 | (I.E) | N.15.23 |
| B2218 | (I.E) | N.15.24 |
| B2219 | (I.E) | N.15.25 |
| B2220 | (I.E) | N.15.26 |
| B2221 | (I.E) | N.15.27 |
| B2222 | (I.E) | N.15.28 |
| B2223 | (I.E) | N.15.29 |
| B2224 | (I.E) | N.15.30 |
| B2225 | (I.E) | N.15.31 |
| B2226 | (I.E) | N.15.32 |
| B2227 | (I.E) | N.15.33 |
| B2228 | (I.E) | N.15.34 |
| B2229 | (I.E) | N.15.35 |
| B2230 | (I.E) | N.15.36 |

TABLE 6
B = Mixture; I = compound I; II = compound II

| B | I | II |
|---|---|---|
| B2231 | (I.F) | N.1.1 |
| B2232 | (I.F) | N.1.2 |
| B2233 | (I.F) | N.1.3 |
| B2234 | (I.F) | N.1.4 |
| B2235 | (I.F) | N.1.5 |
| B2236 | (I.F) | N.1.6 |
| B2237 | (I.F) | N.1.7 |
| B2238 | (I.F) | N.1.8 |
| B2239 | (I.F) | N.1.9 |
| B2240 | (I.F) | N.1.10 |
| B2241 | (I.F) | N.1.11 |
| B2242 | (I.F) | N.1.12 |
| B2243 | (I.F) | N.1.13 |
| B2244 | (I.F) | N.1.14 |
| B2245 | (I.F) | N.1.15 |
| B2246 | (I.F) | N.1.16 |
| B2247 | (I.F) | N.1.17 |
| B2248 | (I.F) | N.1.18 |
| B2249 | (I.F) | N.1.19 |
| B2250 | (I.F) | N.1.20 |
| B2251 | (I.F) | N.1.21 |
| B2252 | (I.F) | N.1.22 |
| B2253 | (I.F) | N.1.23 |
| B2254 | (I.F) | N.1.24 |
| B2255 | (I.F) | N.1.25 |
| B2256 | (I.F) | N.1.26 |
| B2257 | (I.F) | N.1.27 |
| B2258 | (I.F) | N.1.28 |
| B2259 | (I.F) | N.1.29 |
| B2260 | (I.F) | N.1.30 |
| B2261 | (I.F) | N.1.31 |
| B2262 | (I.F) | N.1.32 |
| B2263 | (I.F) | N.1.33 |
| B2264 | (I.F) | N.1.34 |
| B2265 | (I.F) | N.1.35 |
| B2266 | (I.F) | N.1.36 |
| B2267 | (I.F) | N.1.37 |
| B2268 | (I.F) | N.1.38 |
| B2269 | (I.F) | N.1.39 |
| B2270 | (I.F) | N.1.40 |
| B2271 | (I.F) | N.1.41 |
| B2272 | (I.F) | N.1.42 |
| B2273 | (I.F) | N.1.43 |
| B2274 | (I.F) | N.1.44 |
| B2275 | (I.F) | N.1.45 |
| B2276 | (I.F) | N.1.46 |
| B2277 | (I.F) | N.1.47 |
| B2278 | (I.F) | N.1.48 |
| B2279 | (I.F) | N.1.49 |
| B2280 | (I.F) | N.1.50 |
| B2281 | (I.F) | N.1.51 |
| B2282 | (I.F) | N.1.52 |
| B2283 | (I.F) | N.1.53 |
| B2284 | (I.F) | N.1.54 |
| B2285 | (I.F) | N.1.55 |
| B2286 | (I.F) | N.1.56 |
| B2287 | (I.F) | N.1.57 |
| B2288 | (I.F) | N.1.58 |
| B2289 | (I.F) | N.1.59 |
| B2290 | (I.F) | N.1.60 |
| B2291 | (I.F) | N.1.61 |
| B2292 | (I.F) | N.1.62 |
| B2293 | (I.F) | N.1.63 |
| B2294 | (I.F) | N.1.64 |
| B2295 | (I.F) | N.1.65 |
| B2296 | (I.F) | N.1.66 |
| B2297 | (I.F) | N.2.1 |
| B2298 | (I.F) | N.2.2 |
| B2299 | (I.F) | N.2.3 |
| B2300 | (I.F) | N.2.4 |
| B2301 | (I.F) | N.2.5 |
| B2302 | (I.F) | N.2.6 |
| B2303 | (I.F) | N.2.7 |
| B2304 | (I.F) | N.2.8 |
| B2305 | (I.F) | N.2.9 |
| B2306 | (I.F) | N.2.10 |
| B2307 | (I.F) | N.2.11 |
| B2308 | (I.F) | N.2.12 |
| B2309 | (I.F) | N.2.13 |
| B2310 | (I.F) | N.2.14 |
| B2311 | (I.F) | N.2.15 |
| B2312 | (I.F) | N.2.16 |
| B2313 | (I.F) | N.2.17 |
| B2314 | (I.F) | N.2.18 |
| B2315 | (I.F) | N.2.19 |
| B2316 | (I.F) | N.2.20 |
| B2317 | (I.F) | N.2.21 |
| B2318 | (I.F) | N.2.22 |
| B2319 | (I.F) | N.2.23 |
| B2320 | (I.F) | N.2.24 |
| B2321 | (I.F) | N.2.25 |
| B2322 | (I.F) | N.2.26 |
| B2323 | (I.F) | N.2.27 |
| B2324 | (I.F) | N.2.28 |
| B2325 | (I.F) | N.2.29 |
| B2326 | (I.F) | N.2.30 |
| B2327 | (I.F) | N.2.31 |
| B2328 | (I.F) | N.2.32 |
| B2329 | (I.F) | N.2.33 |
| B2330 | (I.F) | N.2.34 |
| B2331 | (I.F) | N.2.35 |
| B2332 | (I.F) | N.2.36 |
| B2333 | (I.F) | N.2.37 |
| B2334 | (I.F) | N.2.38 |
| B2335 | (I.F) | N.2.39 |
| B2336 | (I.F) | N.2.40 |
| B2337 | (I.F) | N.2.41 |
| B2338 | (I.F) | N.2.42 |
| B2339 | (I.F) | N.2.43 |
| B2340 | (I.F) | N.2.44 |
| B2341 | (I.F) | N.2.45 |
| B2342 | (I.F) | N.2.46 |
| B2343 | (I.F) | N.2.47 |
| B2344 | (I.F) | N.2.48 |
| B2345 | (I.F) | N.2.49 |
| B2346 | (I.F) | N.2.50 |
| B2347 | (I.F) | N.2.51 |
| B2348 | (I.F) | N.2.52 |
| B2349 | (I.F) | N.2.53 |
| B2350 | (I.F) | N.2.54 |
| B2351 | (I.F) | N.2.55 |
| B2352 | (I.F) | N.2.56 |
| B2353 | (I.F) | N.2.57 |
| B2354 | (I.F) | N.2.58 |
| B2355 | (I.F) | N.2.59 |
| B2356 | (I.F) | N.2.60 |
| B2357 | (I.F) | N.2.61 |
| B2358 | (I.F) | N.2.62 |
| B2359 | (I.F) | N.2.63 |
| B2360 | (I.F) | N.2.64 |
| B2361 | (I.F) | N.2.65 |
| B2362 | (I.F) | N.2.66 |
| B2363 | (I.F) | N.2.67 |
| B2364 | (I.F) | N.2.68 |
| B2365 | (I.F) | N.2.69 |
| B2366 | (I.F) | N.2.70 |
| B2367 | (I.F) | N.2.71 |
| B2368 | (I.F) | N.2.72 |
| B2369 | (I.F) | N.2.73 |
| B2370 | (I.F) | N.2.74 |
| B2371 | (I.F) | N.2.75 |
| B2372 | (I.F) | N.2.76 |
| B2373 | (I.F) | N.2.77 |
| B2374 | (I.F) | N.2.78 |
| B2375 | (I.F) | N.2.79 |
| B2376 | (I.F) | N.2.80 |
| B2377 | (I.F) | N.2.81 |
| B2378 | (I.F) | N.2.82 |
| B2379 | (I.F) | N.2.83 |
| B2380 | (I.F) | N.2.84 |
| B2381 | (I.F) | N.3.1 |
| B2382 | (I.F) | N.3.2 |
| B2383 | (I.F) | N.3.3 |
| B2384 | (I.F) | N.3.4 |
| B2385 | (I.F) | N.3.5 |
| B2386 | (I.F) | N.3.6 |
| B2387 | (I.F) | N.3.7 |
| B2388 | (I.F) | N.3.8 |
| B2389 | (I.F) | N.3.9 |
| B2390 | (I.F) | N.3.10 |
| B2391 | (I.F) | N.3.11 |
| B2392 | (I.F) | N.3.12 |
| B2393 | (I.F) | N.3.13 |
| B2394 | (I.F) | N.3.14 |
| B2395 | (I.F) | N.3.15 |
| B2396 | (I.F) | N.3.16 |
| B2397 | (I.F) | N.3.17 |
| B2398 | (I.F) | N.3.18 |
| B2399 | (I.F) | N.3.19 |
| B2400 | (I.F) | N.3.20 |
| B2401 | (I.F) | N.3.21 |
| B2402 | (I.F) | N.3.22 |
| B2403 | (I.F) | N.3.23 |
| B2404 | (I.F) | N.3.24 |
| B2405 | (I.F) | N.3.25 |
| B2406 | (I.F) | N.3.26 |
| B2407 | (I.F) | N.3.27 |
| B2408 | (I.F) | N.3.28 |
| B2409 | (I.F) | N.3.29 |
| B2410 | (I.F) | N.3.30 |
| B2411 | (I.F) | N.3.31 |
| B2412 | (I.F) | N.3.32 |
| B2413 | (I.F) | N.3.33 |
| B2414 | (I.F) | N.3.34 |
| B2415 | (I.F) | N.3.35 |
| B2416 | (I.F) | N.3.36 |
| B2417 | (I.F) | N.3.37 |
| B2418 | (I.F) | N.3.38 |
| B2419 | (I.F) | N.3.39 |
| B2420 | (I.F) | N.3.40 |
| B2421 | (I.F) | N.3.41 |
| B2422 | (I.F) | N.3.42 |
| B2423 | (I.F) | N.3.43 |
| B2424 | (I.F) | N.3.44 |
| B2425 | (I.F) | N.3.45 |
| B2426 | (I.F) | N.3.46 |
| B2427 | (I.F) | N.3.47 |
| B2428 | (I.F) | N.3.48 |
| B2429 | (I.F) | N.3.49 |
| B2430 | (I.F) | N.3.50 |
| B2431 | (I.F) | N.3.51 |
| B2432 | (I.F) | N.3.52 |
| B2433 | (I.F) | N.3.53 |
| B2434 | (I.F) | N.3.54 |
| B2435 | (I.F) | N.3.55 |
| B2436 | (I.F) | N.3.56 |
| B2437 | (I.F) | N.3.57 |
| B2438 | (I.F) | N.3.58 |
| B2439 | (I.F) | N.3.59 |
| B2440 | (I.F) | N.3.60 |
| B2441 | (I.F) | N.3.61 |
| B2442 | (I.F) | N.3.62 |
| B2443 | (I.F) | N.3.63 |
| B2444 | (I.F) | N.3.64 |
| B2445 | (I.F) | N.3.65 |
| B2446 | (I.F) | N.3.66 |
| B2447 | (I.F) | N.3.67 |
| B2448 | (I.F) | N.3.68 |
| B2449 | (I.F) | N.3.69 |
| B2450 | (I.F) | N.4.1 |
| B2451 | (I.F) | N.4.2 |
| B2452 | (I.F) | N.4.3 |
| B2453 | (I.F) | N.4.4 |
| B2454 | (I.F) | N.4.5 |
| B2455 | (I.F) | N.4.6 |
| B2456 | (I.F) | N.4.7 |
| B2457 | (I.F) | N.4.8 |
| B2458 | (I.F) | N.4.9 |
| B2459 | (I.F) | N.4.10 |
| B2460 | (I.F) | N.4.11 |
| B2461 | (I.F) | N.4.12 |
| B2462 | (I.F) | N.4.13 |
| B2463 | (I.F) | N.4.14 |
| B2464 | (I.F) | N.4.15 |
| B2465 | (I.F) | N.4.16 |
| B2466 | (I.F) | N.4.17 |
| B2467 | (I.F) | N.4.18 |
| B2468 | (I.F) | N.4.19 |
| B2469 | (I.F) | N.4.20 |
| B2470 | (I.F) | N.4.21 |
| B2471 | (I.F) | N.4.22 |
| B2472 | (I.F) | N.4.23 |
| B2473 | (I.F) | N.4.24 |
| B2474 | (I.F) | N.4.25 |
| B2475 | (I.F) | N.4.26 |
| B2476 | (I.F) | N.4.27 |
| B2477 | (I.F) | N.4.28 |
| B2478 | (I.F) | N.4.29 |
| B2479 | (I.F) | N.4.30 |
| B2480 | (I.F) | N.4.31 |
| B2481 | (I.F) | N.4.32 |
| B2482 | (I.F) | N.4.33 |
| B2483 | (I.F) | N.4.34 |
| B2484 | (I.F) | N.4.35 |
| B2485 | (I.F) | N.4.36 |
| B2486 | (I.F) | N.4.37 |
| B2487 | (I.F) | N.4.38 |
| B2488 | (I.F) | N.4.39 |
| B2489 | (I.F) | N.4.40 |
| B2490 | (I.F) | N.4.41 |
| B2491 | (I.F) | N.4.42 |
| B2492 | (I.F) | N.4.43 |
| B2493 | (I.F) | N.4.44 |
| B2494 | (I.F) | N.4.45 |
| B2495 | (I.F) | N.4.46 |
| B2496 | (I.F) | N.4.47 |
| B2497 | (I.F) | N.5.1 |
| B2498 | (I.F) | N.5.2 |
| B2499 | (I.F) | N.5.3 |
| B2500 | (I.F) | N.5.4 |
| B2501 | (I.F) | N.5.5 |
| B2502 | (I.F) | N.5.6 |
| B2503 | (I.F) | N.5.7 |
| B2504 | (I.F) | N.5.8 |
| B2505 | (I.F) | N.5.9 |
| B2506 | (I.F) | N.5.10 |
| B2507 | (I.F) | N.5.11 |
| B2508 | (I.F) | N.5.12 |
| B2509 | (I.F) | N.5.13 |
| B2510 | (I.F) | N.5.14 |
| B2511 | (I.F) | N.5.15 |
| B2512 | (I.F) | N.5.16 |
| B2513 | (I.F) | N.5.17 |
| B2514 | (I.F) | N.5.18 |
| B2515 | (I.F) | N.5.19 |
| B2516 | (I.F) | N.5.20 |
| B2517 | (I.F) | N.5.21 |
| B2518 | (I.F) | N.5.22 |
| B2519 | (I.F) | N.5.23 |
| B2520 | (I.F) | N.5.24 |
| B2521 | (I.F) | N.5.25 |
| B2522 | (I.F) | N.5.26 |
| B2523 | (I.F) | N.5.27 |
| B2524 | (I.F) | N.6.1 |
| B2525 | (I.F) | N.6.2 |
| B2526 | (I.F) | N.6.3 |
| B2527 | (I.F) | N.6.4 |
| B2528 | (I.F) | N.7.1 |
| B2529 | (I.F) | N.7.2 |
| B2530 | (I.F) | N.7.3 |
| B2531 | (I.F) | N.7.4 |
| B2532 | (I.F) | N.7.5 |
| B2533 | (I.F) | N.8.1 |
| B2534 | (I.F) | N.9.1 |
| B2535 | (I.F) | N.9.2 |
| B2536 | (I.F) | N.9.3 |
| B2537 | (I.F) | N.9.4 |
| B2538 | (I.F) | N.9.5 |
| B2539 | (I.F) | N.9.6 |
| B2540 | (I.F) | N.9.7 |
| B2541 | (I.F) | N.9.8 |
| B2542 | (I.F) | N.9.9 |
| B2543 | (I.F) | N.9.10 |
| B2544 | (I.F) | N.9.11 |
| B2545 | (I.F) | N.9.12 |
| B2546 | (I.F) | N.9.13 |
| B2547 | (I.F) | N.9.14 |
| B2548 | (I.F) | N.9.15 |
| B2549 | (I.F) | N.9.16 |
| B2550 | (I.F) | N.9.17 |
| B2551 | (I.F) | N.9.18 |
| B2552 | (I.F) | N.9.19 |
| B2553 | (I.F) | N.9.20 |
| B2554 | (I.F) | N.9.21 |
| B2555 | (I.F) | N.9.22 |
| B2556 | (I.F) | N.9.23 |
| B2557 | (I.F) | N.9.24 |
| B2558 | (I.F) | N.9.25 |
| B2559 | (I.F) | N.9.26 |
| B2560 | (I.F) | N.10.1 |
| B2561 | (I.F) | N.10.2 |
| B2562 | (I.F) | N.10.3 |
| B2563 | (I.F) | N.10.4 |
| B2564 | (I.F) | N.10.5 |
| B2565 | (I.F) | N.10.6 |
| B2566 | (I.F) | N.10.7 |
| B2567 | (I.F) | N.10.8 |
| B2568 | (I.F) | N.10.9 |
| B2569 | (I.F) | N.10.10 |
| B2570 | (I.F) | N.10.12 |
| B2571 | (I.F) | N.10.13 |
| B2572 | (I.F) | N.10.14 |
| B2573 | (I.F) | N.10.15 |
| B2574 | (I.F) | N.10.16 |
| B2575 | (I.F) | N.10.17 |
| B2576 | (I.F) | N.10.18 |
| B2577 | (I.F) | N.10.19 |
| B2578 | (I.F) | N.10.20 |
| B2579 | (I.F) | N.10.21 |
| B2580 | (I.F) | N.10.22 |
| B2581 | (I.F) | N.10.23 |
| B2582 | (I.F) | N.10.24 |
| B2583 | (I.F) | N.10.25 |
| B2584 | (I.F) | N.10.26 |
| B2585 | (I.F) | N.10.27 |
| B2586 | (I.F) | N.10.28 |
| B2587 | (I.F) | N.10.29 |
| B2588 | (I.F) | N.10.30 |
| B2589 | (I.F) | N.10.31 |
| B2590 | (I.F) | N.10.32 |
| B2591 | (I.F) | N.10.33 |
| B2592 | (I.F) | N.10.34 |
| B2593 | (I.F) | N.10.35 |
| B2594 | (I.F) | N.10.36 |
| B2595 | (I.F) | N.11.1 |
| B2596 | (I.F) | N.11.2 |
| B2597 | (I.F) | N.11.3 |
| B2598 | (I.F) | N.11.4 |
| B2599 | (I.F) | N.11.5 |
| B2600 | (I.F) | N.11.6 |
| B2601 | (I.F) | N.11.7 |
| B2602 | (I.F) | N.12.1 |
| B2603 | (I.F) | N.12.2 |
| B2604 | (I.F) | N.12.3 |
| B2605 | (I.F) | N.13.1 |
| B2606 | (I.F) | N.13.2 |
| B2607 | (I.F) | N.13.3 |
| B2608 | (I.F) | N.13.4 |
| B2609 | (I.F) | N.13.5 |
| B2610 | (I.F) | N.13.6 |
| B2611 | (I.F) | N.13.7 |
| B2612 | (I.F) | N.13.8 |
| B2613 | (I.F) | N.13.9 |
| B2614 | (I.F) | N.13.10 |
| B2615 | (I.F) | N.13.11 |
| B2616 | (I.F) | N.13.12 |
| B2617 | (I.F) | N.13.13 |
| B2618 | (I.F) | N.13.14 |
| B2619 | (I.F) | N.13.15 |
| B2620 | (I.F) | N.13.16 |
| B2621 | (I.F) | N.13.17 |
| B2622 | (I.F) | N.13.18 |
| B2623 | (I.F) | N.13.19 |
| B2624 | (I.F) | N.13.20 |
| B2625 | (I.F) | N.13.21 |
| B2626 | (I.F) | N.13.22 |
| B2627 | (I.F) | N.13.23 |
| B2628 | (I.F) | N.13.24 |
| B2629 | (I.F) | N.13.25 |
| B2630 | (I.F) | N.13.26 |
| B2631 | (I.F) | N.13.27 |
| B2632 | (I.F) | N.13.28 |
| B2633 | (I.F) | N.13.29 |
| B2634 | (I.F) | N.13.30 |
| B2635 | (I.F) | N.13.31 |
| B2636 | (I.F) | N.13.32 |
| B2637 | (I.F) | N.14.1 |
| B2638 | (I.F) | N.14.2 |
| B2639 | (I.F) | N.14.3 |
| B2640 | (I.F) | N.14.4 |
| B2641 | (I.F) | N.15.1 |
| B2642 | (I.F) | N.15.2 |
| B2643 | (I.F) | N.15.3 |
| B2644 | (I.F) | N.15.4 |
| B2645 | (I.F) | N.15.5 |
| B2646 | (I.F) | N.15.6 |
| B2647 | (I.F) | N.15.7 |
| B2648 | (I.F) | N.15.8 |
| B2649 | (I.F) | N.15.9 |
| B2650 | (I.F) | N.15.10 |
| B2651 | (I.F) | N.15.11 |
| B2652 | (I.F) | N.15.12 |
| B2653 | (I.F) | N.15.13 |
| B2654 | (I.F) | N.15.14 |
| B2655 | (I.F) | N.15.15 |
| B2656 | (I.F) | N.15.16 |
| B2657 | (I.F) | N.15.17 |
| B2658 | (I.F) | N.15.18 |
| B2659 | (I.F) | N.15.19 |
| B2660 | (I.F) | N.15.20 |
| B2661 | (I.F) | N.15.21 |
| B2662 | (I.F) | N.15.22 |
| B2663 | (I.F) | N.15.23 |
| B2664 | (I.F) | N.15.24 |
| B2665 | (I.F) | N.15.25 |
| B2666 | (I.F) | N.15.26 |
| B2667 | (I.F) | N.15.27 |
| B2668 | (I.F) | N.15.28 |
| B2669 | (I.F) | N.15.29 |
| B2670 | (I.F) | N.15.30 |
| B2671 | (I.F) | N.15.31 |
| B2672 | (I.F) | N.15.32 |
| B2673 | (I.F) | N.15.33 |
| B2674 | (I.F) | N.15.34 |
| B2675 | (I.F) | N.15.35 |
| B2676 | (I.F) | N.15.36 |

TABLE 7
B = Mixture; I = compound I; II = compound II

| B | I | II |
|---|---|---|
| B2677 | (I.G) | N.1.1 |
| B2678 | (I.G) | N.1.2 |
| B2679 | (I.G) | N.1.3 |
| B2680 | (I.G) | N.1.4 |
| B2681 | (I.G) | N.1.5 |
| B2682 | (I.G) | N.1.6 |
| B2683 | (I.G) | N.1.7 |
| B2684 | (I.G) | N.1.8 |
| B2685 | (I.G) | N.1.9 |
| B2686 | (I.G) | N.1.10 |
| B2687 | (I.G) | N.1.11 |
| B2688 | (I.G) | N.1.12 |
| B2689 | (I.G) | N.1.13 |
| B2690 | (I.G) | N.1.14 |
| B2691 | (I.G) | N.1.15 |
| B2692 | (I.G) | N.1.16 |
| B2693 | (I.G) | N.1.17 |
| B2694 | (I.G) | N.1.18 |
| B2695 | (I.G) | N.1.19 |
| B2696 | (I.G) | N.1.20 |
| B2697 | (I.G) | N.1.21 |
| B2698 | (I.G) | N.1.22 |
| B2699 | (I.G) | N.1.23 |
| B2700 | (I.G) | N.1.24 |
| B2701 | (I.G) | N.1.25 |
| B2702 | (I.G) | N.1.26 |
| B2703 | (I.G) | N.1.27 |
| B2704 | (I.G) | N.1.28 |
| B2705 | (I.G) | N.1.29 |
| B2706 | (I.G) | N.1.30 |
| B2707 | (I.G) | N.1.31 |
| B2708 | (I.G) | N.1.32 |
| B2709 | (I.G) | N.1.33 |
| B2710 | (I.G) | N.1.34 |
| B2711 | (I.G) | N.1.35 |
| B2712 | (I.G) | N.1.36 |
| B2713 | (I.G) | N.1.37 |
| B2714 | (I.G) | N.1.38 |
| B2715 | (I.G) | N.1.39 |
| B2716 | (I.G) | N.1.40 |
| B2717 | (I.G) | N.1.41 |
| B2718 | (I.G) | N.1.42 |
| B2719 | (I.G) | N.1.43 |
| B2720 | (I.G) | N.1.44 |
| B2721 | (I.G) | N.1.45 |
| B2722 | (I.G) | N.1.46 |
| B2723 | (I.G) | N.1.47 |
| B2724 | (I.G) | N.1.48 |
| B2725 | (I.G) | N.1.49 |
| B2726 | (I.G) | N.1.50 |
| B2727 | (I.G) | N.1.51 |
| B2728 | (I.G) | N.1.52 |
| B2729 | (I.G) | N.1.53 |
| B2730 | (I.G) | N.1.54 |
| B2731 | (I.G) | N.1.55 |
| B2732 | (I.G) | N.1.56 |
| B2733 | (I.G) | N.1.57 |
| B2734 | (I.G) | N.1.58 |
| B2735 | (I.G) | N.1.59 |
| B2736 | (I.G) | N.1.60 |
| B2737 | (I.G) | N.1.61 |
| B2738 | (I.G) | N.1.62 |
| B2739 | (I.G) | N.1.63 |
| B2740 | (I.G) | N.1.64 |
| B2741 | (I.G) | N.1.65 |
| B2742 | (I.G) | N.1.66 |
| B2743 | (I.G) | N.2.1 |
| B2744 | (I.G) | N.2.2 |
| B2745 | (I.G) | N.2.3 |
| B2746 | (I.G) | N.2.4 |
| B2747 | (I.G) | N.2.5 |
| B2748 | (I.G) | N.2.6 |
| B2749 | (I.G) | N.2.7 |
| B2750 | (I.G) | N.2.8 |
| B2751 | (I.G) | N.2.9 |
| B2752 | (I.G) | N.2.10 |
| B2753 | (I.G) | N.2.11 |
| B2754 | (I.G) | N.2.12 |
| B2755 | (I.G) | N.2.13 |
| B2756 | (I.G) | N.2.14 |
| B2757 | (I.G) | N.2.15 |
| B2758 | (I.G) | N.2.16 |
| B2759 | (I.G) | N.2.17 |
| B2760 | (I.G) | N.2.18 |
| B2761 | (I.G) | N.2.19 |
| B2762 | (I.G) | N.2.20 |
| B2763 | (I.G) | N.2.21 |
| B2764 | (I.G) | N.2.22 |
| B2765 | (I.G) | N.2.23 |
| B2766 | (I.G) | N.2.24 |
| B2767 | (I.G) | N.2.25 |
| B2768 | (I.G) | N.2.26 |
| B2769 | (I.G) | N.2.27 |
| B2770 | (I.G) | N.2.28 |
| B2771 | (I.G) | N.2.29 |
| B2772 | (I.G) | N.2.30 |
| B2773 | (I.G) | N.2.31 |
| B2774 | (I.G) | N.2.32 |
| B2775 | (I.G) | N.2.33 |
| B2776 | (I.G) | N.2.34 |
| B2777 | (I.G) | N.2.35 |
| B2778 | (I.G) | N.2.36 |
| B2779 | (I.G) | N.2.37 |
| B2780 | (I.G) | N.2.38 |
| B2781 | (I.G) | N.2.39 |
| B2782 | (I.G) | N.2.40 |
| B2783 | (I.G) | N.2.41 |
| B2784 | (I.G) | N.2.42 |
| B2785 | (I.G) | N.2.43 |
| B2786 | (I.G) | N.2.44 |
| B2787 | (I.G) | N.2.45 |
| B2788 | (I.G) | N.2.46 |
| B2789 | (I.G) | N.2.47 |
| B2790 | (I.G) | N.2.48 |
| B2791 | (I.G) | N.2.49 |
| B2792 | (I.G) | N.2.50 |
| B2793 | (I.G) | N.2.51 |
| B2794 | (I.G) | N.2.52 |
| B2795 | (I.G) | N.2.53 |
| B2796 | (I.G) | N.2.54 |
| B2797 | (I.G) | N.2.55 |
| B2798 | (I.G) | N.2.56 |
| B2799 | (I.G) | N.2.57 |
| B2800 | (I.G) | N.2.58 |
| B2801 | (I.G) | N.2.59 |
| B2802 | (I.G) | N.2.60 |
| B2803 | (I.G) | N.2.61 |
| B2804 | (I.G) | N.2.62 |
| B2805 | (I.G) | N.2.63 |
| B2806 | (I.G) | N.2.64 |
| B2807 | (I.G) | N.2.65 |
| B2808 | (I.G) | N.2.66 |
| B2809 | (I.G) | N.2.67 |
| B2810 | (I.G) | N.2.68 |
| B2811 | (I.G) | N.2.69 |
| B2812 | (I.G) | N.2.70 |
| B2813 | (I.G) | N.2.71 |
| B2814 | (I.G) | N.2.72 |
| B2815 | (I.G) | N.2.73 |
| B2816 | (I.G) | N.2.74 |
| B2817 | (I.G) | N.2.75 |
| B2818 | (I.G) | N.2.76 |
| B2819 | (I.G) | N.2.77 |
| B2820 | (I.G) | N.2.78 |
| B2821 | (I.G) | N.2.79 |
| B2822 | (I.G) | N.2.80 |
| B2823 | (I.G) | N.2.81 |
| B2824 | (I.G) | N.2.82 |
| B2825 | (I.G) | N.2.83 |
| B2826 | (I.G) | N.2.84 |
| B2827 | (I.G) | N.3.1 |
| B2828 | (I.G) | N.3.2 |
| B2829 | (I.G) | N.3.3 |
| B2830 | (I.G) | N.3.4 |
| B2831 | (I.G) | N.3.5 |
| B2832 | (I.G) | N.3.6 |
| B2833 | (I.G) | N.3.7 |
| B2834 | (I.G) | N.3.8 |
| B2835 | (I.G) | N.3.9 |
| B2836 | (I.G) | N.3.10 |
| B2837 | (I.G) | N.3.11 |
| B2838 | (I.G) | N.3.12 |
| B2839 | (I.G) | N.3.13 |
| B2840 | (I.G) | N.3.14 |
| B2841 | (I.G) | N.3.15 |
| B2842 | (I.G) | N.3.16 |
| B2843 | (I.G) | N.3.17 |
| B2844 | (I.G) | N.3.18 |
| B2845 | (I.G) | N.3.19 |
| B2846 | (I.G) | N.3.20 |
| B2847 | (I.G) | N.3.21 |
| B2848 | (I.G) | N.3.22 |
| B2849 | (I.G) | N.3.23 |
| B2850 | (I.G) | N.3.24 |
| B2851 | (I.G) | N.3.25 |
| B2852 | (I.G) | N.3.26 |
| B2853 | (I.G) | N.3.27 |
| B2854 | (I.G) | N.3.28 |
| B2855 | (I.G) | N.3.29 |
| B2856 | (I.G) | N.3.30 |
| B2857 | (I.G) | N.3.31 |
| B2858 | (I.G) | N.3.32 |
| B2859 | (I.G) | N.3.33 |
| B2860 | (I.G) | N.3.34 |
| B2861 | (I.G) | N.3.35 |
| B2862 | (I.G) | N.3.36 |
| B2863 | (I.G) | N.3.37 |
| B2864 | (I.G) | N.3.38 |
| B2865 | (I.G) | N.3.39 |
| B2866 | (I.G) | N.3.40 |
| B2867 | (I.G) | N.3.41 |
| B2868 | (I.G) | N.3.42 |
| B2869 | (I.G) | N.3.43 |
| B2870 | (I.G) | N.3.44 |
| B2871 | (I.G) | N.3.45 |
| B2872 | (I.G) | N.3.46 |
| B2873 | (I.G) | N.3.47 |
| B2874 | (I.G) | N.3.48 |
| B2875 | (I.G) | N.3.49 |
| B2876 | (I.G) | N.3.50 |
| B2877 | (I.G) | N.3.51 |
| B2878 | (I.G) | N.3.52 |
| B2879 | (I.G) | N.3.53 |
| B2880 | (I.G) | N.3.54 |
| B2881 | (I.G) | N.3.55 |
| B2882 | (I.G) | N.3.56 |
| B2883 | (I.G) | N.3.57 |
| B2884 | (I.G) | N.3.58 |
| B2885 | (I.G) | N.3.59 |
| B2886 | (I.G) | N.3.60 |
| B2887 | (I.G) | N.3.61 |
| B2888 | (I.G) | N.3.62 |
| B2889 | (I.G) | N.3.63 |
| B2890 | (I.G) | N.3.64 |
| B2891 | (I.G) | N.3.65 |
| B2892 | (I.G) | N.3.66 |
| B2893 | (I.G) | N.3.67 |
| B2894 | (I.G) | N.3.68 |
| B2895 | (I.G) | N.3.69 |
| B2896 | (I.G) | N.4.1 |
| B2897 | (I.G) | N.4.2 |
| B2898 | (I.G) | N.4.3 |
| B2899 | (I.G) | N.4.4 |
| B2900 | (I.G) | N.4.5 |
| B2901 | (I.G) | N.4.6 |
| B2902 | (I.G) | N.4.7 |
| B2903 | (I.G) | N.4.8 |
| B2904 | (I.G) | N.4.9 |
| B2905 | (I.G) | N.4.10 |
| B2906 | (I.G) | N.4.11 |
| B2907 | (I.G) | N.4.12 |
| B2908 | (I.G) | N.4.13 |
| B2909 | (I.G) | N.4.14 |
| B2910 | (I.G) | N.4.15 |
| B2911 | (I.G) | N.4.16 |
| B2912 | (I.G) | N.4.17 |
| B2913 | (I.G) | N.4.18 |
| B2914 | (I.G) | N.4.19 |
| B2915 | (I.G) | N.4.20 |
| B2916 | (I.G) | N.4.21 |
| B2917 | (I.G) | N.4.22 |
| B2918 | (I.G) | N.4.23 |
| B2919 | (I.G) | N.4.24 |
| B2920 | (I.G) | N.4.25 |
| B2921 | (I.G) | N.4.26 |
| B2922 | (I.G) | N.4.27 |
| B2923 | (I.G) | N.4.28 |
| B2924 | (I.G) | N.4.29 |
| B2925 | (I.G) | N.4.30 |
| B2926 | (I.G) | N.4.31 |
| B2927 | (I.G) | N.4.32 |
| B2928 | (I.G) | N.4.33 |
| B2929 | (I.G) | N.4.34 |
| B2930 | (I.G) | N.4.35 |
| B2931 | (I.G) | N.4.36 |
| B2932 | (I.G) | N.4.37 |
| B2933 | (I.G) | N.4.38 |
| B2934 | (I.G) | N.4.39 |
| B2935 | (I.G) | N.4.40 |
| B2936 | (I.G) | N.4.41 |
| B2937 | (I.G) | N.4.42 |
| B2938 | (I.G) | N.4.43 |
| B2939 | (I.G) | N.4.44 |
| B2940 | (I.G) | N.4.45 |
| B2941 | (I.G) | N.4.46 |
| B2942 | (I.G) | N.4.47 |
| B2943 | (I.G) | N.5.1 |
| B2944 | (I.G) | N.5.2 |
| B2945 | (I.G) | N.5.3 |
| B2946 | (I.G) | N.5.4 |
| B2947 | (I.G) | N.5.5 |
| B2948 | (I.G) | N.5.6 |
| B2949 | (I.G) | N.5.7 |
| B2950 | (I.G) | N.5.8 |
| B2951 | (I.G) | N.5.9 |
| B2952 | (I.G) | N.5.10 |
| B2953 | (I.G) | N.5.11 |
| B2954 | (I.G) | N.5.12 |
| B2955 | (I.G) | N.5.13 |
| B2956 | (I.G) | N.5.14 |
| B2957 | (I.G) | N.5.15 |
| B2958 | (I.G) | N.5.16 |
| B2959 | (I.G) | N.5.17 |
| B2960 | (I.G) | N.5.18 |
| B2961 | (I.G) | N.5.19 |
| B2962 | (I.G) | N.5.20 |
| B2963 | (I.G) | N.5.21 |
| B2964 | (I.G) | N.5.22 |
| B2965 | (I.G) | N.5.23 |
| B2966 | (I.G) | N.5.24 |
| B2967 | (I.G) | N.5.25 |
| B2968 | (I.G) | N.5.26 |
| B2969 | (I.G) | N.5.27 |
| B2970 | (I.G) | N.6.1 |
| B2971 | (I.G) | N.6.2 |
| B2972 | (I.G) | N.6.3 |
| B2973 | (I.G) | N.6.4 |
| B2974 | (I.G) | N.7.1 |
| B2975 | (I.G) | N.7.2 |
| B2976 | (I.G) | N.7.3 |
| B2977 | (I.G) | N.7.4 |
| B2978 | (I.G) | N.7.5 |
| B2979 | (I.G) | N.8.1 |
| B2980 | (I.G) | N.9.1 |
| B2981 | (I.G) | N.9.2 |
| B2982 | (I.G) | N.9.3 |
| B2983 | (I.G) | N.9.4 |
| B2984 | (I.G) | N.9.5 |
| B2985 | (I.G) | N.9.6 |
| B2986 | (I.G) | N.9.7 |
| B2987 | (I.G) | N.9.8 |
| B2988 | (I.G) | N.9.9 |
| B2989 | (I.G) | N.9.10 |
| B2990 | (I.G) | N.9.11 |
| B2991 | (I.G) | N.9.12 |
| B2992 | (I.G) | N.9.13 |
| B2993 | (I.G) | N.9.14 |
| B2994 | (I.G) | N.9.15 |
| B2995 | (I.G) | N.9.16 |
| B2996 | (I.G) | N.9.17 |
| B2997 | (I.G) | N.9.18 |
| B2998 | (I.G) | N.9.19 |
| B2999 | (I.G) | N.9.20 |
| B3000 | (I.G) | N.9.21 |
| B3001 | (I.G) | N.9.22 |
| B3002 | (I.G) | N.9.23 |
| B3003 | (I.G) | N.9.24 |
| B3004 | (I.G) | N.9.25 |
| B3005 | (I.G) | N.9.26 |
| B3006 | (I.G) | N.10.1 |
| B3007 | (I.G) | N.10.2 |
| B3008 | (I.G) | N.10.3 |
| B3009 | (I.G) | N.10.4 |
| B3010 | (I.G) | N.10.5 |
| B3011 | (I.G) | N.10.6 |
| B3012 | (I.G) | N.10.7 |
| B3013 | (I.G) | N.10.8 |
| B3014 | (I.G) | N.10.9 |
| B3015 | (I.G) | N.10.10 |
| B3016 | (I.G) | N.10.12 |
| B3017 | (I.G) | N.10.13 |
| B3018 | (I.G) | N.10.14 |
| B3019 | (I.G) | N.10.15 |
| B3020 | (I.G) | N.10.16 |
| B3021 | (I.G) | N.10.17 |
| B3022 | (I.G) | N.10.18 |
| B3023 | (I.G) | N.10.19 |
| B3024 | (I.G) | N.10.20 |
| B3025 | (I.G) | N.10.21 |
| B3026 | (I.G) | N.10.22 |
| B3027 | (I.G) | N.10.23 |
| B3028 | (I.G) | N.10.24 |
| B3029 | (I.G) | N.10.25 |
| B3030 | (I.G) | N.10.26 |
| B3031 | (I.G) | N.10.27 |
| B3032 | (I.G) | N.10.28 |
| B3033 | (I.G) | N.10.29 |
| B3034 | (I.G) | N.10.30 |
| B3035 | (I.G) | N.10.31 |
| B3036 | (I.G) | N.10.32 |
| B3037 | (I.G) | N.10.33 |
| B3038 | (I.G) | N.10.34 |
| B3039 | (I.G) | N.10.35 |
| B3040 | (I.G) | N.10.36 |
| B3041 | (I.G) | N.11.1 |
| B3042 | (I.G) | N.11.2 |
| B3043 | (I.G) | N.11.3 |
| B3044 | (I.G) | N.11.4 |
| B3045 | (I.G) | N.11.5 |
| B3046 | (I.G) | N.11.6 |
| B3047 | (I.G) | N.11.7 |
| B3048 | (I.G) | N.12.1 |
| B3049 | (I.G) | N.12.2 |
| B3050 | (I.G) | N.12.3 |
| B3051 | (I.G) | N.13.1 |
| B3052 | (I.G) | N.13.2 |
| B3053 | (I.G) | N.13.3 |
| B3054 | (I.G) | N.13.4 |
| B3055 | (I.G) | N.13.5 |
| B3056 | (I.G) | N.13.6 |
| B3057 | (I.G) | N.13.7 |
| B3058 | (I.G) | N.13.8 |
| B3059 | (I.G) | N.13.9 |
| B3060 | (I.G) | N.13.10 |
| B3061 | (I.G) | N.13.11 |
| B3062 | (I.G) | N.13.12 |
| B3063 | (I.G) | N.13.13 |
| B3064 | (I.G) | N.13.14 |
| B3065 | (I.G) | N.13.15 |
| B3066 | (I.G) | N.13.16 |
| B3067 | (I.G) | N.13.17 |
| B3068 | (I.G) | N.13.18 |
| B3069 | (I.G) | N.13.19 |
| B3070 | (I.G) | N.13.20 |
| B3071 | (I.G) | N.13.21 |
| B3072 | (I.G) | N.13.22 |
| B3073 | (I.G) | N.13.23 |
| B3074 | (I.G) | N.13.24 |
| B3075 | (I.G) | N.13.25 |
| B3076 | (I.G) | N.13.26 |
| B3077 | (I.G) | N.13.27 |
| B3078 | (I.G) | N.13.28 |
| B3079 | (I.G) | N.13.29 |
| B3080 | (I.G) | N.13.30 |
| B3081 | (I.G) | N.13.31 |
| B3082 | (I.G) | N.13.32 |
| B3083 | (I.G) | N.14.1 |
| B3084 | (I.G) | N.14.2 |
| B3085 | (I.G) | N.14.3 |
| B3086 | (I.G) | N.14.4 |
| B3087 | (I.G) | N.15.1 |
| B3088 | (I.G) | N.15.2 |
| B3089 | (I.G) | N.15.3 |
| B3090 | (I.G) | N.15.4 |
| B3091 | (I.G) | N.15.5 |
| B3092 | (I.G) | N.15.6 |
| B3093 | (I.G) | N.15.7 |
| B3094 | (I.G) | N.15.8 |
| B3095 | (I.G) | N.15.9 |
| B3096 | (I.G) | N.15.10 |
| B3097 | (I.G) | N.15.11 |
| B3098 | (I.G) | N.15.12 |
| B3099 | (I.G) | N.15.13 |
| B3100 | (I.G) | N.15.14 |
| B3101 | (I.G) | N.15.15 |
| B3102 | (I.G) | N.15.16 |
| B3103 | (I.G) | N.15.17 |
| B3104 | (I.G) | N.15.18 |
| B3105 | (I.G) | N.15.19 |
| B3106 | (I.G) | N.15.20 |
| B3107 | (I.G) | N.15.21 |
| B3108 | (I.G) | N.15.22 |
| B3109 | (I.G) | N.15.23 |
| B3110 | (I.G) | N.15.24 |
| B3111 | (I.G) | N.15.25 |
| B3112 | (I.G) | N.15.26 |
| B3113 | (I.G) | N.15.27 |
| B3114 | (I.G) | N.15.28 |
| B3115 | (I.G) | N.15.29 |
| B3116 | (I.G) | N.15.30 |
| B3117 | (I.G) | N.15.31 |
| B3118 | (I.G) | N.15.32 |
| B3119 | (I.G) | N.15.33 |
| B3120 | (I.G) | N.15.34 |
| B3121 | (I.G) | N.15.35 |
| B3122 | (I.G) | N.15.36 |

TABLE 8
B = Mixture; I = compound I; II = compound II

| B | I | II |
|---|---|---|
| B3123 | (I.H) | N.1.1 |
| B3124 | (I.H) | N.1.2 |
| B3125 | (I.H) | N.1.3 |
| B3126 | (I.H) | N.1.4 |
| B3127 | (I.H) | N.1.5 |
| B3128 | (I.H) | N.1.6 |
| B3129 | (I.H) | N.1.7 |
| B3130 | (I.H) | N.1.8 |
| B3131 | (I.H) | N.1.9 |
| B3132 | (I.H) | N.1.10 |
| B3133 | (I.H) | N.1.11 |
| B3134 | (I.H) | N.1.12 |
| B3135 | (I.H) | N.1.13 |
| B3136 | (I.H) | N.1.14 |
| B3137 | (I.H) | N.1.15 |
| B3138 | (I.H) | N.1.16 |
| B3139 | (I.H) | N.1.17 |
| B3140 | (I.H) | N.1.18 |
| B3141 | (I.H) | N.1.19 |
| B3142 | (I.H) | N.1.20 |
| B3143 | (I.H) | N.1.21 |
| B3144 | (I.H) | N.1.22 |
| B3145 | (I.H) | N.1.23 |
| B3146 | (I.H) | N.1.24 |
| B3147 | (I.H) | N.1.25 |
| B3148 | (I.H) | N.1.26 |
| B3149 | (I.H) | N.1.27 |
| B3150 | (I.H) | N.1.28 |
| B3151 | (I.H) | N.1.29 |
| B3152 | (I.H) | N.1.30 |
| B3153 | (I.H) | N.1.31 |
| B3154 | (I.H) | N.1.32 |
| B3155 | (I.H) | N.1.33 |
| B3156 | (I.H) | N.1.34 |
| B3157 | (I.H) | N.1.35 |
| B3158 | (I.H) | N.1.36 |
| B3159 | (I.H) | N.1.37 |
| B3160 | (I.H) | N.1.38 |
| B3161 | (I.H) | N.1.39 |
| B3162 | (I.H) | N.1.40 |
| B3163 | (I.H) | N.1.41 |
| B3164 | (I.H) | N.1.42 |
| B3165 | (I.H) | N.1.43 |
| B3166 | (I.H) | N.1.44 |
| B3167 | (I.H) | N.1.45 |
| B3168 | (I.H) | N.1.46 |
| B3169 | (I.H) | N.1.47 |
| B3170 | (I.H) | N.1.48 |
| B3171 | (I.H) | N.1.49 |
| B3172 | (I.H) | N.1.50 |
| B3173 | (I.H) | N.1.51 |
| B3174 | (I.H) | N.1.52 |
| B3175 | (I.H) | N.1.53 |
| B3176 | (I.H) | N.1.54 |
| B3177 | (I.H) | N.1.55 |
| B3178 | (I.H) | N.1.56 |
| B3179 | (I.H) | N.1.57 |
| B3180 | (I.H) | N.1.58 |
| B3181 | (I.H) | N.1.59 |
| B3182 | (I.H) | N.1.60 |
| B3183 | (I.H) | N.1.61 |
| B3184 | (I.H) | N.1.62 |
| B3185 | (I.H) | N.1.63 |
| B3186 | (I.H) | N.1.64 |
| B3187 | (I.H) | N.1.65 |
| B3188 | (I.H) | N.1.66 |
| B3189 | (I.H) | N.2.1 |
| B3190 | (I.H) | N.2.2 |
| B3191 | (I.H) | N.2.3 |
| B3192 | (I.H) | N.2.4 |
| B3193 | (I.H) | N.2.5 |
| B3194 | (I.H) | N.2.6 |
| B3195 | (I.H) | N.2.7 |
| B3196 | (I.H) | N.2.8 |
| B3197 | (I.H) | N.2.9 |
| B3198 | (I.H) | N.2.10 |
| B3199 | (I.H) | N.2.11 |
| B3200 | (I.H) | N.2.12 |
| B3201 | (I.H) | N.2.13 |
| B3202 | (I.H) | N.2.14 |
| B3203 | (I.H) | N.2.15 |
| B3204 | (I.H) | N.2.16 |
| B3205 | (I.H) | N.2.17 |
| B3206 | (I.H) | N.2.18 |
| B3207 | (I.H) | N.2.19 |
| B3208 | (I.H) | N.2.20 |
| B3209 | (I.H) | N.2.21 |
| B3210 | (I.H) | N.2.22 |
| B3211 | (I.H) | N.2.23 |
| B3212 | (I.H) | N.2.24 |
| B3213 | (I.H) | N.2.25 |
| B3214 | (I.H) | N.2.26 |
| B3215 | (I.H) | N.2.27 |
| B3216 | (I.H) | N.2.28 |
| B3217 | (I.H) | N.2.29 |
| B3218 | (I.H) | N.2.30 |
| B3219 | (I.H) | N.2.31 |
| B3220 | (I.H) | N.2.32 |
| B3221 | (I.H) | N.2.33 |
| B3222 | (I.H) | N.2.34 |
| B3223 | (I.H) | N.2.35 |
| B3224 | (I.H) | N.2.36 |
| B3225 | (I.H) | N.2.37 |
| B3226 | (I.H) | N.2.38 |
| B3227 | (I.H) | N.2.39 |
| B3228 | (I.H) | N.2.40 |
| B3229 | (I.H) | N.2.41 |
| B3230 | (I.H) | N.2.42 |
| B3231 | (I.H) | N.2.43 |
| B3232 | (I.H) | N.2.44 |
| B3233 | (I.H) | N.2.45 |
| B3234 | (I.H) | N.2.46 |
| B3235 | (I.H) | N.2.47 |
| B3236 | (I.H) | N.2.48 |
| B3237 | (I.H) | N.2.49 |
| B3238 | (I.H) | N.2.50 |
| B3239 | (I.H) | N.2.51 |
| B3240 | (I.H) | N.2.52 |
| B3241 | (I.H) | N.2.53 |
| B3242 | (I.H) | N.2.54 |
| B3243 | (I.H) | N.2.55 |
| B3244 | (I.H) | N.2.56 |
| B3245 | (I.H) | N.2.57 |
| B3246 | (I.H) | N.2.58 |
| B3247 | (I.H) | N.2.59 |
| B3248 | (I.H) | N.2.60 |
| B3249 | (I.H) | N.2.61 |
| B3250 | (I.H) | N.2.62 |
| B3251 | (I.H) | N.2.63 |
| B3252 | (I.H) | N.2.64 |
| B3253 | (I.H) | N.2.65 |
| B3254 | (I.H) | N.2.66 |
| B3255 | (I.H) | N.2.67 |
| B3256 | (I.H) | N.2.68 |
| B3257 | (I.H) | N.2.69 |
| B3258 | (I.H) | N.2.70 |
| B3259 | (I.H) | N.2.71 |
| B3260 | (I.H) | N.2.72 |
| B3261 | (I.H) | N.2.73 |
| B3262 | (I.H) | N.2.74 |
| B3263 | (I.H) | N.2.75 |
| B3264 | (I.H) | N.2.76 |
| B3265 | (I.H) | N.2.77 |
| B3266 | (I.H) | N.2.78 |
| B3267 | (I.H) | N.2.79 |
| B3268 | (I.H) | N.2.80 |
| B3269 | (I.H) | N.2.81 |
| B3270 | (I.H) | N.2.82 |
| B3271 | (I.H) | N.2.83 |
| B3272 | (I.H) | N.2.84 |
| B3273 | (I.H) | N.3.1 |
| B3274 | (I.H) | N.3.2 |
| B3275 | (I.H) | N.3.3 |
| B3276 | (I.H) | N.3.4 |
| B3277 | (I.H) | N.3.5 |
| B3278 | (I.H) | N.3.6 |
| B3279 | (I.H) | N.3.7 |
| B3280 | (I.H) | N.3.8 |
| B3281 | (I.H) | N.3.9 |
| B3282 | (I.H) | N.3.10 |
| B3283 | (I.H) | N.3.11 |
| B3284 | (I.H) | N.3.12 |
| B3285 | (I.H) | N.3.13 |
| B3286 | (I.H) | N.3.14 |
| B3287 | (I.H) | N.3.15 |
| B3288 | (I.H) | N.3.16 |
| B3289 | (I.H) | N.3.17 |
| B3290 | (I.H) | N.3.18 |
| B3291 | (I.H) | N.3.19 |
| B3292 | (I.H) | N.3.20 |
| B3293 | (I.H) | N.3.21 |
| B3294 | (I.H) | N.3.22 |
| B3295 | (I.H) | N.3.23 |
| B3296 | (I.H) | N.3.24 |
| B3297 | (I.H) | N.3.25 |
| B3298 | (I.H) | N.3.26 |
| B3299 | (I.H) | N.3.27 |
| B3300 | (I.H) | N.3.28 |
| B3301 | (I.H) | N.3.29 |
| B3302 | (I.H) | N.3.30 |
| B3303 | (I.H) | N.3.31 |
| B3304 | (I.H) | N.3.32 |
| B3305 | (I.H) | N.3.33 |
| B3306 | (I.H) | N.3.34 |
| B3307 | (I.H) | N.3.35 |
| B3308 | (I.H) | N.3.36 |
| B3309 | (I.H) | N.3.37 |
| B3310 | (I.H) | N.3.38 |
| B3311 | (I.H) | N.3.39 |
| B3312 | (I.H) | N.3.40 |
| B3313 | (I.H) | N.3.41 |
| B3314 | (I.H) | N.3.42 |
| B3315 | (I.H) | N.3.43 |
| B3316 | (I.H) | N.3.44 |
| B3317 | (I.H) | N.3.45 |
| B3318 | (I.H) | N.3.46 |
| B3319 | (I.H) | N.3.47 |
| B3320 | (I.H) | N.3.48 |
| B3321 | (I.H) | N.3.49 |
| B3322 | (I.H) | N.3.50 |
| B3323 | (I.H) | N.3.51 |
| B3324 | (I.H) | N.3.52 |
| B3325 | (I.H) | N.3.53 |
| B3326 | (I.H) | N.3.54 |
| B3327 | (I.H) | N.3.55 |
| B3328 | (I.H) | N.3.56 |
| B3329 | (I.H) | N.3.57 |
| B3330 | (I.H) | N.3.58 |
| B3331 | (I.H) | N.3.59 |
| B3332 | (I.H) | N.3.60 |
| B3333 | (I.H) | N.3.61 |
| B3334 | (I.H) | N.3.62 |
| B3335 | (I.H) | N.3.63 |
| B3336 | (I.H) | N.3.64 |
| B3337 | (I.H) | N.3.65 |
| B3338 | (I.H) | N.3.66 |
| B3339 | (I.H) | N.3.67 |
| B3340 | (I.H) | N.3.68 |
| B3341 | (I.H) | N.3.69 |
| B3342 | (I.H) | N.4.1 |
| B3343 | (I.H) | N.4.2 |
| B3344 | (I.H) | N.4.3 |
| B3345 | (I.H) | N.4.4 |
| B3346 | (I.H) | N.4.5 |
| B3347 | (I.H) | N.4.6 |
| B3348 | (I.H) | N.4.7 |
| B3349 | (I.H) | N.4.8 |
| B3350 | (I.H) | N.4.9 |
| B3351 | (I.H) | N.4.10 |
| B3352 | (I.H) | N.4.11 |
| B3353 | (I.H) | N.4.12 |
| B3354 | (I.H) | N.4.13 |
| B3355 | (I.H) | N.4.14 |
| B3356 | (I.H) | N.4.15 |
| B3357 | (I.H) | N.4.16 |
| B3358 | (I.H) | N.4.17 |
| B3359 | (I.H) | N.4.18 |
| B3360 | (I.H) | N.4.19 |
| B3361 | (I.H) | N.4.20 |
| B3362 | (I.H) | N.4.21 |
| B3363 | (I.H) | N.4.22 |
| B3364 | (I.H) | N.4.23 |
| B3365 | (I.H) | N.4.24 |
| B3366 | (I.H) | N.4.25 |
| B3367 | (I.H) | N.4.26 |
| B3368 | (I.H) | N.4.27 |
| B3369 | (I.H) | N.4.28 |
| B3370 | (I.H) | N.4.29 |
| B3371 | (I.H) | N.4.30 |
| B3372 | (I.H) | N.4.31 |
| B3373 | (I.H) | N.4.32 |
| B3374 | (I.H) | N.4.33 |
| B3375 | (I.H) | N.4.34 |
| B3376 | (I.H) | N.4.35 |
| B3377 | (I.H) | N.4.36 |
| B3378 | (I.H) | N.4.37 |
| B3379 | (I.H) | N.4.38 |
| B3380 | (I.H) | N.4.39 |
| B3381 | (I.H) | N.4.40 |
| B3382 | (I.H) | N.4.41 |
| B3383 | (I.H) | N.4.42 |
| B3384 | (I.H) | N.4.43 |
| B3385 | (I.H) | N.4.44 |
| B3386 | (I.H) | N.4.45 |
| B3387 | (I.H) | N.4.46 |
| B3388 | (I.H) | N.4.47 |
| B3389 | (I.H) | N.5.1 |
| B3390 | (I.H) | N.5.2 |
| B3391 | (I.H) | N.5.3 |
| B3392 | (I.H) | N.5.4 |
| B3393 | (I.H) | N.5.5 |
| B3394 | (I.H) | N.5.6 |
| B3395 | (I.H) | N.5.7 |
| B3396 | (I.H) | N.5.8 |
| B3397 | (I.H) | N.5.9 |
| B3398 | (I.H) | N.5.10 |
| B3399 | (I.H) | N.5.11 |
| B3400 | (I.H) | N.5.12 |
| B3401 | (I.H) | N.5.13 |
| B3402 | (I.H) | N.5.14 |
| B3403 | (I.H) | N.5.15 |
| B3404 | (I.H) | N.5.16 |
| B3405 | (I.H) | N.5.17 |
| B3406 | (I.H) | N.5.18 |
| B3407 | (I.H) | N.5.19 |
| B3408 | (I.H) | N.5.20 |
| B3409 | (I.H) | N.5.21 |
| B3410 | (I.H) | N.5.22 |
| B3411 | (I.H) | N.5.23 |
| B3412 | (I.H) | N.5.24 |
| B3413 | (I.H) | N.5.25 |
| B3414 | (I.H) | N.5.26 |
| B3415 | (I.H) | N.5.27 |
| B3416 | (I.H) | N.6.1 |
| B3417 | (I.H) | N.6.2 |
| B3418 | (I.H) | N.6.3 |
| B3419 | (I.H) | N.6.4 |
| B3420 | (I.H) | N.7.1 |
| B3421 | (I.H) | N.7.2 |
| B3422 | (I.H) | N.7.3 |
| B3423 | (I.H) | N.7.4 |
| B3424 | (I.H) | N.7.5 |
| B3425 | (I.H) | N.8.1 |
| B3426 | (I.H) | N.9.1 |
| B3427 | (I.H) | N.9.2 |
| B3428 | (I.H) | N.9.3 |
| B3429 | (I.H) | N.9.4 |
| B3430 | (I.H) | N.9.5 |
| B3431 | (I.H) | N.9.6 |
| B3432 | (I.H) | N.9.7 |
| B3433 | (I.H) | N.9.8 |
| B3434 | (I.H) | N.9.9 |
| B3435 | (I.H) | N.9.10 |
| B3436 | (I.H) | N.9.11 |
| B3437 | (I.H) | N.9.12 |
| B3438 | (I.H) | N.9.13 |
| B3439 | (I.H) | N.9.14 |
| B3440 | (I.H) | N.9.15 |
| B3441 | (I.H) | N.9.16 |
| B3442 | (I.H) | N.9.17 |
| B3443 | (I.H) | N.9.18 |
| B3444 | (I.H) | N.9.19 |
| B3445 | (I.H) | N.9.20 |
| B3446 | (I.H) | N.9.21 |
| B3447 | (I.H) | N.9.22 |
| B3448 | (I.H) | N.9.23 |
| B3449 | (I.H) | N.9.24 |
| B3450 | (I.H) | N.9.25 |
| B3451 | (I.H) | N.9.26 |
| B3452 | (I.H) | N.10.1 |
| B3453 | (I.H) | N.10.2 |
| B3454 | (I.H) | N.10.3 |
| B3455 | (I.H) | N.10.4 |
| B3456 | (I.H) | N.10.5 |
| B3457 | (I.H) | N.10.6 |
| B3458 | (I.H) | N.10.7 |
| B3459 | (I.H) | N.10.8 |
| B3460 | (I.H) | N.10.9 |
| B3461 | (I.H) | N.10.10 |
| B3462 | (I.H) | N.10.12 |
| B3463 | (I.H) | N.10.13 |
| B3464 | (I.H) | N.10.14 |
| B3465 | (I.H) | N.10.15 |
| B3466 | (I.H) | N.10.16 |
| B3467 | (I.H) | N.10.17 |
| B3468 | (I.H) | N.10.18 |
| B3469 | (I.H) | N.10.19 |
| B3470 | (I.H) | N.10.20 |
| B3471 | (I.H) | N.10.21 |
| B3472 | (I.H) | N.10.22 |
| B3473 | (I.H) | N.10.23 |
| B3474 | (I.H) | N.10.24 |
| B3475 | (I.H) | N.10.25 |
| B3476 | (I.H) | N.10.26 |
| B3477 | (I.H) | N.10.27 |
| B3478 | (I.H) | N.10.28 |
| B3479 | (I.H) | N.10.29 |
| B3480 | (I.H) | N.10.30 |
| B3481 | (I.H) | N.10.31 |
| B3482 | (I.H) | N.10.32 |
| B3483 | (I.H) | N.10.33 |
| B3484 | (I.H) | N.10.34 |
| B3485 | (I.H) | N.10.35 |
| B3486 | (I.H) | N.10.36 |
| B3487 | (I.H) | N.11.1 |
| B3488 | (I.H) | N.11.2 |
| B3489 | (I.H) | N.11.3 |
| B3490 | (I.H) | N.11.4 |
| B3491 | (I.H) | N.11.5 |
| B3492 | (I.H) | N.11.6 |
| B3493 | (I.H) | N.11.7 |
| B3494 | (I.H) | N.12.1 |
| B3495 | (I.H) | N.12.2 |
| B3496 | (I.H) | N.12.3 |
| B3497 | (I.H) | N.13.1 |
| B3498 | (I.H) | N.13.2 |
| B3499 | (I.H) | N.13.3 |
| B3500 | (I.H) | N.13.4 |
| B3501 | (I.H) | N.13.5 |
| B3502 | (I.H) | N.13.6 |
| B3503 | (I.H) | N.13.7 |
| B3504 | (I.H) | N.13.8 |
| B3505 | (I.H) | N.13.9 |
| B3506 | (I.H) | N.13.10 |
| B3507 | (I.H) | N.13.11 |
| B3508 | (I.H) | N.13.12 |
| B3509 | (I.H) | N.13.13 |
| B3510 | (I.H) | N.13.14 |
| B3511 | (I.H) | N.13.15 |
| B3512 | (I.H) | N.13.16 |
| B3513 | (I.H) | N.13.17 |
| B3514 | (I.H) | N.13.18 |
| B3515 | (I.H) | N.13.19 |
| B3516 | (I.H) | N.13.20 |
| B3517 | (I.H) | N.13.21 |
| B3518 | (I.H) | N.13.22 |
| B3519 | (I.H) | N.13.23 |
| B3520 | (I.H) | N.13.24 |
| B3521 | (I.H) | N.13.25 |
| B3522 | (I.H) | N.13.26 |
| B3523 | (I.H) | N.13.27 |
| B3524 | (I.H) | N.13.28 |
| B3525 | (I.H) | N.13.29 |
| B3526 | (I.H) | N.13.30 |
| B3527 | (I.H) | N.13.31 |
| B3528 | (I.H) | N.13.32 |
| B3529 | (I.H) | N.14.1 |
| B3530 | (I.H) | N.14.2 |
| B3531 | (I.H) | N.14.3 |
| B3532 | (I.H) | N.14.4 |
| B3533 | (I.H) | N.15.1 |
| B3534 | (I.H) | N.15.2 |
| B3535 | (I.H) | N.15.3 |
| B3536 | (I.H) | N.15.4 |
| B3537 | (I.H) | N.15.5 |
| B3538 | (I.H) | N.15.6 |
| B3539 | (I.H) | N.15.7 |
| B3540 | (I.H) | N.15.8 |
| B3541 | (I.H) | N.15.9 |
| B3542 | (I.H) | N.15.10 |
| B3543 | (I.H) | N.15.11 |
| B3544 | (I.H) | N.15.12 |
| B3545 | (I.H) | N.15.13 |
| B3546 | (I.H) | N.15.14 |
| B3547 | (I.H) | N.15.15 |
| B3548 | (I.H) | N.15.16 |
| B3549 | (I.H) | N.15.17 |
| B3550 | (I.H) | N.15.18 |
| B3551 | (I.H) | N.15.19 |
| B3552 | (I.H) | N.15.20 |
| B3553 | (I.H) | N.15.21 |
| B3554 | (I.H) | N.15.22 |
| B3555 | (I.H) | N.15.23 |
| B3556 | (I.H) | N.15.24 |
| B3557 | (I.H) | N.15.25 |
| B3558 | (I.H) | N.15.26 |
| B3559 | (I.H) | N.15.27 |
| B3560 | (I.H) | N.15.28 |
| B3561 | (I.H) | N.15.29 |
| B3562 | (I.H) | N.15.30 |
| B3563 | (I.H) | N.15.31 |
| B3564 | (I.H) | N.15.32 |
| B3565 | (I.H) | N.15.33 |
| B3566 | (I.H) | N.15.34 |
| B3567 | (I.H) | N.15.35 |
| B3568 | (I.H) | N.15.36 |

TABLE 9
B = Mixture; I = compound I; II = compound II

| B | I | II |
|---|---|---|
| B3569 | (I.J) | N.1.1 |
| B3570 | (I.J) | N.1.2 |
| B3571 | (I.J) | N.1.3 |
| B3572 | (I.J) | N.1.4 |
| B3573 | (I.J) | N.1.5 |
| B3574 | (I.J) | N.1.6 |
| B3575 | (I.J) | N.1.7 |
| B3576 | (I.J) | N.1.8 |
| B3577 | (I.J) | N.1.9 |
| B3578 | (I.J) | N.1.10 |
| B3579 | (I.J) | N.1.11 |
| B3580 | (I.J) | N.1.12 |
| B3581 | (I.J) | N.1.13 |
| B3582 | (I.J) | N.1.14 |
| B3583 | (I.J) | N.1.15 |
| B3584 | (I.J) | N.1.16 |
| B3585 | (I.J) | N.1.17 |
| B3586 | (I.J) | N.1.18 |
| B3587 | (I.J) | N.1.19 |
| B3588 | (I.J) | N.1.20 |
| B3589 | (I.J) | N.1.21 |
| B3590 | (I.J) | N.1.22 |
| B3591 | (I.J) | N.1.23 |
| B3592 | (I.J) | N.1.24 |
| B3593 | (I.J) | N.1.25 |
| B3594 | (I.J) | N.1.26 |
| B3595 | (I.J) | N.1.27 |
| B3596 | (I.J) | N.1.28 |
| B3597 | (I.J) | N.1.29 |
| B3598 | (I.J) | N.1.30 |
| B3599 | (I.J) | N.1.31 |
| B3600 | (I.J) | N.1.32 |
| B3601 | (I.J) | N.1.33 |
| B3602 | (I.J) | N.1.34 |
| B3603 | (I.J) | N.1.35 |
| B3604 | (I.J) | N.1.36 |
| B3605 | (I.J) | N.1.37 |
| B3606 | (I.J) | N.1.38 |
| B3607 | (I.J) | N.1.39 |
| B3608 | (I.J) | N.1.40 |
| B3609 | (I.J) | N.1.41 |
| B3610 | (I.J) | N.1.42 |
| B3611 | (I.J) | N.1.43 |
| B3612 | (I.J) | N.1.44 |
| B3613 | (I.J) | N.1.45 |
| B3614 | (I.J) | N.1.46 |
| B3615 | (I.J) | N.1.47 |
| B3616 | (I.J) | N.1.48 |
| B3617 | (I.J) | N.1.49 |
| B3618 | (I.J) | N.1.50 |
| B3619 | (I.J) | N.1.51 |
| B3620 | (I.J) | N.1.52 |
| B3621 | (I.J) | N.1.53 |
| B3622 | (I.J) | N.1.54 |
| B3623 | (I.J) | N.1.55 |
| B3624 | (I.J) | N.1.56 |
| B3625 | (I.J) | N.1.57 |
| B3626 | (I.J) | N.1.58 |
| B3627 | (I.J) | N.1.59 |
| B3628 | (I.J) | N.1.60 |
| B3629 | (I.J) | N.1.61 |
| B3630 | (I.J) | N.1.62 |
| B3631 | (I.J) | N.1.63 |
| B3632 | (I.J) | N.1.64 |
| B3633 | (I.J) | N.1.65 |
| B3634 | (I.J) | N.1.66 |
| B3635 | (I.J) | N.2.1 |
| B3636 | (I.J) | N.2.2 |
| B3637 | (I.J) | N.2.3 |
| B3638 | (I.J) | N.2.4 |
| B3639 | (I.J) | N.2.5 |
| B3640 | (I.J) | N.2.6 |
| B3641 | (I.J) | N.2.7 |
| B3642 | (I.J) | N.2.8 |
| B3643 | (I.J) | N.2.9 |
| B3644 | (I.J) | N.2.10 |
| B3645 | (I.J) | N.2.11 |
| B3646 | (I.J) | N.2.12 |
| B3647 | (I.J) | N.2.13 |
| B3648 | (I.J) | N.2.14 |
| B3649 | (I.J) | N.2.15 |
| B3650 | (I.J) | N.2.16 |
| B3651 | (I.J) | N.2.17 |
| B3652 | (I.J) | N.2.18 |
| B3653 | (I.J) | N.2.19 |
| B3654 | (I.J) | N.2.20 |
| B3655 | (I.J) | N.2.21 |
| B3656 | (I.J) | N.2.22 |
| B3657 | (I.J) | N.2.23 |
| B3658 | (I.J) | N.2.24 |
| B3659 | (I.J) | N.2.25 |
| B3660 | (I.J) | N.2.26 |
| B3661 | (I.J) | N.2.27 |
| B3662 | (I.J) | N.2.28 |
| B3663 | (I.J) | N.2.29 |
| B3664 | (I.J) | N.2.30 |
| B3665 | (I.J) | N.2.31 |
| B3666 | (I.J) | N.2.32 |
| B3667 | (I.J) | N.2.33 |
| B3668 | (I.J) | N.2.34 |
| B3669 | (I.J) | N.2.35 |
| B3670 | (I.J) | N.2.36 |
| B3671 | (I.J) | N.2.37 |
| B3672 | (I.J) | N.2.38 |
| B3673 | (I.J) | N.2.39 |
| B3674 | (I.J) | N.2.40 |
| B3675 | (I.J) | N.2.41 |
| B3676 | (I.J) | N.2.42 |
| B3677 | (I.J) | N.2.43 |
| B3678 | (I.J) | N.2.44 |
| B3679 | (I.J) | N.2.45 |
| B3680 | (I.J) | N.2.46 |
| B3681 | (I.J) | N.2.47 |
| B3682 | (I.J) | N.2.48 |
| B3683 | (I.J) | N.2.49 |
| B3684 | (I.J) | N.2.50 |
| B3685 | (I.J) | N.2.51 |
| B3686 | (I.J) | N.2.52 |
| B3687 | (I.J) | N.2.53 |
| B3688 | (I.J) | N.2.54 |
| B3689 | (I.J) | N.2.55 |
| B3690 | (I.J) | N.2.56 |
| B3691 | (I.J) | N.2.57 |
| B3692 | (I.J) | N.2.58 |
| B3693 | (I.J) | N.2.59 |
| B3694 | (I.J) | N.2.60 |
| B3695 | (I.J) | N.2.61 |
| B3696 | (I.J) | N.2.62 |
| B3697 | (I.J) | N.2.63 |
| B3698 | (I.J) | N.2.64 |
| B3699 | (I.J) | N.2.65 |
| B3700 | (I.J) | N.2.66 |
| B3701 | (I.J) | N.2.67 |
| B3702 | (I.J) | N.2.68 |
| B3703 | (I.J) | N.2.69 |
| B3704 | (I.J) | N.2.70 |
| B3705 | (I.J) | N.2.71 |
| B3706 | (I.J) | N.2.72 |
| B3707 | (I.J) | N.2.73 |
| B3708 | (I.J) | N.2.74 |
| B3709 | (I.J) | N.2.75 |
| B3710 | (I.J) | N.2.76 |
| B3711 | (I.J) | N.2.77 |
| B3712 | (I.J) | N.2.78 |
| B3713 | (I.J) | N.2.79 |
| B3714 | (I.J) | N.2.80 |
| B3715 | (I.J) | N.2.81 |
| B3716 | (I.J) | N.2.82 |
| B3717 | (I.J) | N.2.83 |
| B3718 | (I.J) | N.2.84 |
| B3719 | (I.J) | N.3.1 |
| B3720 | (I.J) | N.3.2 |
| B3721 | (I.J) | N.3.3 |
| B3722 | (I.J) | N.3.4 |
| B3723 | (I.J) | N.3.5 |
| B3724 | (I.J) | N.3.6 |
| B3725 | (I.J) | N.3.7 |
| B3726 | (I.J) | N.3.8 |
| B3727 | (I.J) | N.3.9 |
| B3728 | (I.J) | N.3.10 |
| B3729 | (I.J) | N.3.11 |
| B3730 | (I.J) | N.3.12 |
| B3731 | (I.J) | N.3.13 |
| B3732 | (I.J) | N.3.14 |
| B3733 | (I.J) | N.3.15 |
| B3734 | (I.J) | N.3.16 |
| B3735 | (I.J) | N.3.17 |
| B3736 | (I.J) | N.3.18 |
| B3737 | (I.J) | N.3.19 |
| B3738 | (I.J) | N.3.20 |
| B3739 | (I.J) | N.3.21 |
| B3740 | (I.J) | N.3.22 |
| B3741 | (I.J) | N.3.23 |
| B3742 | (I.J) | N.3.24 |
| B3743 | (I.J) | N.3.25 |
| B3744 | (I.J) | N.3.26 |
| B3745 | (I.J) | N.3.27 |
| B3746 | (I.J) | N.3.28 |
| B3747 | (I.J) | N.3.29 |
| B3748 | (I.J) | N.3.30 |
| B3749 | (I.J) | N.3.31 |
| B3750 | (I.J) | N.3.32 |
| B3751 | (I.J) | N.3.33 |
| B3752 | (I.J) | N.3.34 |
| B3753 | (I.J) | N.3.35 |
| B3754 | (I.J) | N.3.36 |
| B3755 | (I.J) | N.3.37 |
| B3756 | (I.J) | N.3.38 |
| B3757 | (I.J) | N.3.39 |
| B3758 | (I.J) | N.3.40 |
| B3759 | (I.J) | N.3.41 |
| B3760 | (I.J) | N.3.42 |
| B3761 | (I.J) | N.3.43 |
| B3762 | (I.J) | N.3.44 |
| B3763 | (I.J) | N.3.45 |
| B3764 | (I.J) | N.3.46 |
| B3765 | (I.J) | N.3.47 |
| B3766 | (I.J) | N.3.48 |
| B3767 | (I.J) | N.3.49 |
| B3768 | (I.J) | N.3.50 |
| B3769 | (I.J) | N.3.51 |
| B3770 | (I.J) | N.3.52 |
| B3771 | (I.J) | N.3.53 |
| B3772 | (I.J) | N.3.54 |
| B3773 | (I.J) | N.3.55 |
| B3774 | (I.J) | N.3.56 |
| B3775 | (I.J) | N.3.57 |
| B3776 | (I.J) | N.3.58 |
| B3777 | (I.J) | N.3.59 |
| B3778 | (I.J) | N.3.60 |
| B3779 | (I.J) | N.3.61 |
| B3780 | (I.J) | N.3.62 |
| B3781 | (I.J) | N.3.63 |
| B3782 | (I.J) | N.3.64 |
| B3783 | (I.J) | N.3.65 |
| B3784 | (I.J) | N.3.66 |
| B3785 | (I.J) | N.3.67 |
| B3786 | (I.J) | N.3.68 |
| B3787 | (I.J) | N.3.69 |
| B3788 | (I.J) | N.4.1 |
| B3789 | (I.J) | N.4.2 |
| B3790 | (I.J) | N.4.3 |
| B3791 | (I.J) | N.4.4 |
| B3792 | (I.J) | N.4.5 |
| B3793 | (I.J) | N.4.6 |
| B3794 | (I.J) | N.4.7 |
| B3795 | (I.J) | N.4.8 |
| B3796 | (I.J) | N.4.9 |
| B3797 | (I.J) | N.4.10 |
| B3798 | (I.J) | N.4.11 |
| B3799 | (I.J) | N.4.12 |
| B3800 | (I.J) | N.4.13 |
| B3801 | (I.J) | N.4.14 |
| B3802 | (I.J) | N.4.15 |
| B3803 | (I.J) | N.4.16 |
| B3804 | (I.J) | N.4.17 |
| B3805 | (I.J) | N.4.18 |
| B3806 | (I.J) | N.4.19 |
| B3807 | (I.J) | N.4.20 |
| B3808 | (I.J) | N.4.21 |
| B3809 | (I.J) | N.4.22 |
| B3810 | (I.J) | N.4.23 |
| B3811 | (I.J) | N.4.24 |
| B3812 | (I.J) | N.4.25 |
| B3813 | (I.J) | N.4.26 |
| B3814 | (I.J) | N.4.27 |
| B3815 | (I.J) | N.4.28 |
| B3816 | (I.J) | N.4.29 |
| B3817 | (I.J) | N.4.30 |
| B3818 | (I.J) | N.4.31 |
| B3819 | (I.J) | N.4.32 |
| B3820 | (I.J) | N.4.33 |
| B3821 | (I.J) | N.4.34 |
| B3822 | (I.J) | N.4.35 |
| B3823 | (I.J) | N.4.36 |
| B3824 | (I.J) | N.4.37 |
| B3825 | (I.J) | N.4.38 |
| B3826 | (I.J) | N.4.39 |
| B3827 | (I.J) | N.4.40 |
| B3828 | (I.J) | N.4.41 |
| B3829 | (I.J) | N.4.42 |
| B3830 | (I.J) | N.4.43 |
| B3831 | (I.J) | N.4.44 |
| B3832 | (I.J) | N.4.45 |
| B3833 | (I.J) | N.4.46 |
| B3834 | (I.J) | N.4.47 |
| B3835 | (I.J) | N.5.1 |
| B3836 | (I.J) | N.5.2 |
| B3837 | (I.J) | N.5.3 |
| B3838 | (I.J) | N.5.4 |
| B3839 | (I.J) | N.5.5 |
| B3840 | (I.J) | N.5.6 |
| B3841 | (I.J) | N.5.7 |
| B3842 | (I.J) | N.5.8 |
| B3843 | (I.J) | N.5.9 |
| B3844 | (I.J) | N.5.10 |
| B3845 | (I.J) | N.5.11 |
| B3846 | (I.J) | N.5.12 |
| B3847 | (I.J) | N.5.13 |
| B3848 | (I.J) | N.5.14 |
| B3849 | (I.J) | N.5.15 |
| B3850 | (I.J) | N.5.16 |
| B3851 | (I.J) | N.5.17 |
| B3852 | (I.J) | N.5.18 |
| B3853 | (I.J) | N.5.19 |
| B3854 | (I.J) | N.5.20 |
| B3855 | (I.J) | N.5.21 |
| B3856 | (I.J) | N.5.22 |
| B3857 | (I.J) | N.5.23 |
| B3858 | (I.J) | N.5.24 |
| B3859 | (I.J) | N.5.25 |
| B3860 | (I.J) | N.5.26 |
| B3861 | (I.J) | N.5.27 |
| B3862 | (I.J) | N.6.1 |
| B3863 | (I.J) | N.6.2 |
| B3864 | (I.J) | N.6.3 |
| B3865 | (I.J) | N.6.4 |
| B3866 | (I.J) | N.7.1 |
| B3867 | (I.J) | N.7.2 |
| B3868 | (I.J) | N.7.3 |
| B3869 | (I.J) | N.7.4 |
| B3870 | (I.J) | N.7.5 |
| B3871 | (I.J) | N.8.1 |
| B3872 | (I.J) | N.9.1 |
| B3873 | (I.J) | N.9.2 |
| B3874 | (I.J) | N.9.3 |
| B3875 | (I.J) | N.9.4 |
| B3876 | (I.J) | N.9.5 |
| B3877 | (I.J) | N.9.6 |
| B3878 | (I.J) | N.9.7 |
| B3879 | (I.J) | N.9.8 |
| B3880 | (I.J) | N.9.9 |
| B3881 | (I.J) | N.9.10 |
| B3882 | (I.J) | N.9.11 |
| B3883 | (I.J) | N.9.12 |
| B3884 | (I.J) | N.9.13 |
| B3885 | (I.J) | N.9.14 |
| B3886 | (I.J) | N.9.15 |
| B3887 | (I.J) | N.9.16 |
| B3888 | (I.J) | N.9.17 |
| B3889 | (I.J) | N.9.18 |
| B3890 | (I.J) | N.9.19 |
| B3891 | (I.J) | N.9.20 |
| B3892 | (I.J) | N.9.21 |
| B3893 | (I.J) | N.9.22 |
| B3894 | (I.J) | N.9.23 |
| B3895 | (I.J) | N.9.24 |
| B3896 | (I.J) | N.9.25 |
| B3897 | (I.J) | N.9.26 |
| B3898 | (I.J) | N.10.1 |
| B3899 | (I.J) | N.10.2 |
| B3900 | (I.J) | N.10.3 |
| B3901 | (I.J) | N.10.4 |
| B3902 | (I.J) | N.10.5 |
| B3903 | (I.J) | N.10.6 |
| B3904 | (I.J) | N.10.7 |
| B3905 | (I.J) | N.10.8 |
| B3906 | (I.J) | N.10.9 |
| B3907 | (I.J) | N.10.10 |
| B3908 | (I.J) | N.10.12 |
| B3909 | (I.J) | N.10.13 |
| B3910 | (I.J) | N.10.14 |
| B3911 | (I.J) | N.10.15 |
| B3912 | (I.J) | N.10.16 |
| B3913 | (I.J) | N.10.17 |
| B3914 | (I.J) | N.10.18 |
| B3915 | (I.J) | N.10.19 |
| B3916 | (I.J) | N.10.20 |
| B3917 | (I.J) | N.10.21 |
| B3918 | (I.J) | N.10.22 |
| B3919 | (I.J) | N.10.23 |
| B3920 | (I.J) | N.10.24 |
| B3921 | (I.J) | N.10.25 |
| B3922 | (I.J) | N.10.26 |
| B3923 | (I.J) | N.10.27 |
| B3924 | (I.J) | N.10.28 |
| B3925 | (I.J) | N.10.29 |
| B3926 | (I.J) | N.10.30 |
| B3927 | (I.J) | N.10.31 |
| B3928 | (I.J) | N.10.32 |
| B3929 | (I.J) | N.10.33 |
| B3930 | (I.J) | N.10.34 |
| B3931 | (I.J) | N.10.35 |
| B3932 | (I.J) | N.10.36 |
| B3933 | (I.J) | N.11.1 |
| B3934 | (I.J) | N.11.2 |
| B3935 | (I.J) | N.11.3 |
| B3936 | (I.J) | N.11.4 |
| B3937 | (I.J) | N.11.5 |
| B3938 | (I.J) | N.11.6 |
| B3939 | (I.J) | N.11.7 |
| B3940 | (I.J) | N.12.1 |
| B3941 | (I.J) | N.12.2 |
| B3942 | (I.J) | N.12.3 |
| B3943 | (I.J) | N.13.1 |
| B3944 | (I.J) | N.13.2 |
| B3945 | (I.J) | N.13.3 |
| B3946 | (I.J) | N.13.4 |
| B3947 | (I.J) | N.13.5 |
| B3948 | (I.J) | N.13.6 |
| B3949 | (I.J) | N.13.7 |
| B3950 | (I.J) | N.13.8 |
| B3951 | (I.J) | N.13.9 |
| B3952 | (I.J) | N.13.10 |
| B3953 | (I.J) | N.13.11 |
| B3954 | (I.J) | N.13.12 |
| B3955 | (I.J) | N.13.13 |
| B3956 | (I.J) | N.13.14 |
| B3957 | (I.J) | N.13.15 |
| B3958 | (I.J) | N.13.16 |
| B3959 | (I.J) | N.13.17 |
| B3960 | (I.J) | N.13.18 |
| B3961 | (I.J) | N.13.19 |
| B3962 | (I.J) | N.13.20 |
| B3963 | (I.J) | N.13.21 |
| B3964 | (I.J) | N.13.22 |
| B3965 | (I.J) | N.13.23 |
| B3966 | (I.J) | N.13.24 |
| B3967 | (I.J) | N.13.25 |
| B3968 | (I.J) | N.13.26 |
| B3969 | (I.J) | N.13.27 |
| B3970 | (I.J) | N.13.28 |
| B3971 | (I.J) | N.13.29 |
| B3972 | (I.J) | N.13.30 |
| B3973 | (I.J) | N.13.31 |
| B3974 | (I.J) | N.13.32 |
| B3975 | (I.J) | N.14.1 |
| B3976 | (I.J) | N.14.2 |
| B3977 | (I.J) | N.14.3 |
| B3978 | (I.J) | N.14.4 |
| B3979 | (I.J) | N.15.1 |
| B3980 | (I.J) | N.15.2 |
| B3981 | (I.J) | N.15.3 |
| B3982 | (I.J) | N.15.4 |
| B3983 | (I.J) | N.15.5 |
| B3984 | (I.J) | N.15.6 |
| B3985 | (I.J) | N.15.7 |
| B3986 | (I.J) | N.15.8 |
| B3987 | (I.J) | N.15.9 |
| B3988 | (I.J) | N.15.10 |
| B3989 | (I.J) | N.15.11 |
| B3990 | (I.J) | N.15.12 |
| B3991 | (I.J) | N.15.13 |
| B3992 | (I.J) | N.15.14 |
| B3993 | (I.J) | N.15.15 |
| B3994 | (I.J) | N.15.16 |
| B3995 | (I.J) | N.15.17 |
| B3996 | (I.J) | N.15.18 |
| B3997 | (I.J) | N.15.19 |
| B3998 | (I.J) | N.15.20 |
| B3999 | (I.J) | N.15.21 |
| B4000 | (I.J) | N.15.22 |
| B4001 | (I.J) | N.15.23 |
| B4002 | (I.J) | N.15.24 |
| B4003 | (I.J) | N.15.25 |
| B4004 | (I.J) | N.15.26 |
| B4005 | (I.J) | N.15.27 |
| B4006 | (I.J) | N.15.28 |
| B4007 | (I.J) | N.15.29 |
| B4008 | (I.J) | N.15.30 |
| B4009 | (I.J) | N.15.31 |
| B4010 | (I.J) | N.15.32 |
| B4011 | (I.J) | N.15.33 |
| B4012 | (I.J) | N.15.34 |
| B4013 | (I.J) | N.15.35 |
| B4014 | (I.J) | N.15.36 |

TABLE 10
B = Mixture; I = compound I; II = compound II

| B | I | II |
|---|---|---|
| B4015 | (I.K) | N.1.1 |
| B4016 | (I.K) | N.1.2 |
| B4017 | (I.K) | N.1.3 |
| B4018 | (I.K) | N.1.4 |
| B4019 | (I.K) | N.1.5 |
| B4020 | (I.K) | N.1.6 |
| B4021 | (I.K) | N.1.7 |
| B4022 | (I.K) | N.1.8 |
| B4023 | (I.K) | N.1.9 |
| B4024 | (I.K) | N.1.10 |
| B4025 | (I.K) | N.1.11 |
| B4026 | (I.K) | N.1.12 |
| B4027 | (I.K) | N.1.13 |
| B4028 | (I.K) | N.1.14 |
| B4029 | (I.K) | N.1.15 |
| B4030 | (I.K) | N.1.16 |
| B4031 | (I.K) | N.1.17 |
| B4032 | (I.K) | N.1.18 |
| B4033 | (I.K) | N.1.19 |
| B4034 | (I.K) | N.1.20 |
| B4035 | (I.K) | N.1.21 |
| B4036 | (I.K) | N.1.22 |
| B4037 | (I.K) | N.1.23 |
| B4038 | (I.K) | N.1.24 |
| B4039 | (I.K) | N.1.25 |
| B4040 | (I.K) | N.1.26 |
| B4041 | (I.K) | N.1.27 |
| B4042 | (I.K) | N.1.28 |
| B4043 | (I.K) | N.1.29 |
| B4044 | (I.K) | N.1.30 |
| B4045 | (I.K) | N.1.31 |
| B4046 | (I.K) | N.1.32 |
| B4047 | (I.K) | N.1.33 |
| B4048 | (I.K) | N.1.34 |
| B4049 | (I.K) | N.1.35 |
| B4050 | (I.K) | N.1.36 |
| B4051 | (I.K) | N.1.37 |
| B4052 | (I.K) | N.1.38 |
| B4053 | (I.K) | N.1.39 |
| B4054 | (I.K) | N.1.40 |
| B4055 | (I.K) | N.1.41 |
| B4056 | (I.K) | N.1.42 |
| B4057 | (I.K) | N.1.43 |
| B4058 | (I.K) | N.1.44 |
| B4059 | (I.K) | N.1.45 |
| B4060 | (I.K) | N.1.46 |
| B4061 | (I.K) | N.1.47 |
| B4062 | (I.K) | N.1.48 |
| B4063 | (I.K) | N.1.49 |
| B4064 | (I.K) | N.1.50 |
| B4065 | (I.K) | N.1.51 |
| B4066 | (I.K) | N.1.52 |
| B4067 | (I.K) | N.1.53 |
| B4068 | (I.K) | N.1.54 |
| B4069 | (I.K) | N.1.55 |
| B4070 | (I.K) | N.1.56 |
| B4071 | (I.K) | N.1.57 |
| B4072 | (I.K) | N.1.58 |
| B4073 | (I.K) | N.1.59 |
| B4074 | (I.K) | N.1.60 |
| B4075 | (I.K) | N.1.61 |
| B4076 | (I.K) | N.1.62 |
| B4077 | (I.K) | N.1.63 |
| B4078 | (I.K) | N.1.64 |
| B4079 | (I.K) | N.1.65 |
| B4080 | (I.K) | N.1.66 |
| B4081 | (I.K) | N.2.1 |
| B4082 | (I.K) | N.2.2 |
| B4083 | (I.K) | N.2.3 |
| B4084 | (I.K) | N.2.4 |
| B4085 | (I.K) | N.2.5 |
| B4086 | (I.K) | N.2.6 |
| B4087 | (I.K) | N.2.7 |
| B4088 | (I.K) | N.2.8 |
| B4089 | (I.K) | N.2.9 |
| B4090 | (I.K) | N.2.10 |
| B4091 | (I.K) | N.2.11 |
| B4092 | (I.K) | N.2.12 |
| B4093 | (I.K) | N.2.13 |
| B4094 | (I.K) | N.2.14 |
| B4095 | (I.K) | N.2.15 |
| B4096 | (I.K) | N.2.16 |
| B4097 | (I.K) | N.2.17 |
| B4098 | (I.K) | N.2.18 |
| B4099 | (I.K) | N.2.19 |
| B4100 | (I.K) | N.2.20 |
| B4101 | (I.K) | N.2.21 |
| B4102 | (I.K) | N.2.22 |
| B4103 | (I.K) | N.2.23 |
| B4104 | (I.K) | N.2.24 |
| B4105 | (I.K) | N.2.25 |
| B4106 | (I.K) | N.2.26 |
| B4107 | (I.K) | N.2.27 |
| B4108 | (I.K) | N.2.28 |
| B4109 | (I.K) | N.2.29 |
| B4110 | (I.K) | N.2.30 |
| B4111 | (I.K) | N.2.31 |
| B4112 | (I.K) | N.2.32 |
| B4113 | (I.K) | N.2.33 |
| B4114 | (I.K) | N.2.34 |
| B4115 | (I.K) | N.2.35 |
| B4116 | (I.K) | N.2.36 |
| B4117 | (I.K) | N.2.37 |
| B4118 | (I.K) | N.2.38 |
| B4119 | (I.K) | N.2.39 |
| B4120 | (I.K) | N.2.40 |
| B4121 | (I.K) | N.2.41 |
| B4122 | (I.K) | N.2.42 |
| B4123 | (I.K) | N.2.43 |
| B4124 | (I.K) | N.2.44 |
| B4125 | (I.K) | N.2.45 |
| B4126 | (I.K) | N.2.46 |
| B4127 | (I.K) | N.2.47 |
| B4128 | (I.K) | N.2.48 |
| B4129 | (I.K) | N.2.49 |
| B4130 | (I.K) | N.2.50 |
| B4131 | (I.K) | N.2.51 |
| B4132 | (I.K) | N.2.52 |
| B4133 | (I.K) | N.2.53 |
| B4134 | (I.K) | N.2.54 |
| B4135 | (I.K) | N.2.55 |
| B4136 | (I.K) | N.2.56 |
| B4137 | (I.K) | N.2.57 |
| B4138 | (I.K) | N.2.58 |
| B4139 | (I.K) | N.2.59 |
| B4140 | (I.K) | N.2.60 |
| B4141 | (I.K) | N.2.61 |
| B4142 | (I.K) | N.2.62 |
| B4143 | (I.K) | N.2.63 |
| B4144 | (I.K) | N.2.64 |
| B4145 | (I.K) | N.2.65 |
| B4146 | (I.K) | N.2.66 |
| B4147 | (I.K) | N.2.67 |
| B4148 | (I.K) | N.2.68 |
| B4149 | (I.K) | N.2.69 |
| B4150 | (I.K) | N.2.70 |
| B4151 | (I.K) | N.2.71 |
| B4152 | (I.K) | N.2.72 |
| B4153 | (I.K) | N.2.73 |
| B4154 | (I.K) | N.2.74 |
| B4155 | (I.K) | N.2.75 |
| B4156 | (I.K) | N.2.76 |
| B4157 | (I.K) | N.2.77 |
| B4158 | (I.K) | N.2.78 |
| B4159 | (I.K) | N.2.79 |
| B4160 | (I.K) | N.2.80 |
| B4161 | (I.K) | N.2.81 |
| B4162 | (I.K) | N.2.82 |
| B4163 | (I.K) | N.2.83 |
| B4164 | (I.K) | N.2.84 |
| B4165 | (I.K) | N.3.1 |
| B4166 | (I.K) | N.3.2 |
| B4167 | (I.K) | N.3.3 |
| B4168 | (I.K) | N.3.4 |
| B4169 | (I.K) | N.3.5 |
| B4170 | (I.K) | N.3.6 |
| B4171 | (I.K) | N.3.7 |
| B4172 | (I.K) | N.3.8 |
| B4173 | (I.K) | N.3.9 |
| B4174 | (I.K) | N.3.10 |
| B4175 | (I.K) | N.3.11 |
| B4176 | (I.K) | N.3.12 |
| B4177 | (I.K) | N.3.13 |
| B4178 | (I.K) | N.3.14 |
| B4179 | (I.K) | N.3.15 |
| B4180 | (I.K) | N.3.16 |
| B4181 | (I.K) | N.3.17 |
| B4182 | (I.K) | N.3.18 |
| B4183 | (I.K) | N.3.19 |
| B4184 | (I.K) | N.3.20 |
| B4185 | (I.K) | N.3.21 |
| B4186 | (I.K) | N.3.22 |
| B4187 | (I.K) | N.3.23 |
| B4188 | (I.K) | N.3.24 |
| B4189 | (I.K) | N.3.25 |
| B4190 | (I.K) | N.3.26 |
| B4191 | (I.K) | N.3.27 |
| B4192 | (I.K) | N.3.28 |
| B4193 | (I.K) | N.3.29 |
| B4194 | (I.K) | N.3.30 |
| B4195 | (I.K) | N.3.31 |
| B4196 | (I.K) | N.3.32 |
| B4197 | (I.K) | N.3.33 |
| B4198 | (I.K) | N.3.34 |
| B4199 | (I.K) | N.3.35 |
| B4200 | (I.K) | N.3.36 |
| B4201 | (I.K) | N.3.37 |
| B4202 | (I.K) | N.3.38 |
| B4203 | (I.K) | N.3.39 |
| B4204 | (I.K) | N.3.40 |
| B4205 | (I.K) | N.3.41 |
| B4206 | (I.K) | N.3.42 |
| B4207 | (I.K) | N.3.43 |
| B4208 | (I.K) | N.3.44 |
| B4209 | (I.K) | N.3.45 |
| B4210 | (I.K) | N.3.46 |
| B4211 | (I.K) | N.3.47 |
| B4212 | (I.K) | N.3.48 |
| B4213 | (I.K) | N.3.49 |
| B4214 | (I.K) | N.3.50 |
| B4215 | (I.K) | N.3.51 |
| B4216 | (I.K) | N.3.52 |
| B4217 | (I.K) | N.3.53 |
| B4218 | (I.K) | N.3.54 |
| B4219 | (I.K) | N.3.55 |
| B4220 | (I.K) | N.3.56 |
| B4221 | (I.K) | N.3.57 |
| B4222 | (I.K) | N.3.58 |
| B4223 | (I.K) | N.3.59 |
| B4224 | (I.K) | N.3.60 |
| B4225 | (I.K) | N.3.61 |
| B4226 | (I.K) | N.3.62 |
| B4227 | (I.K) | N.3.63 |
| B4228 | (I.K) | N.3.64 |
| B4229 | (I.K) | N.3.65 |
| B4230 | (I.K) | N.3.66 |
| B4231 | (I.K) | N.3.67 |
| B4232 | (I.K) | N.3.68 |
| B4233 | (I.K) | N.3.69 |
| B4234 | (I.K) | N.4.1 |
| B4235 | (I.K) | N.4.2 |
| B4236 | (I.K) | N.4.3 |
| B4237 | (I.K) | N.4.4 |
| B4238 | (I.K) | N.4.5 |
| B4239 | (I.K) | N.4.6 |
| B4240 | (I.K) | N.4.7 |
| B4241 | (I.K) | N.4.8 |
| B4242 | (I.K) | N.4.9 |
| B4243 | (I.K) | N.4.10 |
| B4244 | (I.K) | N.4.11 |
| B4245 | (I.K) | N.4.12 |
| B4246 | (I.K) | N.4.13 |
| B4247 | (I.K) | N.4.14 |
| B4248 | (I.K) | N.4.15 |
| B4249 | (I.K) | N.4.16 |
| B4250 | (I.K) | N.4.17 |
| B4251 | (I.K) | N.4.18 |
| B4252 | (I.K) | N.4.19 |
| B4253 | (I.K) | N.4.20 |
| B4254 | (I.K) | N.4.21 |
| B4255 | (I.K) | N.4.22 |
| B4256 | (I.K) | N.4.23 |
| B4257 | (I.K) | N.4.24 |
| B4258 | (I.K) | N.4.25 |
| B4259 | (I.K) | N.4.26 |
| B4260 | (I.K) | N.4.27 |
| B4261 | (I.K) | N.4.28 |
| B4262 | (I.K) | N.4.29 |
| B4263 | (I.K) | N.4.30 |
| B4264 | (I.K) | N.4.31 |
| B4265 | (I.K) | N.4.32 |
| B4266 | (I.K) | N.4.33 |
| B4267 | (I.K) | N.4.34 |
| B4268 | (I.K) | N.4.35 |
| B4269 | (I.K) | N.4.36 |
| B4270 | (I.K) | N.4.37 |
| B4271 | (I.K) | N.4.38 |
| B4272 | (I.K) | N.4.39 |
| B4273 | (I.K) | N.4.40 |
| B4274 | (I.K) | N.4.41 |
| B4275 | (I.K) | N.4.42 |
| B4276 | (I.K) | N.4.43 |
| B4277 | (I.K) | N.4.44 |
| B4278 | (I.K) | N.4.45 |
| B4279 | (I.K) | N.4.46 |
| B4280 | (I.K) | N.4.47 |
| B4281 | (I.K) | N.5.1 |
| B4282 | (I.K) | N.5.2 |
| B4283 | (I.K) | N.5.3 |
| B4284 | (I.K) | N.5.4 |
| B4285 | (I.K) | N.5.5 |
| B4286 | (I.K) | N.5.6 |
| B4287 | (I.K) | N.5.7 |
| B4288 | (I.K) | N.5.8 |
| B4289 | (I.K) | N.5.9 |
| B4290 | (I.K) | N.5.10 |
| B4291 | (I.K) | N.5.11 |
| B4292 | (I.K) | N.5.12 |
| B4293 | (I.K) | N.5.13 |
| B4294 | (I.K) | N.5.14 |
| B4295 | (I.K) | N.5.15 |
| B4296 | (I.K) | N.5.16 |
| B4297 | (I.K) | N.5.17 |
| B4298 | (I.K) | N.5.18 |
| B4299 | (I.K) | N.5.19 |
| B4300 | (I.K) | N.5.20 |
| B4301 | (I.K) | N.5.21 |
| B4302 | (I.K) | N.5.22 |
| B4303 | (I.K) | N.5.23 |
| B4304 | (I.K) | N.5.24 |
| B4305 | (I.K) | N.5.25 |
| B4306 | (I.K) | N.5.26 |
| B4307 | (I.K) | N.5.27 |
| B4308 | (I.K) | N.6.1 |
| B4309 | (I.K) | N.6.2 |
| B4310 | (I.K) | N.6.3 |
| B4311 | (I.K) | N.6.4 |
| B4312 | (I.K) | N.7.1 |
| B4313 | (I.K) | N.7.2 |
| B4314 | (I.K) | N.7.3 |
| B4315 | (I.K) | N.7.4 |
| B4316 | (I.K) | N.7.5 |
| B4317 | (I.K) | N.8.1 |
| B4318 | (I.K) | N.9.1 |
| B4319 | (I.K) | N.9.2 |
| B4320 | (I.K) | N.9.3 |
| B4321 | (I.K) | N.9.4 |
| B4322 | (I.K) | N.9.5 |
| B4323 | (I.K) | N.9.6 |
| B4324 | (I.K) | N.9.7 |
| B4325 | (I.K) | N.9.8 |
| B4326 | (I.K) | N.9.9 |
| B4327 | (I.K) | N.9.10 |
| B4328 | (I.K) | N.9.11 |
| B4329 | (I.K) | N.9.12 |
| B4330 | (I.K) | N.9.13 |
| B4331 | (I.K) | N.9.14 |
| B4332 | (I.K) | N.9.15 |
| B4333 | (I.K) | N.9.16 |
| B4334 | (I.K) | N.9.17 |
| B4335 | (I.K) | N.9.18 |
| B4336 | (I.K) | N.9.19 |
| B4337 | (I.K) | N.9.20 |
| B4338 | (I.K) | N.9.21 |
| B4339 | (I.K) | N.9.22 |
| B4340 | (I.K) | N.9.23 |
| B4341 | (I.K) | N.9.24 |
| B4342 | (I.K) | N.9.25 |
| B4343 | (I.K) | N.9.26 |
| B4344 | (I.K) | N.10.1 |
| B4345 | (I.K) | N.10.2 |
| B4346 | (I.K) | N.10.3 |
| B4347 | (I.K) | N.10.4 |
| B4348 | (I.K) | N.10.5 |
| B4349 | (I.K) | N.10.6 |
| B4350 | (I.K) | N.10.7 |
| B4351 | (I.K) | N.10.8 |
| B4352 | (I.K) | N.10.9 |
| B4353 | (I.K) | N.10.10 |
| B4354 | (I.K) | N.10.12 |
| B4355 | (I.K) | N.10.13 |
| B4356 | (I.K) | N.10.14 |
| B4357 | (I.K) | N.10.15 |
| B4358 | (I.K) | N.10.16 |
| B4359 | (I.K) | N.10.17 |
| B4360 | (I.K) | N.10.18 |
| B4361 | (I.K) | N.10.19 |
| B4362 | (I.K) | N.10.20 |
| B4363 | (I.K) | N.10.21 |
| B4364 | (I.K) | N.10.22 |
| B4365 | (I.K) | N.10.23 |
| B4366 | (I.K) | N.10.24 |
| B4367 | (I.K) | N.10.25 |
| B4368 | (I.K) | N.10.26 |
| B4369 | (I.K) | N.10.27 |
| B4370 | (I.K) | N.10.28 |
| B4371 | (I.K) | N.10.29 |
| B4372 | (I.K) | N.10.30 |
| B4373 | (I.K) | N.10.31 |
| B4374 | (I.K) | N.10.32 |
| B4375 | (I.K) | N.10.33 |
| B4376 | (I.K) | N.10.34 |
| B4377 | (I.K) | N.10.35 |
| B4378 | (I.K) | N.10.36 |
| B4379 | (I.K) | N.11.1 |
| B4380 | (I.K) | N.11.2 |
| B4381 | (I.K) | N.11.3 |
| B4382 | (I.K) | N.11.4 |
| B4383 | (I.K) | N.11.5 |
| B4384 | (I.K) | N.11.6 |
| B4385 | (I.K) | N.11.7 |
| B4386 | (I.K) | N.12.1 |
| B4387 | (I.K) | N.12.2 |
| B4388 | (I.K) | N.12.3 |
| B4389 | (I.K) | N.13.1 |
| B4390 | (I.K) | N.13.2 |
| B4391 | (I.K) | N.13.3 |
| B4392 | (I.K) | N.13.4 |
| B4393 | (I.K) | N.13.5 |
| B4394 | (I.K) | N.13.6 |
| B4395 | (I.K) | N.13.7 |
| B4396 | (I.K) | N.13.8 |
| B4397 | (I.K) | N.13.9 |
| B4398 | (I.K) | N.13.10 |
| B4399 | (I.K) | N.13.11 |
| B4400 | (I.K) | N.13.12 |
| B4401 | (I.K) | N.13.13 |
| B4402 | (I.K) | N.13.14 |
| B4403 | (I.K) | N.13.15 |
| B4404 | (I.K) | N.13.16 |
| B4405 | (I.K) | N.13.17 |
| B4406 | (I.K) | N.13.18 |
| B4407 | (I.K) | N.13.19 |
| B4408 | (I.K) | N.13.20 |
| B4409 | (I.K) | N.13.21 |
| B4410 | (I.K) | N.13.22 |
| B4411 | (I.K) | N.13.23 |
| B4412 | (I.K) | N.13.24 |
| B4413 | (I.K) | N.13.25 |
| B4414 | (I.K) | N.13.26 |
| B4415 | (I.K) | N.13.27 |
| B4416 | (I.K) | N.13.28 |
| B4417 | (I.K) | N.13.29 |
| B4418 | (I.K) | N.13.30 |
| B4419 | (I.K) | N.13.31 |
| B4420 | (I.K) | N.13.32 |
| B4421 | (I.K) | N.14.1 |
| B4422 | (I.K) | N.14.2 |
| B4423 | (I.K) | N.14.3 |
| B4424 | (I.K) | N.14.4 |
| B4425 | (I.K) | N.15.1 |
| B4426 | (I.K) | N.15.2 |
| B4427 | (I.K) | N.15.3 |
| B4428 | (I.K) | N.15.4 |
| B4429 | (I.K) | N.15.5 |
| B4430 | (I.K) | N.15.6 |
| B4431 | (I.K) | N.15.7 |
| B4432 | (I.K) | N.15.8 |
| B4433 | (I.K) | N.15.9 |
| B4434 | (I.K) | N.15.10 |
| B4435 | (I.K) | N.15.11 |
| B4436 | (I.K) | N.15.12 |
| B4437 | (I.K) | N.15.13 |
| B4438 | (I.K) | N.15.14 |
| B4439 | (I.K) | N.15.15 |
| B4440 | (I.K) | N.15.16 |
| B4441 | (I.K) | N.15.17 |
| B4442 | (I.K) | N.15.18 |
| B4443 | (I.K) | N.15.19 |
| B4444 | (I.K) | N.15.20 |
| B4445 | (I.K) | N.15.21 |
| B4446 | (I.K) | N.15.22 |
| B4447 | (I.K) | N.15.23 |
| B4448 | (I.K) | N.15.24 |
| B4449 | (I.K) | N.15.25 |
| B4450 | (I.K) | N.15.26 |
| B4451 | (I.K) | N.15.27 |
| B4452 | (I.K) | N.15.28 |
| B4453 | (I.K) | N.15.29 |
| B4454 | (I.K) | N.15.30 |
| B4455 | (I.K) | N.15.31 |
| B4456 | (I.K) | N.15.32 |
| B4457 | (I.K) | N.15.33 |
| B4458 | (I.K) | N.15.34 |
| B4459 | (I.K) | N.15.35 |
| B4460 | (I.K) | N.15.36 |

TABLE 11

| B | I | II |
|---|---|---|
| B4461 | (I.L) | N.1.1 |
| B4462 | (I.L) | N.1.2 |
| B4463 | (I.L) | N.1.3 |
| B4464 | (I.L) | N.1.4 |
| B4465 | (I.L) | N.1.5 |
| B4466 | (I.L) | N.1.6 |
| B4467 | (I.L) | N.1.7 |
| B4468 | (I.L) | N.1.8 |
| B4469 | (I.L) | N.1.9 |
| B4470 | (I.L) | N.1.10 |
| B4471 | (I.L) | N.1.11 |
| B4472 | (I.L) | N.1.12 |
| B4473 | (I.L) | N.1.13 |
| B4474 | (I.L) | N.1.14 |
| B4475 | (I.L) | N.1.15 |
| B4476 | (I.L) | N.1.16 |
| B4477 | (I.L) | N.1.17 |
| B4478 | (I.L) | N.1.18 |
| B4479 | (I.L) | N.1.19 |
| B4480 | (I.L) | N.1.20 |
| B4481 | (I.L) | N.1.21 |
| B4482 | (I.L) | N.1.22 |
| B4483 | (I.L) | N.1.23 |
| B4484 | (I.L) | N.1.24 |
| B4485 | (I.L) | N.1.25 |
| B4486 | (I.L) | N.1.26 |
| B4487 | (I.L) | N.1.27 |
| B4488 | (I.L) | N.1.28 |
| B4489 | (I.L) | N.1.29 |
| B4490 | (I.L) | N.1.30 |
| B4491 | (I.L) | N.1.31 |
| B4492 | (I.L) | N.1.32 |
| B4493 | (I.L) | N.1.33 |
| B4494 | (I.L) | N.1.34 |
| B4495 | (I.L) | N.1.35 |
| B4496 | (I.L) | N.1.36 |
| B4497 | (I.L) | N.1.37 |
| B4498 | (I.L) | N.1.38 |
| B4499 | (I.L) | N.1.39 |
| B4500 | (I.L) | N.1.40 |
| B4501 | (I.L) | N.1.41 |
| B4502 | (I.L) | N.1.42 |
| B4503 | (I.L) | N.1.43 |
| B4504 | (I.L) | N.1.44 |
| B4505 | (I.L) | N.1.45 |
| B4506 | (I.L) | N.1.46 |
| B4507 | (I.L) | N.1.47 |
| B4508 | (I.L) | N.1.48 |
| B4509 | (I.L) | N.1.49 |
| B4510 | (I.L) | N.1.50 |
| B4511 | (I.L) | N.1.51 |
| B4512 | (I.L) | N.1.52 |
| B4513 | (I.L) | N.1.53 |
| B4514 | (I.L) | N.1.54 |
| B4515 | (I.L) | N.1.55 |
| B4516 | (I.L) | N.1.56 |
| B4517 | (I.L) | N.1.57 |
| B4518 | (I.L) | N.1.58 |
| B4519 | (I.L) | N.1.59 |
| B4520 | (I.L) | N.1.60 |
| B4521 | (I.L) | N.1.61 |
| B4522 | (I.L) | N.1.62 |
| B4523 | (I.L) | N.1.63 |
| B4524 | (I.L) | N.1.64 |
| B4525 | (I.L) | N.1.65 |
| B4526 | (I.L) | N.1.66 |
| B4527 | (I.L) | N.2.1 |
| B4528 | (I.L) | N.2.2 |
| B4529 | (I.L) | N.2.3 |
| B4530 | (I.L) | N.2.4 |
| B4531 | (I.L) | N.2.5 |
| B4532 | (I.L) | N.2.6 |
| B4533 | (I.L) | N.2.7 |
| B4534 | (I.L) | N.2.8 |
| B4535 | (I.L) | N.2.9 |
| B4536 | (I.L) | N.2.10 |
| B4537 | (I.L) | N.2.11 |
| B4538 | (I.L) | N.2.12 |
| B4539 | (I.L) | N.2.13 |
| B4540 | (I.L) | N.2.14 |
| B4541 | (I.L) | N.2.15 |
| B4542 | (I.L) | N.2.16 |
| B4543 | (I.L) | N.2.17 |
| B4544 | (I.L) | N.2.18 |
| B4545 | (I.L) | N.2.19 |
| B4546 | (I.L) | N.2.20 |
| B4547 | (I.L) | N.2.21 |
| B4548 | (I.L) | N.2.22 |
| B4549 | (I.L) | N.2.23 |
| B4550 | (I.L) | N.2.24 |
| B4551 | (I.L) | N.2.25 |
| B4552 | (I.L) | N.2.26 |
| B4553 | (I.L) | N.2.27 |
| B4554 | (I.L) | N.2.28 |
| B4555 | (I.L) | N.2.29 |
| B4556 | (I.L) | N.2.30 |
| B4557 | (I.L) | N.2.31 |
| B4558 | (I.L) | N.2.32 |
| B4559 | (I.L) | N.2.33 |
| B4560 | (I.L) | N.2.34 |
| B4561 | (I.L) | N.2.35 |
| B4562 | (I.L) | N.2.36 |
| B4563 | (I.L) | N.2.37 |
| B4564 | (I.L) | N.2.38 |
| B4565 | (I.L) | N.2.39 |
| B4566 | (I.L) | N.2.40 |
| B4567 | (I.L) | N.2.41 |
| B4568 | (I.L) | N.2.42 |
| B4569 | (I.L) | N.2.43 |
| B4570 | (I.L) | N.2.44 |
| B4571 | (I.L) | N.2.45 |
| B4572 | (I.L) | N.2.46 |
| B4573 | (I.L) | N.2.47 |
| B4574 | (I.L) | N.2.48 |
| B4575 | (I.L) | N.2.49 |
| B4576 | (I.L) | N.2.50 |
| B4577 | (I.L) | N.2.51 |
| B4578 | (I.L) | N.2.52 |
| B4579 | (I.L) | N.2.53 |
| B4580 | (I.L) | N.2.54 |
| B4581 | (I.L) | N.2.55 |
| B4582 | (I.L) | N.2.56 |
| B4583 | (I.L) | N.2.57 |
| B4584 | (I.L) | N.2.58 |
| B4585 | (I.L) | N.2.59 |
| B4586 | (I.L) | N.2.60 |
| B4587 | (I.L) | N.2.61 |
| B4588 | (I.L) | N.2.62 |
| B4589 | (I.L) | N.2.63 |
| B4590 | (I.L) | N.2.64 |
| B4591 | (I.L) | N.2.65 |
| B4592 | (I.L) | N.2.66 |
| B4593 | (I.L) | N.2.67 |
| B4594 | (I.L) | N.2.68 |
| B4595 | (I.L) | N.2.69 |
| B4596 | (I.L) | N.2.70 |
| B4597 | (I.L) | N.2.71 |
| B4598 | (I.L) | N.2.72 |
| B4599 | (I.L) | N.2.73 |
| B4600 | (I.L) | N.2.74 |
| B4601 | (I.L) | N.2.75 |
| B4602 | (I.L) | N.2.76 |
| B4603 | (I.L) | N.2.77 |
| B4604 | (I.L) | N.2.78 |
| B4605 | (I.L) | N.2.79 |
| B4606 | (I.L) | N.2.80 |
| B4607 | (I.L) | N.2.81 |
| B4608 | (I.L) | N.2.82 |
| B4609 | (I.L) | N.2.83 |
| B4610 | (I.L) | N.2.84 |
| B4611 | (I.L) | N.3.1 |
| B4612 | (I.L) | N.3.2 |
| B4613 | (I.L) | N.3.3 |
| B4614 | (I.L) | N.3.4 |
| B4615 | (I.L) | N.3.5 |
| B4616 | (I.L) | N.3.6 |
| B4617 | (I.L) | N.3.7 |
| B4618 | (I.L) | N.3.8 |
| B4619 | (I.L) | N.3.9 |
| B4620 | (I.L) | N.3.10 |
| B4621 | (I.L) | N.3.11 |
| B4622 | (I.L) | N.3.12 |
| B4623 | (I.L) | N.3.13 |
| B4624 | (I.L) | N.3.14 |
| B4625 | (I.L) | N.3.15 |
| B4626 | (I.L) | N.3.16 |
| B4627 | (I.L) | N.3.17 |
| B4628 | (I.L) | N.3.18 |
| B4629 | (I.L) | N.3.19 |
| B4630 | (I.L) | N.3.20 |
| B4631 | (I.L) | N.3.21 |
| B4632 | (I.L) | N.3.22 |
| B4633 | (I.L) | N.3.23 |
| B4634 | (I.L) | N.3.24 |
| B4635 | (I.L) | N.3.25 |
| B4636 | (I.L) | N.3.26 |
| B4637 | (I.L) | N.3.27 |
| B4638 | (I.L) | N.3.28 |
| B4639 | (I.L) | N.3.29 |
| B4640 | (I.L) | N.3.30 |
| B4641 | (I.L) | N.3.31 |
| B4642 | (I.L) | N.3.32 |
| B4643 | (I.L) | N.3.33 |
| B4644 | (I.L) | N.3.34 |
| B4645 | (I.L) | N.3.35 |
| B4646 | (I.L) | N.3.36 |
| B4647 | (I.L) | N.3.37 |
| B4648 | (I.L) | N.3.38 |
| B4649 | (I.L) | N.3.39 |
| B4650 | (I.L) | N.3.40 |
| B4651 | (I.L) | N.3.41 |
| B4652 | (I.L) | N.3.42 |
| B4653 | (I.L) | N.3.43 |
| B4654 | (I.L) | N.3.44 |
| B4655 | (I.L) | N.3.45 |
| B4656 | (I.L) | N.3.46 |
| B4657 | (I.L) | N.3.47 |
| B4658 | (I.L) | N.3.48 |
| B4659 | (I.L) | N.3.49 |
| B4660 | (I.L) | N.3.50 |
| B4661 | (I.L) | N.3.51 |
| B4662 | (I.L) | N.3.52 |
| B4663 | (I.L) | N.3.53 |
| B4664 | (I.L) | N.3.54 |
| B4665 | (I.L) | N.3.55 |
| B4666 | (I.L) | N.3.56 |
| B4667 | (I.L) | N.3.57 |
| B4668 | (I.L) | N.3.58 |
| B4669 | (I.L) | N.3.59 |
| B4670 | (I.L) | N.3.60 |
| B4671 | (I.L) | N.3.61 |
| B4672 | (I.L) | N.3.62 |
| B4673 | (I.L) | N.3.63 |
| B4674 | (I.L) | N.3.64 |
| B4675 | (I.L) | N.3.65 |
| B4676 | (I.L) | N.3.66 |
| B4677 | (I.L) | N.3.67 |
| B4678 | (I.L) | N.3.68 |
| B4679 | (I.L) | N.3.69 |
| B4680 | (I.L) | N.4.1 |
| B4681 | (I.L) | N.4.2 |
| B4682 | (I.L) | N.4.3 |
| B4683 | (I.L) | N.4.4 |
| B4684 | (I.L) | N.4.5 |
| B4685 | (I.L) | N.4.6 |
| B4686 | (I.L) | N.4.7 |
| B4687 | (I.L) | N.4.8 |
| B4688 | (I.L) | N.4.9 |
| B4689 | (I.L) | N.4.10 |
| B4690 | (I.L) | N.4.11 |
| B4691 | (I.L) | N.4.12 |
| B4692 | (I.L) | N.4.13 |
| B4693 | (I.L) | N.4.14 |
| B4694 | (I.L) | N.4.15 |
| B4695 | (I.L) | N.4.16 |
| B4696 | (I.L) | N.4.17 |
| B4697 | (I.L) | N.4.18 |
| B4698 | (I.L) | N.4.19 |
| B4699 | (I.L) | N.4.20 |
| B4700 | (I.L) | N.4.21 |
| B4701 | (I.L) | N.4.22 |
| B4702 | (I.L) | N.4.23 |
| B4703 | (I.L) | N.4.24 |
| B4704 | (I.L) | N.4.25 |
| B4705 | (I.L) | N.4.26 |
| B4706 | (I.L) | N.4.27 |
| B4707 | (I.L) | N.4.28 |
| B4708 | (I.L) | N.4.29 |
| B4709 | (I.L) | N.4.30 |
| B4710 | (I.L) | N.4.31 |
| B4711 | (I.L) | N.4.32 |
| B4712 | (I.L) | N.4.33 |
| B4713 | (I.L) | N.4.34 |
| B4714 | (I.L) | N.4.35 |
| B4715 | (I.L) | N.4.36 |
| B4716 | (I.L) | N.4.37 |
| B4717 | (I.L) | N.4.38 |
| B4718 | (I.L) | N.4.39 |
| B4719 | (I.L) | N.4.40 |
| B4720 | (I.L) | N.4.41 |
| B4721 | (I.L) | N.4.42 |
| B4722 | (I.L) | N.4.43 |
| B4723 | (I.L) | N.4.44 |
| B4724 | (I.L) | N.4.45 |
| B4725 | (I.L) | N.4.46 |
| B4726 | (I.L) | N.4.47 |
| B4727 | (I.L) | N.5.1 |
| B4728 | (I.L) | N.5.2 |
| B4729 | (I.L) | N.5.3 |
| B4730 | (I.L) | N.5.4 |
| B4731 | (I.L) | N.5.5 |
| B4732 | (I.L) | N.5.6 |
| B4733 | (I.L) | N.5.7 |
| B4734 | (I.L) | N.5.8 |
| B4735 | (I.L) | N.5.9 |
| B4736 | (I.L) | N.5.10 |
| B4737 | (I.L) | N.5.11 |
| B4738 | (I.L) | N.5.12 |
| B4739 | (I.L) | N.5.13 |
| B4740 | (I.L) | N.5.14 |
| B4741 | (I.L) | N.5.15 |
| B4742 | (I.L) | N.5.16 |
| B4743 | (I.L) | N.5.17 |
| B4744 | (I.L) | N.5.18 |
| B4745 | (I.L) | N.5.19 |
| B4746 | (I.L) | N.5.20 |
| B4747 | (I.L) | N.5.21 |
| B4748 | (I.L) | N.5.22 |
| B4749 | (I.L) | N.5.23 |
| B4750 | (I.L) | N.5.24 |
| B4751 | (I.L) | N.5.25 |
| B4752 | (I.L) | N.5.26 |
| B4753 | (I.L) | N.5.27 |
| B4754 | (I.L) | N.6.1 |
| B4755 | (I.L) | N.6.2 |
| B4756 | (I.L) | N.6.3 |
| B4757 | (I.L) | N.6.4 |
| B4758 | (I.L) | N.7.1 |
| B4759 | (I.L) | N.7.2 |
| B4760 | (I.L) | N.7.3 |
| B4761 | (I.L) | N.7.4 |
| B4762 | (I.L) | N.7.5 |
| B4763 | (I.L) | N.8.1 |
| B4764 | (I.L) | N.9.1 |
| B4765 | (I.L) | N.9.2 |
| B4766 | (I.L) | N.9.3 |
| B4767 | (I.L) | N.9.4 |
| B4768 | (I.L) | N.9.5 |
| B4769 | (I.L) | N.9.6 |
| B4770 | (I.L) | N.9.7 |
| B4771 | (I.L) | N.9.8 |
| B4772 | (I.L) | N.9.9 |
| B4773 | (I.L) | N.9.10 |
| B4774 | (I.L) | N.9.11 |
| B4775 | (I.L) | N.9.12 |
| B4776 | (I.L) | N.9.13 |
| B4777 | (I.L) | N.9.14 |
| B4778 | (I.L) | N.9.15 |
| B4779 | (I.L) | N.9.16 |
| B4780 | (I.L) | N.9.17 |
| B4781 | (I.L) | N.9.18 |
| B4782 | (I.L) | N.9.19 |
| B4783 | (I.L) | N.9.20 |
| B4784 | (I.L) | N.9.21 |
| B4785 | (I.L) | N.9.22 |
| B4786 | (I.L) | N.9.23 |
| B4787 | (I.L) | N.9.24 |
| B4788 | (I.L) | N.9.25 |
| B4789 | (I.L) | N.9.26 |
| B4790 | (I.L) | N.10.1 |
| B4791 | (I.L) | N.10.2 |
| B4792 | (I.L) | N.10.3 |
| B4793 | (I.L) | N.10.4 |
| B4794 | (I.L) | N.10.5 |
| B4795 | (I.L) | N.10.6 |
| B4796 | (I.L) | N.10.7 |
| B4797 | (I.L) | N.10.8 |
| B4798 | (I.L) | N.10.9 |
| B4799 | (I.L) | N.10.10 |
| B4800 | (I.L) | N.10.12 |
| B4801 | (I.L) | N.10.13 |
| B4802 | (I.L) | N.10.14 |
| B4803 | (I.L) | N.10.15 |
| B4804 | (I.L) | N.10.16 |
| B4805 | (I.L) | N.10.17 |
| B4806 | (I.L) | N.10.18 |
| B4807 | (I.L) | N.10.19 |
| B4808 | (I.L) | N.10.20 |
| B4809 | (I.L) | N.10.21 |
| B4810 | (I.L) | N.10.22 |
| B4811 | (I.L) | N.10.23 |
| B4812 | (I.L) | N.10.24 |
| B4813 | (I.L) | N.10.25 |
| B4814 | (I.L) | N.10.26 |
| B4815 | (I.L) | N.10.27 |
| B4816 | (I.L) | N.10.28 |
| B4817 | (I.L) | N.10.29 |
| B4818 | (I.L) | N.10.30 |
| B4819 | (I.L) | N.10.31 |
| B4820 | (I.L) | N.10.32 |
| B4821 | (I.L) | N.10.33 |
| B4822 | (I.L) | N.10.34 |
| B4823 | (I.L) | N.10.35 |
| B4824 | (I.L) | N.10.36 |
| B4825 | (I.L) | N.11.1 |
| B4826 | (I.L) | N.11.2 |
| B4827 | (I.L) | N.11.3 |
| B4828 | (I.L) | N.11.4 |
| B4829 | (I.L) | N.11.5 |
| B4830 | (I.L) | N.11.6 |
| B4831 | (I.L) | N.11.7 |
| B4832 | (I.L) | N.12.1 |
| B4833 | (I.L) | N.12.2 |
| B4834 | (I.L) | N.12.3 |
| B4835 | (I.L) | N.13.1 |
| B4836 | (I.L) | N.13.2 |
| B4837 | (I.L) | N.13.3 |
| B4838 | (I.L) | N.13.4 |
| B4839 | (I.L) | N.13.5 |
| B4840 | (I.L) | N.13.6 |
| B4841 | (I.L) | N.13.7 |
| B4842 | (I.L) | N.13.8 |
| B4843 | (I.L) | N.13.9 |
| B4844 | (I.L) | N.13.10 |
| B4845 | (I.L) | N.13.11 |
| B4846 | (I.L) | N.13.12 |
| B4847 | (I.L) | N.13.13 |
| B4848 | (I.L) | N.13.14 |
| B4849 | (I.L) | N.13.15 |
| B4850 | (I.L) | N.13.16 |
| B4851 | (I.L) | N.13.17 |
| B4852 | (I.L) | N.13.18 |
| B4853 | (I.L) | N.13.19 |
| B4854 | (I.L) | N.13.20 |
| B4855 | (I.L) | N.13.21 |
| B4856 | (I.L) | N.13.22 |
| B4857 | (I.L) | N.13.23 |
| B4858 | (I.L) | N.13.24 |
| B4859 | (I.L) | N.13.25 |
| B4860 | (I.L) | N.13.26 |
| B4861 | (I.L) | N.13.27 |
| B4862 | (I.L) | N.13.28 |
| B4863 | (I.L) | N.13.29 |
| B4864 | (I.L) | N.13.30 |
| B4865 | (I.L) | N.13.31 |
| B4866 | (I.L) | N.13.32 |
| B4867 | (I.L) | N.14.1 |
| B4868 | (I.L) | N.14.2 |
| B4869 | (I.L) | N.14.3 |
| B4870 | (I.L) | N.14.4 |
| B4871 | (I.L) | N.15.1 |
| B4872 | (I.L) | N.15.2 |
| B4873 | (I.L) | N.15.3 |
| B4874 | (I.L) | N.15.4 |
| B4875 | (I.L) | N.15.5 |
| B4876 | (I.L) | N.15.6 |
| B4877 | (I.L) | N.15.7 |
| B4878 | (I.L) | N.15.8 |
| B4879 | (I.L) | N.15.9 |
| B4880 | (I.L) | N.15.10 |
| B4881 | (I.L) | N.15.11 |
| B4882 | (I.L) | N.15.12 |
| B4883 | (I.L) | N.15.13 |
| B4884 | (I.L) | N.15.14 |
| B4885 | (I.L) | N.15.15 |
| B4886 | (I.L) | N.15.16 |
| B4887 | (I.L) | N.15.17 |
| B4888 | (I.L) | N.15.18 |
| B4889 | (I.L) | N.15.19 |
| B4890 | (I.L) | N.15.20 |
| B4891 | (I.L) | N.15.21 |
| B4892 | (I.L) | N.15.22 |
| B4893 | (I.L) | N.15.23 |
| B4894 | (I.L) | N.15.24 |
| B4895 | (I.L) | N.15.25 |
| B4896 | (I.L) | N.15.26 |
| B4897 | (I.L) | N.15.27 |
| B4898 | (I.L) | N.15.28 |
| B4899 | (I.L) | N.15.29 |
| B4900 | (I.L) | N.15.30 |
| B4901 | (I.L) | N.15.31 |
| B4902 | (I.L) | N.15.32 |
| B4903 | (I.L) | N.15.33 |
| B4904 | (I.L) | N.15.34 |
| B4905 | (I.L) | N.15.35 |
| B4906 | (I.L) | N.15.36 |

B = Mixture;
I = compound I;
II = compound II

TABLE 12

| B | I | II |
|---|---|---|
| B4907 | (I.M) | N.1.1 |
| B4908 | (I.M) | N.1.2 |
| B4909 | (I.M) | N.1.3 |
| B4910 | (I.M) | N.1.4 |
| B4911 | (I.M) | N.1.5 |
| B4912 | (I.M) | N.1.6 |
| B4913 | (I.M) | N.1.7 |
| B4914 | (I.M) | N.1.8 |
| B4915 | (I.M) | N.1.9 |
| B4916 | (I.M) | N.1.10 |
| B4917 | (I.M) | N.1.11 |
| B4918 | (I.M) | N.1.12 |
| B4919 | (I.M) | N.1.13 |
| B4920 | (I.M) | N.1.14 |
| B4921 | (I.M) | N.1.15 |
| B4922 | (I.M) | N.1.16 |
| B4923 | (I.M) | N.1.17 |
| B4924 | (I.M) | N.1.18 |
| B4925 | (I.M) | N.1.19 |
| B4926 | (I.M) | N.1.20 |
| B4927 | (I.M) | N.1.21 |
| B4928 | (I.M) | N.1.22 |
| B4929 | (I.M) | N.1.23 |
| B4930 | (I.M) | N.1.24 |
| B4931 | (I.M) | N.1.25 |
| B4932 | (I.M) | N.1.26 |
| B4933 | (I.M) | N.1.27 |
| B4934 | (I.M) | N.1.28 |
| B4935 | (I.M) | N.1.29 |
| B4936 | (I.M) | N.1.30 |
| B4937 | (I.M) | N.1.31 |
| B4938 | (I.M) | N.1.32 |
| B4939 | (I.M) | N.1.33 |
| B4940 | (I.M) | N.1.34 |
| B4941 | (I.M) | N.1.35 |
| B4942 | (I.M) | N.1.36 |
| B4943 | (I.M) | N.1.37 |
| B4944 | (I.M) | N.1.38 |
| B4945 | (I.M) | N.1.39 |
| B4946 | (I.M) | N.1.40 |
| B4947 | (I.M) | N.1.41 |
| B4948 | (I.M) | N.1.42 |
| B4949 | (I.M) | N.1.43 |
| B4950 | (I.M) | N.1.44 |
| B4951 | (I.M) | N.1.45 |
| B4952 | (I.M) | N.1.46 |
| B4953 | (I.M) | N.1.47 |
| B4954 | (I.M) | N.1.48 |
| B4955 | (I.M) | N.1.49 |
| B4956 | (I.M) | N.1.50 |
| B4957 | (I.M) | N.1.51 |
| B4958 | (I.M) | N.1.52 |
| B4959 | (I.M) | N.1.53 |
| B4960 | (I.M) | N.1.54 |
| B4961 | (I.M) | N.1.55 |
| B4962 | (I.M) | N.1.56 |
| B4963 | (I.M) | N.1.57 |
| B4964 | (I.M) | N.1.58 |
| B4965 | (I.M) | N.1.59 |
| B4966 | (I.M) | N.1.60 |
| B4967 | (I.M) | N.1.61 |
| B4968 | (I.M) | N.1.62 |
| B4969 | (I.M) | N.1.63 |
| B4970 | (I.M) | N.1.64 |
| B4971 | (I.M) | N.1.65 |
| B4972 | (I.M) | N.1.66 |
| B4973 | (I.M) | N.2.1 |
| B4974 | (I.M) | N.2.2 |
| B4975 | (I.M) | N.2.3 |
| B4976 | (I.M) | N.2.4 |
| B4977 | (I.M) | N.2.5 |
| B4978 | (I.M) | N.2.6 |
| B4979 | (I.M) | N.2.7 |
| B4980 | (I.M) | N.2.8 |
| B4981 | (I.M) | N.2.9 |
| B4982 | (I.M) | N.2.10 |
| B4983 | (I.M) | N.2.11 |
| B4984 | (I.M) | N.2.12 |
| B4985 | (I.M) | N.2.13 |
| B4986 | (I.M) | N.2.14 |
| B4987 | (I.M) | N.2.15 |
| B4988 | (I.M) | N.2.16 |
| B4989 | (I.M) | N.2.17 |
| B4990 | (I.M) | N.2.18 |
| B4991 | (I.M) | N.2.19 |
| B4992 | (I.M) | N.2.20 |
| B4993 | (I.M) | N.2.21 |
| B4994 | (I.M) | N.2.22 |
| B4995 | (I.M) | N.2.23 |
| B4996 | (I.M) | N.2.24 |
| B4997 | (I.M) | N.2.25 |
| B4998 | (I.M) | N.2.26 |
| B4999 | (I.M) | N.2.27 |
| B5000 | (I.M) | N.2.28 |
| B5001 | (I.M) | N.2.29 |
| B5002 | (I.M) | N.2.30 |
| B5003 | (I.M) | N.2.31 |
| B5004 | (I.M) | N.2.32 |
| B5005 | (I.M) | N.2.33 |
| B5006 | (I.M) | N.2.34 |
| B5007 | (I.M) | N.2.35 |
| B5008 | (I.M) | N.2.36 |
| B5009 | (I.M) | N.2.37 |
| B5010 | (I.M) | N.2.38 |
| B5011 | (I.M) | N.2.39 |
| B5012 | (I.M) | N.2.40 |
| B5013 | (I.M) | N.2.41 |
| B5014 | (I.M) | N.2.42 |
| B5015 | (I.M) | N.2.43 |
| B5016 | (I.M) | N.2.44 |
| B5017 | (I.M) | N.2.45 |
| B5018 | (I.M) | N.2.46 |
| B5019 | (I.M) | N.2.47 |
| B5020 | (I.M) | N.2.48 |
| B5021 | (I.M) | N.2.49 |
| B5022 | (I.M) | N.2.50 |
| B5023 | (I.M) | N.2.51 |
| B5024 | (I.M) | N.2.52 |
| B5025 | (I.M) | N.2.53 |
| B5026 | (I.M) | N.2.54 |
| B5027 | (I.M) | N.2.55 |
| B5028 | (I.M) | N.2.56 |
| B5029 | (I.M) | N.2.57 |
| B5030 | (I.M) | N.2.58 |
| B5031 | (I.M) | N.2.59 |
| B5032 | (I.M) | N.2.60 |
| B5033 | (I.M) | N.2.61 |
| B5034 | (I.M) | N.2.62 |
| B5035 | (I.M) | N.2.63 |
| B5036 | (I.M) | N.2.64 |
| B5037 | (I.M) | N.2.65 |
| B5038 | (I.M) | N.2.66 |
| B5039 | (I.M) | N.2.67 |
| B5040 | (I.M) | N.2.68 |
| B5041 | (I.M) | N.2.69 |
| B5042 | (I.M) | N.2.70 |
| B5043 | (I.M) | N.2.71 |
| B5044 | (I.M) | N.2.72 |
| B5045 | (I.M) | N.2.73 |
| B5046 | (I.M) | N.2.74 |
| B5047 | (I.M) | N.2.75 |
| B5048 | (I.M) | N.2.76 |
| B5049 | (I.M) | N.2.77 |
| B5050 | (I.M) | N.2.78 |
| B5051 | (I.M) | N.2.79 |
| B5052 | (I.M) | N.2.80 |
| B5053 | (I.M) | N.2.81 |
| B5054 | (I.M) | N.2.82 |
| B5055 | (I.M) | N.2.83 |
| B5056 | (I.M) | N.2.84 |
| B5057 | (I.M) | N.3.1 |
| B5058 | (I.M) | N.3.2 |
| B5059 | (I.M) | N.3.3 |
| B5060 | (I.M) | N.3.4 |
| B5061 | (I.M) | N.3.5 |
| B5062 | (I.M) | N.3.6 |
| B5063 | (I.M) | N.3.7 |
| B5064 | (I.M) | N.3.8 |
| B5065 | (I.M) | N.3.9 |
| B5066 | (I.M) | N.3.10 |
| B5067 | (I.M) | N.3.11 |
| B5068 | (I.M) | N.3.12 |
| B5069 | (I.M) | N.3.13 |
| B5070 | (I.M) | N.3.14 |
| B5071 | (I.M) | N.3.15 |
| B5072 | (I.M) | N.3.16 |
| B5073 | (I.M) | N.3.17 |
| B5074 | (I.M) | N.3.18 |
| B5075 | (I.M) | N.3.19 |
| B5076 | (I.M) | N.3.20 |
| B5077 | (I.M) | N.3.21 |
| B5078 | (I.M) | N.3.22 |
| B5079 | (I.M) | N.3.23 |
| B5080 | (I.M) | N.3.24 |
| B5081 | (I.M) | N.3.25 |
| B5082 | (I.M) | N.3.26 |
| B5083 | (I.M) | N.3.27 |
| B5084 | (I.M) | N.3.28 |
| B5085 | (I.M) | N.3.29 |
| B5086 | (I.M) | N.3.30 |
| B5087 | (I.M) | N.3.31 |
| B5088 | (I.M) | N.3.32 |
| B5089 | (I.M) | N.3.33 |
| B5090 | (I.M) | N.3.34 |
| B5091 | (I.M) | N.3.35 |
| B5092 | (I.M) | N.3.36 |
| B5093 | (I.M) | N.3.37 |
| B5094 | (I.M) | N.3.38 |
| B5095 | (I.M) | N.3.39 |
| B5096 | (I.M) | N.3.40 |
| B5097 | (I.M) | N.3.41 |
| B5098 | (I.M) | N.3.42 |
| B5099 | (I.M) | N.3.43 |
| B5100 | (I.M) | N.3.44 |
| B5101 | (I.M) | N.3.45 |
| B5102 | (I.M) | N.3.46 |
| B5103 | (I.M) | N.3.47 |
| B5104 | (I.M) | N.3.48 |
| B5105 | (I.M) | N.3.49 |
| B5106 | (I.M) | N.3.50 |
| B5107 | (I.M) | N.3.51 |
| B5108 | (I.M) | N.3.52 |
| B5109 | (I.M) | N.3.53 |
| B5110 | (I.M) | N.3.54 |
| B5111 | (I.M) | N.3.55 |
| B5112 | (I.M) | N.3.56 |
| B5113 | (I.M) | N.3.57 |
| B5114 | (I.M) | N.3.58 |
| B5115 | (I.M) | N.3.59 |
| B5116 | (I.M) | N.3.60 |
| B5117 | (I.M) | N.3.61 |
| B5118 | (I.M) | N.3.62 |
| B5119 | (I.M) | N.3.63 |
| B5120 | (I.M) | N.3.64 |
| B5121 | (I.M) | N.3.65 |
| B5122 | (I.M) | N.3.66 |
| B5123 | (I.M) | N.3.67 |
| B5124 | (I.M) | N.3.68 |
| B5125 | (I.M) | N.3.69 |
| B5126 | (I.M) | N.4.1 |
| B5127 | (I.M) | N.4.2 |
| B5128 | (I.M) | N.4.3 |
| B5129 | (I.M) | N.4.4 |
| B5130 | (I.M) | N.4.5 |
| B5131 | (I.M) | N.4.6 |
| B5132 | (I.M) | N.4.7 |
| B5133 | (I.M) | N.4.8 |
| B5134 | (I.M) | N.4.9 |
| B5135 | (I.M) | N.4.10 |
| B5136 | (I.M) | N.4.11 |
| B5137 | (I.M) | N.4.12 |
| B5138 | (I.M) | N.4.13 |
| B5139 | (I.M) | N.4.14 |
| B5140 | (I.M) | N.4.15 |
| B5141 | (I.M) | N.4.16 |
| B5142 | (I.M) | N.4.17 |
| B5143 | (I.M) | N.4.18 |
| B5144 | (I.M) | N.4.19 |
| B5145 | (I.M) | N.4.20 |
| B5146 | (I.M) | N.4.21 |
| B5147 | (I.M) | N.4.22 |
| B5148 | (I.M) | N.4.23 |
| B5149 | (I.M) | N.4.24 |
| B5150 | (I.M) | N.4.25 |
| B5151 | (I.M) | N.4.26 |
| B5152 | (I.M) | N.4.27 |
| B5153 | (I.M) | N.4.28 |
| B5154 | (I.M) | N.4.29 |
| B5155 | (I.M) | N.4.30 |
| B5156 | (I.M) | N.4.31 |
| B5157 | (I.M) | N.4.32 |
| B5158 | (I.M) | N.4.33 |
| B5159 | (I.M) | N.4.34 |
| B5160 | (I.M) | N.4.35 |
| B5161 | (I.M) | N.4.36 |
| B5162 | (I.M) | N.4.37 |
| B5163 | (I.M) | N.4.38 |
| B5164 | (I.M) | N.4.39 |
| B5165 | (I.M) | N.4.40 |
| B5166 | (I.M) | N.4.41 |
| B5167 | (I.M) | N.4.42 |
| B5168 | (I.M) | N.4.43 |
| B5169 | (I.M) | N.4.44 |
| B5170 | (I.M) | N.4.45 |
| B5171 | (I.M) | N.4.46 |
| B5172 | (I.M) | N.4.47 |
| B5173 | (I.M) | N.5.1 |
| B5174 | (I.M) | N.5.2 |
| B5175 | (I.M) | N.5.3 |
| B5176 | (I.M) | N.5.4 |
| B5177 | (I.M) | N.5.5 |
| B5178 | (I.M) | N.5.6 |
| B5179 | (I.M) | N.5.7 |
| B5180 | (I.M) | N.5.8 |
| B5181 | (I.M) | N.5.9 |
| B5182 | (I.M) | N.5.10 |
| B5183 | (I.M) | N.5.11 |
| B5184 | (I.M) | N.5.12 |
| B5185 | (I.M) | N.5.13 |
| B5186 | (I.M) | N.5.14 |
| B5187 | (I.M) | N.5.15 |
| B5188 | (I.M) | N.5.16 |
| B5189 | (I.M) | N.5.17 |
| B5190 | (I.M) | N.5.18 |
| B5191 | (I.M) | N.5.19 |
| B5192 | (I.M) | N.5.20 |
| B5193 | (I.M) | N.5.21 |
| B5194 | (I.M) | N.5.22 |
| B5195 | (I.M) | N.5.23 |
| B5196 | (I.M) | N.5.24 |
| B5197 | (I.M) | N.5.25 |
| B5198 | (I.M) | N.5.26 |
| B5199 | (I.M) | N.5.27 |
| B5200 | (I.M) | N.6.1 |
| B5201 | (I.M) | N.6.2 |
| B5202 | (I.M) | N.6.3 |
| B5203 | (I.M) | N.6.4 |
| B5204 | (I.M) | N.7.1 |
| B5205 | (I.M) | N.7.2 |
| B5206 | (I.M) | N.7.3 |
| B5207 | (I.M) | N.7.4 |
| B5208 | (I.M) | N.7.5 |
| B5209 | (I.M) | N.8.1 |
| B5210 | (I.M) | N.9.1 |
| B5211 | (I.M) | N.9.2 |
| B5212 | (I.M) | N.9.3 |
| B5213 | (I.M) | N.9.4 |
| B5214 | (I.M) | N.9.5 |
| B5215 | (I.M) | N.9.6 |
| B5216 | (I.M) | N.9.7 |
| B5217 | (I.M) | N.9.8 |
| B5218 | (I.M) | N.9.9 |
| B5219 | (I.M) | N.9.10 |
| B5220 | (I.M) | N.9.11 |
| B5221 | (I.M) | N.9.12 |
| B5222 | (I.M) | N.9.13 |
| B5223 | (I.M) | N.9.14 |
| B5224 | (I.M) | N.9.15 |
| B5225 | (I.M) | N.9.16 |
| B5226 | (I.M) | N.9.17 |
| B5227 | (I.M) | N.9.18 |
| B5228 | (I.M) | N.9.19 |
| B5229 | (I.M) | N.9.20 |
| B5230 | (I.M) | N.9.21 |
| B5231 | (I.M) | N.9.22 |
| B5232 | (I.M) | N.9.23 |
| B5233 | (I.M) | N.9.24 |
| B5234 | (I.M) | N.9.25 |
| B5235 | (I.M) | N.9.26 |
| B5236 | (I.M) | N.10.1 |
| B5237 | (I.M) | N.10.2 |
| B5238 | (I.M) | N.10.3 |
| B5239 | (I.M) | N.10.4 |
| B5240 | (I.M) | N.10.5 |
| B5241 | (I.M) | N.10.6 |
| B5242 | (I.M) | N.10.7 |
| B5243 | (I.M) | N.10.8 |
| B5244 | (I.M) | N.10.9 |
| B5245 | (I.M) | N.10.10 |
| B5246 | (I.M) | N.10.12 |
| B5247 | (I.M) | N.10.13 |
| B5248 | (I.M) | N.10.14 |
| B5249 | (I.M) | N.10.15 |
| B5250 | (I.M) | N.10.16 |
| B5251 | (I.M) | N.10.17 |
| B5252 | (I.M) | N.10.18 |
| B5253 | (I.M) | N.10.19 |
| B5254 | (I.M) | N.10.20 |
| B5255 | (I.M) | N.10.21 |
| B5256 | (I.M) | N.10.22 |
| B5257 | (I.M) | N.10.23 |
| B5258 | (I.M) | N.10.24 |
| B5259 | (I.M) | N.10.25 |
| B5260 | (I.M) | N.10.26 |
| B5261 | (I.M) | N.10.27 |
| B5262 | (I.M) | N.10.28 |
| B5263 | (I.M) | N.10.29 |
| B5264 | (I.M) | N.10.30 |
| B5265 | (I.M) | N.10.31 |
| B5266 | (I.M) | N.10.32 |
| B5267 | (I.M) | N.10.33 |
| B5268 | (I.M) | N.10.34 |
| B5269 | (I.M) | N.10.35 |
| B5270 | (I.M) | N.10.36 |
| B5271 | (I.M) | N.11.1 |
| B5272 | (I.M) | N.11.2 |
| B5273 | (I.M) | N.11.3 |
| B5274 | (I.M) | N.11.4 |
| B5275 | (I.M) | N.11.5 |
| B5276 | (I.M) | N.11.6 |
| B5277 | (I.M) | N.11.7 |
| B5278 | (I.M) | N.12.1 |
| B5279 | (I.M) | N.12.2 |
| B5280 | (I.M) | N.12.3 |
| B5281 | (I.M) | N.13.1 |
| B5282 | (I.M) | N.13.2 |
| B5283 | (I.M) | N.13.3 |
| B5284 | (I.M) | N.13.4 |
| B5285 | (I.M) | N.13.5 |
| B5286 | (I.M) | N.13.6 |
| B5287 | (I.M) | N.13.7 |
| B5288 | (I.M) | N.13.8 |
| B5289 | (I.M) | N.13.9 |
| B5290 | (I.M) | N.13.10 |
| B5291 | (I.M) | N.13.11 |
| B5292 | (I.M) | N.13.12 |
| B5293 | (I.M) | N.13.13 |
| B5294 | (I.M) | N.13.14 |
| B5295 | (I.M) | N.13.15 |
| B5296 | (I.M) | N.13.16 |
| B5297 | (I.M) | N.13.17 |
| B5298 | (I.M) | N.13.18 |
| B5299 | (I.M) | N.13.19 |
| B5300 | (I.M) | N.13.20 |
| B5301 | (I.M) | N.13.21 |
| B5302 | (I.M) | N.13.22 |
| B5303 | (I.M) | N.13.23 |
| B5304 | (I.M) | N.13.24 |
| B5305 | (I.M) | N.13.25 |
| B5306 | (I.M) | N.13.26 |
| B5307 | (I.M) | N.13.27 |
| B5308 | (I.M) | N.13.28 |
| B5309 | (I.M) | N.13.29 |
| B5310 | (I.M) | N.13.30 |
| B5311 | (I.M) | N.13.31 |
| B5312 | (I.M) | N.13.32 |
| B5313 | (I.M) | N.14.1 |
| B5314 | (I.M) | N.14.2 |
| B5315 | (I.M) | N.14.3 |
| B5316 | (I.M) | N.14.4 |
| B5317 | (I.M) | N.15.1 |
| B5318 | (I.M) | N.15.2 |
| B5319 | (I.M) | N.15.3 |
| B5320 | (I.M) | N.15.4 |
| B5321 | (I.M) | N.15.5 |
| B5322 | (I.M) | N.15.6 |
| B5323 | (I.M) | N.15.7 |
| B5324 | (I.M) | N.15.8 |
| B5325 | (I.M) | N.15.9 |
| B5326 | (I.M) | N.15.10 |
| B5327 | (I.M) | N.15.11 |
| B5328 | (I.M) | N.15.12 |
| B5329 | (I.M) | N.15.13 |
| B5330 | (I.M) | N.15.14 |
| B5331 | (I.M) | N.15.15 |
| B5332 | (I.M) | N.15.16 |
| B5333 | (I.M) | N.15.17 |
| B5334 | (I.M) | N.15.18 |
| B5335 | (I.M) | N.15.19 |
| B5336 | (I.M) | N.15.20 |
| B5337 | (I.M) | N.15.21 |
| B5338 | (I.M) | N.15.22 |
| B5339 | (I.M) | N.15.23 |
| B5340 | (I.M) | N.15.24 |
| B5341 | (I.M) | N.15.25 |
| B5342 | (I.M) | N.15.26 |
| B5343 | (I.M) | N.15.27 |
| B5344 | (I.M) | N.15.28 |
| B5345 | (I.M) | N.15.29 |
| B5346 | (I.M) | N.15.30 |
| B5347 | (I.M) | N.15.31 |
| B5348 | (I.M) | N.15.32 |
| B5349 | (I.M) | N.15.33 |
| B5350 | (I.M) | N.15.34 |
| B5351 | (I.M) | N.15.35 |
| B5352 | (I.M) | N.15.36 |

B = Mixture;
I = compound I;
II = compound II

TABLE 13

| B | I | II |
|---|---|---|
| B5353 | (I.N) | N.1.1 |
| B5354 | (I.N) | N.1.2 |
| B5355 | (I.N) | N.1.3 |
| B5356 | (I.N) | N.1.4 |
| B5357 | (I.N) | N.1.5 |
| B5358 | (I.N) | N.1.6 |
| B5359 | (I.N) | N.1.7 |
| B5360 | (I.N) | N.1.8 |
| B5361 | (I.N) | N.1.9 |
| B5362 | (I.N) | N.1.10 |
| B5363 | (I.N) | N.1.11 |
| B5364 | (I.N) | N.1.12 |
| B5365 | (I.N) | N.1.13 |
| B5366 | (I.N) | N.1.14 |
| B5367 | (I.N) | N.1.15 |
| B5368 | (I.N) | N.1.16 |
| B5369 | (I.N) | N.1.17 |
| B5370 | (I.N) | N.1.18 |
| B5371 | (I.N) | N.1.19 |
| B5372 | (I.N) | N.1.20 |
| B5373 | (I.N) | N.1.21 |
| B5374 | (I.N) | N.1.22 |
| B5375 | (I.N) | N.1.23 |
| B5376 | (I.N) | N.1.24 |
| B5377 | (I.N) | N.1.25 |
| B5378 | (I.N) | N.1.26 |
| B5379 | (I.N) | N.1.27 |
| B5380 | (I.N) | N.1.28 |
| B5381 | (I.N) | N.1.29 |
| B5382 | (I.N) | N.1.30 |
| B5383 | (I.N) | N.1.31 |
| B5384 | (I.N) | N.1.32 |
| B5385 | (I.N) | N.1.33 |
| B5386 | (I.N) | N.1.34 |
| B5387 | (I.N) | N.1.35 |
| B5388 | (I.N) | N.1.36 |
| B5389 | (I.N) | N.1.37 |
| B5390 | (I.N) | N.1.38 |
| B5391 | (I.N) | N.1.39 |
| B5392 | (I.N) | N.1.40 |
| B5393 | (I.N) | N.1.41 |
| B5394 | (I.N) | N.1.42 |
| B5395 | (I.N) | N.1.43 |
| B5396 | (I.N) | N.1.44 |
| B5397 | (I.N) | N.1.45 |
| B5398 | (I.N) | N.1.46 |
| B5399 | (I.N) | N.1.47 |
| B5400 | (I.N) | N.1.48 |
| B5401 | (I.N) | N.1.49 |
| B5402 | (I.N) | N.1.50 |
| B5403 | (I.N) | N.1.51 |
| B5404 | (I.N) | N.1.52 |
| B5405 | (I.N) | N.1.53 |
| B5406 | (I.N) | N.1.54 |
| B5407 | (I.N) | N.1.55 |
| B5408 | (I.N) | N.1.56 |
| B5409 | (I.N) | N.1.57 |
| B5410 | (I.N) | N.1.58 |
| B5411 | (I.N) | N.1.59 |
| B5412 | (I.N) | N.1.60 |
| B5413 | (I.N) | N.1.61 |
| B5414 | (I.N) | N.1.62 |
| B5415 | (I.N) | N.1.63 |
| B5416 | (I.N) | N.1.64 |
| B5417 | (I.N) | N.1.65 |
| B5418 | (I.N) | N.1.66 |
| B5419 | (I.N) | N.2.1 |
| B5420 | (I.N) | N.2.2 |
| B5421 | (I.N) | N.2.3 |
| B5422 | (I.N) | N.2.4 |
| B5423 | (I.N) | N.2.5 |
| B5424 | (I.N) | N.2.6 |
| B5425 | (I.N) | N.2.7 |
| B5426 | (I.N) | N.2.8 |
| B5427 | (I.N) | N.2.9 |
| B5428 | (I.N) | N.2.10 |
| B5429 | (I.N) | N.2.11 |
| B5430 | (I.N) | N.2.12 |
| B5431 | (I.N) | N.2.13 |
| B5432 | (I.N) | N.2.14 |
| B5433 | (I.N) | N.2.15 |
| B5434 | (I.N) | N.2.16 |
| B5435 | (I.N) | N.2.17 |
| B5436 | (I.N) | N.2.18 |
| B5437 | (I.N) | N.2.19 |
| B5438 | (I.N) | N.2.20 |
| B5439 | (I.N) | N.2.21 |
| B5440 | (I.N) | N.2.22 |
| B5441 | (I.N) | N.2.23 |
| B5442 | (I.N) | N.2.24 |
| B5443 | (I.N) | N.2.25 |
| B5444 | (I.N) | N.2.26 |
| B5445 | (I.N) | N.2.27 |
| B5446 | (I.N) | N.2.28 |
| B5447 | (I.N) | N.2.29 |
| B5448 | (I.N) | N.2.30 |
| B5449 | (I.N) | N.2.31 |
| B5450 | (I.N) | N.2.32 |
| B5451 | (I.N) | N.2.33 |
| B5452 | (I.N) | N.2.34 |
| B5453 | (I.N) | N.2.35 |
| B5454 | (I.N) | N.2.36 |
| B5455 | (I.N) | N.2.37 |
| B5456 | (I.N) | N.2.38 |
| B5457 | (I.N) | N.2.39 |
| B5458 | (I.N) | N.2.40 |
| B5459 | (I.N) | N.2.41 |
| B5460 | (I.N) | N.2.42 |
| B5461 | (I.N) | N.2.43 |
| B5462 | (I.N) | N.2.44 |
| B5463 | (I.N) | N.2.45 |
| B5464 | (I.N) | N.2.46 |
| B5465 | (I.N) | N.2.47 |
| B5466 | (I.N) | N.2.48 |
| B5467 | (I.N) | N.2.49 |
| B5468 | (I.N) | N.2.50 |
| B5469 | (I.N) | N.2.51 |
| B5470 | (I.N) | N.2.52 |
| B5471 | (I.N) | N.2.53 |
| B5472 | (I.N) | N.2.54 |
| B5473 | (I.N) | N.2.55 |
| B5474 | (I.N) | N.2.56 |
| B5475 | (I.N) | N.2.57 |
| B5476 | (I.N) | N.2.58 |
| B5477 | (I.N) | N.2.59 |
| B5478 | (I.N) | N.2.60 |
| B5479 | (I.N) | N.2.61 |
| B5480 | (I.N) | N.2.62 |
| B5481 | (I.N) | N.2.63 |
| B5482 | (I.N) | N.2.64 |
| B5483 | (I.N) | N.2.65 |
| B5484 | (I.N) | N.2.66 |
| B5485 | (I.N) | N.2.67 |
| B5486 | (I.N) | N.2.68 |
| B5487 | (I.N) | N.2.69 |
| B5488 | (I.N) | N.2.70 |
| B5489 | (I.N) | N.2.71 |
| B5490 | (I.N) | N.2.72 |
| B5491 | (I.N) | N.2.73 |
| B5492 | (I.N) | N.2.74 |
| B5493 | (I.N) | N.2.75 |
| B5494 | (I.N) | N.2.76 |
| B5495 | (I.N) | N.2.77 |
| B5496 | (I.N) | N.2.78 |
| B5497 | (I.N) | N.2.79 |
| B5498 | (I.N) | N.2.80 |
| B5499 | (I.N) | N.2.81 |
| B5500 | (I.N) | N.2.82 |
| B5501 | (I.N) | N.2.83 |
| B5502 | (I.N) | N.2.84 |
| B5503 | (I.N) | N.3.1 |
| B5504 | (I.N) | N.3.2 |
| B5505 | (I.N) | N.3.3 |
| B5506 | (I.N) | N.3.4 |
| B5507 | (I.N) | N.3.5 |
| B5508 | (I.N) | N.3.6 |
| B5509 | (I.N) | N.3.7 |
| B5510 | (I.N) | N.3.8 |
| B5511 | (I.N) | N.3.9 |
| B5512 | (I.N) | N.3.10 |
| B5513 | (I.N) | N.3.11 |
| B5514 | (I.N) | N.3.12 |
| B5515 | (I.N) | N.3.13 |
| B5516 | (I.N) | N.3.14 |
| B5517 | (I.N) | N.3.15 |
| B5518 | (I.N) | N.3.16 |
| B5519 | (I.N) | N.3.17 |
| B5520 | (I.N) | N.3.18 |
| B5521 | (I.N) | N.3.19 |
| B5522 | (I.N) | N.3.20 |
| B5523 | (I.N) | N.3.21 |
| B5524 | (I.N) | N.3.22 |
| B5525 | (I.N) | N.3.23 |
| B5526 | (I.N) | N.3.24 |
| B5527 | (I.N) | N.3.25 |
| B5528 | (I.N) | N.3.26 |
| B5529 | (I.N) | N.3.27 |
| B5530 | (I.N) | N.3.28 |
| B5531 | (I.N) | N.3.29 |
| B5532 | (I.N) | N.3.30 |
| B5533 | (I.N) | N.3.31 |
| B5534 | (I.N) | N.3.32 |
| B5535 | (I.N) | N.3.33 |
| B5536 | (I.N) | N.3.34 |
| B5537 | (I.N) | N.3.35 |
| B5538 | (I.N) | N.3.36 |
| B5539 | (I.N) | N.3.37 |
| B5540 | (I.N) | N.3.38 |
| B5541 | (I.N) | N.3.39 |
| B5542 | (I.N) | N.3.40 |
| B5543 | (I.N) | N.3.41 |
| B5544 | (I.N) | N.3.42 |
| B5545 | (I.N) | N.3.43 |
| B5546 | (I.N) | N.3.44 |
| B5547 | (I.N) | N.3.45 |
| B5548 | (I.N) | N.3.46 |
| B5549 | (I.N) | N.3.47 |
| B5550 | (I.N) | N.3.48 |
| B5551 | (I.N) | N.3.49 |
| B5552 | (I.N) | N.3.50 |
| B5553 | (I.N) | N.3.51 |
| B5554 | (I.N) | N.3.52 |
| B5555 | (I.N) | N.3.53 |
| B5556 | (I.N) | N.3.54 |
| B5557 | (I.N) | N.3.55 |
| B5558 | (I.N) | N.3.56 |
| B5559 | (I.N) | N.3.57 |
| B5560 | (I.N) | N.3.58 |
| B5561 | (I.N) | N.3.59 |
| B5562 | (I.N) | N.3.60 |
| B5563 | (I.N) | N.3.61 |
| B5564 | (I.N) | N.3.62 |
| B5565 | (I.N) | N.3.63 |
| B5566 | (I.N) | N.3.64 |
| B5567 | (I.N) | N.3.65 |
| B5568 | (I.N) | N.3.66 |
| B5569 | (I.N) | N.3.67 |
| B5570 | (I.N) | N.3.68 |
| B5571 | (I.N) | N.3.69 |
| B5572 | (I.N) | N.4.1 |
| B5573 | (I.N) | N.4.2 |
| B5574 | (I.N) | N.4.3 |
| B5575 | (I.N) | N.4.4 |
| B5576 | (I.N) | N.4.5 |
| B5577 | (I.N) | N.4.6 |
| B5578 | (I.N) | N.4.7 |
| B5579 | (I.N) | N.4.8 |
| B5580 | (I.N) | N.4.9 |
| B5581 | (I.N) | N.4.10 |
| B5582 | (I.N) | N.4.11 |
| B5583 | (I.N) | N.4.12 |
| B5584 | (I.N) | N.4.13 |
| B5585 | (I.N) | N.4.14 |
| B5586 | (I.N) | N.4.15 |
| B5587 | (I.N) | N.4.16 |
| B5588 | (I.N) | N.4.17 |
| B5589 | (I.N) | N.4.18 |
| B5590 | (I.N) | N.4.19 |
| B5591 | (I.N) | N.4.20 |
| B5592 | (I.N) | N.4.21 |
| B5593 | (I.N) | N.4.22 |
| B5594 | (I.N) | N.4.23 |
| B5595 | (I.N) | N.4.24 |
| B5596 | (I.N) | N.4.25 |
| B5597 | (I.N) | N.4.26 |
| B5598 | (I.N) | N.4.27 |
| B5599 | (I.N) | N.4.28 |
| B5600 | (I.N) | N.4.29 |
| B5601 | (I.N) | N.4.30 |
| B5602 | (I.N) | N.4.31 |
| B5603 | (I.N) | N.4.32 |
| B5604 | (I.N) | N.4.33 |
| B5605 | (I.N) | N.4.34 |
| B5606 | (I.N) | N.4.35 |
| B5607 | (I.N) | N.4.36 |
| B5608 | (I.N) | N.4.37 |
| B5609 | (I.N) | N.4.38 |
| B5610 | (I.N) | N.4.39 |
| B5611 | (I.N) | N.4.40 |
| B5612 | (I.N) | N.4.41 |
| B5613 | (I.N) | N.4.42 |
| B5614 | (I.N) | N.4.43 |
| B5615 | (I.N) | N.4.44 |
| B5616 | (I.N) | N.4.45 |
| B5617 | (I.N) | N.4.46 |
| B5618 | (I.N) | N.4.47 |
| B5619 | (I.N) | N.5.1 |
| B5620 | (I.N) | N.5.2 |
| B5621 | (I.N) | N.5.3 |
| B5622 | (I.N) | N.5.4 |
| B5623 | (I.N) | N.5.5 |
| B5624 | (I.N) | N.5.6 |
| B5625 | (I.N) | N.5.7 |
| B5626 | (I.N) | N.5.8 |
| B5627 | (I.N) | N.5.9 |
| B5628 | (I.N) | N.5.10 |
| B5629 | (I.N) | N.5.11 |
| B5630 | (I.N) | N.5.12 |
| B5631 | (I.N) | N.5.13 |
| B5632 | (I.N) | N.5.14 |
| B5633 | (I.N) | N.5.15 |
| B5634 | (I.N) | N.5.16 |
| B5635 | (I.N) | N.5.17 |
| B5636 | (I.N) | N.5.18 |
| B5637 | (I.N) | N.5.19 |
| B5638 | (I.N) | N.5.20 |
| B5639 | (I.N) | N.5.21 |
| B5640 | (I.N) | N.5.22 |
| B5641 | (I.N) | N.5.23 |
| B5642 | (I.N) | N.5.24 |
| B5643 | (I.N) | N.5.25 |
| B5644 | (I.N) | N.5.26 |
| B5645 | (I.N) | N.5.27 |
| B5646 | (I.N) | N.6.1 |
| B5647 | (I.N) | N.6.2 |
| B5648 | (I.N) | N.6.3 |
| B5649 | (I.N) | N.6.4 |
| B5650 | (I.N) | N.7.1 |
| B5651 | (I.N) | N.7.2 |
| B5652 | (I.N) | N.7.3 |
| B5653 | (I.N) | N.7.4 |
| B5654 | (I.N) | N.7.5 |
| B5655 | (I.N) | N.8.1 |
| B5656 | (I.N) | N.9.1 |
| B5657 | (I.N) | N.9.2 |
| B5658 | (I.N) | N.9.3 |
| B5659 | (I.N) | N.9.4 |
| B5660 | (I.N) | N.9.5 |
| B5661 | (I.N) | N.9.6 |
| B5662 | (I.N) | N.9.7 |
| B5663 | (I.N) | N.9.8 |
| B5664 | (I.N) | N.9.9 |
| B5665 | (I.N) | N.9.10 |
| B5666 | (I.N) | N.9.11 |
| B5667 | (I.N) | N.9.12 |
| B5668 | (I.N) | N.9.13 |
| B5669 | (I.N) | N.9.14 |
| B5670 | (I.N) | N.9.15 |
| B5671 | (I.N) | N.9.16 |
| B5672 | (I.N) | N.9.17 |
| B5673 | (I.N) | N.9.18 |
| B5674 | (I.N) | N.9.19 |
| B5675 | (I.N) | N.9.20 |
| B5676 | (I.N) | N.9.21 |
| B5677 | (I.N) | N.9.22 |
| B5678 | (I.N) | N.9.23 |
| B5679 | (I.N) | N.9.24 |
| B5680 | (I.N) | N.9.25 |
| B5681 | (I.N) | N.9.26 |
| B5682 | (I.N) | N.10.1 |
| B5683 | (I.N) | N.10.2 |
| B5684 | (I.N) | N.10.3 |
| B5685 | (I.N) | N.10.4 |
| B5686 | (I.N) | N.10.5 |
| B5687 | (I.N) | N.10.6 |
| B5688 | (I.N) | N.10.7 |
| B5689 | (I.N) | N.10.8 |
| B5690 | (I.N) | N.10.9 |
| B5691 | (I.N) | N.10.10 |
| B5692 | (I.N) | N.10.12 |
| B5693 | (I.N) | N.10.13 |
| B5694 | (I.N) | N.10.14 |
| B5695 | (I.N) | N.10.15 |
| B5696 | (I.N) | N.10.16 |
| B5697 | (I.N) | N.10.17 |
| B5698 | (I.N) | N.10.18 |
| B5699 | (I.N) | N.10.19 |
| B5700 | (I.N) | N.10.20 |
| B5701 | (I.N) | N.10.21 |
| B5702 | (I.N) | N.10.22 |
| B5703 | (I.N) | N.10.23 |
| B5704 | (I.N) | N.10.24 |
| B5705 | (I.N) | N.10.25 |
| B5706 | (I.N) | N.10.26 |
| B5707 | (I.N) | N.10.27 |
| B5708 | (I.N) | N.10.28 |
| B5709 | (I.N) | N.10.29 |
| B5710 | (I.N) | N.10.30 |
| B5711 | (I.N) | N.10.31 |
| B5712 | (I.N) | N.10.32 |
| B5713 | (I.N) | N.10.33 |
| B5714 | (I.N) | N.10.34 |
| B5715 | (I.N) | N.10.35 |
| B5716 | (I.N) | N.10.36 |
| B5717 | (I.N) | N.11.1 |
| B5718 | (I.N) | N.11.2 |
| B5719 | (I.N) | N.11.3 |
| B5720 | (I.N) | N.11.4 |
| B5721 | (I.N) | N.11.5 |
| B5722 | (I.N) | N.11.6 |
| B5723 | (I.N) | N.11.7 |
| B5724 | (I.N) | N.12.1 |
| B5725 | (I.N) | N.12.2 |
| B5726 | (I.N) | N.12.3 |
| B5727 | (I.N) | N.13.1 |
| B5728 | (I.N) | N.13.2 |
| B5729 | (I.N) | N.13.3 |
| B5730 | (I.N) | N.13.4 |
| B5731 | (I.N) | N.13.5 |
| B5732 | (I.N) | N.13.6 |
| B5733 | (I.N) | N.13.7 |
| B5734 | (I.N) | N.13.8 |
| B5735 | (I.N) | N.13.9 |
| B5736 | (I.N) | N.13.10 |
| B5737 | (I.N) | N.13.11 |
| B5738 | (I.N) | N.13.12 |
| B5739 | (I.N) | N.13.13 |
| B5740 | (I.N) | N.13.14 |
| B5741 | (I.N) | N.13.15 |
| B5742 | (I.N) | N.13.16 |
| B5743 | (I.N) | N.13.17 |
| B5744 | (I.N) | N.13.18 |
| B5745 | (I.N) | N.13.19 |
| B5746 | (I.N) | N.13.20 |
| B5747 | (I.N) | N.13.21 |
| B5748 | (I.N) | N.13.22 |
| B5749 | (I.N) | N.13.23 |
| B5750 | (I.N) | N.13.24 |
| B5751 | (I.N) | N.13.25 |
| B5752 | (I.N) | N.13.26 |
| B5753 | (I.N) | N.13.27 |
| B5754 | (I.N) | N.13.28 |
| B5755 | (I.N) | N.13.29 |
| B5756 | (I.N) | N.13.30 |
| B5757 | (I.N) | N.13.31 |
| B5758 | (I.N) | N.13.32 |
| B5759 | (I.N) | N.14.1 |
| B5760 | (I.N) | N.14.2 |
| B5761 | (I.N) | N.14.3 |
| B5762 | (I.N) | N.14.4 |
| B5763 | (I.N) | N.15.1 |
| B5764 | (I.N) | N.15.2 |
| B5765 | (I.N) | N.15.3 |
| B5766 | (I.N) | N.15.4 |
| B5767 | (I.N) | N.15.5 |
| B5768 | (I.N) | N.15.6 |
| B5769 | (I.N) | N.15.7 |
| B5770 | (I.N) | N.15.8 |
| B5771 | (I.N) | N.15.9 |
| B5772 | (I.N) | N.15.10 |
| B5773 | (I.N) | N.15.11 |
| B5774 | (I.N) | N.15.12 |
| B5775 | (I.N) | N.15.13 |
| B5776 | (I.N) | N.15.14 |
| B5777 | (I.N) | N.15.15 |
| B5778 | (I.N) | N.15.16 |
| B5779 | (I.N) | N.15.17 |
| B5780 | (I.N) | N.15.18 |
| B5781 | (I.N) | N.15.19 |
| B5782 | (I.N) | N.15.20 |
| B5783 | (I.N) | N.15.21 |
| B5784 | (I.N) | N.15.22 |
| B5785 | (I.N) | N.15.23 |
| B5786 | (I.N) | N.15.24 |
| B5787 | (I.N) | N.15.25 |
| B5788 | (I.N) | N.15.26 |
| B5789 | (I.N) | N.15.27 |
| B5790 | (I.N) | N.15.28 |
| B5791 | (I.N) | N.15.29 |
| B5792 | (I.N) | N.15.30 |
| B5793 | (I.N) | N.15.31 |
| B5794 | (I.N) | N.15.32 |
| B5795 | (I.N) | N.15.33 |
| B5796 | (I.N) | N.15.34 |
| B5797 | (I.N) | N.15.35 |
| B5798 | (I.N) | N.15.36 |

B = Mixture;
I = compound I;
II = compound II

TABLE 14

| B | I | II |
|---|---|---|
| B5799 | (I.O) | N.1.1 |
| B5800 | (I.O) | N.1.2 |
| B5801 | (I.O) | N.1.3 |
| B5802 | (I.O) | N.1.4 |
| B5803 | (I.O) | N.1.5 |
| B5804 | (I.O) | N.1.6 |
| B5805 | (I.O) | N.1.7 |
| B5806 | (I.O) | N.1.8 |
| B5807 | (I.O) | N.1.9 |
| B5808 | (I.O) | N.1.10 |
| B5809 | (I.O) | N.1.11 |
| B5810 | (I.O) | N.1.12 |
| B5811 | (I.O) | N.1.13 |
| B5812 | (I.O) | N.1.14 |
| B5813 | (I.O) | N.1.15 |
| B5814 | (I.O) | N.1.16 |
| B5815 | (I.O) | N.1.17 |
| B5816 | (I.O) | N.1.18 |
| B5817 | (I.O) | N.1.19 |
| B5818 | (I.O) | N.1.20 |
| B5819 | (I.O) | N.1.21 |
| B5820 | (I.O) | N.1.22 |
| B5821 | (I.O) | N.1.23 |
| B5822 | (I.O) | N.1.24 |
| B5823 | (I.O) | N.1.25 |
| B5824 | (I.O) | N.1.26 |
| B5825 | (I.O) | N.1.27 |
| B5826 | (I.O) | N.1.28 |
| B5827 | (I.O) | N.1.29 |
| B5828 | (I.O) | N.1.30 |
| B5829 | (I.O) | N.1.31 |
| B5830 | (I.O) | N.1.32 |
| B5831 | (I.O) | N.1.33 |
| B5832 | (I.O) | N.1.34 |
| B5833 | (I.O) | N.1.35 |
| B5834 | (I.O) | N.1.36 |
| B5835 | (I.O) | N.1.37 |
| B5836 | (I.O) | N.1.38 |
| B5837 | (I.O) | N.1.39 |
| B5838 | (I.O) | N.1.40 |
| B5839 | (I.O) | N.1.41 |
| B5840 | (I.O) | N.1.42 |
| B5841 | (I.O) | N.1.43 |
| B5842 | (I.O) | N.1.44 |
| B5843 | (I.O) | N.1.45 |
| B5844 | (I.O) | N.1.46 |
| B5845 | (I.O) | N.1.47 |
| B5846 | (I.O) | N.1.48 |
| B5847 | (I.O) | N.1.49 |
| B5848 | (I.O) | N.1.50 |
| B5849 | (I.O) | N.1.51 |
| B5850 | (I.O) | N.1.52 |
| B5851 | (I.O) | N.1.53 |
| B5852 | (I.O) | N.1.54 |
| B5853 | (I.O) | N.1.55 |
| B5854 | (I.O) | N.1.56 |
| B5855 | (I.O) | N.1.57 |
| B5856 | (I.O) | N.1.58 |
| B5857 | (I.O) | N.1.59 |
| B5858 | (I.O) | N.1.60 |
| B5859 | (I.O) | N.1.61 |
| B5860 | (I.O) | N.1.62 |
| B5861 | (I.O) | N.1.63 |
| B5862 | (I.O) | N.1.64 |
| B5863 | (I.O) | N.1.65 |
| B5864 | (I.O) | N.1.66 |
| B5865 | (I.O) | N.2.1 |
| B5866 | (I.O) | N.2.2 |
| B5867 | (I.O) | N.2.3 |
| B5868 | (I.O) | N.2.4 |
| B5869 | (I.O) | N.2.5 |
| B5870 | (I.O) | N.2.6 |
| B5871 | (I.O) | N.2.7 |
| B5872 | (I.O) | N.2.8 |
| B5873 | (I.O) | N.2.9 |
| B5874 | (I.O) | N.2.10 |
| B5875 | (I.O) | N.2.11 |
| B5876 | (I.O) | N.2.12 |
| B5877 | (I.O) | N.2.13 |
| B5878 | (I.O) | N.2.14 |
| B5879 | (I.O) | N.2.15 |
| B5880 | (I.O) | N.2.16 |
| B5881 | (I.O) | N.2.17 |
| B5882 | (I.O) | N.2.18 |
| B5883 | (I.O) | N.2.19 |
| B5884 | (I.O) | N.2.20 |
| B5885 | (I.O) | N.2.21 |
| B5886 | (I.O) | N.2.22 |
| B5887 | (I.O) | N.2.23 |
| B5888 | (I.O) | N.2.24 |
| B5889 | (I.O) | N.2.25 |
| B5890 | (I.O) | N.2.26 |
| B5891 | (I.O) | N.2.27 |
| B5892 | (I.O) | N.2.28 |
| B5893 | (I.O) | N.2.29 |
| B5894 | (I.O) | N.2.30 |
| B5895 | (I.O) | N.2.31 |
| B5896 | (I.O) | N.2.32 |
| B5897 | (I.O) | N.2.33 |
| B5898 | (I.O) | N.2.34 |
| B5899 | (I.O) | N.2.35 |
| B5900 | (I.O) | N.2.36 |
| B5901 | (I.O) | N.2.37 |
| B5902 | (I.O) | N.2.38 |
| B5903 | (I.O) | N.2.39 |
| B5904 | (I.O) | N.2.40 |
| B5905 | (I.O) | N.2.41 |
| B5906 | (I.O) | N.2.42 |
| B5907 | (I.O) | N.2.43 |
| B5908 | (I.O) | N.2.44 |
| B5909 | (I.O) | N.2.45 |
| B5910 | (I.O) | N.2.46 |
| B5911 | (I.O) | N.2.47 |
| B5912 | (I.O) | N.2.48 |
| B5913 | (I.O) | N.2.49 |
| B5914 | (I.O) | N.2.50 |
| B5915 | (I.O) | N.2.51 |
| B5916 | (I.O) | N.2.52 |
| B5917 | (I.O) | N.2.53 |
| B5918 | (I.O) | N.2.54 |
| B5919 | (I.O) | N.2.55 |
| B5920 | (I.O) | N.2.56 |
| B5921 | (I.O) | N.2.57 |
| B5922 | (I.O) | N.2.58 |
| B5923 | (I.O) | N.2.59 |
| B5924 | (I.O) | N.2.60 |
| B5925 | (I.O) | N.2.61 |
| B5926 | (I.O) | N.2.62 |
| B5927 | (I.O) | N.2.63 |
| B5928 | (I.O) | N.2.64 |
| B5929 | (I.O) | N.2.65 |
| B5930 | (I.O) | N.2.66 |
| B5931 | (I.O) | N.2.67 |
| B5932 | (I.O) | N.2.68 |
| B5933 | (I.O) | N.2.69 |
| B5934 | (I.O) | N.2.70 |
| B5935 | (I.O) | N.2.71 |
| B5936 | (I.O) | N.2.72 |
| B5937 | (I.O) | N.2.73 |
| B5938 | (I.O) | N.2.74 |
| B5939 | (I.O) | N.2.75 |
| B5940 | (I.O) | N.2.76 |
| B5941 | (I.O) | N.2.77 |
| B5942 | (I.O) | N.2.78 |
| B5943 | (I.O) | N.2.79 |
| B5944 | (I.O) | N.2.80 |
| B5945 | (I.O) | N.2.81 |
| B5946 | (I.O) | N.2.82 |
| B5947 | (I.O) | N.2.83 |
| B5948 | (I.O) | N.2.84 |
| B5949 | (I.O) | N.3.1 |
| B5950 | (I.O) | N.3.2 |
| B5951 | (I.O) | N.3.3 |
| B5952 | (I.O) | N.3.4 |
| B5953 | (I.O) | N.3.5 |
| B5954 | (I.O) | N.3.6 |
| B5955 | (I.O) | N.3.7 |
| B5956 | (I.O) | N.3.8 |
| B5957 | (I.O) | N.3.9 |
| B5958 | (I.O) | N.3.10 |
| B5959 | (I.O) | N.3.11 |
| B5960 | (I.O) | N.3.12 |
| B5961 | (I.O) | N.3.13 |
| B5962 | (I.O) | N.3.14 |
| B5963 | (I.O) | N.3.15 |
| B5964 | (I.O) | N.3.16 |
| B5965 | (I.O) | N.3.17 |
| B5966 | (I.O) | N.3.18 |
| B5967 | (I.O) | N.3.19 |
| B5968 | (I.O) | N.3.20 |
| B5969 | (I.O) | N.3.21 |
| B5970 | (I.O) | N.3.22 |
| B5971 | (I.O) | N.3.23 |
| B5972 | (I.O) | N.3.24 |
| B5973 | (I.O) | N.3.25 |
| B5974 | (I.O) | N.3.26 |
| B5975 | (I.O) | N.3.27 |
| B5976 | (I.O) | N.3.28 |
| B5977 | (I.O) | N.3.29 |
| B5978 | (I.O) | N.3.30 |
| B5979 | (I.O) | N.3.31 |
| B5980 | (I.O) | N.3.32 |
| B5981 | (I.O) | N.3.33 |
| B5982 | (I.O) | N.3.34 |
| B5983 | (I.O) | N.3.35 |
| B5984 | (I.O) | N.3.36 |
| B5985 | (I.O) | N.3.37 |
| B5986 | (I.O) | N.3.38 |
| B5987 | (I.O) | N.3.39 |
| B5988 | (I.O) | N.3.40 |
| B5989 | (I.O) | N.3.41 |
| B5990 | (I.O) | N.3.42 |
| B5991 | (I.O) | N.3.43 |
| B5992 | (I.O) | N.3.44 |
| B5993 | (I.O) | N.3.45 |
| B5994 | (I.O) | N.3.46 |
| B5995 | (I.O) | N.3.47 |
| B5996 | (I.O) | N.3.48 |
| B5997 | (I.O) | N.3.49 |
| B5998 | (I.O) | N.3.50 |
| B5999 | (I.O) | N.3.51 |
| B6000 | (I.O) | N.3.52 |
| B6001 | (I.O) | N.3.53 |
| B6002 | (I.O) | N.3.54 |
| B6003 | (I.O) | N.3.55 |
| B6004 | (I.O) | N.3.56 |
| B6005 | (I.O) | N.3.57 |
| B6006 | (I.O) | N.3.58 |
| B6007 | (I.O) | N.3.59 |
| B6008 | (I.O) | N.3.60 |
| B6009 | (I.O) | N.3.61 |
| B6010 | (I.O) | N.3.62 |
| B6011 | (I.O) | N.3.63 |
| B6012 | (I.O) | N.3.64 |
| B6013 | (I.O) | N.3.65 |
| B6014 | (I.O) | N.3.66 |
| B6015 | (I.O) | N.3.67 |
| B6016 | (I.O) | N.3.68 |
| B6017 | (I.O) | N.3.69 |
| B6018 | (I.O) | N.4.1 |
| B6019 | (I.O) | N.4.2 |
| B6020 | (I.O) | N.4.3 |
| B6021 | (I.O) | N.4.4 |
| B6022 | (I.O) | N.4.5 |
| B6023 | (I.O) | N.4.6 |
| B6024 | (I.O) | N.4.7 |
| B6025 | (I.O) | N.4.8 |
| B6026 | (I.O) | N.4.9 |
| B6027 | (I.O) | N.4.10 |
| B6028 | (I.O) | N.4.11 |
| B6029 | (I.O) | N.4.12 |
| B6030 | (I.O) | N.4.13 |
| B6031 | (I.O) | N.4.14 |
| B6032 | (I.O) | N.4.15 |
| B6033 | (I.O) | N.4.16 |
| B6034 | (I.O) | N.4.17 |
| B6035 | (I.O) | N.4.18 |
| B6036 | (I.O) | N.4.19 |
| B6037 | (I.O) | N.4.20 |
| B6038 | (I.O) | N.4.21 |
| B6039 | (I.O) | N.4.22 |
| B6040 | (I.O) | N.4.23 |
| B6041 | (I.O) | N.4.24 |
| B6042 | (I.O) | N.4.25 |
| B6043 | (I.O) | N.4.26 |
| B6044 | (I.O) | N.4.27 |
| B6045 | (I.O) | N.4.28 |
| B6046 | (I.O) | N.4.29 |
| B6047 | (I.O) | N.4.30 |
| B6048 | (I.O) | N.4.31 |
| B6049 | (I.O) | N.4.32 |
| B6050 | (I.O) | N.4.33 |
| B6051 | (I.O) | N.4.34 |
| B6052 | (I.O) | N.4.35 |
| B6053 | (I.O) | N.4.36 |
| B6054 | (I.O) | N.4.37 |
| B6055 | (I.O) | N.4.38 |
| B6056 | (I.O) | N.4.39 |
| B6057 | (I.O) | N.4.40 |
| B6058 | (I.O) | N.4.41 |
| B6059 | (I.O) | N.4.42 |
| B6060 | (I.O) | N.4.43 |
| B6061 | (I.O) | N.4.44 |
| B6062 | (I.O) | N.4.45 |
| B6063 | (I.O) | N.4.46 |
| B6064 | (I.O) | N.4.47 |
| B6065 | (I.O) | N.5.1 |
| B6066 | (I.O) | N.5.2 |
| B6067 | (I.O) | N.5.3 |
| B6068 | (I.O) | N.5.4 |
| B6069 | (I.O) | N.5.5 |
| B6070 | (I.O) | N.5.6 |
| B6071 | (I.O) | N.5.7 |
| B6072 | (I.O) | N.5.8 |
| B6073 | (I.O) | N.5.9 |
| B6074 | (I.O) | N.5.10 |
| B6075 | (I.O) | N.5.11 |
| B6076 | (I.O) | N.5.12 |
| B6077 | (I.O) | N.5.13 |
| B6078 | (I.O) | N.5.14 |
| B6079 | (I.O) | N.5.15 |
| B6080 | (I.O) | N.5.16 |
| B6081 | (I.O) | N.5.17 |
| B6082 | (I.O) | N.5.18 |
| B6083 | (I.O) | N.5.19 |
| B6084 | (I.O) | N.5.20 |
| B6085 | (I.O) | N.5.21 |
| B6086 | (I.O) | N.5.22 |
| B6087 | (I.O) | N.5.23 |
| B6088 | (I.O) | N.5.24 |
| B6089 | (I.O) | N.5.25 |
| B6090 | (I.O) | N.5.26 |
| B6091 | (I.O) | N.5.27 |
| B6092 | (I.O) | N.6.1 |
| B6093 | (I.O) | N.6.2 |
| B6094 | (I.O) | N.6.3 |
| B6095 | (I.O) | N.6.4 |
| B6096 | (I.O) | N.7.1 |
| B6097 | (I.O) | N.7.2 |
| B6098 | (I.O) | N.7.3 |
| B6099 | (I.O) | N.7.4 |
| B6100 | (I.O) | N.7.5 |
| B6101 | (I.O) | N.8.1 |
| B6102 | (I.O) | N.9.1 |
| B6103 | (I.O) | N.9.2 |
| B6104 | (I.O) | N.9.3 |
| B6105 | (I.O) | N.9.4 |
| B6106 | (I.O) | N.9.5 |
| B6107 | (I.O) | N.9.6 |
| B6108 | (I.O) | N.9.7 |
| B6109 | (I.O) | N.9.8 |
| B6110 | (I.O) | N.9.9 |
| B6111 | (I.O) | N.9.10 |
| B6112 | (I.O) | N.9.11 |
| B6113 | (I.O) | N.9.12 |
| B6114 | (I.O) | N.9.13 |
| B6115 | (I.O) | N.9.14 |
| B6116 | (I.O) | N.9.15 |
| B6117 | (I.O) | N.9.16 |
| B6118 | (I.O) | N.9.17 |
| B6119 | (I.O) | N.9.18 |
| B6120 | (I.O) | N.9.19 |
| B6121 | (I.O) | N.9.20 |
| B6122 | (I.O) | N.9.21 |
| B6123 | (I.O) | N.9.22 |
| B6124 | (I.O) | N.9.23 |
| B6125 | (I.O) | N.9.24 |
| B6126 | (I.O) | N.9.25 |
| B6127 | (I.O) | N.9.26 |
| B6128 | (I.O) | N.10.1 |
| B6129 | (I.O) | N.10.2 |
| B6130 | (I.O) | N.10.3 |
| B6131 | (I.O) | N.10.4 |
| B6132 | (I.O) | N.10.5 |
| B6133 | (I.O) | N.10.6 |
| B6134 | (I.O) | N.10.7 |
| B6135 | (I.O) | N.10.8 |
| B6136 | (I.O) | N.10.9 |
| B6137 | (I.O) | N.10.10 |
| B6138 | (I.O) | N.10.12 |
| B6139 | (I.O) | N.10.13 |
| B6140 | (I.O) | N.10.14 |
| B6141 | (I.O) | N.10.15 |
| B6142 | (I.O) | N.10.16 |
| B6143 | (I.O) | N.10.17 |
| B6144 | (I.O) | N.10.18 |
| B6145 | (I.O) | N.10.19 |
| B6146 | (I.O) | N.10.20 |
| B6147 | (I.O) | N.10.21 |
| B6148 | (I.O) | N.10.22 |
| B6149 | (I.O) | N.10.23 |
| B6150 | (I.O) | N.10.24 |
| B6151 | (I.O) | N.10.25 |
| B6152 | (I.O) | N.10.26 |
| B6153 | (I.O) | N.10.27 |
| B6154 | (I.O) | N.10.28 |
| B6155 | (I.O) | N.10.29 |
| B6156 | (I.O) | N.10.30 |
| B6157 | (I.O) | N.10.31 |
| B6158 | (I.O) | N.10.32 |
| B6159 | (I.O) | N.10.33 |
| B6160 | (I.O) | N.10.34 |
| B6161 | (I.O) | N.10.35 |
| B6162 | (I.O) | N.10.36 |
| B6163 | (I.O) | N.11.1 |
| B6164 | (I.O) | N.11.2 |
| B6165 | (I.O) | N.11.3 |
| B6166 | (I.O) | N.11.4 |
| B6167 | (I.O) | N.11.5 |
| B6168 | (I.O) | N.11.6 |
| B6169 | (I.O) | N.11.7 |
| B6170 | (I.O) | N.12.1 |
| B6171 | (I.O) | N.12.2 |
| B6172 | (I.O) | N.12.3 |
| B6173 | (I.O) | N.13.1 |
| B6174 | (I.O) | N.13.2 |
| B6175 | (I.O) | N.13.3 |
| B6176 | (I.O) | N.13.4 |
| B6177 | (I.O) | N.13.5 |
| B6178 | (I.O) | N.13.6 |
| B6179 | (I.O) | N.13.7 |
| B6180 | (I.O) | N.13.8 |
| B6181 | (I.O) | N.13.9 |
| B6182 | (I.O) | N.13.10 |
| B6183 | (I.O) | N.13.11 |
| B6184 | (I.O) | N.13.12 |
| B6185 | (I.O) | N.13.13 |
| B6186 | (I.O) | N.13.14 |
| B6187 | (I.O) | N.13.15 |
| B6188 | (I.O) | N.13.16 |
| B6189 | (I.O) | N.13.17 |
| B6190 | (I.O) | N.13.18 |
| B6191 | (I.O) | N.13.19 |
| B6192 | (I.O) | N.13.20 |
| B6193 | (I.O) | N.13.21 |
| B6194 | (I.O) | N.13.22 |
| B6195 | (I.O) | N.13.23 |
| B6196 | (I.O) | N.13.24 |
| B6197 | (I.O) | N.13.25 |
| B6198 | (I.O) | N.13.26 |
| B6199 | (I.O) | N.13.27 |
| B6200 | (I.O) | N.13.28 |
| B6201 | (I.O) | N.13.29 |
| B6202 | (I.O) | N.13.30 |
| B6203 | (I.O) | N.13.31 |
| B6204 | (I.O) | N.13.32 |
| B6205 | (I.O) | N.14.1 |
| B6206 | (I.O) | N.14.2 |
| B6207 | (I.O) | N.14.3 |
| B6208 | (I.O) | N.14.4 |
| B6209 | (I.O) | N.15.1 |
| B6210 | (I.O) | N.15.2 |
| B6211 | (I.O) | N.15.3 |
| B6212 | (I.O) | N.15.4 |
| B6213 | (I.O) | N.15.5 |
| B6214 | (I.O) | N.15.6 |
| B6215 | (I.O) | N.15.7 |
| B6216 | (I.O) | N.15.8 |
| B6217 | (I.O) | N.15.9 |
| B6218 | (I.O) | N.15.10 |
| B6219 | (I.O) | N.15.11 |
| B6220 | (I.O) | N.15.12 |
| B6221 | (I.O) | N.15.13 |
| B6222 | (I.O) | N.15.14 |
| B6223 | (I.O) | N.15.15 |
| B6224 | (I.O) | N.15.16 |
| B6225 | (I.O) | N.15.17 |
| B6226 | (I.O) | N.15.18 |
| B6227 | (I.O) | N.15.19 |
| B6228 | (I.O) | N.15.20 |
| B6229 | (I.O) | N.15.21 |
| B6230 | (I.O) | N.15.22 |
| B6231 | (I.O) | N.15.23 |
| B6232 | (I.O) | N.15.24 |
| B6233 | (I.O) | N.15.25 |
| B6234 | (I.O) | N.15.26 |
| B6235 | (I.O) | N.15.27 |
| B6236 | (I.O) | N.15.28 |
| B6237 | (I.O) | N.15.29 |
| B6238 | (I.O) | N.15.30 |
| B6239 | (I.O) | N.15.31 |
| B6240 | (I.O) | N.15.32 |
| B6241 | (I.O) | N.15.33 |
| B6242 | (I.O) | N.15.34 |
| B6243 | (I.O) | N.15.35 |
| B6244 | (I.O) | N.15.36 |

B = Mixture;
I = compound I;
II = compound II

TABLE 15

| B | I | II |
|---|---|---|
| B6245 | (I.P) | N.1.1 |
| B6246 | (I.P) | N.1.2 |
| B6247 | (I.P) | N.1.3 |
| B6248 | (I.P) | N.1.4 |
| B6249 | (I.P) | N.1.5 |
| B6250 | (I.P) | N.1.6 |
| B6251 | (I.P) | N.1.7 |
| B6252 | (I.P) | N.1.8 |
| B6253 | (I.P) | N.1.9 |
| B6254 | (I.P) | N.1.10 |
| B6255 | (I.P) | N.1.11 |
| B6256 | (I.P) | N.1.12 |
| B6257 | (I.P) | N.1.13 |
| B6258 | (I.P) | N.1.14 |
| B6259 | (I.P) | N.1.15 |
| B6260 | (I.P) | N.1.16 |
| B6261 | (I.P) | N.1.17 |
| B6262 | (I.P) | N.1.18 |
| B6263 | (I.P) | N.1.19 |
| B6264 | (I.P) | N.1.20 |
| B6265 | (I.P) | N.1.21 |
| B6266 | (I.P) | N.1.22 |
| B6267 | (I.P) | N.1.23 |
| B6268 | (I.P) | N.1.24 |
| B6269 | (I.P) | N.1.25 |
| B6270 | (I.P) | N.1.26 |
| B6271 | (I.P) | N.1.27 |
| B6272 | (I.P) | N.1.28 |
| B6273 | (I.P) | N.1.29 |
| B6274 | (I.P) | N.1.30 |
| B6275 | (I.P) | N.1.31 |
| B6276 | (I.P) | N.1.32 |
| B6277 | (I.P) | N.1.33 |
| B6278 | (I.P) | N.1.34 |
| B6279 | (I.P) | N.1.35 |
| B6280 | (I.P) | N.1.36 |
| B6281 | (I.P) | N.1.37 |
| B6282 | (I.P) | N.1.38 |
| B6283 | (I.P) | N.1.39 |
| B6284 | (I.P) | N.1.40 |
| B6285 | (I.P) | N.1.41 |
| B6286 | (I.P) | N.1.42 |
| B6287 | (I.P) | N.1.43 |
| B6288 | (I.P) | N.1.44 |
| B6289 | (I.P) | N.1.45 |
| B6290 | (I.P) | N.1.46 |
| B6291 | (I.P) | N.1.47 |
| B6292 | (I.P) | N.1.48 |
| B6293 | (I.P) | N.1.49 |
| B6294 | (I.P) | N.1.50 |
| B6295 | (I.P) | N.1.51 |
| B6296 | (I.P) | N.1.52 |
| B6297 | (I.P) | N.1.53 |
| B6298 | (I.P) | N.1.54 |
| B6299 | (I.P) | N.1.55 |
| B6300 | (I.P) | N.1.56 |
| B6301 | (I.P) | N.1.57 |
| B6302 | (I.P) | N.1.58 |
| B6303 | (I.P) | N.1.59 |
| B6304 | (I.P) | N.1.60 |
| B6305 | (I.P) | N.1.61 |
| B6306 | (I.P) | N.1.62 |
| B6307 | (I.P) | N.1.63 |
| B6308 | (I.P) | N.1.64 |
| B6309 | (I.P) | N.1.65 |
| B6310 | (I.P) | N.1.66 |
| B6311 | (I.P) | N.2.1 |
| B6312 | (I.P) | N.2.2 |
| B6313 | (I.P) | N.2.3 |
| B6314 | (I.P) | N.2.4 |
| B6315 | (I.P) | N.2.5 |
| B6316 | (I.P) | N.2.6 |
| B6317 | (I.P) | N.2.7 |
| B6318 | (I.P) | N.2.8 |
| B6319 | (I.P) | N.2.9 |
| B6320 | (I.P) | N.2.10 |
| B6321 | (I.P) | N.2.11 |
| B6322 | (I.P) | N.2.12 |
| B6323 | (I.P) | N.2.13 |
| B6324 | (I.P) | N.2.14 |
| B6325 | (I.P) | N.2.15 |
| B6326 | (I.P) | N.2.16 |
| B6327 | (I.P) | N.2.17 |
| B6328 | (I.P) | N.2.18 |
| B6329 | (I.P) | N.2.19 |
| B6330 | (I.P) | N.2.20 |
| B6331 | (I.P) | N.2.21 |
| B6332 | (I.P) | N.2.22 |
| B6333 | (I.P) | N.2.23 |
| B6334 | (I.P) | N.2.24 |
| B6335 | (I.P) | N.2.25 |
| B6336 | (I.P) | N.2.26 |
| B6337 | (I.P) | N.2.27 |
| B6338 | (I.P) | N.2.28 |
| B6339 | (I.P) | N.2.29 |
| B6340 | (I.P) | N.2.30 |
| B6341 | (I.P) | N.2.31 |
| B6342 | (I.P) | N.2.32 |
| B6343 | (I.P) | N.2.33 |
| B6344 | (I.P) | N.2.34 |
| B6345 | (I.P) | N.2.35 |
| B6346 | (I.P) | N.2.36 |
| B6347 | (I.P) | N.2.37 |
| B6348 | (I.P) | N.2.38 |
| B6349 | (I.P) | N.2.39 |
| B6350 | (I.P) | N.2.40 |
| B6351 | (I.P) | N.2.41 |
| B6352 | (I.P) | N.2.42 |
| B6353 | (I.P) | N.2.43 |
| B6354 | (I.P) | N.2.44 |
| B6355 | (I.P) | N.2.45 |
| B6356 | (I.P) | N.2.46 |
| B6357 | (I.P) | N.2.47 |
| B6358 | (I.P) | N.2.48 |
| B6359 | (I.P) | N.2.49 |
| B6360 | (I.P) | N.2.50 |
| B6361 | (I.P) | N.2.51 |
| B6362 | (I.P) | N.2.52 |
| B6363 | (I.P) | N.2.53 |
| B6364 | (I.P) | N.2.54 |
| B6365 | (I.P) | N.2.55 |
| B6366 | (I.P) | N.2.56 |
| B6367 | (I.P) | N.2.57 |
| B6368 | (I.P) | N.2.58 |
| B6369 | (I.P) | N.2.59 |
| B6370 | (I.P) | N.2.60 |
| B6371 | (I.P) | N.2.61 |
| B6372 | (I.P) | N.2.62 |
| B6373 | (I.P) | N.2.63 |
| B6374 | (I.P) | N.2.64 |
| B6375 | (I.P) | N.2.65 |
| B6376 | (I.P) | N.2.66 |
| B6377 | (I.P) | N.2.67 |
| B6378 | (I.P) | N.2.68 |
| B6379 | (I.P) | N.2.69 |
| B6380 | (I.P) | N.2.70 |
| B6381 | (I.P) | N.2.71 |
| B6382 | (I.P) | N.2.72 |
| B6383 | (I.P) | N.2.73 |
| B6384 | (I.P) | N.2.74 |
| B6385 | (I.P) | N.2.75 |
| B6386 | (I.P) | N.2.76 |
| B6387 | (I.P) | N.2.77 |
| B6388 | (I.P) | N.2.78 |
| B6389 | (I.P) | N.2.79 |
| B6390 | (I.P) | N.2.80 |
| B6391 | (I.P) | N.2.81 |
| B6392 | (I.P) | N.2.82 |
| B6393 | (I.P) | N.2.83 |
| B6394 | (I.P) | N.2.84 |
| B6395 | (I.P) | N.3.1 |
| B6396 | (I.P) | N.3.2 |
| B6397 | (I.P) | N.3.3 |
| B6398 | (I.P) | N.3.4 |
| B6399 | (I.P) | N.3.5 |
| B6400 | (I.P) | N.3.6 |
| B6401 | (I.P) | N.3.7 |
| B6402 | (I.P) | N.3.8 |
| B6403 | (I.P) | N.3.9 |
| B6404 | (I.P) | N.3.10 |
| B6405 | (I.P) | N.3.11 |
| B6406 | (I.P) | N.3.12 |
| B6407 | (I.P) | N.3.13 |
| B6408 | (I.P) | N.3.14 |
| B6409 | (I.P) | N.3.15 |
| B6410 | (I.P) | N.3.16 |
| B6411 | (I.P) | N.3.17 |
| B6412 | (I.P) | N.3.18 |
| B6413 | (I.P) | N.3.19 |
| B6414 | (I.P) | N.3.20 |
| B6415 | (I.P) | N.3.21 |
| B6416 | (I.P) | N.3.22 |
| B6417 | (I.P) | N.3.23 |
| B6418 | (I.P) | N.3.24 |
| B6419 | (I.P) | N.3.25 |
| B6420 | (I.P) | N.3.26 |
| B6421 | (I.P) | N.3.27 |
| B6422 | (I.P) | N.3.28 |
| B6423 | (I.P) | N.3.29 |
| B6424 | (I.P) | N.3.30 |
| B6425 | (I.P) | N.3.31 |
| B6426 | (I.P) | N.3.32 |
| B6427 | (I.P) | N.3.33 |
| B6428 | (I.P) | N.3.34 |
| B6429 | (I.P) | N.3.35 |
| B6430 | (I.P) | N.3.36 |
| B6431 | (I.P) | N.3.37 |
| B6432 | (I.P) | N.3.38 |
| B6433 | (I.P) | N.3.39 |
| B6434 | (I.P) | N.3.40 |
| B6435 | (I.P) | N.3.41 |
| B6436 | (I.P) | N.3.42 |
| B6437 | (I.P) | N.3.43 |
| B6438 | (I.P) | N.3.44 |
| B6439 | (I.P) | N.3.45 |
| B6440 | (I.P) | N.3.46 |
| B6441 | (I.P) | N.3.47 |
| B6442 | (I.P) | N.3.48 |
| B6443 | (I.P) | N.3.49 |
| B6444 | (I.P) | N.3.50 |
| B6445 | (I.P) | N.3.51 |
| B6446 | (I.P) | N.3.52 |
| B6447 | (I.P) | N.3.53 |
| B6448 | (I.P) | N.3.54 |
| B6449 | (I.P) | N.3.55 |
| B6450 | (I.P) | N.3.56 |
| B6451 | (I.P) | N.3.57 |
| B6452 | (I.P) | N.3.58 |
| B6453 | (I.P) | N.3.59 |
| B6454 | (I.P) | N.3.60 |
| B6455 | (I.P) | N.3.61 |
| B6456 | (I.P) | N.3.62 |
| B6457 | (I.P) | N.3.63 |
| B6458 | (I.P) | N.3.64 |
| B6459 | (I.P) | N.3.65 |
| B6460 | (I.P) | N.3.66 |
| B6461 | (I.P) | N.3.67 |
| B6462 | (I.P) | N.3.68 |
| B6463 | (I.P) | N.3.69 |
| B6464 | (I.P) | N.4.1 |
| B6465 | (I.P) | N.4.2 |
| B6466 | (I.P) | N.4.3 |
| B6467 | (I.P) | N.4.4 |
| B6468 | (I.P) | N.4.5 |
| B6469 | (I.P) | N.4.6 |
| B6470 | (I.P) | N.4.7 |
| B6471 | (I.P) | N.4.8 |
| B6472 | (I.P) | N.4.9 |
| B6473 | (I.P) | N.4.10 |
| B6474 | (I.P) | N.4.11 |
| B6475 | (I.P) | N.4.12 |
| B6476 | (I.P) | N.4.13 |
| B6477 | (I.P) | N.4.14 |
| B6478 | (I.P) | N.4.15 |
| B6479 | (I.P) | N.4.16 |
| B6480 | (I.P) | N.4.17 |
| B6481 | (I.P) | N.4.18 |
| B6482 | (I.P) | N.4.19 |
| B6483 | (I.P) | N.4.20 |
| B6484 | (I.P) | N.4.21 |
| B6485 | (I.P) | N.4.22 |
| B6486 | (I.P) | N.4.23 |
| B6487 | (I.P) | N.4.24 |
| B6488 | (I.P) | N.4.25 |
| B6489 | (I.P) | N.4.26 |
| B6490 | (I.P) | N.4.27 |
| B6491 | (I.P) | N.4.28 |
| B6492 | (I.P) | N.4.29 |
| B6493 | (I.P) | N.4.30 |
| B6494 | (I.P) | N.4.31 |
| B6495 | (I.P) | N.4.32 |
| B6496 | (I.P) | N.4.33 |
| B6497 | (I.P) | N.4.34 |
| B6498 | (I.P) | N.4.35 |
| B6499 | (I.P) | N.4.36 |
| B6500 | (I.P) | N.4.37 |
| B6501 | (I.P) | N.4.38 |
| B6502 | (I.P) | N.4.39 |
| B6503 | (I.P) | N.4.40 |
| B6504 | (I.P) | N.4.41 |
| B6505 | (I.P) | N.4.42 |
| B6506 | (I.P) | N.4.43 |
| B6507 | (I.P) | N.4.44 |
| B6508 | (I.P) | N.4.45 |
| B6509 | (I.P) | N.4.46 |
| B6510 | (I.P) | N.4.47 |
| B6511 | (I.P) | N.5.1 |
| B6512 | (I.P) | N.5.2 |
| B6513 | (I.P) | N.5.3 |
| B6514 | (I.P) | N.5.4 |
| B6515 | (I.P) | N.5.5 |
| B6516 | (I.P) | N.5.6 |
| B6517 | (I.P) | N.5.7 |
| B6518 | (I.P) | N.5.8 |
| B6519 | (I.P) | N.5.9 |
| B6520 | (I.P) | N.5.10 |
| B6521 | (I.P) | N.5.11 |
| B6522 | (I.P) | N.5.12 |
| B6523 | (I.P) | N.5.13 |
| B6524 | (I.P) | N.5.14 |
| B6525 | (I.P) | N.5.15 |
| B6526 | (I.P) | N.5.16 |
| B6527 | (I.P) | N.5.17 |
| B6528 | (I.P) | N.5.18 |
| B6529 | (I.P) | N.5.19 |
| B6530 | (I.P) | N.5.20 |
| B6531 | (I.P) | N.5.21 |
| B6532 | (I.P) | N.5.22 |
| B6533 | (I.P) | N.5.23 |
| B6534 | (I.P) | N.5.24 |
| B6535 | (I.P) | N.5.25 |
| B6536 | (I.P) | N.5.26 |
| B6537 | (I.P) | N.5.27 |
| B6538 | (I.P) | N.6.1 |
| B6539 | (I.P) | N.6.2 |
| B6540 | (I.P) | N.6.3 |
| B6541 | (I.P) | N.6.4 |
| B6542 | (I.P) | N.7.1 |
| B6543 | (I.P) | N.7.2 |
| B6544 | (I.P) | N.7.3 |
| B6545 | (I.P) | N.7.4 |
| B6546 | (I.P) | N.7.5 |
| B6547 | (I.P) | N.8.1 |
| B6548 | (I.P) | N.9.1 |
| B6549 | (I.P) | N.9.2 |
| B6550 | (I.P) | N.9.3 |
| B6551 | (I.P) | N.9.4 |
| B6552 | (I.P) | N.9.5 |
| B6553 | (I.P) | N.9.6 |
| B6554 | (I.P) | N.9.7 |
| B6555 | (I.P) | N.9.8 |
| B6556 | (I.P) | N.9.9 |
| B6557 | (I.P) | N.9.10 |
| B6558 | (I.P) | N.9.11 |
| B6559 | (I.P) | N.9.12 |
| B6560 | (I.P) | N.9.13 |
| B6561 | (I.P) | N.9.14 |
| B6562 | (I.P) | N.9.15 |
| B6563 | (I.P) | N.9.16 |
| B6564 | (I.P) | N.9.17 |
| B6565 | (I.P) | N.9.18 |
| B6566 | (I.P) | N.9.19 |
| B6567 | (I.P) | N.9.20 |
| B6568 | (I.P) | N.9.21 |
| B6569 | (I.P) | N.9.22 |
| B6570 | (I.P) | N.9.23 |
| B6571 | (I.P) | N.9.24 |
| B6572 | (I.P) | N.9.25 |
| B6573 | (I.P) | N.9.26 |
| B6574 | (I.P) | N.10.1 |
| B6575 | (I.P) | N.10.2 |
| B6576 | (I.P) | N.10.3 |
| B6577 | (I.P) | N.10.4 |
| B6578 | (I.P) | N.10.5 |
| B6579 | (I.P) | N.10.6 |
| B6580 | (I.P) | N.10.7 |
| B6581 | (I.P) | N.10.8 |
| B6582 | (I.P) | N.10.9 |
| B6583 | (I.P) | N.10.10 |
| B6584 | (I.P) | N.10.12 |
| B6585 | (I.P) | N.10.13 |
| B6586 | (I.P) | N.10.14 |
| B6587 | (I.P) | N.10.15 |
| B6588 | (I.P) | N.10.16 |
| B6589 | (I.P) | N.10.17 |
| B6590 | (I.P) | N.10.18 |
| B6591 | (I.P) | N.10.19 |
| B6592 | (I.P) | N.10.20 |
| B6593 | (I.P) | N.10.21 |
| B6594 | (I.P) | N.10.22 |
| B6595 | (I.P) | N.10.23 |
| B6596 | (I.P) | N.10.24 |
| B6597 | (I.P) | N.10.25 |
| B6598 | (I.P) | N.10.26 |
| B6599 | (I.P) | N.10.27 |
| B6600 | (I.P) | N.10.28 |
| B6601 | (I.P) | N.10.29 |
| B6602 | (I.P) | N.10.30 |
| B6603 | (I.P) | N.10.31 |
| B6604 | (I.P) | N.10.32 |
| B6605 | (I.P) | N.10.33 |
| B6606 | (I.P) | N.10.34 |
| B6607 | (I.P) | N.10.35 |
| B6608 | (I.P) | N.10.36 |
| B6609 | (I.P) | N.11.1 |
| B6610 | (I.P) | N.11.2 |
| B6611 | (I.P) | N.11.3 |
| B6612 | (I.P) | N.11.4 |
| B6613 | (I.P) | N.11.5 |
| B6614 | (I.P) | N.11.6 |
| B6615 | (I.P) | N.11.7 |
| B6616 | (I.P) | N.12.1 |
| B6617 | (I.P) | N.12.2 |
| B6618 | (I.P) | N.12.3 |
| B6619 | (I.P) | N.13.1 |
| B6620 | (I.P) | N.13.2 |
| B6621 | (I.P) | N.13.3 |
| B6622 | (I.P) | N.13.4 |
| B6623 | (I.P) | N.13.5 |
| B6624 | (I.P) | N.13.6 |
| B6625 | (I.P) | N.13.7 |
| B6626 | (I.P) | N.13.8 |
| B6627 | (I.P) | N.13.9 |
| B6628 | (I.P) | N.13.10 |
| B6629 | (I.P) | N.13.11 |
| B6630 | (I.P) | N.13.12 |
| B6631 | (I.P) | N.13.13 |
| B6632 | (I.P) | N.13.14 |
| B6633 | (I.P) | N.13.15 |
| B6634 | (I.P) | N.13.16 |
| B6635 | (I.P) | N.13.17 |
| B6636 | (I.P) | N.13.18 |
| B6637 | (I.P) | N.13.19 |
| B6638 | (I.P) | N.13.20 |
| B6639 | (I.P) | N.13.21 |
| B6640 | (I.P) | N.13.22 |
| B6641 | (I.P) | N.13.23 |
| B6642 | (I.P) | N.13.24 |
| B6643 | (I.P) | N.13.25 |
| B6644 | (I.P) | N.13.26 |
| B6645 | (I.P) | N.13.27 |
| B6646 | (I.P) | N.13.28 |
| B6647 | (I.P) | N.13.29 |
| B6648 | (I.P) | N.13.30 |
| B6649 | (I.P) | N.13.31 |
| B6650 | (I.P) | N.13.32 |
| B6651 | (I.P) | N.14.1 |
| B6652 | (I.P) | N.14.2 |
| B6653 | (I.P) | N.14.3 |
| B6654 | (I.P) | N.14.4 |
| B6655 | (I.P) | N.15.1 |
| B6656 | (I.P) | N.15.2 |
| B6657 | (I.P) | N.15.3 |
| B6658 | (I.P) | N.15.4 |
| B6659 | (I.P) | N.15.5 |
| B6660 | (I.P) | N.15.6 |
| B6661 | (I.P) | N.15.7 |
| B6662 | (I.P) | N.15.8 |
| B6663 | (I.P) | N.15.9 |
| B6664 | (I.P) | N.15.10 |
| B6665 | (I.P) | N.15.11 |
| B6666 | (I.P) | N.15.12 |
| B6667 | (I.P) | N.15.13 |
| B6668 | (I.P) | N.15.14 |
| B6669 | (I.P) | N.15.15 |
| B6670 | (I.P) | N.15.16 |
| B6671 | (I.P) | N.15.17 |
| B6672 | (I.P) | N.15.18 |
| B6673 | (I.P) | N.15.19 |
| B6674 | (I.P) | N.15.20 |
| B6675 | (I.P) | N.15.21 |
| B6676 | (I.P) | N.15.22 |
| B6677 | (I.P) | N.15.23 |
| B6678 | (I.P) | N.15.24 |
| B6679 | (I.P) | N.15.25 |
| B6680 | (I.P) | N.15.26 |
| B6681 | (I.P) | N.15.27 |
| B6682 | (I.P) | N.15.28 |
| B6683 | (I.P) | N.15.29 |
| B6684 | (I.P) | N.15.30 |
| B6685 | (I.P) | N.15.31 |
| B6686 | (I.P) | N.15.32 |
| B6687 | (I.P) | N.15.33 |
| B6688 | (I.P) | N.15.34 |
| B6689 | (I.P) | N.15.35 |
| B6690 | (I.P) | N.15.36 |

B = Mixture;
I = compound I;
II = compound II

TABLE 16
B = Mixture; I = compound I; II = compound II

| B | I | II |
|---|---|---|
| B6691 | (I.Q) | N.1.1 |
| B6692 | (I.Q) | N.1.2 |
| B6693 | (I.Q) | N.1.3 |
| B6694 | (I.Q) | N.1.4 |
| B6695 | (I.Q) | N.1.5 |
| B6696 | (I.Q) | N.1.6 |
| B6697 | (I.Q) | N.1.7 |
| B6698 | (I.Q) | N.1.8 |
| B6699 | (I.Q) | N.1.9 |
| B6700 | (I.Q) | N.1.10 |
| B6701 | (I.Q) | N.1.11 |
| B6702 | (I.Q) | N.1.12 |
| B6703 | (I.Q) | N.1.13 |
| B6704 | (I.Q) | N.1.14 |
| B6705 | (I.Q) | N.1.15 |
| B6706 | (I.Q) | N.1.16 |
| B6707 | (I.Q) | N.1.17 |
| B6708 | (I.Q) | N.1.18 |
| B6709 | (I.Q) | N.1.19 |
| B6710 | (I.Q) | N.1.20 |
| B6711 | (I.Q) | N.1.21 |
| B6712 | (I.Q) | N.1.22 |
| B6713 | (I.Q) | N.1.23 |
| B6714 | (I.Q) | N.1.24 |
| B6715 | (I.Q) | N.1.25 |
| B6716 | (I.Q) | N.1.26 |
| B6717 | (I.Q) | N.1.27 |
| B6718 | (I.Q) | N.1.28 |
| B6719 | (I.Q) | N.1.29 |
| B6720 | (I.Q) | N.1.30 |
| B6721 | (I.Q) | N.1.31 |
| B6722 | (I.Q) | N.1.32 |
| B6723 | (I.Q) | N.1.33 |
| B6724 | (I.Q) | N.1.34 |
| B6725 | (I.Q) | N.1.35 |
| B6726 | (I.Q) | N.1.36 |
| B6727 | (I.Q) | N.1.37 |
| B6728 | (I.Q) | N.1.38 |
| B6729 | (I.Q) | N.1.39 |
| B6730 | (I.Q) | N.1.40 |
| B6731 | (I.Q) | N.1.41 |
| B6732 | (I.Q) | N.1.42 |
| B6733 | (I.Q) | N.1.43 |
| B6734 | (I.Q) | N.1.44 |
| B6735 | (I.Q) | N.1.45 |
| B6736 | (I.Q) | N.1.46 |
| B6737 | (I.Q) | N.1.47 |
| B6738 | (I.Q) | N.1.48 |
| B6739 | (I.Q) | N.1.49 |
| B6740 | (I.Q) | N.1.50 |
| B6741 | (I.Q) | N.1.51 |
| B6742 | (I.Q) | N.1.52 |
| B6743 | (I.Q) | N.1.53 |
| B6744 | (I.Q) | N.1.54 |
| B6745 | (I.Q) | N.1.55 |
| B6746 | (I.Q) | N.1.56 |
| B6747 | (I.Q) | N.1.57 |
| B6748 | (I.Q) | N.1.58 |
| B6749 | (I.Q) | N.1.59 |
| B6750 | (I.Q) | N.1.60 |
| B6751 | (I.Q) | N.1.61 |
| B6752 | (I.Q) | N.1.62 |
| B6753 | (I.Q) | N.1.63 |
| B6754 | (I.Q) | N.1.64 |
| B6755 | (I.Q) | N.1.65 |
| B6756 | (I.Q) | N.1.66 |
| B6757 | (I.Q) | N.2.1 |
| B6758 | (I.Q) | N.2.2 |
| B6759 | (I.Q) | N.2.3 |
| B6760 | (I.Q) | N.2.4 |
| B6761 | (I.Q) | N.2.5 |
| B6762 | (I.Q) | N.2.6 |
| B6763 | (I.Q) | N.2.7 |
| B6764 | (I.Q) | N.2.8 |
| B6765 | (I.Q) | N.2.9 |
| B6766 | (I.Q) | N.2.10 |
| B6767 | (I.Q) | N.2.11 |
| B6768 | (I.Q) | N.2.12 |
| B6769 | (I.Q) | N.2.13 |
| B6770 | (I.Q) | N.2.14 |
| B6771 | (I.Q) | N.2.15 |
| B6772 | (I.Q) | N.2.16 |
| B6773 | (I.Q) | N.2.17 |
| B6774 | (I.Q) | N.2.18 |
| B6775 | (I.Q) | N.2.19 |
| B6776 | (I.Q) | N.2.20 |
| B6777 | (I.Q) | N.2.21 |
| B6778 | (I.Q) | N.2.22 |
| B6779 | (I.Q) | N.2.23 |
| B6780 | (I.Q) | N.2.24 |
| B6781 | (I.Q) | N.2.25 |
| B6782 | (I.Q) | N.2.26 |
| B6783 | (I.Q) | N.2.27 |
| B6784 | (I.Q) | N.2.28 |
| B6785 | (I.Q) | N.2.29 |
| B6786 | (I.Q) | N.2.30 |
| B6787 | (I.Q) | N.2.31 |
| B6788 | (I.Q) | N.2.32 |
| B6789 | (I.Q) | N.2.33 |
| B6790 | (I.Q) | N.2.34 |
| B6791 | (I.Q) | N.2.35 |
| B6792 | (I.Q) | N.2.36 |
| B6793 | (I.Q) | N.2.37 |
| B6794 | (I.Q) | N.2.38 |
| B6795 | (I.Q) | N.2.39 |
| B6796 | (I.Q) | N.2.40 |
| B6797 | (I.Q) | N.2.41 |
| B6798 | (I.Q) | N.2.42 |
| B6799 | (I.Q) | N.2.43 |
| B6800 | (I.Q) | N.2.44 |
| B6801 | (I.Q) | N.2.45 |
| B6802 | (I.Q) | N.2.46 |
| B6803 | (I.Q) | N.2.47 |
| B6804 | (I.Q) | N.2.48 |
| B6805 | (I.Q) | N.2.49 |
| B6806 | (I.Q) | N.2.50 |
| B6807 | (I.Q) | N.2.51 |
| B6808 | (I.Q) | N.2.52 |
| B6809 | (I.Q) | N.2.53 |
| B6810 | (I.Q) | N.2.54 |
| B6811 | (I.Q) | N.2.55 |
| B6812 | (I.Q) | N.2.56 |
| B6813 | (I.Q) | N.2.57 |
| B6814 | (I.Q) | N.2.58 |
| B6815 | (I.Q) | N.2.59 |
| B6816 | (I.Q) | N.2.60 |
| B6817 | (I.Q) | N.2.61 |
| B6818 | (I.Q) | N.2.62 |
| B6819 | (I.Q) | N.2.63 |
| B6820 | (I.Q) | N.2.64 |
| B6821 | (I.Q) | N.2.65 |
| B6822 | (I.Q) | N.2.66 |
| B6823 | (I.Q) | N.2.67 |
| B6824 | (I.Q) | N.2.68 |
| B6825 | (I.Q) | N.2.69 |
| B6826 | (I.Q) | N.2.70 |
| B6827 | (I.Q) | N.2.71 |
| B6828 | (I.Q) | N.2.72 |
| B6829 | (I.Q) | N.2.73 |
| B6830 | (I.Q) | N.2.74 |
| B6831 | (I.Q) | N.2.75 |
| B6832 | (I.Q) | N.2.76 |
| B6833 | (I.Q) | N.2.77 |
| B6834 | (I.Q) | N.2.78 |
| B6835 | (I.Q) | N.2.79 |
| B6836 | (I.Q) | N.2.80 |
| B6837 | (I.Q) | N.2.81 |
| B6838 | (I.Q) | N.2.82 |
| B6839 | (I.Q) | N.2.83 |
| B6840 | (I.Q) | N.2.84 |
| B6841 | (I.Q) | N.3.1 |
| B6842 | (I.Q) | N.3.2 |
| B6843 | (I.Q) | N.3.3 |
| B6844 | (I.Q) | N.3.4 |
| B6845 | (I.Q) | N.3.5 |
| B6846 | (I.Q) | N.3.6 |
| B6847 | (I.Q) | N.3.7 |
| B6848 | (I.Q) | N.3.8 |
| B6849 | (I.Q) | N.3.9 |
| B6850 | (I.Q) | N.3.10 |
| B6851 | (I.Q) | N.3.11 |
| B6852 | (I.Q) | N.3.12 |
| B6853 | (I.Q) | N.3.13 |
| B6854 | (I.Q) | N.3.14 |
| B6855 | (I.Q) | N.3.15 |
| B6856 | (I.Q) | N.3.16 |
| B6857 | (I.Q) | N.3.17 |
| B6858 | (I.Q) | N.3.18 |
| B6859 | (I.Q) | N.3.19 |
| B6860 | (I.Q) | N.3.20 |
| B6861 | (I.Q) | N.3.21 |
| B6862 | (I.Q) | N.3.22 |
| B6863 | (I.Q) | N.3.23 |
| B6864 | (I.Q) | N.3.24 |
| B6865 | (I.Q) | N.3.25 |
| B6866 | (I.Q) | N.3.26 |
| B6867 | (I.Q) | N.3.27 |
| B6868 | (I.Q) | N.3.28 |
| B6869 | (I.Q) | N.3.29 |
| B6870 | (I.Q) | N.3.30 |
| B6871 | (I.Q) | N.3.31 |
| B6872 | (I.Q) | N.3.32 |
| B6873 | (I.Q) | N.3.33 |
| B6874 | (I.Q) | N.3.34 |
| B6875 | (I.Q) | N.3.35 |
| B6876 | (I.Q) | N.3.36 |
| B6877 | (I.Q) | N.3.37 |
| B6878 | (I.Q) | N.3.38 |
| B6879 | (I.Q) | N.3.39 |
| B6880 | (I.Q) | N.3.40 |
| B6881 | (I.Q) | N.3.41 |
| B6882 | (I.Q) | N.3.42 |
| B6883 | (I.Q) | N.3.43 |
| B6884 | (I.Q) | N.3.44 |
| B6885 | (I.Q) | N.3.45 |
| B6886 | (I.Q) | N.3.46 |
| B6887 | (I.Q) | N.3.47 |
| B6888 | (I.Q) | N.3.48 |
| B6889 | (I.Q) | N.3.49 |
| B6890 | (I.Q) | N.3.50 |
| B6891 | (I.Q) | N.3.51 |
| B6892 | (I.Q) | N.3.52 |
| B6893 | (I.Q) | N.3.53 |
| B6894 | (I.Q) | N.3.54 |
| B6895 | (I.Q) | N.3.55 |
| B6896 | (I.Q) | N.3.56 |
| B6897 | (I.Q) | N.3.57 |
| B6898 | (I.Q) | N.3.58 |
| B6899 | (I.Q) | N.3.59 |
| B6900 | (I.Q) | N.3.60 |
| B6901 | (I.Q) | N.3.61 |
| B6902 | (I.Q) | N.3.62 |
| B6903 | (I.Q) | N.3.63 |
| B6904 | (I.Q) | N.3.64 |
| B6905 | (I.Q) | N.3.65 |
| B6906 | (I.Q) | N.3.66 |
| B6907 | (I.Q) | N.3.67 |
| B6908 | (I.Q) | N.3.68 |
| B6909 | (I.Q) | N.3.69 |
| B6910 | (I.Q) | N.4.1 |
| B6911 | (I.Q) | N.4.2 |
| B6912 | (I.Q) | N.4.3 |
| B6913 | (I.Q) | N.4.4 |
| B6914 | (I.Q) | N.4.5 |
| B6915 | (I.Q) | N.4.6 |
| B6916 | (I.Q) | N.4.7 |
| B6917 | (I.Q) | N.4.8 |
| B6918 | (I.Q) | N.4.9 |
| B6919 | (I.Q) | N.4.10 |
| B6920 | (I.Q) | N.4.11 |
| B6921 | (I.Q) | N.4.12 |
| B6922 | (I.Q) | N.4.13 |
| B6923 | (I.Q) | N.4.14 |
| B6924 | (I.Q) | N.4.15 |
| B6925 | (I.Q) | N.4.16 |
| B6926 | (I.Q) | N.4.17 |
| B6927 | (I.Q) | N.4.18 |
| B6928 | (I.Q) | N.4.19 |
| B6929 | (I.Q) | N.4.20 |
| B6930 | (I.Q) | N.4.21 |
| B6931 | (I.Q) | N.4.22 |
| B6932 | (I.Q) | N.4.23 |
| B6933 | (I.Q) | N.4.24 |
| B6934 | (I.Q) | N.4.25 |
| B6935 | (I.Q) | N.4.26 |
| B6936 | (I.Q) | N.4.27 |
| B6937 | (I.Q) | N.4.28 |
| B6938 | (I.Q) | N.4.29 |
| B6939 | (I.Q) | N.4.30 |
| B6940 | (I.Q) | N.4.31 |
| B6941 | (I.Q) | N.4.32 |
| B6942 | (I.Q) | N.4.33 |
| B6943 | (I.Q) | N.4.34 |
| B6944 | (I.Q) | N.4.35 |
| B6945 | (I.Q) | N.4.36 |
| B6946 | (I.Q) | N.4.37 |
| B6947 | (I.Q) | N.4.38 |
| B6948 | (I.Q) | N.4.39 |
| B6949 | (I.Q) | N.4.40 |
| B6950 | (I.Q) | N.4.41 |
| B6951 | (I.Q) | N.4.42 |
| B6952 | (I.Q) | N.4.43 |
| B6953 | (I.Q) | N.4.44 |
| B6954 | (I.Q) | N.4.45 |
| B6955 | (I.Q) | N.4.46 |
| B6956 | (I.Q) | N.4.47 |
| B6957 | (I.Q) | N.5.1 |
| B6958 | (I.Q) | N.5.2 |
| B6959 | (I.Q) | N.5.3 |
| B6960 | (I.Q) | N.5.4 |
| B6961 | (I.Q) | N.5.5 |
| B6962 | (I.Q) | N.5.6 |
| B6963 | (I.Q) | N.5.7 |
| B6964 | (I.Q) | N.5.8 |
| B6965 | (I.Q) | N.5.9 |
| B6966 | (I.Q) | N.5.10 |
| B6967 | (I.Q) | N.5.11 |
| B6968 | (I.Q) | N.5.12 |
| B6969 | (I.Q) | N.5.13 |
| B6970 | (I.Q) | N.5.14 |
| B6971 | (I.Q) | N.5.15 |
| B6972 | (I.Q) | N.5.16 |
| B6973 | (I.Q) | N.5.17 |
| B6974 | (I.Q) | N.5.18 |
| B6975 | (I.Q) | N.5.19 |
| B6976 | (I.Q) | N.5.20 |
| B6977 | (I.Q) | N.5.21 |
| B6978 | (I.Q) | N.5.22 |
| B6979 | (I.Q) | N.5.23 |
| B6980 | (I.Q) | N.5.24 |
| B6981 | (I.Q) | N.5.25 |
| B6982 | (I.Q) | N.5.26 |
| B6983 | (I.Q) | N.5.27 |
| B6984 | (I.Q) | N.6.1 |
| B6985 | (I.Q) | N.6.2 |
| B6986 | (I.Q) | N.6.3 |
| B6987 | (I.Q) | N.6.4 |
| B6988 | (I.Q) | N.7.1 |
| B6989 | (I.Q) | N.7.2 |
| B6990 | (I.Q) | N.7.3 |
| B6991 | (I.Q) | N.7.4 |
| B6992 | (I.Q) | N.7.5 |
| B6993 | (I.Q) | N.8.1 |
| B6994 | (I.Q) | N.9.1 |
| B6995 | (I.Q) | N.9.2 |
| B6996 | (I.Q) | N.9.3 |
| B6997 | (I.Q) | N.9.4 |
| B6998 | (I.Q) | N.9.5 |
| B6999 | (I.Q) | N.9.6 |
| B7000 | (I.Q) | N.9.7 |
| B7001 | (I.Q) | N.9.8 |
| B7002 | (I.Q) | N.9.9 |
| B7003 | (I.Q) | N.9.10 |
| B7004 | (I.Q) | N.9.11 |
| B7005 | (I.Q) | N.9.12 |
| B7006 | (I.Q) | N.9.13 |
| B7007 | (I.Q) | N.9.14 |
| B7008 | (I.Q) | N.9.15 |
| B7009 | (I.Q) | N.9.16 |
| B7010 | (I.Q) | N.9.17 |
| B7011 | (I.Q) | N.9.18 |
| B7012 | (I.Q) | N.9.19 |
| B7013 | (I.Q) | N.9.20 |
| B7014 | (I.Q) | N.9.21 |
| B7015 | (I.Q) | N.9.22 |
| B7016 | (I.Q) | N.9.23 |
| B7017 | (I.Q) | N.9.24 |
| B7018 | (I.Q) | N.9.25 |
| B7019 | (I.Q) | N.9.26 |
| B7020 | (I.Q) | N.10.1 |
| B7021 | (I.Q) | N.10.2 |
| B7022 | (I.Q) | N.10.3 |
| B7023 | (I.Q) | N.10.4 |
| B7024 | (I.Q) | N.10.5 |
| B7025 | (I.Q) | N.10.6 |
| B7026 | (I.Q) | N.10.7 |
| B7027 | (I.Q) | N.10.8 |
| B7028 | (I.Q) | N.10.9 |
| B7029 | (I.Q) | N.10.10 |
| B7030 | (I.Q) | N.10.12 |
| B7031 | (I.Q) | N.10.13 |
| B7032 | (I.Q) | N.10.14 |
| B7033 | (I.Q) | N.10.15 |
| B7034 | (I.Q) | N.10.16 |
| B7035 | (I.Q) | N.10.17 |
| B7036 | (I.Q) | N.10.18 |
| B7037 | (I.Q) | N.10.19 |
| B7038 | (I.Q) | N.10.20 |
| B7039 | (I.Q) | N.10.21 |
| B7040 | (I.Q) | N.10.22 |
| B7041 | (I.Q) | N.10.23 |
| B7042 | (I.Q) | N.10.24 |
| B7043 | (I.Q) | N.10.25 |
| B7044 | (I.Q) | N.10.26 |
| B7045 | (I.Q) | N.10.27 |
| B7046 | (I.Q) | N.10.28 |
| B7047 | (I.Q) | N.10.29 |
| B7048 | (I.Q) | N.10.30 |
| B7049 | (I.Q) | N.10.31 |
| B7050 | (I.Q) | N.10.32 |
| B7051 | (I.Q) | N.10.33 |
| B7052 | (I.Q) | N.10.34 |
| B7053 | (I.Q) | N.10.35 |
| B7054 | (I.Q) | N.10.36 |
| B7055 | (I.Q) | N.11.1 |
| B7056 | (I.Q) | N.11.2 |
| B7057 | (I.Q) | N.11.3 |
| B7058 | (I.Q) | N.11.4 |
| B7059 | (I.Q) | N.11.5 |
| B7060 | (I.Q) | N.11.6 |
| B7061 | (I.Q) | N.11.7 |
| B7062 | (I.Q) | N.12.1 |
| B7063 | (I.Q) | N.12.2 |
| B7064 | (I.Q) | N.12.3 |
| B7065 | (I.Q) | N.13.1 |
| B7066 | (I.Q) | N.13.2 |
| B7067 | (I.Q) | N.13.3 |
| B7068 | (I.Q) | N.13.4 |
| B7069 | (I.Q) | N.13.5 |
| B7070 | (I.Q) | N.13.6 |
| B7071 | (I.Q) | N.13.7 |
| B7072 | (I.Q) | N.13.8 |
| B7073 | (I.Q) | N.13.9 |
| B7074 | (I.Q) | N.13.10 |
| B7075 | (I.Q) | N.13.11 |
| B7076 | (I.Q) | N.13.12 |
| B7077 | (I.Q) | N.13.13 |
| B7078 | (I.Q) | N.13.14 |
| B7079 | (I.Q) | N.13.15 |
| B7080 | (I.Q) | N.13.16 |
| B7081 | (I.Q) | N.13.17 |
| B7082 | (I.Q) | N.13.18 |
| B7083 | (I.Q) | N.13.19 |
| B7084 | (I.Q) | N.13.20 |
| B7085 | (I.Q) | N.13.21 |
| B7086 | (I.Q) | N.13.22 |
| B7087 | (I.Q) | N.13.23 |
| B7088 | (I.Q) | N.13.24 |
| B7089 | (I.Q) | N.13.25 |
| B7090 | (I.Q) | N.13.26 |
| B7091 | (I.Q) | N.13.27 |
| B7092 | (I.Q) | N.13.28 |
| B7093 | (I.Q) | N.13.29 |
| B7094 | (I.Q) | N.13.30 |
| B7095 | (I.Q) | N.13.31 |
| B7096 | (I.Q) | N.13.32 |
| B7097 | (I.Q) | N.14.1 |
| B7098 | (I.Q) | N.14.2 |
| B7099 | (I.Q) | N.14.3 |
| B7100 | (I.Q) | N.14.4 |
| B7101 | (I.Q) | N.15.1 |
| B7102 | (I.Q) | N.15.2 |
| B7103 | (I.Q) | N.15.3 |
| B7104 | (I.Q) | N.15.4 |
| B7105 | (I.Q) | N.15.5 |
| B7106 | (I.Q) | N.15.6 |
| B7107 | (I.Q) | N.15.7 |
| B7108 | (I.Q) | N.15.8 |
| B7109 | (I.Q) | N.15.9 |
| B7110 | (I.Q) | N.15.10 |
| B7111 | (I.Q) | N.15.11 |
| B7112 | (I.Q) | N.15.12 |
| B7113 | (I.Q) | N.15.13 |
| B7114 | (I.Q) | N.15.14 |
| B7115 | (I.Q) | N.15.15 |
| B7116 | (I.Q) | N.15.16 |
| B7117 | (I.Q) | N.15.17 |
| B7118 | (I.Q) | N.15.18 |
| B7119 | (I.Q) | N.15.19 |
| B7120 | (I.Q) | N.15.20 |
| B7121 | (I.Q) | N.15.21 |
| B7122 | (I.Q) | N.15.22 |
| B7123 | (I.Q) | N.15.23 |
| B7124 | (I.Q) | N.15.24 |
| B7125 | (I.Q) | N.15.25 |
| B7126 | (I.Q) | N.15.26 |
| B7127 | (I.Q) | N.15.27 |
| B7128 | (I.Q) | N.15.28 |
| B7129 | (I.Q) | N.15.29 |
| B7130 | (I.Q) | N.15.30 |
| B7131 | (I.Q) | N.15.31 |
| B7132 | (I.Q) | N.15.32 |
| B7133 | (I.Q) | N.15.33 |
| B7134 | (I.Q) | N.15.34 |
| B7135 | (I.Q) | N.15.35 |
| B7136 | (I.Q) | N.15.36 |

TABLE 17
B = Mixture: I = compound I: II = compound II

| B | I | II |
|---|---|---|
| B7137 | (I.R) | N.1.1 |
| B7138 | (I.R) | N.1.2 |
| B7139 | (I.R) | N.1.3 |
| B7140 | (I.R) | N.1.4 |
| B7141 | (I.R) | N.1.5 |
| B7142 | (I.R) | N.1.6 |
| B7143 | (I.R) | N.1.7 |
| B7144 | (I.R) | N.1.8 |
| B7145 | (I.R) | N.1.9 |
| B7146 | (I.R) | N.1.10 |
| B7147 | (I.R) | N.1.11 |
| B7148 | (I.R) | N.1.12 |
| B7149 | (I.R) | N.1.13 |
| B7150 | (I.R) | N.1.14 |
| B7151 | (I.R) | N.1.15 |
| B7152 | (I.R) | N.1.16 |
| B7153 | (I.R) | N.1.17 |
| B7154 | (I.R) | N.1.18 |
| B7155 | (I.R) | N.1.19 |
| B7156 | (I.R) | N.1.20 |
| B7157 | (I.R) | N.1.21 |
| B7158 | (I.R) | N.1.22 |
| B7159 | (I.R) | N.1.23 |
| B7160 | (I.R) | N.1.24 |
| B7161 | (I.R) | N.1.25 |
| B7162 | (I.R) | N.1.26 |
| B7163 | (I.R) | N.1.27 |
| B7164 | (I.R) | N.1.28 |
| B7165 | (I.R) | N.1.29 |
| B7166 | (I.R) | N.1.30 |
| B7167 | (I.R) | N.1.31 |
| B7168 | (I.R) | N.1.32 |
| B7169 | (I.R) | N.1.33 |
| B7170 | (I.R) | N.1.34 |
| B7171 | (I.R) | N.1.35 |
| B7172 | (I.R) | N.1.36 |
| B7173 | (I.R) | N.1.37 |
| B7174 | (I.R) | N.1.38 |
| B7175 | (I.R) | N.1.39 |
| B7176 | (I.R) | N.1.40 |
| B7177 | (I.R) | N.1.41 |
| B7178 | (I.R) | N.1.42 |
| B7179 | (I.R) | N.1.43 |
| B7180 | (I.R) | N.1.44 |
| B7181 | (I.R) | N.1.45 |
| B7182 | (I.R) | N.1.46 |
| B7183 | (I.R) | N.1.47 |
| B7184 | (I.R) | N.1.48 |
| B7185 | (I.R) | N.1.49 |
| B7186 | (I.R) | N.1.50 |
| B7187 | (I.R) | N.1.51 |
| B7188 | (I.R) | N.1.52 |
| B7189 | (I.R) | N.1.53 |
| B7190 | (I.R) | N.1.54 |
| B7191 | (I.R) | N.1.55 |
| B7192 | (I.R) | N.1.56 |
| B7193 | (I.R) | N.1.57 |
| B7194 | (I.R) | N.1.58 |
| B7195 | (I.R) | N.1.59 |
| B7196 | (I.R) | N.1.60 |
| B7197 | (I.R) | N.1.61 |
| B7198 | (I.R) | N.1.62 |
| B7199 | (I.R) | N.1.63 |
| B7200 | (I.R) | N.1.64 |
| B7201 | (I.R) | N.1.65 |
| B7202 | (I.R) | N.1.66 |
| B7203 | (I.R) | N.2.1 |
| B7204 | (I.R) | N.2.2 |
| B7205 | (I.R) | N.2.3 |
| B7206 | (I.R) | N.2.4 |
| B7207 | (I.R) | N.2.5 |
| B7208 | (I.R) | N.2.6 |
| B7209 | (I.R) | N.2.7 |
| B7210 | (I.R) | N.2.8 |
| B7211 | (I.R) | N.2.9 |
| B7212 | (I.R) | N.2.10 |
| B7213 | (I.R) | N.2.11 |
| B7214 | (I.R) | N.2.12 |
| B7215 | (I.R) | N.2.13 |
| B7216 | (I.R) | N.2.14 |
| B7217 | (I.R) | N.2.15 |
| B7218 | (I.R) | N.2.16 |
| B7219 | (I.R) | N.2.17 |
| B7220 | (I.R) | N.2.18 |
| B7221 | (I.R) | N.2.19 |
| B7222 | (I.R) | N.2.20 |
| B7223 | (I.R) | N.2.21 |
| B7224 | (I.R) | N.2.22 |
| B7225 | (I.R) | N.2.23 |
| B7226 | (I.R) | N.2.24 |
| B7227 | (I.R) | N.2.25 |
| B7228 | (I.R) | N.2.26 |
| B7229 | (I.R) | N.2.27 |
| B7230 | (I.R) | N.2.28 |
| B7231 | (I.R) | N.2.29 |
| B7232 | (I.R) | N.2.30 |
| B7233 | (I.R) | N.2.31 |
| B7234 | (I.R) | N.2.32 |
| B7235 | (I.R) | N.2.33 |
| B7236 | (I.R) | N.2.34 |
| B7237 | (I.R) | N.2.35 |
| B7238 | (I.R) | N.2.36 |
| B7239 | (I.R) | N.2.37 |
| B7240 | (I.R) | N.2.38 |
| B7241 | (I.R) | N.2.39 |
| B7242 | (I.R) | N.2.40 |
| B7243 | (I.R) | N.2.41 |
| B7244 | (I.R) | N.2.42 |
| B7245 | (I.R) | N.2.43 |
| B7246 | (I.R) | N.2.44 |
| B7247 | (I.R) | N.2.45 |
| B7320 | (I.R) | N.3.34 |
| B7321 | (I.R) | N.3.35 |
| B7322 | (I.R) | N.3.36 |
| B7323 | (I.R) | N.3.37 |
| B7324 | (I.R) | N.3.38 |
| B7325 | (I.R) | N.3.39 |
| B7326 | (I.R) | N.3.40 |
| B7327 | (I.R) | N.3.41 |
| B7328 | (I.R) | N.3.42 |
| B7329 | (I.R) | N.3.43 |
| B7330 | (I.R) | N.3.44 |
| B7331 | (I.R) | N.3.45 |
| B7332 | (I.R) | N.3.46 |
| B7333 | (I.R) | N.3.47 |
| B7334 | (I.R) | N.3.48 |
| B7335 | (I.R) | N.3.49 |
| B7336 | (I.R) | N.3.50 |
| B7337 | (I.R) | N.3.51 |
| B7338 | (I.R) | N.3.52 |
| B7339 | (I.R) | N.3.53 |
| B7340 | (I.R) | N.3.54 |
| B7341 | (I.R) | N.3.55 |
| B7342 | (I.R) | N.3.56 |
| B7343 | (I.R) | N.3.57 |
| B7344 | (I.R) | N.3.58 |
| B7345 | (I.R) | N.3.59 |
| B7346 | (I.R) | N.3.60 |
| B7347 | (I.R) | N.3.61 |
| B7348 | (I.R) | N.3.62 |
| B7349 | (I.R) | N.3.63 |
| B7350 | (I.R) | N.3.64 |
| B7351 | (I.R) | N.3.65 |
| B7352 | (I.R) | N.3.66 |
| B7353 | (I.R) | N.3.67 |
| B7354 | (I.R) | N.3.68 |
| B7355 | (I.R) | N.3.69 |
| B7284 | (I.R) | N.2.82 |
| B7285 | (I.R) | N.2.83 |
| B7286 | (I.R) | N.2.84 |
| B7287 | (I.R) | N.3.1 |
| B7288 | (I.R) | N.3.2 |
| B7289 | (I.R) | N.3.3 |
| B7290 | (I.R) | N.3.4 |
| B7291 | (I.R) | N.3.5 |
| B7292 | (I.R) | N.3.6 |
| B7293 | (I.R) | N.3.7 |
| B7294 | (I.R) | N.3.8 |
| B7295 | (I.R) | N.3.9 |
| B7296 | (I.R) | N.3.10 |
| B7297 | (I.R) | N.3.11 |
| B7298 | (I.R) | N.3.12 |
| B7299 | (I.R) | N.3.13 |
| B7300 | (I.R) | N.3.14 |
| B7301 | (I.R) | N.3.15 |
| B7302 | (I.R) | N.3.16 |
| B7303 | (I.R) | N.3.17 |
| B7304 | (I.R) | N.3.18 |
| B7305 | (I.R) | N.3.19 |
| B7306 | (I.R) | N.3.20 |
| B7307 | (I.R) | N.3.21 |
| B7308 | (I.R) | N.3.22 |
| B7309 | (I.R) | N.3.23 |
| B7310 | (I.R) | N.3.24 |
| B7311 | (I.R) | N.3.25 |
| B7312 | (I.R) | N.3.26 |
| B7313 | (I.R) | N.3.27 |
| B7314 | (I.R) | N.3.28 |
| B7315 | (I.R) | N.3.29 |
| B7316 | (I.R) | N.3.30 |
| B7317 | (I.R) | N.3.31 |
| B7318 | (I.R) | N.3.32 |
| B7319 | (I.R) | N.3.33 |
| B7248 | (I.R) | N.2.46 |
| B7249 | (I.R) | N.2.47 |
| B7250 | (I.R) | N.2.48 |
| B7251 | (I.R) | N.2.49 |
| B7252 | (I.R) | N.2.50 |
| B7253 | (I.R) | N.2.51 |
| B7254 | (I.R) | N.2.52 |
| B7255 | (I.R) | N.2.53 |
| B7256 | (I.R) | N.2.54 |
| B7257 | (I.R) | N.2.55 |
| B7258 | (I.R) | N.2.56 |
| B7259 | (I.R) | N.2.57 |
| B7260 | (I.R) | N.2.58 |
| B7261 | (I.R) | N.2.59 |
| B7262 | (I.R) | N.2.60 |
| B7263 | (I.R) | N.2.61 |
| B7264 | (I.R) | N.2.62 |
| B7265 | (I.R) | N.2.63 |
| B7266 | (I.R) | N.2.64 |
| B7267 | (I.R) | N.2.65 |
| B7268 | (I.R) | N.2.66 |
| B7269 | (I.R) | N.2.67 |
| B7270 | (I.R) | N.2.68 |
| B7271 | (I.R) | N.2.69 |
| B7272 | (I.R) | N.2.70 |
| B7273 | (I.R) | N.2.71 |
| B7274 | (I.R) | N.2.72 |
| B7275 | (I.R) | N.2.73 |
| B7276 | (I.R) | N.2.74 |
| B7277 | (I.R) | N.2.75 |
| B7278 | (I.R) | N.2.76 |
| B7279 | (I.R) | N.2.77 |
| B7280 | (I.R) | N.2.78 |
| B7281 | (I.R) | N.2.79 |
| B7282 | (I.R) | N.2.80 |
| B7283 | (I.R) | N.2.81 |
| B7356 | (I.R) | N.4.1 |
| B7357 | (I.R) | N.4.2 |
| B7358 | (I.R) | N.4.3 |
| B7359 | (I.R) | N.4.4 |
| B7360 | (I.R) | N.4.5 |
| B7361 | (I.R) | N.4.6 |
| B7362 | (I.R) | N.4.7 |
| B7363 | (I.R) | N.4.8 |
| B7364 | (I.R) | N.4.9 |
| B7365 | (I.R) | N.4.10 |
| B7366 | (I.R) | N.4.11 |
| B7367 | (I.R) | N.4.12 |
| B7368 | (I.R) | N.4.13 |
| B7369 | (I.R) | N.4.14 |
| B7370 | (I.R) | N.4.15 |
| B7371 | (I.R) | N.4.16 |
| B7372 | (I.R) | N.4.17 |
| B7373 | (I.R) | N.4.18 |
| B7374 | (I.R) | N.4.19 |
| B7375 | (I.R) | N.4.20 |
| B7376 | (I.R) | N.4.21 |
| B7377 | (I.R) | N.4.22 |
| B7378 | (I.R) | N.4.23 |
| B7379 | (I.R) | N.4.24 |
| B7380 | (I.R) | N.4.25 |
| B7381 | (I.R) | N.4.26 |
| B7382 | (I.R) | N.4.27 |
| B7383 | (I.R) | N.4.28 |
| B7384 | (I.R) | N.4.29 |
| B7385 | (I.R) | N.4.30 |
| B7386 | (I.R) | N.4.31 |
| B7387 | (I.R) | N.4.32 |
| B7388 | (I.R) | N.4.33 |
| B7389 | (I.R) | N.4.34 |
| B7390 | (I.R) | N.4.35 |
| B7391 | (I.R) | N.4.36 |
| B7392 | (I.R) | N.4.37 |
| B7393 | (I.R) | N.4.38 |
| B7394 | (I.R) | N.4.39 |
| B7395 | (I.R) | N.4.40 |
| B7396 | (I.R) | N.4.41 |
| B7397 | (I.R) | N.4.42 |
| B7398 | (I.R) | N.4.43 |
| B7399 | (I.R) | N.4.44 |
| B7400 | (I.R) | N.4.45 |
| B7401 | (I.R) | N.4.46 |
| B7402 | (I.R) | N.4.47 |
| B7403 | (I.R) | N.5.1 |
| B7404 | (I.R) | N.5.2 |
| B7405 | (I.R) | N.5.3 |
| B7406 | (I.R) | N.5.4 |
| B7407 | (I.R) | N.5.5 |
| B7408 | (I.R) | N.5.6 |
| B7409 | (I.R) | N.5.7 |
| B7410 | (I.R) | N.5.8 |
| B7411 | (I.R) | N.5.9 |
| B7412 | (I.R) | N.5.10 |
| B7413 | (I.R) | N.5.11 |
| B7414 | (I.R) | N.5.12 |
| B7415 | (I.R) | N.5.13 |
| B7416 | (I.R) | N.5.14 |
| B7417 | (I.R) | N.5.15 |
| B7418 | (I.R) | N.5.16 |
| B7419 | (I.R) | N.5.17 |
| B7420 | (I.R) | N.5.18 |
| B7421 | (I.R) | N.5.19 |
| B7422 | (I.R) | N.5.20 |
| B7423 | (I.R) | N.5.21 |
| B7424 | (I.R) | N.5.22 |
| B7425 | (I.R) | N.5.23 |
| B7426 | (I.R) | N.5.24 |
| B7427 | (I.R) | N.5.25 |
| B7428 | (I.R) | N.5.26 |
| B7429 | (I.R) | N.5.27 |
| B7430 | (I.R) | N.6.1 |
| B7431 | (I.R) | N.6.2 |
| B7432 | (I.R) | N.6.3 |
| B7433 | (I.R) | N.6.4 |
| B7434 | (I.R) | N.7.1 |
| B7435 | (I.R) | N.7.2 |
| B7436 | (I.R) | N.7.3 |
| B7437 | (I.R) | N.7.4 |
| B7438 | (I.R) | N.7.5 |
| B7439 | (I.R) | N.8.1 |
| B7440 | (I.R) | N.9.1 |
| B7441 | (I.R) | N.9.2 |
| B7442 | (I.R) | N.9.3 |
| B7443 | (I.R) | N.9.4 |
| B7444 | (I.R) | N.9.5 |
| B7445 | (I.R) | N.9.6 |
| B7446 | (I.R) | N.9.7 |
| B7447 | (I.R) | N.9.8 |
| B7448 | (I.R) | N.9.9 |
| B7449 | (I.R) | N.9.10 |
| B7450 | (I.R) | N.9.11 |
| B7451 | (I.R) | N.9.12 |
| B7452 | (I.R) | N.9.13 |
| B7453 | (I.R) | N.9.14 |
| B7454 | (I.R) | N.9.15 |
| B7455 | (I.R) | N.9.16 |
| B7456 | (I.R) | N.9.17 |
| B7457 | (I.R) | N.9.18 |
| B7458 | (I.R) | N.9.19 |
| B7459 | (I.R) | N.9.20 |
| B7460 | (I.R) | N.9.21 |
| B7461 | (I.R) | N.9.22 |
| B7462 | (I.R) | N.9.23 |
| B7463 | (I.R) | N.9.24 |
| B7464 | (I.R) | N.9.25 |
| B7465 | (I.R) | N.9.26 |
| B7466 | (I.R) | N.10.1 |
| B7467 | (I.R) | N.10.2 |
| B7468 | (I.R) | N.10.3 |
| B7469 | (I.R) | N.10.4 |
| B7470 | (I.R) | N.10.5 |
| B7471 | (I.R) | N.10.6 |
| B7472 | (I.R) | N.10.7 |
| B7473 | (I.R) | N.10.8 |
| B7474 | (I.R) | N.10.9 |
| B7475 | (I.R) | N.10.10 |
| B7476 | (I.R) | N.10.12 |
| B7477 | (I.R) | N.10.13 |
| B7478 | (I.R) | N.10.14 |
| B7479 | (I.R) | N.10.15 |
| B7480 | (I.R) | N.10.16 |
| B7481 | (I.R) | N.10.17 |
| B7482 | (I.R) | N.10.18 |
| B7483 | (I.R) | N.10.19 |
| B7484 | (I.R) | N.10.20 |
| B7485 | (I.R) | N.10.21 |
| B7486 | (I.R) | N.10.22 |
| B7487 | (I.R) | N.10.23 |
| B7488 | (I.R) | N.10.24 |
| B7489 | (I.R) | N.10.25 |
| B7490 | (I.R) | N.10.26 |
| B7491 | (I.R) | N.10.27 |
| B7492 | (I.R) | N.10.28 |
| B7493 | (I.R) | N.10.29 |
| B7494 | (I.R) | N.10.30 |
| B7495 | (I.R) | N.10.31 |
| B7496 | (I.R) | N.10.32 |
| B7497 | (I.R) | N.10.33 |
| B7498 | (I.R) | N.10.34 |
| B7499 | (I.R) | N.10.35 |
| B7500 | (I.R) | N.10.36 |
| B7501 | (I.R) | N.11.1 |
| B7502 | (I.R) | N.11.2 |
| B7503 | (I.R) | N.11.3 |
| B7504 | (I.R) | N.11.4 |
| B7505 | (I.R) | N.11.5 |
| B7506 | (I.R) | N.11.6 |
| B7507 | (I.R) | N.11.7 |
| B7508 | (I.R) | N.12.1 |
| B7509 | (I.R) | N.12.2 |
| B7510 | (I.R) | N.12.3 |
| B7511 | (I.R) | N.13.1 |
| B7512 | (I.R) | N.13.2 |
| B7513 | (I.R) | N.13.3 |
| B7514 | (I.R) | N.13.4 |
| B7515 | (I.R) | N.13.5 |
| B7516 | (I.R) | N.13.6 |
| B7517 | (I.R) | N.13.7 |
| B7518 | (I.R) | N.13.8 |
| B7519 | (I.R) | N.13.9 |
| B7520 | (I.R) | N.13.10 |
| B7521 | (I.R) | N.13.11 |
| B7522 | (I.R) | N.13.12 |
| B7523 | (I.R) | N.13.13 |
| B7524 | (I.R) | N.13.14 |
| B7525 | (I.R) | N.13.15 |
| B7526 | (I.R) | N.13.16 |
| B7527 | (I.R) | N.13.17 |
| B7528 | (I.R) | N.13.18 |
| B7529 | (I.R) | N.13.19 |
| B7530 | (I.R) | N.13.20 |
| B7531 | (I.R) | N.13.21 |
| B7532 | (I.R) | N.13.22 |
| B7533 | (I.R) | N.13.23 |
| B7534 | (I.R) | N.13.24 |
| B7535 | (I.R) | N.13.25 |
| B7536 | (I.R) | N.13.26 |
| B7537 | (I.R) | N.13.27 |
| B7538 | (I.R) | N.13.28 |
| B7539 | (I.R) | N.13.29 |
| B7540 | (I.R) | N.13.30 |
| B7541 | (I.R) | N.13.31 |
| B7542 | (I.R) | N.13.32 |
| B7543 | (I.R) | N.14.1 |
| B7544 | (I.R) | N.14.2 |
| B7545 | (I.R) | N.14.3 |
| B7546 | (I.R) | N.14.4 |
| B7547 | (I.R) | N.15.1 |
| B7548 | (I.R) | N.15.2 |
| B7549 | (I.R) | N.15.3 |
| B7550 | (I.R) | N.15.4 |
| B7551 | (I.R) | N.15.5 |
| B7552 | (I.R) | N.15.6 |
| B7553 | (I.R) | N.15.7 |
| B7554 | (I.R) | N.15.8 |
| B7555 | (I.R) | N.15.9 |
| B7556 | (I.R) | N.15.10 |
| B7557 | (I.R) | N.15.11 |
| B7558 | (I.R) | N.15.12 |
| B7559 | (I.R) | N.15.13 |
| B7560 | (I.R) | N.15.14 |
| B7561 | (I.R) | N.15.15 |
| B7562 | (I.R) | N.15.16 |
| B7563 | (I.R) | N.15.17 |
| B7564 | (I.R) | N.15.18 |
| B7565 | (I.R) | N.15.19 |
| B7566 | (I.R) | N.15.20 |
| B7567 | (I.R) | N.15.21 |
| B7568 | (I.R) | N.15.22 |
| B7569 | (I.R) | N.15.23 |
| B7570 | (I.R) | N.15.24 |
| B7571 | (I.R) | N.15.25 |
| B7572 | (I.R) | N.15.26 |
| B7573 | (I.R) | N.15.27 |
| B7574 | (I.R) | N.15.28 |
| B7575 | (I.R) | N.15.29 |
| B7576 | (I.R) | N.15.30 |
| B7577 | (I.R) | N.15.31 |
| B7578 | (I.R) | N.15.32 |
| B7579 | (I.R) | N.15.33 |
| B7580 | (I.R) | N.15.34 |
| B7581 | (I.R) | N.15.35 |
| B7582 | (I.R) | N.15.36 |

TABLE 18
B = Mixture; I = compound I; II = compound II

| B | I | II |
|---|---|---|
| B7583 | (I.S) | N.1.1 |
| B7584 | (I.S) | N.1.2 |
| B7585 | (I.S) | N.1.3 |
| B7586 | (I.S) | N.1.4 |
| B7587 | (I.S) | N.1.5 |
| B7588 | (I.S) | N.1.6 |
| B7589 | (I.S) | N.1.7 |
| B7590 | (I.S) | N.1.8 |
| B7591 | (I.S) | N.1.9 |
| B7592 | (I.S) | N.1.10 |
| B7593 | (I.S) | N.1.11 |
| B7594 | (I.S) | N.1.12 |
| B7595 | (I.S) | N.1.13 |
| B7596 | (I.S) | N.1.14 |
| B7597 | (I.S) | N.1.15 |
| B7598 | (I.S) | N.1.16 |
| B7599 | (I.S) | N.1.17 |
| B7600 | (I.S) | N.1.18 |
| B7601 | (I.S) | N.1.19 |
| B7602 | (I.S) | N.1.20 |
| B7603 | (I.S) | N.1.21 |
| B7604 | (I.S) | N.1.22 |
| B7605 | (I.S) | N.1.23 |
| B7606 | (I.S) | N.1.24 |
| B7607 | (I.S) | N.1.25 |
| B7608 | (I.S) | N.1.26 |
| B7609 | (I.S) | N.1.27 |
| B7610 | (I.S) | N.1.28 |
| B7611 | (I.S) | N.1.29 |
| B7612 | (I.S) | N.1.30 |
| B7613 | (I.S) | N.1.31 |
| B7614 | (I.S) | N.1.32 |
| B7615 | (I.S) | N.1.33 |
| B7616 | (I.S) | N.1.34 |
| B7617 | (I.S) | N.1.35 |
| B7618 | (I.S) | N.1.36 |
| B7619 | (I.S) | N.1.37 |
| B7620 | (I.S) | N.1.38 |
| B7621 | (I.S) | N.1.39 |
| B7622 | (I.S) | N.1.40 |
| B7623 | (I.S) | N.1.41 |
| B7624 | (I.S) | N.1.42 |
| B7625 | (I.S) | N.1.43 |
| B7626 | (I.S) | N.1.44 |
| B7627 | (I.S) | N.1.45 |
| B7628 | (I.S) | N.1.46 |
| B7629 | (I.S) | N.1.47 |
| B7630 | (I.S) | N.1.48 |
| B7631 | (I.S) | N.1.49 |
| B7632 | (I.S) | N.1.50 |
| B7633 | (I.S) | N.1.51 |
| B7634 | (I.S) | N.1.52 |
| B7635 | (I.S) | N.1.53 |
| B7636 | (I.S) | N.1.54 |
| B7637 | (I.S) | N.1.55 |
| B7638 | (I.S) | N.1.56 |
| B7639 | (I.S) | N.1.57 |
| B7640 | (I.S) | N.1.58 |
| B7641 | (I.S) | N.1.59 |
| B7642 | (I.S) | N.1.60 |
| B7643 | (I.S) | N.1.61 |
| B7644 | (I.S) | N.1.62 |
| B7645 | (I.S) | N.1.63 |
| B7646 | (I.S) | N.1.64 |
| B7647 | (I.S) | N.1.65 |
| B7648 | (I.S) | N.1.66 |
| B7649 | (I.S) | N.2.1 |
| B7650 | (I.S) | N.2.2 |
| B7651 | (I.S) | N.2.3 |
| B7652 | (I.S) | N.2.4 |
| B7653 | (I.S) | N.2.5 |
| B7654 | (I.S) | N.2.6 |
| B7655 | (I.S) | N.2.7 |
| B7656 | (I.S) | N.2.8 |
| B7657 | (I.S) | N.2.9 |
| B7658 | (I.S) | N.2.10 |
| B7659 | (I.S) | N.2.11 |
| B7660 | (I.S) | N.2.12 |
| B7661 | (I.S) | N.2.13 |
| B7662 | (I.S) | N.2.14 |
| B7663 | (I.S) | N.2.15 |
| B7664 | (I.S) | N.2.16 |
| B7665 | (I.S) | N.2.17 |
| B7666 | (I.S) | N.2.18 |
| B7667 | (I.S) | N.2.19 |
| B7668 | (I.S) | N.2.20 |
| B7669 | (I.S) | N.2.21 |
| B7670 | (I.S) | N.2.22 |
| B7671 | (I.S) | N.2.23 |
| B7672 | (I.S) | N.2.24 |
| B7673 | (I.S) | N.2.25 |
| B7674 | (I.S) | N.2.26 |
| B7675 | (I.S) | N.2.27 |
| B7676 | (I.S) | N.2.28 |
| B7677 | (I.S) | N.2.29 |
| B7678 | (I.S) | N.2.30 |
| B7679 | (I.S) | N.2.31 |
| B7680 | (I.S) | N.2.32 |
| B7681 | (I.S) | N.2.33 |
| B7682 | (I.S) | N.2.34 |
| B7683 | (I.S) | N.2.35 |
| B7684 | (I.S) | N.2.36 |
| B7685 | (I.S) | N.2.37 |
| B7686 | (I.S) | N.2.38 |
| B7687 | (I.S) | N.2.39 |
| B7688 | (I.S) | N.2.40 |
| B7689 | (I.S) | N.2.41 |
| B7690 | (I.S) | N.2.42 |
| B7691 | (I.S) | N.2.43 |
| B7692 | (I.S) | N.2.44 |
| B7693 | (I.S) | N.2.45 |
| B7694 | (I.S) | N.2.46 |
| B7695 | (I.S) | N.2.47 |
| B7696 | (I.S) | N.2.48 |
| B7697 | (I.S) | N.2.49 |
| B7698 | (I.S) | N.2.50 |
| B7699 | (I.S) | N.2.51 |
| B7700 | (I.S) | N.2.52 |
| B7701 | (I.S) | N.2.53 |
| B7702 | (I.S) | N.2.54 |
| B7703 | (I.S) | N.2.55 |
| B7704 | (I.S) | N.2.56 |
| B7705 | (I.S) | N.2.57 |
| B7706 | (I.S) | N.2.58 |
| B7707 | (I.S) | N.2.59 |
| B7708 | (I.S) | N.2.60 |
| B7709 | (I.S) | N.2.61 |
| B7710 | (I.S) | N.2.62 |
| B7711 | (I.S) | N.2.63 |
| B7712 | (I.S) | N.2.64 |
| B7713 | (I.S) | N.2.65 |
| B7714 | (I.S) | N.2.66 |
| B7715 | (I.S) | N.2.67 |
| B7716 | (I.S) | N.2.68 |
| B7717 | (I.S) | N.2.69 |
| B7718 | (I.S) | N.2.70 |
| B7719 | (I.S) | N.2.71 |
| B7720 | (I.S) | N.2.72 |
| B7721 | (I.S) | N.2.73 |
| B7722 | (I.S) | N.2.74 |
| B7723 | (I.S) | N.2.75 |
| B7724 | (I.S) | N.2.76 |
| B7725 | (I.S) | N.2.77 |
| B7726 | (I.S) | N.2.78 |
| B7727 | (I.S) | N.2.79 |
| B7728 | (I.S) | N.2.80 |
| B7729 | (I.S) | N.2.81 |
| B7730 | (I.S) | N.2.82 |
| B7731 | (I.S) | N.2.83 |
| B7732 | (I.S) | N.2.84 |
| B7733 | (I.S) | N.3.1 |
| B7734 | (I.S) | N.3.2 |
| B7735 | (I.S) | N.3.3 |
| B7736 | (I.S) | N.3.4 |
| B7737 | (I.S) | N.3.5 |
| B7738 | (I.S) | N.3.6 |
| B7739 | (I.S) | N.3.7 |
| B7740 | (I.S) | N.3.8 |
| B7741 | (I.S) | N.3.9 |
| B7742 | (I.S) | N.3.10 |
| B7743 | (I.S) | N.3.11 |
| B7744 | (I.S) | N.3.12 |
| B7745 | (I.S) | N.3.13 |
| B7746 | (I.S) | N.3.14 |
| B7747 | (I.S) | N.3.15 |
| B7748 | (I.S) | N.3.16 |
| B7749 | (I.S) | N.3.17 |
| B7750 | (I.S) | N.3.18 |
| B7751 | (I.S) | N.3.19 |
| B7752 | (I.S) | N.3.20 |
| B7753 | (I.S) | N.3.21 |
| B7754 | (I.S) | N.3.22 |
| B7755 | (I.S) | N.3.23 |
| B7756 | (I.S) | N.3.24 |
| B7757 | (I.S) | N.3.25 |
| B7758 | (I.S) | N.3.26 |
| B7759 | (I.S) | N.3.27 |
| B7760 | (I.S) | N.3.28 |
| B7761 | (I.S) | N.3.29 |
| B7762 | (I.S) | N.3.30 |
| B7763 | (I.S) | N.3.31 |
| B7764 | (I.S) | N.3.32 |
| B7765 | (I.S) | N.3.33 |
| B7766 | (I.S) | N.3.34 |
| B7767 | (I.S) | N.3.35 |
| B7768 | (I.S) | N.3.36 |
| B7769 | (I.S) | N.3.37 |
| B7770 | (I.S) | N.3.38 |
| B7771 | (I.S) | N.3.39 |
| B7772 | (I.S) | N.3.40 |
| B7773 | (I.S) | N.3.41 |
| B7774 | (I.S) | N.3.42 |
| B7775 | (I.S) | N.3.43 |
| B7776 | (I.S) | N.3.44 |
| B7777 | (I.S) | N.3.45 |
| B7778 | (I.S) | N.3.46 |
| B7779 | (I.S) | N.3.47 |
| B7780 | (I.S) | N.3.48 |
| B7781 | (I.S) | N.3.49 |
| B7782 | (I.S) | N.3.50 |
| B7783 | (I.S) | N.3.51 |
| B7784 | (I.S) | N.3.52 |
| B7785 | (I.S) | N.3.53 |
| B7786 | (I.S) | N.3.54 |
| B7787 | (I.S) | N.3.55 |
| B7788 | (I.S) | N.3.56 |
| B7789 | (I.S) | N.3.57 |
| B7790 | (I.S) | N.3.58 |
| B7791 | (I.S) | N.3.59 |
| B7792 | (I.S) | N.3.60 |
| B7793 | (I.S) | N.3.61 |
| B7794 | (I.S) | N.3.62 |
| B7795 | (I.S) | N.3.63 |
| B7796 | (I.S) | N.3.64 |
| B7797 | (I.S) | N.3.65 |
| B7798 | (I.S) | N.3.66 |
| B7799 | (I.S) | N.3.67 |
| B7800 | (I.S) | N.3.68 |
| B7801 | (I.S) | N.3.69 |
| B7802 | (I.S) | N.4.1 |
| B7803 | (I.S) | N.4.2 |
| B7804 | (I.S) | N.4.3 |
| B7805 | (I.S) | N.4.4 |
| B7806 | (I.S) | N.4.5 |
| B7807 | (I.S) | N.4.6 |
| B7808 | (I.S) | N.4.7 |
| B7809 | (I.S) | N.4.8 |
| B7810 | (I.S) | N.4.9 |
| B7811 | (I.S) | N.4.10 |
| B7812 | (I.S) | N.4.11 |
| B7813 | (I.S) | N.4.12 |
| B7814 | (I.S) | N.4.13 |
| B7815 | (I.S) | N.4.14 |
| B7816 | (I.S) | N.4.15 |
| B7817 | (I.S) | N.4.16 |
| B7818 | (I.S) | N.4.17 |
| B7819 | (I.S) | N.4.18 |
| B7820 | (I.S) | N.4.19 |
| B7821 | (I.S) | N.4.20 |
| B7822 | (I.S) | N.4.21 |
| B7823 | (I.S) | N.4.22 |
| B7824 | (I.S) | N.4.23 |
| B7825 | (I.S) | N.4.24 |
| B7826 | (I.S) | N.4.25 |
| B7827 | (I.S) | N.4.26 |
| B7828 | (I.S) | N.4.27 |
| B7829 | (I.S) | N.4.28 |
| B7830 | (I.S) | N.4.29 |
| B7831 | (I.S) | N.4.30 |
| B7832 | (I.S) | N.4.31 |
| B7833 | (I.S) | N.4.32 |
| B7834 | (I.S) | N.4.33 |
| B7835 | (I.S) | N.4.34 |
| B7836 | (I.S) | N.4.35 |
| B7837 | (I.S) | N.4.36 |
| B7838 | (I.S) | N.4.37 |
| B7839 | (I.S) | N.4.38 |
| B7840 | (I.S) | N.4.39 |
| B7841 | (I.S) | N.4.40 |
| B7842 | (I.S) | N.4.41 |
| B7843 | (I.S) | N.4.42 |
| B7844 | (I.S) | N.4.43 |
| B7845 | (I.S) | N.4.44 |
| B7846 | (I.S) | N.4.45 |
| B7847 | (I.S) | N.4.46 |
| B7848 | (I.S) | N.4.47 |
| B7849 | (I.S) | N.5.1 |
| B7850 | (I.S) | N.5.2 |
| B7851 | (I.S) | N.5.3 |
| B7852 | (I.S) | N.5.4 |
| B7853 | (I.S) | N.5.5 |
| B7854 | (I.S) | N.5.6 |
| B7855 | (I.S) | N.5.7 |
| B7856 | (I.S) | N.5.8 |
| B7857 | (I.S) | N.5.9 |
| B7858 | (I.S) | N.5.10 |
| B7859 | (I.S) | N.5.11 |
| B7860 | (I.S) | N.5.12 |
| B7861 | (I.S) | N.5.13 |
| B7862 | (I.S) | N.5.14 |
| B7863 | (I.S) | N.5.15 |
| B7864 | (I.S) | N.5.16 |
| B7865 | (I.S) | N.5.17 |
| B7866 | (I.S) | N.5.18 |
| B7867 | (I.S) | N.5.19 |
| B7868 | (I.S) | N.5.20 |
| B7869 | (I.S) | N.5.21 |
| B7870 | (I.S) | N.5.22 |
| B7871 | (I.S) | N.5.23 |
| B7872 | (I.S) | N.5.24 |
| B7873 | (I.S) | N.5.25 |
| B7874 | (I.S) | N.5.26 |
| B7875 | (I.S) | N.5.27 |
| B7876 | (I.S) | N.6.1 |
| B7877 | (I.S) | N.6.2 |
| B7878 | (I.S) | N.6.3 |
| B7879 | (I.S) | N.6.4 |
| B7880 | (I.S) | N.7.1 |
| B7881 | (I.S) | N.7.2 |
| B7882 | (I.S) | N.7.3 |
| B7883 | (I.S) | N.7.4 |
| B7884 | (I.S) | N.7.5 |
| B7885 | (I.S) | N.8.1 |
| B7886 | (I.S) | N.9.1 |
| B7887 | (I.S) | N.9.2 |
| B7888 | (I.S) | N.9.3 |
| B7889 | (I.S) | N.9.4 |
| B7890 | (I.S) | N.9.5 |
| B7891 | (I.S) | N.9.6 |
| B7892 | (I.S) | N.9.7 |
| B7893 | (I.S) | N.9.8 |
| B7894 | (I.S) | N.9.9 |
| B7895 | (I.S) | N.9.10 |
| B7896 | (I.S) | N.9.11 |
| B7897 | (I.S) | N.9.12 |
| B7898 | (I.S) | N.9.13 |
| B7899 | (I.S) | N.9.14 |
| B7900 | (I.S) | N.9.15 |
| B7901 | (I.S) | N.9.16 |
| B7902 | (I.S) | N.9.17 |
| B7903 | (I.S) | N.9.18 |
| B7904 | (I.S) | N.9.19 |
| B7905 | (I.S) | N.9.20 |
| B7906 | (I.S) | N.9.21 |
| B7907 | (I.S) | N.9.22 |
| B7908 | (I.S) | N.9.23 |
| B7909 | (I.S) | N.9.24 |
| B7910 | (I.S) | N.9.25 |
| B7911 | (I.S) | N.9.26 |
| B7912 | (I.S) | N.10.1 |
| B7913 | (I.S) | N.10.2 |
| B7914 | (I.S) | N.10.3 |
| B7915 | (I.S) | N.10.4 |
| B7916 | (I.S) | N.10.5 |
| B7917 | (I.S) | N.10.6 |
| B7918 | (I.S) | N.10.7 |
| B7919 | (I.S) | N.10.8 |
| B7920 | (I.S) | N.10.9 |
| B7921 | (I.S) | N.10.10 |
| B7922 | (I.S) | N.10.12 |
| B7923 | (I.S) | N.10.13 |
| B7924 | (I.S) | N.10.14 |
| B7925 | (I.S) | N.10.15 |
| B7926 | (I.S) | N.10.16 |
| B7927 | (I.S) | N.10.17 |
| B7928 | (I.S) | N.10.18 |
| B7929 | (I.S) | N.10.19 |
| B7930 | (I.S) | N.10.20 |
| B7931 | (I.S) | N.10.21 |
| B7932 | (I.S) | N.10.22 |
| B7933 | (I.S) | N.10.23 |
| B7934 | (I.S) | N.10.24 |
| B7935 | (I.S) | N.10.25 |
| B7936 | (I.S) | N.10.26 |
| B7937 | (I.S) | N.10.27 |
| B7938 | (I.S) | N.10.28 |
| B7939 | (I.S) | N.10.29 |
| B7940 | (I.S) | N.10.30 |
| B7941 | (I.S) | N.10.31 |
| B7942 | (I.S) | N.10.32 |
| B7943 | (I.S) | N.10.33 |
| B7944 | (I.S) | N.10.34 |
| B7945 | (I.S) | N.10.35 |
| B7946 | (I.S) | N.10.36 |
| B7947 | (I.S) | N.11.1 |
| B7948 | (I.S) | N.11.2 |
| B7949 | (I.S) | N.11.3 |
| B7950 | (I.S) | N.11.4 |
| B7951 | (I.S) | N.11.5 |
| B7952 | (I.S) | N.11.6 |
| B7953 | (I.S) | N.11.7 |
| B7954 | (I.S) | N.12.1 |
| B7955 | (I.S) | N.12.2 |
| B7956 | (I.S) | N.12.3 |
| B7957 | (I.S) | N.13.1 |
| B7958 | (I.S) | N.13.2 |
| B7959 | (I.S) | N.13.3 |
| B7960 | (I.S) | N.13.4 |
| B7961 | (I.S) | N.13.5 |
| B7962 | (I.S) | N.13.6 |
| B7963 | (I.S) | N.13.7 |
| B7964 | (I.S) | N.13.8 |
| B7965 | (I.S) | N.13.9 |
| B7966 | (I.S) | N.13.10 |
| B7967 | (I.S) | N.13.11 |
| B7968 | (I.S) | N.13.12 |
| B7969 | (I.S) | N.13.13 |
| B7970 | (I.S) | N.13.14 |
| B7971 | (I.S) | N.13.15 |
| B7972 | (I.S) | N.13.16 |
| B7973 | (I.S) | N.13.17 |
| B7974 | (I.S) | N.13.18 |
| B7975 | (I.S) | N.13.19 |
| B7976 | (I.S) | N.13.20 |
| B7977 | (I.S) | N.13.21 |
| B7978 | (I.S) | N.13.22 |
| B7979 | (I.S) | N.13.23 |
| B7980 | (I.S) | N.13.24 |
| B7981 | (I.S) | N.13.25 |
| B7982 | (I.S) | N.13.26 |
| B7983 | (I.S) | N.13.27 |
| B7984 | (I.S) | N.13.28 |
| B7985 | (I.S) | N.13.29 |
| B7986 | (I.S) | N.13.30 |
| B7987 | (I.S) | N.13.31 |
| B7988 | (I.S) | N.13.32 |
| B7989 | (I.S) | N.14.1 |
| B7990 | (I.S) | N.14.2 |
| B7991 | (I.S) | N.14.3 |
| B7992 | (I.S) | N.14.4 |
| B7993 | (I.S) | N.15.1 |
| B7994 | (I.S) | N.15.2 |
| B7995 | (I.S) | N.15.3 |
| B7996 | (I.S) | N.15.4 |
| B7997 | (I.S) | N.15.5 |
| B7998 | (I.S) | N.15.6 |
| B7999 | (I.S) | N.15.7 |
| B8000 | (I.S) | N.15.8 |
| B8001 | (I.S) | N.15.9 |
| B8002 | (I.S) | N.15.10 |
| B8003 | (I.S) | N.15.11 |
| B8004 | (I.S) | N.15.12 |
| B8005 | (I.S) | N.15.13 |
| B8006 | (I.S) | N.15.14 |
| B8007 | (I.S) | N.15.15 |
| B8008 | (I.S) | N.15.16 |
| B8009 | (I.S) | N.15.17 |
| B8010 | (I.S) | N.15.18 |
| B8011 | (I.S) | N.15.19 |
| B8012 | (I.S) | N.15.20 |
| B8013 | (I.S) | N.15.21 |
| B8014 | (I.S) | N.15.22 |
| B8015 | (I.S) | N.15.23 |
| B8016 | (I.S) | N.15.24 |
| B8017 | (I.S) | N.15.25 |
| B8018 | (I.S) | N.15.26 |
| B8019 | (I.S) | N.15.27 |
| B8020 | (I.S) | N.15.28 |
| B8021 | (I.S) | N.15.29 |
| B8022 | (I.S) | N.15.30 |
| B8023 | (I.S) | N.15.31 |
| B8024 | (I.S) | N.15.32 |
| B8025 | (I.S) | N.15.33 |
| B8026 | (I.S) | N.15.34 |
| B8027 | (I.S) | N.15.35 |
| B8028 | (I.S) | N.15.36 |

TABLE 19
B = Mixture; I = compound I; II = compound II

| B | I | II |
|---|---|---|
| B8029 | (I.T) | N.1.1 |
| B8030 | (I.T) | N.1.2 |
| B8031 | (I.T) | N.1.3 |
| B8032 | (I.T) | N.1.4 |
| B8033 | (I.T) | N.1.5 |
| B8034 | (I.T) | N.1.6 |
| B8035 | (I.T) | N.1.7 |
| B8036 | (I.T) | N.1.8 |
| B8037 | (I.T) | N.1.9 |
| B8038 | (I.T) | N.1.10 |
| B8039 | (I.T) | N.1.11 |
| B8040 | (I.T) | N.1.12 |
| B8041 | (I.T) | N.1.13 |
| B8042 | (I.T) | N.1.14 |
| B8043 | (I.T) | N.1.15 |
| B8044 | (I.T) | N.1.16 |
| B8045 | (I.T) | N.1.17 |
| B8046 | (I.T) | N.1.18 |
| B8047 | (I.T) | N.1.19 |
| B8048 | (I.T) | N.1.20 |
| B8049 | (I.T) | N.1.21 |
| B8050 | (I.T) | N.1.22 |
| B8051 | (I.T) | N.1.23 |
| B8052 | (I.T) | N.1.24 |
| B8053 | (I.T) | N.1.25 |
| B8054 | (I.T) | N.1.26 |
| B8055 | (I.T) | N.1.27 |
| B8056 | (I.T) | N.1.28 |
| B8057 | (I.T) | N.1.29 |
| B8058 | (I.T) | N.1.30 |
| B8059 | (I.T) | N.1.31 |
| B8060 | (I.T) | N.1.32 |
| B8061 | (I.T) | N.1.33 |
| B8062 | (I.T) | N.1.34 |
| B8063 | (I.T) | N.1.35 |
| B8064 | (I.T) | N.1.36 |
| B8065 | (I.T) | N.1.37 |
| B8066 | (I.T) | N.1.38 |
| B8067 | (I.T) | N.1.39 |
| B8068 | (I.T) | N.1.40 |
| B8069 | (I.T) | N.1.41 |
| B8070 | (I.T) | N.1.42 |
| B8071 | (I.T) | N.1.43 |
| B8072 | (I.T) | N.1.44 |
| B8073 | (I.T) | N.1.45 |
| B8074 | (I.T) | N.1.46 |
| B8075 | (I.T) | N.1.47 |
| B8076 | (I.T) | N.1.48 |
| B8077 | (I.T) | N.1.49 |
| B8078 | (I.T) | N.1.50 |
| B8079 | (I.T) | N.1.51 |
| B8080 | (I.T) | N.1.52 |
| B8081 | (I.T) | N.1.53 |
| B8082 | (I.T) | N.1.54 |
| B8083 | (I.T) | N.1.55 |
| B8084 | (I.T) | N.1.56 |
| B8085 | (I.T) | N.1.57 |
| B8086 | (I.T) | N.1.58 |
| B8087 | (I.T) | N.1.59 |
| B8088 | (I.T) | N.1.60 |
| B8089 | (I.T) | N.1.61 |
| B8090 | (I.T) | N.1.62 |
| B8091 | (I.T) | N.1.63 |
| B8092 | (I.T) | N.1.64 |
| B8093 | (I.T) | N.1.65 |
| B8094 | (I.T) | N.1.66 |
| B8095 | (I.T) | N.2.1 |
| B8096 | (I.T) | N.2.2 |
| B8097 | (I.T) | N.2.3 |
| B8098 | (I.T) | N.2.4 |
| B8099 | (I.T) | N.2.5 |
| B8100 | (I.T) | N.2.6 |
| B8101 | (I.T) | N.2.7 |
| B8102 | (I.T) | N.2.8 |
| B8103 | (I.T) | N.2.9 |
| B8104 | (I.T) | N.2.10 |
| B8105 | (I.T) | N.2.11 |
| B8106 | (I.T) | N.2.12 |
| B8107 | (I.T) | N.2.13 |
| B8108 | (I.T) | N.2.14 |
| B8109 | (I.T) | N.2.15 |
| B8110 | (I.T) | N.2.16 |
| B8111 | (I.T) | N.2.17 |
| B8112 | (I.T) | N.2.18 |
| B8113 | (I.T) | N.2.19 |
| B8114 | (I.T) | N.2.20 |
| B8115 | (I.T) | N.2.21 |
| B8116 | (I.T) | N.2.22 |
| B8117 | (I.T) | N.2.23 |
| B8118 | (I.T) | N.2.24 |
| B8119 | (I.T) | N.2.25 |
| B8120 | (I.T) | N.2.26 |
| B8121 | (I.T) | N.2.27 |
| B8122 | (I.T) | N.2.28 |
| B8123 | (I.T) | N.2.29 |
| B8124 | (I.T) | N.2.30 |
| B8125 | (I.T) | N.2.31 |
| B8126 | (I.T) | N.2.32 |
| B8127 | (I.T) | N.2.33 |
| B8128 | (I.T) | N.2.34 |
| B8129 | (I.T) | N.2.35 |
| B8130 | (I.T) | N.2.36 |
| B8131 | (I.T) | N.2.37 |
| B8132 | (I.T) | N.2.38 |
| B8133 | (I.T) | N.2.39 |
| B8134 | (I.T) | N.2.40 |
| B8135 | (I.T) | N.2.41 |
| B8136 | (I.T) | N.2.42 |
| B8137 | (I.T) | N.2.43 |
| B8138 | (I.T) | N.2.44 |
| B8139 | (I.T) | N.2.45 |
| B8140 | (I.T) | N.2.46 |
| B8141 | (I.T) | N.2.47 |
| B8142 | (I.T) | N.2.48 |
| B8143 | (I.T) | N.2.49 |
| B8144 | (I.T) | N.2.50 |
| B8145 | (I.T) | N.2.51 |
| B8146 | (I.T) | N.2.52 |
| B8147 | (I.T) | N.2.53 |
| B8148 | (I.T) | N.2.54 |
| B8149 | (I.T) | N.2.55 |
| B8150 | (I.T) | N.2.56 |
| B8151 | (I.T) | N.2.57 |
| B8152 | (I.T) | N.2.58 |
| B8153 | (I.T) | N.2.59 |
| B8154 | (I.T) | N.2.60 |
| B8155 | (I.T) | N.2.61 |
| B8156 | (I.T) | N.2.62 |
| B8157 | (I.T) | N.2.63 |
| B8158 | (I.T) | N.2.64 |
| B8159 | (I.T) | N.2.65 |
| B8160 | (I.T) | N.2.66 |
| B8161 | (I.T) | N.2.67 |
| B8162 | (I.T) | N.2.68 |
| B8163 | (I.T) | N.2.69 |
| B8164 | (I.T) | N.2.70 |
| B8165 | (I.T) | N.2.71 |
| B8166 | (I.T) | N.2.72 |
| B8167 | (I.T) | N.2.73 |
| B8168 | (I.T) | N.2.74 |
| B8169 | (I.T) | N.2.75 |
| B8170 | (I.T) | N.2.76 |
| B8171 | (I.T) | N.2.77 |
| B8172 | (I.T) | N.2.78 |
| B8173 | (I.T) | N.2.79 |
| B8174 | (I.T) | N.2.80 |
| B8175 | (I.T) | N.2.81 |
| B8176 | (I.T) | N.2.82 |
| B8177 | (I.T) | N.2.83 |
| B8178 | (I.T) | N.2.84 |
| B8179 | (I.T) | N.3.1 |
| B8180 | (I.T) | N.3.2 |
| B8181 | (I.T) | N.3.3 |
| B8182 | (I.T) | N.3.4 |
| B8183 | (I.T) | N.3.5 |
| B8184 | (I.T) | N.3.6 |
| B8185 | (I.T) | N.3.7 |
| B8186 | (I.T) | N.3.8 |
| B8187 | (I.T) | N.3.9 |
| B8188 | (I.T) | N.3.10 |
| B8189 | (I.T) | N.3.11 |
| B8190 | (I.T) | N.3.12 |
| B8191 | (I.T) | N.3.13 |
| B8192 | (I.T) | N.3.14 |
| B8193 | (I.T) | N.3.15 |
| B8194 | (I.T) | N.3.16 |
| B8195 | (I.T) | N.3.17 |
| B8196 | (I.T) | N.3.18 |
| B8197 | (I.T) | N.3.19 |
| B8198 | (I.T) | N.3.20 |
| B8199 | (I.T) | N.3.21 |
| B8200 | (I.T) | N.3.22 |
| B8201 | (I.T) | N.3.23 |
| B8202 | (I.T) | N.3.24 |
| B8203 | (I.T) | N.3.25 |
| B8204 | (I.T) | N.3.26 |
| B8205 | (I.T) | N.3.27 |
| B8206 | (I.T) | N.3.28 |
| B8207 | (I.T) | N.3.29 |
| B8208 | (I.T) | N.3.30 |
| B8209 | (I.T) | N.3.31 |
| B8210 | (I.T) | N.3.32 |
| B8211 | (I.T) | N.3.33 |
| B8212 | (I.T) | N.3.34 |
| B8213 | (I.T) | N.3.35 |
| B8214 | (I.T) | N.3.36 |
| B8215 | (I.T) | N.3.37 |
| B8216 | (I.T) | N.3.38 |
| B8217 | (I.T) | N.3.39 |
| B8218 | (I.T) | N.3.40 |
| B8219 | (I.T) | N.3.41 |
| B8220 | (I.T) | N.3.42 |
| B8221 | (I.T) | N.3.43 |
| B8222 | (I.T) | N.3.44 |
| B8223 | (I.T) | N.3.45 |
| B8224 | (I.T) | N.3.46 |
| B8225 | (I.T) | N.3.47 |
| B8226 | (I.T) | N.3.48 |
| B8227 | (I.T) | N.3.49 |
| B8228 | (I.T) | N.3.50 |
| B8229 | (I.T) | N.3.51 |
| B8230 | (I.T) | N.3.52 |
| B8231 | (I.T) | N.3.53 |
| B8232 | (I.T) | N.3.54 |
| B8233 | (I.T) | N.3.55 |
| B8234 | (I.T) | N.3.56 |
| B8235 | (I.T) | N.3.57 |
| B8236 | (I.T) | N.3.58 |
| B8237 | (I.T) | N.3.59 |
| B8238 | (I.T) | N.3.60 |
| B8239 | (I.T) | N.3.61 |
| B8240 | (I.T) | N.3.62 |
| B8241 | (I.T) | N.3.63 |
| B8242 | (I.T) | N.3.64 |
| B8243 | (I.T) | N.3.65 |
| B8244 | (I.T) | N.3.66 |
| B8245 | (I.T) | N.3.67 |
| B8246 | (I.T) | N.3.68 |
| B8247 | (I.T) | N.3.69 |
| B8248 | (I.T) | N.4.1 |
| B8249 | (I.T) | N.4.2 |
| B8250 | (I.T) | N.4.3 |
| B8251 | (I.T) | N.4.4 |
| B8252 | (I.T) | N.4.5 |
| B8253 | (I.T) | N.4.6 |
| B8254 | (I.T) | N.4.7 |
| B8255 | (I.T) | N.4.8 |
| B8256 | (I.T) | N.4.9 |
| B8257 | (I.T) | N.4.10 |
| B8258 | (I.T) | N.4.11 |
| B8259 | (I.T) | N.4.12 |
| B8260 | (I.T) | N.4.13 |
| B8261 | (I.T) | N.4.14 |
| B8262 | (I.T) | N.4.15 |
| B8263 | (I.T) | N.4.16 |
| B8264 | (I.T) | N.4.17 |
| B8265 | (I.T) | N.4.18 |
| B8266 | (I.T) | N.4.19 |
| B8267 | (I.T) | N.4.20 |
| B8268 | (I.T) | N.4.21 |
| B8269 | (I.T) | N.4.22 |
| B8270 | (I.T) | N.4.23 |
| B8271 | (I.T) | N.4.24 |
| B8272 | (I.T) | N.4.25 |
| B8273 | (I.T) | N.4.26 |
| B8274 | (I.T) | N.4.27 |
| B8275 | (I.T) | N.4.28 |
| B8276 | (I.T) | N.4.29 |
| B8277 | (I.T) | N.4.30 |
| B8278 | (I.T) | N.4.31 |
| B8279 | (I.T) | N.4.32 |
| B8280 | (I.T) | N.4.33 |
| B8281 | (I.T) | N.4.34 |
| B8282 | (I.T) | N.4.35 |
| B8283 | (I.T) | N.4.36 |
| B8284 | (I.T) | N.4.37 |
| B8285 | (I.T) | N.4.38 |
| B8286 | (I.T) | N.4.39 |
| B8287 | (I.T) | N.4.40 |
| B8288 | (I.T) | N.4.41 |
| B8289 | (I.T) | N.4.42 |
| B8290 | (I.T) | N.4.43 |
| B8291 | (I.T) | N.4.44 |
| B8292 | (I.T) | N.4.45 |
| B8293 | (I.T) | N.4.46 |
| B8294 | (I.T) | N.4.47 |
| B8295 | (I.T) | N.5.1 |
| B8296 | (I.T) | N.5.2 |
| B8297 | (I.T) | N.5.3 |
| B8298 | (I.T) | N.5.4 |
| B8299 | (I.T) | N.5.5 |
| B8300 | (I.T) | N.5.6 |
| B8301 | (I.T) | N.5.7 |
| B8302 | (I.T) | N.5.8 |
| B8303 | (I.T) | N.5.9 |
| B8304 | (I.T) | N.5.10 |
| B8305 | (I.T) | N.5.11 |
| B8306 | (I.T) | N.5.12 |
| B8307 | (I.T) | N.5.13 |
| B8308 | (I.T) | N.5.14 |
| B8309 | (I.T) | N.5.15 |
| B8310 | (I.T) | N.5.16 |
| B8311 | (I.T) | N.5.17 |
| B8312 | (I.T) | N.5.18 |
| B8313 | (I.T) | N.5.19 |
| B8314 | (I.T) | N.5.20 |
| B8315 | (I.T) | N.5.21 |
| B8316 | (I.T) | N.5.22 |
| B8317 | (I.T) | N.5.23 |
| B8318 | (I.T) | N.5.24 |
| B8319 | (I.T) | N.5.25 |
| B8320 | (I.T) | N.5.26 |
| B8321 | (I.T) | N.5.27 |
| B8322 | (I.T) | N.6.1 |
| B8323 | (I.T) | N.6.2 |
| B8324 | (I.T) | N.6.3 |
| B8325 | (I.T) | N.6.4 |
| B8326 | (I.T) | N.7.1 |
| B8327 | (I.T) | N.7.2 |
| B8328 | (I.T) | N.7.3 |
| B8329 | (I.T) | N.7.4 |
| B8330 | (I.T) | N.7.5 |
| B8331 | (I.T) | N.8.1 |
| B8332 | (I.T) | N.9.1 |
| B8333 | (I.T) | N.9.2 |
| B8334 | (I.T) | N.9.3 |
| B8335 | (I.T) | N.9.4 |
| B8336 | (I.T) | N.9.5 |
| B8337 | (I.T) | N.9.6 |
| B8338 | (I.T) | N.9.7 |
| B8339 | (I.T) | N.9.8 |
| B8340 | (I.T) | N.9.9 |
| B8341 | (I.T) | N.9.10 |
| B8342 | (I.T) | N.9.11 |
| B8343 | (I.T) | N.9.12 |
| B8344 | (I.T) | N.9.13 |
| B8345 | (I.T) | N.9.14 |
| B8346 | (I.T) | N.9.15 |
| B8347 | (I.T) | N.9.16 |
| B8348 | (I.T) | N.9.17 |
| B8349 | (I.T) | N.9.18 |
| B8350 | (I.T) | N.9.19 |
| B8351 | (I.T) | N.9.20 |
| B8352 | (I.T) | N.9.21 |
| B8353 | (I.T) | N.9.22 |
| B8354 | (I.T) | N.9.23 |
| B8355 | (I.T) | N.9.24 |
| B8356 | (I.T) | N.9.25 |
| B8357 | (I.T) | N.9.26 |
| B8358 | (I.T) | N.10.1 |
| B8359 | (I.T) | N.10.2 |
| B8360 | (I.T) | N.10.3 |
| B8361 | (I.T) | N.10.4 |
| B8362 | (I.T) | N.10.5 |
| B8363 | (I.T) | N.10.6 |
| B8364 | (I.T) | N.10.7 |
| B8365 | (I.T) | N.10.8 |
| B8366 | (I.T) | N.10.9 |
| B8367 | (I.T) | N.10.10 |
| B8368 | (I.T) | N.10.12 |
| B8369 | (I.T) | N.10.13 |
| B8370 | (I.T) | N.10.14 |
| B8371 | (I.T) | N.10.15 |
| B8372 | (I.T) | N.10.16 |
| B8373 | (I.T) | N.10.17 |
| B8374 | (I.T) | N.10.18 |
| B8375 | (I.T) | N.10.19 |
| B8376 | (I.T) | N.10.20 |
| B8377 | (I.T) | N.10.21 |
| B8378 | (I.T) | N.10.22 |
| B8379 | (I.T) | N.10.23 |
| B8380 | (I.T) | N.10.24 |
| B8381 | (I.T) | N.10.25 |
| B8382 | (I.T) | N.10.26 |
| B8383 | (I.T) | N.10.27 |
| B8384 | (I.T) | N.10.28 |
| B8385 | (I.T) | N.10.29 |
| B8386 | (I.T) | N.10.30 |
| B8387 | (I.T) | N.10.31 |
| B8388 | (I.T) | N.10.32 |
| B8389 | (I.T) | N.10.33 |
| B8390 | (I.T) | N.10.34 |
| B8391 | (I.T) | N.10.35 |
| B8392 | (I.T) | N.10.36 |
| B8393 | (I.T) | N.11.1 |
| B8394 | (I.T) | N.11.2 |
| B8395 | (I.T) | N.11.3 |
| B8396 | (I.T) | N.11.4 |
| B8397 | (I.T) | N.11.5 |
| B8398 | (I.T) | N.11.6 |
| B8399 | (I.T) | N.11.7 |
| B8400 | (I.T) | N.12.1 |
| B8401 | (I.T) | N.12.2 |
| B8402 | (I.T) | N.12.3 |
| B8403 | (I.T) | N.13.1 |
| B8404 | (I.T) | N.13.2 |
| B8405 | (I.T) | N.13.3 |
| B8406 | (I.T) | N.13.4 |
| B8407 | (I.T) | N.13.5 |
| B8408 | (I.T) | N.13.6 |
| B8409 | (I.T) | N.13.7 |
| B8410 | (I.T) | N.13.8 |
| B8411 | (I.T) | N.13.9 |
| B8412 | (I.T) | N.13.10 |
| B8413 | (I.T) | N.13.11 |
| B8414 | (I.T) | N.13.12 |
| B8415 | (I.T) | N.13.13 |
| B8416 | (I.T) | N.13.14 |
| B8417 | (I.T) | N.13.15 |
| B8418 | (I.T) | N.13.16 |
| B8419 | (I.T) | N.13.17 |
| B8420 | (I.T) | N.13.18 |
| B8421 | (I.T) | N.13.19 |
| B8422 | (I.T) | N.13.20 |
| B8423 | (I.T) | N.13.21 |
| B8424 | (I.T) | N.13.22 |
| B8425 | (I.T) | N.13.23 |
| B8426 | (I.T) | N.13.24 |
| B8427 | (I.T) | N.13.25 |
| B8428 | (I.T) | N.13.26 |
| B8429 | (I.T) | N.13.27 |
| B8430 | (I.T) | N.13.28 |
| B8431 | (I.T) | N.13.29 |
| B8432 | (I.T) | N.13.30 |
| B8433 | (I.T) | N.13.31 |
| B8434 | (I.T) | N.13.32 |
| B8435 | (I.T) | N.14.1 |
| B8436 | (I.T) | N.14.2 |
| B8437 | (I.T) | N.14.3 |
| B8438 | (I.T) | N.14.4 |
| B8439 | (I.T) | N.15.1 |
| B8440 | (I.T) | N.15.2 |
| B8441 | (I.T) | N.15.3 |
| B8442 | (I.T) | N.15.4 |
| B8443 | (I.T) | N.15.5 |
| B8444 | (I.T) | N.15.6 |
| B8445 | (I.T) | N.15.7 |
| B8446 | (I.T) | N.15.8 |
| B8447 | (I.T) | N.15.9 |
| B8448 | (I.T) | N.15.10 |
| B8449 | (I.T) | N.15.11 |
| B8450 | (I.T) | N.15.12 |
| B8451 | (I.T) | N.15.13 |
| B8452 | (I.T) | N.15.14 |
| B8453 | (I.T) | N.15.15 |
| B8454 | (I.T) | N.15.16 |
| B8455 | (I.T) | N.15.17 |
| B8456 | (I.T) | N.15.18 |
| B8457 | (I.T) | N.15.19 |
| B8458 | (I.T) | N.15.20 |
| B8459 | (I.T) | N.15.21 |
| B8460 | (I.T) | N.15.22 |
| B8461 | (I.T) | N.15.23 |
| B8462 | (I.T) | N.15.24 |
| B8463 | (I.T) | N.15.25 |
| B8464 | (I.T) | N.15.26 |
| B8465 | (I.T) | N.15.27 |
| B8466 | (I.T) | N.15.28 |
| B8467 | (I.T) | N.15.29 |
| B8468 | (I.T) | N.15.30 |
| B8469 | (I.T) | N.15.31 |
| B8470 | (I.T) | N.15.32 |
| B8471 | (I.T) | N.15.33 |
| B8472 | (I.T) | N.15.34 |
| B8473 | (I.T) | N.15.35 |
| B8474 | (I.T) | N.15.36 |

TABLE 20
B = Mixture; I = compound I; II = compound II

| B | I | II |
|---|---|---|
| B8475 | (I.U) | N.1.1 |
| B8476 | (I.U) | N.1.2 |
| B8477 | (I.U) | N.1.3 |
| B8478 | (I.U) | N.1.4 |
| B8479 | (I.U) | N.1.5 |
| B8480 | (I.U) | N.1.6 |
| B8481 | (I.U) | N.1.7 |
| B8482 | (I.U) | N.1.8 |
| B8483 | (I.U) | N.1.9 |
| B8484 | (I.U) | N.1.10 |
| B8485 | (I.U) | N.1.11 |
| B8486 | (I.U) | N.1.12 |
| B8487 | (I.U) | N.1.13 |
| B8488 | (I.U) | N.1.14 |
| B8489 | (I.U) | N.1.15 |
| B8490 | (I.U) | N.1.16 |
| B8491 | (I.U) | N.1.17 |
| B8492 | (I.U) | N.1.18 |
| B8493 | (I.U) | N.1.19 |
| B8494 | (I.U) | N.1.20 |
| B8495 | (I.U) | N.1.21 |
| B8496 | (I.U) | N.1.22 |
| B8497 | (I.U) | N.1.23 |
| B8498 | (I.U) | N.1.24 |
| B8499 | (I.U) | N.1.25 |
| B8500 | (I.U) | N.1.26 |
| B8501 | (I.U) | N.1.27 |
| B8502 | (I.U) | N.1.28 |
| B8503 | (I.U) | N.1.29 |
| B8504 | (I.U) | N.1.30 |
| B8505 | (I.U) | N.1.31 |
| B8506 | (I.U) | N.1.32 |
| B8507 | (I.U) | N.1.33 |
| B8508 | (I.U) | N.1.34 |
| B8509 | (I.U) | N.1.35 |
| B8510 | (I.U) | N.1.36 |
| B8511 | (I.U) | N.1.37 |
| B8512 | (I.U) | N.1.38 |
| B8513 | (I.U) | N.1.39 |
| B8514 | (I.U) | N.1.40 |
| B8515 | (I.U) | N.1.41 |
| B8516 | (I.U) | N.1.42 |
| B8517 | (I.U) | N.1.43 |
| B8518 | (I.U) | N.1.44 |
| B8519 | (I.U) | N.1.45 |
| B8520 | (I.U) | N.1.46 |
| B8521 | (I.U) | N.1.47 |
| B8522 | (I.U) | N.1.48 |
| B8523 | (I.U) | N.1.49 |
| B8524 | (I.U) | N.1.50 |
| B8525 | (I.U) | N.1.51 |
| B8526 | (I.U) | N.1.52 |
| B8527 | (I.U) | N.1.53 |
| B8528 | (I.U) | N.1.54 |
| B8529 | (I.U) | N.1.55 |
| B8530 | (I.U) | N.1.56 |
| B8531 | (I.U) | N.1.57 |
| B8532 | (I.U) | N.1.58 |
| B8533 | (I.U) | N.1.59 |
| B8534 | (I.U) | N.1.60 |
| B8535 | (I.U) | N.1.61 |
| B8536 | (I.U) | N.1.62 |
| B8537 | (I.U) | N.1.63 |
| B8538 | (I.U) | N.1.64 |
| B8539 | (I.U) | N.1.65 |
| B8540 | (I.U) | N.1.66 |
| B8541 | (I.U) | N.2.1 |
| B8542 | (I.U) | N.2.2 |
| B8543 | (I.U) | N.2.3 |
| B8544 | (I.U) | N.2.4 |
| B8545 | (I.U) | N.2.5 |
| B8546 | (I.U) | N.2.6 |
| B8547 | (I.U) | N.2.7 |
| B8548 | (I.U) | N.2.8 |
| B8549 | (I.U) | N.2.9 |
| B8550 | (I.U) | N.2.10 |
| B8551 | (I.U) | N.2.11 |
| B8552 | (I.U) | N.2.12 |
| B8553 | (I.U) | N.2.13 |
| B8554 | (I.U) | N.2.14 |
| B8555 | (I.U) | N.2.15 |
| B8556 | (I.U) | N.2.16 |
| B8557 | (I.U) | N.2.17 |
| B8558 | (I.U) | N.2.18 |
| B8559 | (I.U) | N.2.19 |
| B8560 | (I.U) | N.2.20 |
| B8561 | (I.U) | N.2.21 |
| B8562 | (I.U) | N.2.22 |
| B8563 | (I.U) | N.2.23 |
| B8564 | (I.U) | N.2.24 |
| B8565 | (I.U) | N.2.25 |
| B8566 | (I.U) | N.2.26 |
| B8567 | (I.U) | N.2.27 |
| B8568 | (I.U) | N.2.28 |
| B8569 | (I.U) | N.2.29 |
| B8570 | (I.U) | N.2.30 |
| B8571 | (I.U) | N.2.31 |
| B8572 | (I.U) | N.2.32 |
| B8573 | (I.U) | N.2.33 |
| B8574 | (I.U) | N.2.34 |
| B8575 | (I.U) | N.2.35 |
| B8576 | (I.U) | N.2.36 |
| B8577 | (I.U) | N.2.37 |
| B8578 | (I.U) | N.2.38 |
| B8579 | (I.U) | N.2.39 |
| B8580 | (I.U) | N.2.40 |
| B8581 | (I.U) | N.2.41 |
| B8582 | (I.U) | N.2.42 |
| B8583 | (I.U) | N.2.43 |
| B8584 | (I.U) | N.2.44 |
| B8585 | (I.U) | N.2.45 |
| B8586 | (I.U) | N.2.46 |
| B8587 | (I.U) | N.2.47 |
| B8588 | (I.U) | N.2.48 |
| B8589 | (I.U) | N.2.49 |
| B8590 | (I.U) | N.2.50 |
| B8591 | (I.U) | N.2.51 |
| B8592 | (I.U) | N.2.52 |
| B8593 | (I.U) | N.2.53 |
| B8594 | (I.U) | N.2.54 |
| B8595 | (I.U) | N.2.55 |
| B8596 | (I.U) | N.2.56 |
| B8597 | (I.U) | N.2.57 |
| B8598 | (I.U) | N.2.58 |
| B8599 | (I.U) | N.2.59 |
| B8600 | (I.U) | N.2.60 |
| B8601 | (I.U) | N.2.61 |
| B8602 | (I.U) | N.2.62 |
| B8603 | (I.U) | N.2.63 |
| B8604 | (I.U) | N.2.64 |
| B8605 | (I.U) | N.2.65 |
| B8606 | (I.U) | N.2.66 |
| B8607 | (I.U) | N.2.67 |
| B8608 | (I.U) | N.2.68 |
| B8609 | (I.U) | N.2.69 |
| B8610 | (I.U) | N.2.70 |
| B8611 | (I.U) | N.2.71 |
| B8612 | (I.U) | N.2.72 |
| B8613 | (I.U) | N.2.73 |
| B8614 | (I.U) | N.2.74 |
| B8615 | (I.U) | N.2.75 |
| B8616 | (I.U) | N.2.76 |
| B8617 | (I.U) | N.2.77 |
| B8618 | (I.U) | N.2.78 |
| B8619 | (I.U) | N.2.79 |
| B8620 | (I.U) | N.2.80 |
| B8621 | (I.U) | N.2.81 |
| B8622 | (I.U) | N.2.82 |
| B8623 | (I.U) | N.2.83 |
| B8624 | (I.U) | N.2.84 |
| B8625 | (I.U) | N.3.1 |
| B8626 | (I.U) | N.3.2 |
| B8627 | (I.U) | N.3.3 |
| B8628 | (I.U) | N.3.4 |
| B8629 | (I.U) | N.3.5 |
| B8630 | (I.U) | N.3.6 |
| B8631 | (I.U) | N.3.7 |
| B8632 | (I.U) | N.3.8 |
| B8633 | (I.U) | N.3.9 |
| B8634 | (I.U) | N.3.10 |
| B8635 | (I.U) | N.3.11 |
| B8636 | (I.U) | N.3.12 |
| B8637 | (I.U) | N.3.13 |
| B8638 | (I.U) | N.3.14 |
| B8639 | (I.U) | N.3.15 |
| B8640 | (I.U) | N.3.16 |
| B8641 | (I.U) | N.3.17 |
| B8642 | (I.U) | N.3.18 |
| B8643 | (I.U) | N.3.19 |
| B8644 | (I.U) | N.3.20 |
| B8645 | (I.U) | N.3.21 |
| B8646 | (I.U) | N.3.22 |
| B8647 | (I.U) | N.3.23 |
| B8648 | (I.U) | N.3.24 |
| B8649 | (I.U) | N.3.25 |
| B8650 | (I.U) | N.3.26 |
| B8651 | (I.U) | N.3.27 |
| B8652 | (I.U) | N.3.28 |
| B8653 | (I.U) | N.3.29 |
| B8654 | (I.U) | N.3.30 |
| B8655 | (I.U) | N.3.31 |
| B8656 | (I.U) | N.3.32 |
| B8657 | (I.U) | N.3.33 |
| B8658 | (I.U) | N.3.34 |
| B8659 | (I.U) | N.3.35 |
| B8660 | (I.U) | N.3.36 |
| B8661 | (I.U) | N.3.37 |
| B8662 | (I.U) | N.3.38 |
| B8663 | (I.U) | N.3.39 |
| B8664 | (I.U) | N.3.40 |
| B8665 | (I.U) | N.3.41 |
| B8666 | (I.U) | N.3.42 |
| B8667 | (I.U) | N.3.43 |
| B8668 | (I.U) | N.3.44 |
| B8669 | (I.U) | N.3.45 |
| B8670 | (I.U) | N.3.46 |
| B8671 | (I.U) | N.3.47 |
| B8672 | (I.U) | N.3.48 |
| B8673 | (I.U) | N.3.49 |
| B8674 | (I.U) | N.3.50 |
| B8675 | (I.U) | N.3.51 |
| B8676 | (I.U) | N.3.52 |
| B8677 | (I.U) | N.3.53 |
| B8678 | (I.U) | N.3.54 |
| B8679 | (I.U) | N.3.55 |
| B8680 | (I.U) | N.3.56 |
| B8681 | (I.U) | N.3.57 |
| B8682 | (I.U) | N.3.58 |
| B8683 | (I.U) | N.3.59 |
| B8684 | (I.U) | N.3.60 |
| B8685 | (I.U) | N.3.61 |
| B8686 | (I.U) | N.3.62 |
| B8687 | (I.U) | N.3.63 |
| B8688 | (I.U) | N.3.64 |
| B8689 | (I.U) | N.3.65 |
| B8690 | (I.U) | N.3.66 |
| B8691 | (I.U) | N.3.67 |
| B8692 | (I.U) | N.3.68 |
| B8693 | (I.U) | N.3.69 |
| B8694 | (I.U) | N.4.1 |
| B8695 | (I.U) | N.4.2 |
| B8696 | (I.U) | N.4.3 |
| B8697 | (I.U) | N.4.4 |
| B8698 | (I.U) | N.4.5 |
| B8699 | (I.U) | N.4.6 |
| B8700 | (I.U) | N.4.7 |
| B8701 | (I.U) | N.4.8 |
| B8702 | (I.U) | N.4.9 |
| B8703 | (I.U) | N.4.10 |
| B8704 | (I.U) | N.4.11 |
| B8705 | (I.U) | N.4.12 |
| B8706 | (I.U) | N.4.13 |
| B8707 | (I.U) | N.4.14 |
| B8708 | (I.U) | N.4.15 |
| B8709 | (I.U) | N.4.16 |
| B8710 | (I.U) | N.4.17 |
| B8711 | (I.U) | N.4.18 |
| B8712 | (I.U) | N.4.19 |
| B8713 | (I.U) | N.4.20 |
| B8714 | (I.U) | N.4.21 |
| B8715 | (I.U) | N.4.22 |
| B8716 | (I.U) | N.4.23 |
| B8717 | (I.U) | N.4.24 |
| B8718 | (I.U) | N.4.25 |
| B8719 | (I.U) | N.4.26 |
| B8720 | (I.U) | N.4.27 |
| B8721 | (I.U) | N.4.28 |
| B8722 | (I.U) | N.4.29 |
| B8723 | (I.U) | N.4.30 |
| B8724 | (I.U) | N.4.31 |
| B8725 | (I.U) | N.4.32 |
| B8726 | (I.U) | N.4.33 |
| B8727 | (I.U) | N.4.34 |
| B8728 | (I.U) | N.4.35 |
| B8729 | (I.U) | N.4.36 |
| B8730 | (I.U) | N.4.37 |
| B8731 | (I.U) | N.4.38 |
| B8732 | (I.U) | N.4.39 |
| B8733 | (I.U) | N.4.40 |
| B8734 | (I.U) | N.4.41 |
| B8735 | (I.U) | N.4.42 |
| B8736 | (I.U) | N.4.43 |
| B8737 | (I.U) | N.4.44 |
| B8738 | (I.U) | N.4.45 |
| B8739 | (I.U) | N.4.46 |
| B8740 | (I.U) | N.4.47 |
| B8741 | (I.U) | N.5.1 |
| B8742 | (I.U) | N.5.2 |
| B8743 | (I.U) | N.5.3 |
| B8744 | (I.U) | N.5.4 |
| B8745 | (I.U) | N.5.5 |
| B8746 | (I.U) | N.5.6 |
| B8747 | (I.U) | N.5.7 |
| B8748 | (I.U) | N.5.8 |
| B8749 | (I.U) | N.5.9 |
| B8750 | (I.U) | N.5.10 |
| B8751 | (I.U) | N.5.11 |
| B8752 | (I.U) | N.5.12 |
| B8753 | (I.U) | N.5.13 |
| B8754 | (I.U) | N.5.14 |
| B8755 | (I.U) | N.5.15 |
| B8756 | (I.U) | N.5.16 |
| B8757 | (I.U) | N.5.17 |
| B8758 | (I.U) | N.5.18 |
| B8759 | (I.U) | N.5.19 |
| B8760 | (I.U) | N.5.20 |
| B8761 | (I.U) | N.5.21 |
| B8762 | (I.U) | N.5.22 |
| B8763 | (I.U) | N.5.23 |
| B8764 | (I.U) | N.5.24 |
| B8765 | (I.U) | N.5.25 |
| B8766 | (I.U) | N.5.26 |
| B8767 | (I.U) | N.5.27 |
| B8768 | (I.U) | N.6.1 |
| B8769 | (I.U) | N.6.2 |
| B8770 | (I.U) | N.6.3 |
| B8771 | (I.U) | N.6.4 |
| B8772 | (I.U) | N.7.1 |
| B8773 | (I.U) | N.7.2 |
| B8774 | (I.U) | N.7.3 |
| B8775 | (I.U) | N.7.4 |
| B8776 | (I.U) | N.7.5 |
| B8777 | (I.U) | N.8.1 |
| B8778 | (I.U) | N.9.1 |
| B8779 | (I.U) | N.9.2 |
| B8780 | (I.U) | N.9.3 |
| B8781 | (I.U) | N.9.4 |
| B8782 | (I.U) | N.9.5 |
| B8783 | (I.U) | N.9.6 |
| B8784 | (I.U) | N.9.7 |
| B8785 | (I.U) | N.9.8 |
| B8786 | (I.U) | N.9.9 |
| B8787 | (I.U) | N.9.10 |
| B8788 | (I.U) | N.9.11 |
| B8789 | (I.U) | N.9.12 |
| B8790 | (I.U) | N.9.13 |
| B8791 | (I.U) | N.9.14 |
| B8792 | (I.U) | N.9.15 |
| B8793 | (I.U) | N.9.16 |
| B8794 | (I.U) | N.9.17 |
| B8795 | (I.U) | N.9.18 |
| B8796 | (I.U) | N.9.19 |
| B8797 | (I.U) | N.9.20 |
| B8798 | (I.U) | N.9.21 |
| B8799 | (I.U) | N.9.22 |
| B8800 | (I.U) | N.9.23 |
| B8801 | (I.U) | N.9.24 |
| B8802 | (I.U) | N.9.25 |
| B8803 | (I.U) | N.9.26 |
| B8804 | (I.U) | N.10.1 |
| B8805 | (I.U) | N.10.2 |
| B8806 | (I.U) | N.10.3 |
| B8807 | (I.U) | N.10.4 |
| B8808 | (I.U) | N.10.5 |
| B8809 | (I.U) | N.10.6 |
| B8810 | (I.U) | N.10.7 |
| B8811 | (I.U) | N.10.8 |
| B8812 | (I.U) | N.10.9 |
| B8813 | (I.U) | N.10.10 |
| B8814 | (I.U) | N.10.12 |
| B8815 | (I.U) | N.10.13 |
| B8816 | (I.U) | N.10.14 |
| B8817 | (I.U) | N.10.15 |
| B8818 | (I.U) | N.10.16 |
| B8819 | (I.U) | N.10.17 |
| B8820 | (I.U) | N.10.18 |
| B8821 | (I.U) | N.10.19 |
| B8822 | (I.U) | N.10.20 |
| B8823 | (I.U) | N.10.21 |
| B8824 | (I.U) | N.10.22 |
| B8825 | (I.U) | N.10.23 |
| B8826 | (I.U) | N.10.24 |
| B8827 | (I.U) | N.10.25 |
| B8828 | (I.U) | N.10.26 |
| B8829 | (I.U) | N.10.27 |
| B8830 | (I.U) | N.10.28 |
| B8831 | (I.U) | N.10.29 |
| B8832 | (I.U) | N.10.30 |
| B8833 | (I.U) | N.10.31 |
| B8834 | (I.U) | N.10.32 |
| B8835 | (I.U) | N.10.33 |
| B8836 | (I.U) | N.10.34 |
| B8837 | (I.U) | N.10.35 |
| B8838 | (I.U) | N.10.36 |
| B8839 | (I.U) | N.11.1 |
| B8840 | (I.U) | N.11.2 |
| B8841 | (I.U) | N.11.3 |
| B8842 | (I.U) | N.11.4 |
| B8843 | (I.U) | N.11.5 |
| B8844 | (I.U) | N.11.6 |
| B8845 | (I.U) | N.11.7 |
| B8846 | (I.U) | N.12.1 |
| B8847 | (I.U) | N.12.2 |
| B8848 | (I.U) | N.12.3 |
| B8849 | (I.U) | N.13.1 |
| B8850 | (I.U) | N.13.2 |
| B8851 | (I.U) | N.13.3 |
| B8852 | (I.U) | N.13.4 |
| B8853 | (I.U) | N.13.5 |
| B8854 | (I.U) | N.13.6 |
| B8855 | (I.U) | N.13.7 |
| B8856 | (I.U) | N.13.8 |
| B8857 | (I.U) | N.13.9 |
| B8858 | (I.U) | N.13.10 |
| B8859 | (I.U) | N.13.11 |
| B8860 | (I.U) | N.13.12 |
| B8861 | (I.U) | N.13.13 |
| B8862 | (I.U) | N.13.14 |
| B8863 | (I.U) | N.13.15 |
| B8864 | (I.U) | N.13.16 |
| B8865 | (I.U) | N.13.17 |
| B8866 | (I.U) | N.13.18 |
| B8867 | (I.U) | N.13.19 |
| B8868 | (I.U) | N.13.20 |
| B8869 | (I.U) | N.13.21 |
| B8870 | (I.U) | N.13.22 |
| B8871 | (I.U) | N.13.23 |
| B8872 | (I.U) | N.13.24 |
| B8873 | (I.U) | N.13.25 |
| B8874 | (I.U) | N.13.26 |
| B8875 | (I.U) | N.13.27 |
| B8876 | (I.U) | N.13.28 |
| B8877 | (I.U) | N.13.29 |
| B8878 | (I.U) | N.13.30 |
| B8879 | (I.U) | N.13.31 |
| B8880 | (I.U) | N.13.32 |
| B8881 | (I.U) | N.14.1 |
| B8882 | (I.U) | N.14.2 |
| B8883 | (I.U) | N.14.3 |
| B8884 | (I.U) | N.14.4 |
| B8885 | (I.U) | N.15.1 |
| B8886 | (I.U) | N.15.2 |
| B8887 | (I.U) | N.15.3 |
| B8888 | (I.U) | N.15.4 |
| B8889 | (I.U) | N.15.5 |
| B8890 | (I.U) | N.15.6 |
| B8891 | (I.U) | N.15.7 |
| B8892 | (I.U) | N.15.8 |
| B8893 | (I.U) | N.15.9 |
| B8894 | (I.U) | N.15.10 |
| B8895 | (I.U) | N.15.11 |
| B8896 | (I.U) | N.15.12 |
| B8897 | (I.U) | N.15.13 |
| B8898 | (I.U) | N.15.14 |
| B8899 | (I.U) | N.15.15 |
| B8900 | (I.U) | N.15.16 |
| B8901 | (I.U) | N.15.17 |
| B8902 | (I.U) | N.15.18 |
| B8903 | (I.U) | N.15.19 |
| B8904 | (I.U) | N.15.20 |
| B8905 | (I.U) | N.15.21 |
| B8906 | (I.U) | N.15.22 |
| B8907 | (I.U) | N.15.23 |
| B8908 | (I.U) | N.15.24 |
| B8909 | (I.U) | N.15.25 |
| B8910 | (I.U) | N.15.26 |
| B8911 | (I.U) | N.15.27 |
| B8912 | (I.U) | N.15.28 |
| B8913 | (I.U) | N.15.29 |
| B8914 | (I.U) | N.15.30 |
| B8915 | (I.U) | N.15.31 |
| B8916 | (I.U) | N.15.32 |
| B8917 | (I.U) | N.15.33 |
| B8918 | (I.U) | N.15.34 |
| B8919 | (I.U) | N.15.35 |
| B8920 | (I.U) | N.15.36 |

TABLE 21

| B | I | II |
|---|---|---|
| B8921 | (I.V) | N.1.1 |
| B8922 | (I.V) | N.1.2 |
| B8923 | (I.V) | N.1.3 |
| B8924 | (I.V) | N.1.4 |
| B8925 | (I.V) | N.1.5 |
| B8926 | (I.V) | N.1.6 |
| B8927 | (I.V) | N.1.7 |
| B8928 | (I.V) | N.1.8 |
| B8929 | (I.V) | N.1.9 |
| B8930 | (I.V) | N.1.10 |
| B8931 | (I.V) | N.1.11 |
| B8932 | (I.V) | N.1.12 |
| B8933 | (I.V) | N.1.13 |
| B8934 | (I.V) | N.1.14 |
| B8935 | (I.V) | N.1.15 |
| B8936 | (I.V) | N.1.16 |
| B8937 | (I.V) | N.1.17 |
| B8938 | (I.V) | N.1.18 |
| B8939 | (I.V) | N.1.19 |
| B8940 | (I.V) | N.1.20 |
| B8941 | (I.V) | N.1.21 |
| B8942 | (I.V) | N.1.22 |
| B8943 | (I.V) | N.1.23 |
| B8944 | (I.V) | N.1.24 |
| B8945 | (I.V) | N.1.25 |
| B8946 | (I.V) | N.1.26 |
| B8947 | (I.V) | N.1.27 |
| B8948 | (I.V) | N.1.28 |
| B8949 | (I.V) | N.1.29 |
| B8950 | (I.V) | N.1.30 |
| B8951 | (I.V) | N.1.31 |
| B8952 | (I.V) | N.1.32 |
| B8953 | (I.V) | N.1.33 |
| B8954 | (I.V) | N.1.34 |
| B8955 | (I.V) | N.1.35 |
| B8956 | (I.V) | N.1.36 |
| B8957 | (I.V) | N.1.37 |
| B8958 | (I.V) | N.1.38 |
| B8959 | (I.V) | N.1.39 |
| B8960 | (I.V) | N.1.40 |
| B8961 | (I.V) | N.1.41 |
| B8962 | (I.V) | N.1.42 |
| B8963 | (I.V) | N.1.43 |
| B8964 | (I.V) | N.1.44 |
| B8965 | (I.V) | N.1.45 |
| B8966 | (I.V) | N.1.46 |
| B8967 | (I.V) | N.1.47 |
| B8968 | (I.V) | N.1.48 |
| B8969 | (I.V) | N.1.49 |
| B8970 | (I.V) | N.1.50 |
| B8971 | (I.V) | N.1.51 |
| B8972 | (I.V) | N.1.52 |
| B8973 | (I.V) | N.1.53 |
| B8974 | (I.V) | N.1.54 |
| B8975 | (I.V) | N.1.55 |
| B8976 | (I.V) | N.1.56 |
| B8977 | (I.V) | N.1.57 |
| B8978 | (I.V) | N.1.58 |
| B8979 | (I.V) | N.1.59 |
| B8980 | (I.V) | N.1.60 |
| B8981 | (I.V) | N.1.61 |
| B8982 | (I.V) | N.1.62 |
| B8983 | (I.V) | N.1.63 |
| B8984 | (I.V) | N.1.64 |
| B8985 | (I.V) | N.1.65 |
| B8986 | (I.V) | N.1.66 |
| B8987 | (I.V) | N.2.1 |
| B8988 | (I.V) | N.2.2 |
| B8989 | (I.V) | N.2.3 |
| B8990 | (I.V) | N.2.4 |
| B8991 | (I.V) | N.2.5 |
| B8992 | (I.V) | N.2.6 |
| B8993 | (I.V) | N.2.7 |
| B8994 | (I.V) | N.2.8 |
| B8995 | (I.V) | N.2.9 |
| B8996 | (I.V) | N.2.10 |
| B8997 | (I.V) | N.2.11 |
| B8998 | (I.V) | N.2.12 |
| B8999 | (I.V) | N.2.13 |
| B9000 | (I.V) | N.2.14 |
| B9001 | (I.V) | N.2.15 |
| B9002 | (I.V) | N.2.16 |
| B9003 | (I.V) | N.2.17 |
| B9004 | (I.V) | N.2.18 |
| B9005 | (I.V) | N.2.19 |
| B9006 | (I.V) | N.2.20 |
| B9007 | (I.V) | N.2.21 |
| B9008 | (I.V) | N.2.22 |
| B9009 | (I.V) | N.2.23 |
| B9010 | (I.V) | N.2.24 |
| B9011 | (I.V) | N.2.25 |
| B9012 | (I.V) | N.2.26 |
| B9013 | (I.V) | N.2.27 |
| B9014 | (I.V) | N.2.28 |
| B9015 | (I.V) | N.2.29 |
| B9016 | (I.V) | N.2.30 |
| B9017 | (I.V) | N.2.31 |
| B9018 | (I.V) | N.2.32 |
| B9019 | (I.V) | N.2.33 |
| B9020 | (I.V) | N.2.34 |
| B9021 | (I.V) | N.2.35 |
| B9022 | (I.V) | N.2.36 |
| B9023 | (I.V) | N.2.37 |
| B9024 | (I.V) | N.2.38 |
| B9025 | (I.V) | N.2.39 |
| B9026 | (I.V) | N.2.40 |
| B9027 | (I.V) | N.2.41 |
| B9028 | (I.V) | N.2.42 |
| B9029 | (I.V) | N.2.43 |
| B9030 | (I.V) | N.2.44 |
| B9031 | (I.V) | N.2.45 |
| B9032 | (I.V) | N.2.46 |
| B9033 | (I.V) | N.2.47 |
| B9034 | (I.V) | N.2.48 |
| B9035 | (I.V) | N.2.49 |
| B9036 | (I.V) | N.2.50 |
| B9037 | (I.V) | N.2.51 |
| B9038 | (I.V) | N.2.52 |
| B9039 | (I.V) | N.2.53 |
| B9040 | (I.V) | N.2.54 |
| B9041 | (I.V) | N.2.55 |
| B9042 | (I.V) | N.2.56 |
| B9043 | (I.V) | N.2.57 |
| B9044 | (I.V) | N.2.58 |
| B9045 | (I.V) | N.2.59 |
| B9046 | (I.V) | N.2.60 |
| B9047 | (I.V) | N.2.61 |
| B9048 | (I.V) | N.2.62 |
| B9049 | (I.V) | N.2.63 |
| B9050 | (I.V) | N.2.64 |
| B9051 | (I.V) | N.2.65 |
| B9052 | (I.V) | N.2.66 |
| B9053 | (I.V) | N.2.67 |
| B9054 | (I.V) | N.2.68 |
| B9055 | (I.V) | N.2.69 |
| B9056 | (I.V) | N.2.70 |
| B9057 | (I.V) | N.2.71 |
| B9058 | (I.V) | N.2.72 |
| B9059 | (I.V) | N.2.73 |
| B9060 | (I.V) | N.2.74 |
| B9061 | (I.V) | N.2.75 |
| B9062 | (I.V) | N.2.76 |
| B9063 | (I.V) | N.2.77 |
| B9064 | (I.V) | N.2.78 |
| B9065 | (I.V) | N.2.79 |
| B9066 | (I.V) | N.2.80 |
| B9067 | (I.V) | N.2.81 |
| B9068 | (I.V) | N.2.82 |
| B9069 | (I.V) | N.2.83 |
| B9070 | (I.V) | N.2.84 |
| B9071 | (I.V) | N.3.1 |
| B9072 | (I.V) | N.3.2 |
| B9073 | (I.V) | N.3.3 |
| B9074 | (I.V) | N.3.4 |
| B9075 | (I.V) | N.3.5 |
| B9076 | (I.V) | N.3.6 |
| B9077 | (I.V) | N.3.7 |
| B9078 | (I.V) | N.3.8 |
| B9079 | (I.V) | N.3.9 |
| B9080 | (I.V) | N.3.10 |
| B9081 | (I.V) | N.3.11 |
| B9082 | (I.V) | N.3.12 |
| B9083 | (I.V) | N.3.13 |
| B9084 | (I.V) | N.3.14 |
| B9085 | (I.V) | N.3.15 |
| B9086 | (I.V) | N.3.16 |
| B9087 | (I.V) | N.3.17 |
| B9088 | (I.V) | N.3.18 |
| B9089 | (I.V) | N.3.19 |
| B9090 | (I.V) | N.3.20 |
| B9091 | (I.V) | N.3.21 |
| B9092 | (I.V) | N.3.22 |
| B9093 | (I.V) | N.3.23 |
| B9094 | (I.V) | N.3.24 |
| B9095 | (I.V) | N.3.25 |
| B9096 | (I.V) | N.3.26 |
| B9097 | (I.V) | N.3.27 |
| B9098 | (I.V) | N.3.28 |
| B9099 | (I.V) | N.3.29 |
| B9100 | (I.V) | N.3.30 |
| B9101 | (I.V) | N.3.31 |
| B9102 | (I.V) | N.3.32 |
| B9103 | (I.V) | N.3.33 |
| B9104 | (I.V) | N.3.34 |
| B9105 | (I.V) | N.3.35 |
| B9106 | (I.V) | N.3.36 |
| B9107 | (I.V) | N.3.37 |
| B9108 | (I.V) | N.3.38 |
| B9109 | (I.V) | N.3.39 |
| B9110 | (I.V) | N.3.40 |
| B9111 | (I.V) | N.3.41 |
| B9112 | (I.V) | N.3.42 |
| B9113 | (I.V) | N.3.43 |
| B9114 | (I.V) | N.3.44 |
| B9115 | (I.V) | N.3.45 |
| B9116 | (I.V) | N.3.46 |
| B9117 | (I.V) | N.3.47 |
| B9118 | (I.V) | N.3.48 |
| B9119 | (I.V) | N.3.49 |
| B9120 | (I.V) | N.3.50 |
| B9121 | (I.V) | N.3.51 |
| B9122 | (I.V) | N.3.52 |
| B9123 | (I.V) | N.3.53 |
| B9124 | (I.V) | N.3.54 |
| B9125 | (I.V) | N.3.55 |
| B9126 | (I.V) | N.3.56 |
| B9127 | (I.V) | N.3.57 |
| B9128 | (I.V) | N.3.58 |
| B9129 | (I.V) | N.3.59 |
| B9130 | (I.V) | N.3.60 |
| B9131 | (I.V) | N.3.61 |
| B9132 | (I.V) | N.3.62 |
| B9133 | (I.V) | N.3.63 |
| B9134 | (I.V) | N.3.64 |
| B9135 | (I.V) | N.3.65 |
| B9136 | (I.V) | N.3.66 |
| B9137 | (I.V) | N.3.67 |
| B9138 | (I.V) | N.3.68 |
| B9139 | (I.V) | N.3.69 |
| B9140 | (I.V) | N.4.1 |
| B9141 | (I.V) | N.4.2 |
| B9142 | (I.V) | N.4.3 |
| B9143 | (I.V) | N.4.4 |
| B9144 | (I.V) | N.4.5 |
| B9145 | (I.V) | N.4.6 |
| B9146 | (I.V) | N.4.7 |
| B9147 | (I.V) | N.4.8 |
| B9148 | (I.V) | N.4.9 |
| B9149 | (I.V) | N.4.10 |
| B9150 | (I.V) | N.4.11 |
| B9151 | (I.V) | N.4.12 |
| B9152 | (I.V) | N.4.13 |
| B9153 | (I.V) | N.4.14 |
| B9154 | (I.V) | N.4.15 |
| B9155 | (I.V) | N.4.16 |
| B9156 | (I.V) | N.4.17 |
| B9157 | (I.V) | N.4.18 |
| B9158 | (I.V) | N.4.19 |
| B9159 | (I.V) | N.4.20 |
| B9160 | (I.V) | N.4.21 |
| B9161 | (I.V) | N.4.22 |
| B9162 | (I.V) | N.4.23 |
| B9163 | (I.V) | N.4.24 |
| B9164 | (I.V) | N.4.25 |
| B9165 | (I.V) | N.4.26 |
| B9166 | (I.V) | N.4.27 |
| B9167 | (I.V) | N.4.28 |
| B9168 | (I.V) | N.4.29 |
| B9169 | (I.V) | N.4.30 |
| B9170 | (I.V) | N.4.31 |
| B9171 | (I.V) | N.4.32 |
| B9172 | (I.V) | N.4.33 |
| B9173 | (I.V) | N.4.34 |
| B9174 | (I.V) | N.4.35 |
| B9175 | (I.V) | N.4.36 |
| B9176 | (I.V) | N.4.37 |
| B9177 | (I.V) | N.4.38 |
| B9178 | (I.V) | N.4.39 |
| B9179 | (I.V) | N.4.40 |
| B9180 | (I.V) | N.4.41 |
| B9181 | (I.V) | N.4.42 |
| B9182 | (I.V) | N.4.43 |
| B9183 | (I.V) | N.4.44 |
| B9184 | (I.V) | N.4.45 |
| B9185 | (I.V) | N.4.46 |
| B9186 | (I.V) | N.4.47 |
| B9187 | (I.V) | N.5.1 |
| B9188 | (I.V) | N.5.2 |
| B9189 | (I.V) | N.5.3 |
| B9190 | (I.V) | N.5.4 |
| B9191 | (I.V) | N.5.5 |
| B9192 | (I.V) | N.5.6 |
| B9193 | (I.V) | N.5.7 |
| B9194 | (I.V) | N.5.8 |
| B9195 | (I.V) | N.5.9 |
| B9196 | (I.V) | N.5.10 |
| B9197 | (I.V) | N.5.11 |
| B9198 | (I.V) | N.5.12 |
| B9199 | (I.V) | N.5.13 |
| B9200 | (I.V) | N.5.14 |
| B9201 | (I.V) | N.5.15 |
| B9202 | (I.V) | N.5.16 |
| B9203 | (I.V) | N.5.17 |
| B9204 | (I.V) | N.5.18 |
| B9205 | (I.V) | N.5.19 |
| B9206 | (I.V) | N.5.20 |
| B9207 | (I.V) | N.5.21 |
| B9208 | (I.V) | N.5.22 |
| B9209 | (I.V) | N.5.23 |
| B9210 | (I.V) | N.5.24 |
| B9211 | (I.V) | N.5.25 |
| B9212 | (I.V) | N.5.26 |
| B9213 | (I.V) | N.5.27 |
| B9214 | (I.V) | N.6.1 |
| B9215 | (I.V) | N.6.2 |
| B9216 | (I.V) | N.6.3 |
| B9217 | (I.V) | N.6.4 |
| B9218 | (I.V) | N.7.1 |
| B9219 | (I.V) | N.7.2 |
| B9220 | (I.V) | N.7.3 |
| B9221 | (I.V) | N.7.4 |
| B9222 | (I.V) | N.7.5 |
| B9223 | (I.V) | N.8.1 |
| B9224 | (I.V) | N.9.1 |
| B9225 | (I.V) | N.9.2 |
| B9226 | (I.V) | N.9.3 |
| B9227 | (I.V) | N.9.4 |
| B9228 | (I.V) | N.9.5 |
| B9229 | (I.V) | N.9.6 |
| B9230 | (I.V) | N.9.7 |
| B9231 | (I.V) | N.9.8 |
| B9232 | (I.V) | N.9.9 |
| B9233 | (I.V) | N.9.10 |
| B9234 | (I.V) | N.9.11 |
| B9235 | (I.V) | N.9.12 |
| B9236 | (I.V) | N.9.13 |
| B9237 | (I.V) | N.9.14 |
| B9238 | (I.V) | N.9.15 |
| B9239 | (I.V) | N.9.16 |
| B9240 | (I.V) | N.9.17 |
| B9241 | (I.V) | N.9.18 |
| B9242 | (I.V) | N.9.19 |
| B9243 | (I.V) | N.9.20 |
| B9244 | (I.V) | N.9.21 |
| B9245 | (I.V) | N.9.22 |
| B9246 | (I.V) | N.9.23 |
| B9247 | (I.V) | N.9.24 |
| B9248 | (I.V) | N.9.25 |
| B9249 | (I.V) | N.9.26 |
| B9250 | (I.V) | N.10.1 |
| B9251 | (I.V) | N.10.2 |
| B9252 | (I.V) | N.10.3 |
| B9253 | (I.V) | N.10.4 |
| B9254 | (I.V) | N.10.5 |
| B9255 | (I.V) | N.10.6 |
| B9256 | (I.V) | N.10.7 |
| B9257 | (I.V) | N.10.8 |
| B9258 | (I.V) | N.10.9 |
| B9259 | (I.V) | N.10.10 |
| B9260 | (I.V) | N.10.12 |
| B9261 | (I.V) | N.10.13 |
| B9262 | (I.V) | N.10.14 |
| B9263 | (I.V) | N.10.15 |
| B9264 | (I.V) | N.10.16 |
| B9265 | (I.V) | N.10.17 |
| B9266 | (I.V) | N.10.18 |
| B9267 | (I.V) | N.10.19 |
| B9268 | (I.V) | N.10.20 |
| B9269 | (I.V) | N.10.21 |
| B9270 | (I.V) | N.10.22 |
| B9271 | (I.V) | N.10.23 |
| B9272 | (I.V) | N.10.24 |
| B9273 | (I.V) | N.10.25 |
| B9274 | (I.V) | N.10.26 |
| B9275 | (I.V) | N.10.27 |
| B9276 | (I.V) | N.10.28 |
| B9277 | (I.V) | N.10.29 |
| B9278 | (I.V) | N.10.30 |
| B9279 | (I.V) | N.10.31 |
| B9280 | (I.V) | N.10.32 |
| B9281 | (I.V) | N.10.33 |
| B9282 | (I.V) | N.10.34 |
| B9283 | (I.V) | N.10.35 |
| B9284 | (I.V) | N.10.36 |
| B9285 | (I.V) | N.11.1 |
| B9286 | (I.V) | N.11.2 |
| B9287 | (I.V) | N.11.3 |
| B9288 | (I.V) | N.11.4 |
| B9289 | (I.V) | N.11.5 |
| B9290 | (I.V) | N.11.6 |
| B9291 | (I.V) | N.11.7 |
| B9292 | (I.V) | N.12.1 |
| B9293 | (I.V) | N.12.2 |
| B9294 | (I.V) | N.12.3 |
| B9295 | (I.V) | N.13.1 |
| B9296 | (I.V) | N.13.2 |
| B9297 | (I.V) | N.13.3 |
| B9298 | (I.V) | N.13.4 |
| B9299 | (I.V) | N.13.5 |
| B9300 | (I.V) | N.13.6 |
| B9301 | (I.V) | N.13.7 |
| B9302 | (I.V) | N.13.8 |
| B9303 | (I.V) | N.13.9 |
| B9304 | (I.V) | N.13.10 |
| B9305 | (I.V) | N.13.11 |
| B9306 | (I.V) | N.13.12 |
| B9307 | (I.V) | N.13.13 |
| B9308 | (I.V) | N.13.14 |
| B9309 | (I.V) | N.13.15 |
| B9310 | (I.V) | N.13.16 |
| B9311 | (I.V) | N.13.17 |
| B9312 | (I.V) | N.13.18 |
| B9313 | (I.V) | N.13.19 |
| B9314 | (I.V) | N.13.20 |
| B9315 | (I.V) | N.13.21 |
| B9316 | (I.V) | N.13.22 |
| B9317 | (I.V) | N.13.23 |
| B9318 | (I.V) | N.13.24 |
| B9319 | (I.V) | N.13.25 |
| B9320 | (I.V) | N.13.26 |
| B9321 | (I.V) | N.13.27 |
| B9322 | (I.V) | N.13.28 |
| B9323 | (I.V) | N.13.29 |
| B9324 | (I.V) | N.13.30 |
| B9325 | (I.V) | N.13.31 |
| B9326 | (I.V) | N.13.32 |
| B9327 | (I.V) | N.14.1 |
| B9328 | (I.V) | N.14.2 |
| B9329 | (I.V) | N.14.3 |
| B9330 | (I.V) | N.14.4 |
| B9331 | (I.V) | N.15.1 |
| B9332 | (I.V) | N.15.2 |
| B9333 | (I.V) | N.15.3 |
| B9334 | (I.V) | N.15.4 |
| B9335 | (I.V) | N.15.5 |
| B9336 | (I.V) | N.15.6 |
| B9337 | (I.V) | N.15.7 |
| B9338 | (I.V) | N.15.8 |
| B9339 | (I.V) | N.15.9 |
| B9340 | (I.V) | N.15.10 |
| B9341 | (I.V) | N.15.11 |
| B9342 | (I.V) | N.15.12 |
| B9343 | (I.V) | N.15.13 |
| B9344 | (I.V) | N.15.14 |
| B9345 | (I.V) | N.15.15 |
| B9346 | (I.V) | N.15.16 |
| B9347 | (I.V) | N.15.17 |
| B9348 | (I.V) | N.15.18 |
| B9349 | (I.V) | N.15.19 |
| B9350 | (I.V) | N.15.20 |
| B9351 | (I.V) | N.15.21 |
| B9352 | (I.V) | N.15.22 |
| B9353 | (I.V) | N.15.23 |
| B9354 | (I.V) | N.15.24 |
| B9355 | (I.V) | N.15.25 |
| B9356 | (I.V) | N.15.26 |
| B9357 | (I.V) | N.15.27 |
| B9358 | (I.V) | N.15.28 |
| B9359 | (I.V) | N.15.29 |
| B9360 | (I.V) | N.15.30 |
| B9361 | (I.V) | N.15.31 |
| B9362 | (I.V) | N.15.32 |
| B9363 | (I.V) | N.15.33 |
| B9364 | (I.V) | N.15.34 |
| B9365 | (I.V) | N.15.35 |
| B9366 | (I.V) | N.15.36 |

B = Mixture;
I = compound I;
II = compound II

TABLE 22

| B | I | II |
|---|---|---|
| B9367 | (I.W) | N.1.1 |
| B9368 | (I.W) | N.1.2 |
| B9369 | (I.W) | N.1.3 |
| B9370 | (I.W) | N.1.4 |
| B9371 | (I.W) | N.1.5 |
| B9372 | (I.W) | N.1.6 |
| B9373 | (I.W) | N.1.7 |
| B9374 | (I.W) | N.1.8 |
| B9375 | (I.W) | N.1.9 |
| B9376 | (I.W) | N.1.10 |
| B9377 | (I.W) | N.1.11 |
| B9378 | (I.W) | N.1.12 |
| B9379 | (I.W) | N.1.13 |
| B9380 | (I.W) | N.1.14 |
| B9381 | (I.W) | N.1.15 |
| B9382 | (I.W) | N.1.16 |
| B9383 | (I.W) | N.1.17 |
| B9384 | (I.W) | N.1.18 |
| B9385 | (I.W) | N.1.19 |
| B9386 | (I.W) | N.1.20 |
| B9387 | (I.W) | N.1.21 |
| B9388 | (I.W) | N.1.22 |
| B9389 | (I.W) | N.1.23 |
| B9390 | (I.W) | N.1.24 |
| B9391 | (I.W) | N.1.25 |
| B9392 | (I.W) | N.1.26 |
| B9393 | (I.W) | N.1.27 |
| B9394 | (I.W) | N.1.28 |
| B9395 | (I.W) | N.1.29 |
| B9396 | (I.W) | N.1.30 |
| B9397 | (I.W) | N.1.31 |
| B9398 | (I.W) | N.1.32 |
| B9399 | (I.W) | N.1.33 |
| B9400 | (I.W) | N.1.34 |
| B9401 | (I.W) | N.1.35 |
| B9402 | (I.W) | N.1.36 |
| B9403 | (I.W) | N.1.37 |
| B9404 | (I.W) | N.1.38 |
| B9405 | (I.W) | N.1.39 |
| B9406 | (I.W) | N.1.40 |
| B9407 | (I.W) | N.1.41 |
| B9408 | (I.W) | N.1.42 |
| B9409 | (I.W) | N.1.43 |
| B9410 | (I.W) | N.1.44 |
| B9411 | (I.W) | N.1.45 |
| B9412 | (I.W) | N.1.46 |
| B9413 | (I.W) | N.1.47 |
| B9414 | (I.W) | N.1.48 |
| B9415 | (I.W) | N.1.49 |
| B9416 | (I.W) | N.1.50 |
| B9417 | (I.W) | N.1.51 |
| B9418 | (I.W) | N.1.52 |
| B9419 | (I.W) | N.1.53 |
| B9420 | (I.W) | N.1.54 |
| B9421 | (I.W) | N.1.55 |
| B9422 | (I.W) | N.1.56 |
| B9423 | (I.W) | N.1.57 |
| B9424 | (I.W) | N.1.58 |
| B9425 | (I.W) | N.1.59 |
| B9426 | (I.W) | N.1.60 |
| B9427 | (I.W) | N.1.61 |
| B9428 | (I.W) | N.1.62 |
| B9429 | (I.W) | N.1.63 |
| B9430 | (I.W) | N.1.64 |
| B9431 | (I.W) | N.1.65 |
| B9432 | (I.W) | N.1.66 |
| B9433 | (I.W) | N.2.1 |
| B9434 | (I.W) | N.2.2 |
| B9435 | (I.W) | N.2.3 |
| B9436 | (I.W) | N.2.4 |
| B9437 | (I.W) | N.2.5 |
| B9438 | (I.W) | N.2.6 |
| B9439 | (I.W) | N.2.7 |
| B9440 | (I.W) | N.2.8 |
| B9441 | (I.W) | N.2.9 |
| B9442 | (I.W) | N.2.10 |
| B9443 | (I.W) | N.2.11 |
| B9444 | (I.W) | N.2.12 |
| B9445 | (I.W) | N.2.13 |
| B9446 | (I.W) | N.2.14 |
| B9447 | (I.W) | N.2.15 |
| B9448 | (I.W) | N.2.16 |
| B9449 | (I.W) | N.2.17 |
| B9450 | (I.W) | N.2.18 |
| B9451 | (I.W) | N.2.19 |
| B9452 | (I.W) | N.2.20 |
| B9453 | (I.W) | N.2.21 |
| B9454 | (I.W) | N.2.22 |
| B9455 | (I.W) | N.2.23 |
| B9456 | (I.W) | N.2.24 |
| B9457 | (I.W) | N.2.25 |
| B9458 | (I.W) | N.2.26 |
| B9459 | (I.W) | N.2.27 |
| B9460 | (I.W) | N.2.28 |
| B9461 | (I.W) | N.2.29 |
| B9462 | (I.W) | N.2.30 |
| B9463 | (I.W) | N.2.31 |
| B9464 | (I.W) | N.2.32 |
| B9465 | (I.W) | N.2.33 |
| B9466 | (I.W) | N.2.34 |
| B9467 | (I.W) | N.2.35 |
| B9468 | (I.W) | N.2.36 |
| B9469 | (I.W) | N.2.37 |
| B9470 | (I.W) | N.2.38 |
| B9471 | (I.W) | N.2.39 |
| B9472 | (I.W) | N.2.40 |
| B9473 | (I.W) | N.2.41 |
| B9474 | (I.W) | N.2.42 |
| B9475 | (I.W) | N.2.43 |
| B9476 | (I.W) | N.2.44 |
| B9477 | (I.W) | N.2.45 |
| B9478 | (I.W) | N.2.46 |
| B9479 | (I.W) | N.2.47 |
| B9480 | (I.W) | N.2.48 |
| B9481 | (I.W) | N.2.49 |
| B9482 | (I.W) | N.2.50 |
| B9483 | (I.W) | N.2.51 |
| B9484 | (I.W) | N.2.52 |
| B9485 | (I.W) | N.2.53 |
| B9486 | (I.W) | N.2.54 |
| B9487 | (I.W) | N.2.55 |
| B9488 | (I.W) | N.2.56 |
| B9489 | (I.W) | N.2.57 |
| B9490 | (I.W) | N.2.58 |
| B9491 | (I.W) | N.2.59 |
| B9492 | (I.W) | N.2.60 |
| B9493 | (I.W) | N.2.61 |
| B9494 | (I.W) | N.2.62 |
| B9495 | (I.W) | N.2.63 |
| B9496 | (I.W) | N.2.64 |
| B9497 | (I.W) | N.2.65 |
| B9498 | (I.W) | N.2.66 |
| B9499 | (I.W) | N.2.67 |
| B9500 | (I.W) | N.2.68 |
| B9501 | (I.W) | N.2.69 |
| B9502 | (I.W) | N.2.70 |
| B9503 | (I.W) | N.2.71 |
| B9504 | (I.W) | N.2.72 |
| B9505 | (I.W) | N.2.73 |
| B9506 | (I.W) | N.2.74 |
| B9507 | (I.W) | N.2.75 |
| B9508 | (I.W) | N.2.76 |
| B9509 | (I.W) | N.2.77 |
| B9510 | (I.W) | N.2.78 |
| B9511 | (I.W) | N.2.79 |
| B9512 | (I.W) | N.2.80 |
| B9513 | (I.W) | N.2.81 |
| B9514 | (I.W) | N.2.82 |
| B9515 | (I.W) | N.2.83 |
| B9516 | (I.W) | N.2.84 |
| B9517 | (I.W) | N.3.1 |
| B9518 | (I.W) | N.3.2 |
| B9519 | (I.W) | N.3.3 |
| B9520 | (I.W) | N.3.4 |
| B9521 | (I.W) | N.3.5 |
| B9522 | (I.W) | N.3.6 |
| B9523 | (I.W) | N.3.7 |
| B9524 | (I.W) | N.3.8 |
| B9525 | (I.W) | N.3.9 |
| B9526 | (I.W) | N.3.10 |
| B9527 | (I.W) | N.3.11 |
| B9528 | (I.W) | N.3.12 |
| B9529 | (I.W) | N.3.13 |
| B9530 | (I.W) | N.3.14 |
| B9531 | (I.W) | N.3.15 |
| B9532 | (I.W) | N.3.16 |
| B9533 | (I.W) | N.3.17 |
| B9534 | (I.W) | N.3.18 |
| B9535 | (I.W) | N.3.19 |
| B9536 | (I.W) | N.3.20 |
| B9537 | (I.W) | N.3.21 |
| B9538 | (I.W) | N.3.22 |
| B9539 | (I.W) | N.3.23 |
| B9540 | (I.W) | N.3.24 |
| B9541 | (I.W) | N.3.25 |
| B9542 | (I.W) | N.3.26 |
| B9543 | (I.W) | N.3.27 |
| B9544 | (I.W) | N.3.28 |
| B9545 | (I.W) | N.3.29 |
| B9546 | (I.W) | N.3.30 |
| B9547 | (I.W) | N.3.31 |
| B9548 | (I.W) | N.3.32 |
| B9549 | (I.W) | N.3.33 |
| B9550 | (I.W) | N.3.34 |
| B9551 | (I.W) | N.3.35 |
| B9552 | (I.W) | N.3.36 |
| B9553 | (I.W) | N.3.37 |
| B9554 | (I.W) | N.3.38 |
| B9555 | (I.W) | N.3.39 |
| B9556 | (I.W) | N.3.40 |
| B9557 | (I.W) | N.3.41 |
| B9558 | (I.W) | N.3.42 |
| B9559 | (I.W) | N.3.43 |
| B9560 | (I.W) | N.3.44 |
| B9561 | (I.W) | N.3.45 |
| B9562 | (I.W) | N.3.46 |
| B9563 | (I.W) | N.3.47 |
| B9564 | (I.W) | N.3.48 |
| B9565 | (I.W) | N.3.49 |
| B9566 | (I.W) | N.3.50 |
| B9567 | (I.W) | N.3.51 |
| B9568 | (I.W) | N.3.52 |
| B9569 | (I.W) | N.3.53 |
| B9570 | (I.W) | N.3.54 |
| B9571 | (I.W) | N.3.55 |
| B9572 | (I.W) | N.3.56 |
| B9573 | (I.W) | N.3.57 |
| B9574 | (I.W) | N.3.58 |
| B9575 | (I.W) | N.3.59 |
| B9576 | (I.W) | N.3.60 |
| B9577 | (I.W) | N.3.61 |
| B9578 | (I.W) | N.3.62 |
| B9579 | (I.W) | N.3.63 |
| B9580 | (I.W) | N.3.64 |
| B9581 | (I.W) | N.3.65 |
| B9582 | (I.W) | N.3.66 |
| B9583 | (I.W) | N.3.67 |
| B9584 | (I.W) | N.3.68 |
| B9585 | (I.W) | N.3.69 |
| B9586 | (I.W) | N.4.1 |
| B9587 | (I.W) | N.4.2 |
| B9588 | (I.W) | N.4.3 |
| B9589 | (I.W) | N.4.4 |
| B9590 | (I.W) | N.4.5 |
| B9591 | (I.W) | N.4.6 |
| B9592 | (I.W) | N.4.7 |
| B9593 | (I.W) | N.4.8 |
| B9594 | (I.W) | N.4.9 |
| B9595 | (I.W) | N.4.10 |
| B9596 | (I.W) | N.4.11 |
| B9597 | (I.W) | N.4.12 |
| B9598 | (I.W) | N.4.13 |
| B9599 | (I.W) | N.4.14 |
| B9600 | (I.W) | N.4.15 |
| B9601 | (I.W) | N.4.16 |
| B9602 | (I.W) | N.4.17 |
| B9603 | (I.W) | N.4.18 |
| B9604 | (I.W) | N.4.19 |
| B9605 | (I.W) | N.4.20 |
| B9606 | (I.W) | N.4.21 |
| B9607 | (I.W) | N.4.22 |
| B9608 | (I.W) | N.4.23 |
| B9609 | (I.W) | N.4.24 |
| B9610 | (I.W) | N.4.25 |
| B9611 | (I.W) | N.4.26 |
| B9612 | (I.W) | N.4.27 |
| B9613 | (I.W) | N.4.28 |
| B9614 | (I.W) | N.4.29 |
| B9615 | (I.W) | N.4.30 |
| B9616 | (I.W) | N.4.31 |
| B9617 | (I.W) | N.4.32 |
| B9618 | (I.W) | N.4.33 |
| B9619 | (I.W) | N.4.34 |
| B9620 | (I.W) | N.4.35 |
| B9621 | (I.W) | N.4.36 |
| B9622 | (I.W) | N.4.37 |
| B9623 | (I.W) | N.4.38 |
| B9624 | (I.W) | N.4.39 |
| B9625 | (I.W) | N.4.40 |
| B9626 | (I.W) | N.4.41 |
| B9627 | (I.W) | N.4.42 |
| B9628 | (I.W) | N.4.43 |
| B9629 | (I.W) | N.4.44 |
| B9630 | (I.W) | N.4.45 |
| B9631 | (I.W) | N.4.46 |
| B9632 | (I.W) | N.4.47 |
| B9633 | (I.W) | N.5.1 |
| B9634 | (I.W) | N.5.2 |
| B9635 | (I.W) | N.5.3 |
| B9636 | (I.W) | N.5.4 |
| B9637 | (I.W) | N.5.5 |
| B9638 | (I.W) | N.5.6 |
| B9639 | (I.W) | N.5.7 |
| B9640 | (I.W) | N.5.8 |
| B9641 | (I.W) | N.5.9 |
| B9642 | (I.W) | N.5.10 |
| B9643 | (I.W) | N.5.11 |
| B9644 | (I.W) | N.5.12 |
| B9645 | (I.W) | N.5.13 |
| B9646 | (I.W) | N.5.14 |
| B9647 | (I.W) | N.5.15 |
| B9648 | (I.W) | N.5.16 |
| B9649 | (I.W) | N.5.17 |
| B9650 | (I.W) | N.5.18 |
| B9651 | (I.W) | N.5.19 |
| B9652 | (I.W) | N.5.20 |
| B9653 | (I.W) | N.5.21 |
| B9654 | (I.W) | N.5.22 |
| B9655 | (I.W) | N.5.23 |
| B9656 | (I.W) | N.5.24 |
| B9657 | (I.W) | N.5.25 |
| B9658 | (I.W) | N.5.26 |
| B9659 | (I.W) | N.5.27 |
| B9660 | (I.W) | N.6.1 |
| B9661 | (I.W) | N.6.2 |
| B9662 | (I.W) | N.6.3 |
| B9663 | (I.W) | N.6.4 |
| B9664 | (I.W) | N.7.1 |
| B9665 | (I.W) | N.7.2 |
| B9666 | (I.W) | N.7.3 |
| B9667 | (I.W) | N.7.4 |
| B9668 | (I.W) | N.7.5 |
| B9669 | (I.W) | N.8.1 |
| B9670 | (I.W) | N.9.1 |
| B9671 | (I.W) | N.9.2 |
| B9672 | (I.W) | N.9.3 |
| B9673 | (I.W) | N.9.4 |
| B9674 | (I.W) | N.9.5 |
| B9675 | (I.W) | N.9.6 |
| B9676 | (I.W) | N.9.7 |
| B9677 | (I.W) | N.9.8 |
| B9678 | (I.W) | N.9.9 |
| B9679 | (I.W) | N.9.10 |
| B9680 | (I.W) | N.9.11 |
| B9681 | (I.W) | N.9.12 |
| B9682 | (I.W) | N.9.13 |
| B9683 | (I.W) | N.9.14 |
| B9684 | (I.W) | N.9.15 |
| B9685 | (I.W) | N.9.16 |
| B9686 | (I.W) | N.9.17 |
| B9687 | (I.W) | N.9.18 |
| B9688 | (I.W) | N.9.19 |
| B9689 | (I.W) | N.9.20 |
| B9690 | (I.W) | N.9.21 |
| B9691 | (I.W) | N.9.22 |
| B9692 | (I.W) | N.9.23 |
| B9693 | (I.W) | N.9.24 |
| B9694 | (I.W) | N.9.25 |
| B9695 | (I.W) | N.9.26 |
| B9696 | (I.W) | N.10.1 |
| B9697 | (I.W) | N.10.2 |
| B9698 | (I.W) | N.10.3 |
| B9699 | (I.W) | N.10.4 |
| B9700 | (I.W) | N.10.5 |
| B9701 | (I.W) | N.10.6 |
| B9702 | (I.W) | N.10.7 |
| B9703 | (I.W) | N.10.8 |
| B9704 | (I.W) | N.10.9 |
| B9705 | (I.W) | N.10.10 |
| B9706 | (I.W) | N.10.12 |
| B9707 | (I.W) | N.10.13 |
| B9708 | (I.W) | N.10.14 |
| B9709 | (I.W) | N.10.15 |
| B9710 | (I.W) | N.10.16 |
| B9711 | (I.W) | N.10.17 |
| B9712 | (I.W) | N.10.18 |
| B9713 | (I.W) | N.10.19 |
| B9714 | (I.W) | N.10.20 |
| B9715 | (I.W) | N.10.21 |
| B9716 | (I.W) | N.10.22 |
| B9717 | (I.W) | N.10.23 |
| B9718 | (I.W) | N.10.24 |
| B9719 | (I.W) | N.10.25 |
| B9720 | (I.W) | N.10.26 |
| B9721 | (I.W) | N.10.27 |
| B9722 | (I.W) | N.10.28 |
| B9723 | (I.W) | N.10.29 |
| B9724 | (I.W) | N.10.30 |
| B9725 | (I.W) | N.10.31 |
| B9726 | (I.W) | N.10.32 |
| B9727 | (I.W) | N.10.33 |
| B9728 | (I.W) | N.10.34 |
| B9729 | (I.W) | N.10.35 |
| B9730 | (I.W) | N.10.36 |
| B9731 | (I.W) | N.11.1 |
| B9732 | (I.W) | N.11.2 |
| B9733 | (I.W) | N.11.3 |
| B9734 | (I.W) | N.11.4 |
| B9735 | (I.W) | N.11.5 |
| B9736 | (I.W) | N.11.6 |
| B9737 | (I.W) | N.11.7 |
| B9738 | (I.W) | N.12.1 |
| B9739 | (I.W) | N.12.2 |
| B9740 | (I.W) | N.12.3 |
| B9741 | (I.W) | N.13.1 |
| B9742 | (I.W) | N.13.2 |
| B9743 | (I.W) | N.13.3 |
| B9744 | (I.W) | N.13.4 |
| B9745 | (I.W) | N.13.5 |
| B9746 | (I.W) | N.13.6 |
| B9747 | (I.W) | N.13.7 |
| B9748 | (I.W) | N.13.8 |
| B9749 | (I.W) | N.13.9 |
| B9750 | (I.W) | N.13.10 |
| B9751 | (I.W) | N.13.11 |
| B9752 | (I.W) | N.13.12 |
| B9753 | (I.W) | N.13.13 |
| B9754 | (I.W) | N.13.14 |
| B9755 | (I.W) | N.13.15 |
| B9756 | (I.W) | N.13.16 |
| B9757 | (I.W) | N.13.17 |
| B9758 | (I.W) | N.13.18 |
| B9759 | (I.W) | N.13.19 |
| B9760 | (I.W) | N.13.20 |
| B9761 | (I.W) | N.13.21 |
| B9762 | (I.W) | N.13.22 |
| B9763 | (I.W) | N.13.23 |
| B9764 | (I.W) | N.13.24 |
| B9765 | (I.W) | N.13.25 |
| B9766 | (I.W) | N.13.26 |
| B9767 | (I.W) | N.13.27 |
| B9768 | (I.W) | N.13.28 |
| B9769 | (I.W) | N.13.29 |
| B9770 | (I.W) | N.13.30 |
| B9771 | (I.W) | N.13.31 |
| B9772 | (I.W) | N.13.32 |
| B9773 | (I.W) | N.14.1 |
| B9774 | (I.W) | N.14.2 |
| B9775 | (I.W) | N.14.3 |
| B9776 | (I.W) | N.14.4 |
| B9777 | (I.W) | N.15.1 |
| B9778 | (I.W) | N.15.2 |
| B9779 | (I.W) | N.15.3 |
| B9780 | (I.W) | N.15.4 |
| B9781 | (I.W) | N.15.5 |
| B9782 | (I.W) | N.15.6 |
| B9783 | (I.W) | N.15.7 |
| B9784 | (I.W) | N.15.8 |
| B9785 | (I.W) | N.15.9 |
| B9786 | (I.W) | N.15.10 |
| B9787 | (I.W) | N.15.11 |
| B9788 | (I.W) | N.15.12 |
| B9789 | (I.W) | N.15.13 |
| B9790 | (I.W) | N.15.14 |
| B9791 | (I.W) | N.15.15 |
| B9792 | (I.W) | N.15.16 |
| B9793 | (I.W) | N.15.17 |
| B9794 | (I.W) | N.15.18 |
| B9795 | (I.W) | N.15.19 |
| B9796 | (I.W) | N.15.20 |
| B9797 | (I.W) | N.15.21 |
| B9798 | (I.W) | N.15.22 |
| B9799 | (I.W) | N.15.23 |
| B9800 | (I.W) | N.15.24 |
| B9801 | (I.W) | N.15.25 |
| B9802 | (I.W) | N.15.26 |
| B9803 | (I.W) | N.15.27 |
| B9804 | (I.W) | N.15.28 |
| B9805 | (I.W) | N.15.29 |
| B9806 | (I.W) | N.15.30 |
| B9807 | (I.W) | N.15.31 |
| B9808 | (I.W) | N.15.32 |
| B9809 | (I.W) | N.15.33 |
| B9810 | (I.W) | N.15.34 |
| B9811 | (I.W) | N.15.35 |
| B9812 | (I.W) | N.15.36 |

B = Mixture;
I = compound I;
II = compound II

TABLE 23

| B | I | II |
|---|---|---|
| B9813 | (I.X) | N.1.1 |
| B9814 | (I.X) | N.1.2 |
| B9815 | (I.X) | N.1.3 |
| B9816 | (I.X) | N.1.4 |
| B9817 | (I.X) | N.1.5 |
| B9818 | (I.X) | N.1.6 |
| B9819 | (I.X) | N.1.7 |
| B9820 | (I.X) | N.1.8 |
| B9821 | (I.X) | N.1.9 |
| B9822 | (I.X) | N.1.10 |
| B9823 | (I.X) | N.1.11 |
| B9824 | (I.X) | N.1.12 |
| B9825 | (I.X) | N.1.13 |
| B9826 | (I.X) | N.1.14 |
| B9827 | (I.X) | N.1.15 |
| B9828 | (I.X) | N.1.16 |
| B9829 | (I.X) | N.1.17 |
| B9830 | (I.X) | N.1.18 |
| B9831 | (I.X) | N.1.19 |
| B9832 | (I.X) | N.1.20 |
| B9833 | (I.X) | N.1.21 |
| B9834 | (I.X) | N.1.22 |
| B9835 | (I.X) | N.1.23 |
| B9836 | (I.X) | N.1.24 |
| B9837 | (I.X) | N.1.25 |
| B9838 | (I.X) | N.1.26 |
| B9839 | (I.X) | N.1.27 |
| B9840 | (I.X) | N.1.28 |
| B9841 | (I.X) | N.1.29 |
| B9842 | (I.X) | N.1.30 |
| B9843 | (I.X) | N.1.31 |
| B9844 | (I.X) | N.1.32 |
| B9845 | (I.X) | N.1.33 |
| B9846 | (I.X) | N.1.34 |
| B9847 | (I.X) | N.1.35 |
| B9848 | (I.X) | N.1.36 |
| B9849 | (I.X) | N.1.37 |
| B9850 | (I.X) | N.1.38 |
| B9851 | (I.X) | N.1.39 |
| B9852 | (I.X) | N.1.40 |
| B9853 | (I.X) | N.1.41 |
| B9854 | (I.X) | N.1.42 |
| B9855 | (I.X) | N.1.43 |
| B9856 | (I.X) | N.1.44 |
| B9857 | (I.X) | N.1.45 |
| B9858 | (I.X) | N.1.46 |
| B9859 | (I.X) | N.1.47 |
| B9860 | (I.X) | N.1.48 |
| B9861 | (I.X) | N.1.49 |
| B9862 | (I.X) | N.1.50 |
| B9863 | (I.X) | N.1.51 |
| B9864 | (I.X) | N.1.52 |
| B9865 | (I.X) | N.1.53 |
| B9866 | (I.X) | N.1.54 |
| B9867 | (I.X) | N.1.55 |
| B9868 | (I.X) | N.1.56 |
| B9869 | (I.X) | N.1.57 |
| B9870 | (I.X) | N.1.58 |
| B9871 | (I.X) | N.1.59 |
| B9872 | (I.X) | N.1.60 |
| B9873 | (I.X) | N.1.61 |
| B9874 | (I.X) | N.1.62 |
| B9875 | (I.X) | N.1.63 |
| B9876 | (I.X) | N.1.64 |
| B9877 | (I.X) | N.1.65 |
| B9878 | (I.X) | N.1.66 |
| B9879 | (I.X) | N.2.1 |
| B9880 | (I.X) | N.2.2 |
| B9881 | (I.X) | N.2.3 |
| B9882 | (I.X) | N.2.4 |
| B9883 | (I.X) | N.2.5 |
| B9884 | (I.X) | N.2.6 |
| B9885 | (I.X) | N.2.7 |
| B9886 | (I.X) | N.2.8 |
| B9887 | (I.X) | N.2.9 |
| B9888 | (I.X) | N.2.10 |
| B9889 | (I.X) | N.2.11 |
| B9890 | (I.X) | N.2.12 |
| B9891 | (I.X) | N.2.13 |
| B9892 | (I.X) | N.2.14 |
| B9893 | (I.X) | N.2.15 |
| B9894 | (I.X) | N.2.16 |
| B9895 | (I.X) | N.2.17 |
| B9896 | (I.X) | N.2.18 |
| B9897 1 | (I.X) | N.2.19 |
| B9898 | (I.X) | N.2.20 |
| B9899 | (I.X) | N.2.21 |
| B9900 | (I.X) | N.2.22 |
| B9901 | (I.X) | N.2.23 |
| B9902 | (I.X) | N.2.24 |
| B9903 | (I.X) | N.2.25 |
| B9904 | (I.X) | N.2.26 |
| B9905 | (I.X) | N.2.27 |
| B9906 | (I.X) | N.2.28 |
| B9907 | (I.X) | N.2.29 |
| B9908 | (I.X) | N.2.30 |
| B9909 | (I.X) | N.2.31 |
| B9910 | (I.X) | N.2.32 |
| B9911 | (I.X) | N.2.33 |
| B9912 | (I.X) | N.2.34 |
| B9913 | (I.X) | N.2.35 |
| B9914 | (I.X) | N.2.36 |
| B9915 | (I.X) | N.2.37 |
| B9916 | (I.X) | N.2.38 |
| B9917 | (I.X) | N.2.39 |
| B9918 | (I.X) | N.2.40 |
| B9919 | (I.X) | N.2.41 |
| B9920 | (I.X) | N.2.42 |
| B9921 | (I.X) | N.2.43 |
| B9922 | (I.X) | N.2.44 |
| B9923 | (I.X) | N.2.45 |
| B9924 | (I.X) | N.2.46 |
| B9925 | (I.X) | N.2.47 |
| B9926 | (I.X) | N.2.48 |
| B9927 | (I.X) | N.2.49 |
| B9928 | (I.X) | N.2.50 |
| B9929 | (I.X) | N.2.51 |
| B9930 | (I.X) | N.2.52 |
| B9931 | (I.X) | N.2.53 |
| B9932 | (I.X) | N.2.54 |
| B9933 | (I.X) | N.2.55 |
| B9934 | (I.X) | N.2.56 |
| B9935 | (I.X) | N.2.57 |
| B9936 | (I.X) | N.2.58 |
| B9937 | (I.X) | N.2.59 |
| B9938 | (I.X) | N.2.60 |
| B9939 | (I.X) | N.2.61 |
| B9940 | (I.X) | N.2.62 |
| B9941 | (I.X) | N.2.63 |
| B9942 | (I.X) | N.2.64 |
| B9943 | (I.X) | N.2.65 |
| B9944 | (I.X) | N.2.66 |
| B9945 | (I.X) | N.2.67 |
| B9946 | (I.X) | N.2.68 |
| B9947 | (I.X) | N.2.69 |
| B9948 | (I.X) | N.2.70 |
| B9949 | (I.X) | N.2.71 |
| B9950 | (I.X) | N.2.72 |
| B9951 | (I.X) | N.2.73 |
| B9952 | (I.X) | N.2.74 |
| B9953 | (I.X) | N.2.75 |
| B9954 | (I.X) | N.2.76 |
| B9955 | (I.X) | N.2.77 |
| B9956 | (I.X) | N.2.78 |
| B9957 | (I.X) | N.2.79 |
| B9958 | (I.X) | N.2.80 |
| B9959 | (I.X) | N.2.81 |
| B9960 | (I.X) | N.2.82 |
| B9961 | (I.X) | N.2.83 |
| B9962 | (I.X) | N.2.84 |
| B9963 | (I.X) | N.3.1 |
| B9964 | (I.X) | N.3.2 |
| B9965 | (I.X) | N.3.3 |
| B9966 | (I.X) | N.3.4 |
| B9967 | (I.X) | N.3.5 |
| B9968 | (I.X) | N.3.6 |
| B9969 | (I.X) | N.3.7 |
| B9970 | (I.X) | N.3.8 |
| B9971 | (I.X) | N.3.9 |
| B9972 | (I.X) | N.3.10 |
| B9973 | (I.X) | N.3.11 |
| B9974 | (I.X) | N.3.12 |
| B9975 | (I.X) | N.3.13 |
| B9976 | (I.X) | N.3.14 |
| B9977 | (I.X) | N.3.15 |
| B9978 | (I.X) | N.3.16 |
| B9979 | (I.X) | N.3.17 |
| B9980 | (I.X) | N.3.18 |
| B9981 | (I.X) | N.3.19 |
| B9982 | (I.X) | N.3.20 |
| B9983 | (I.X) | N.3.21 |
| B9984 | (I.X) | N.3.22 |
| B9985 | (I.X) | N.3.23 |
| B9986 | (I.X) | N.3.24 |
| B9987 | (I.X) | N.3.25 |
| B9988 | (I.X) | N.3.26 |
| B9989 | (I.X) | N.3.27 |
| B9990 | (I.X) | N.3.28 |
| B9991 | (I.X) | N.3.29 |
| B9992 | (I.X) | N.3.30 |
| B9993 | (I.X) | N.3.31 |
| B9994 | (I.X) | N.3.32 |
| B9995 | (I.X) | N.3.33 |
| B9996 | (I.X) | N.3.34 |
| B9997 | (I.X) | N.3.35 |
| B9998 | (I.X) | N.3.36 |
| B9999 | (I.X) | N.3.37 |
| B10000 | (I.X) | N.3.38 |
| B10001 | (I.X) | N.3.39 |
| B10002 | (I.X) | N.3.40 |
| B10003 | (I.X) | N.3.41 |
| B10004 | (I.X) | N.3.42 |
| B10005 | (I.X) | N.3.43 |
| B10006 | (I.X) | N.3.44 |
| B10007 | (I.X) | N.3.45 |
| B10008 | (I.X) | N.3.46 |
| B10009 | (I.X) | N.3.47 |
| B10010 | (I.X) | N.3.48 |
| B10011 | (I.X) | N.3.49 |
| B10012 | (I.X) | N.3.50 |
| B10013 | (I.X) | N.3.51 |
| B10014 | (I.X) | N.3.52 |
| B10015 | (I.X) | N.3.53 |
| B10016 | (I.X) | N.3.54 |
| B10017 | (I.X) | N.3.55 |
| B10018 | (I.X) | N.3.56 |
| B10019 | (I.X) | N.3.57 |
| B10020 | (I.X) | N.3.58 |
| B10021 | (I.X) | N.3.59 |
| B10022 | (I.X) | N.3.60 |
| B10023 | (I.X) | N.3.61 |
| B10024 | (I.X) | N.3.62 |
| B10025 | (I.X) | N.3.63 |
| B10026 | (I.X) | N.3.64 |
| B10027 | (I.X) | N.3.65 |
| B10028 | (I.X) | N.3.66 |
| B10029 | (I.X) | N.3.67 |
| B10030 | (I.X) | N.3.68 |
| B10031 | (I.X) | N.3.69 |
| B10032 | (I.X) | N.4.1 |
| B10033 | (I.X) | N.4.2 |
| B10034 | (I.X) | N.4.3 |
| B10035 | (I.X) | N.4.4 |
| B10036 | (I.X) | N.4.5 |
| B10037 | (I.X) | N.4.6 |
| B10038 | (I.X) | N.4.7 |
| B10039 | (I.X) | N.4.8 |
| B10040 | (I.X) | N.4.9 |
| B10041 | (I.X) | N.4.10 |
| B10042 | (I.X) | N.4.11 |
| B10043 | (I.X) | N.4.12 |
| B10044 | (I.X) | N.4.13 |
| B10045 | (I.X) | N.4.14 |
| B10046 | (I.X) | N.4.15 |
| B10047 | (I.X) | N.4.16 |
| B10048 | (I.X) | N.4.17 |
| B10049 | (I.X) | N.4.18 |
| B10050 | (I.X) | N.4.19 |
| B10051 | (I.X) | N.4.20 |
| B10052 | (I.X) | N.4.21 |
| B10053 | (I.X) | N.4.22 |
| B10054 | (I.X) | N.4.23 |
| B10055 | (I.X) | N.4.24 |
| B10056 | (I.X) | N.4.25 |
| B10057 | (I.X) | N.4.26 |
| B10058 | (I.X) | N.4.27 |
| B10059 | (I.X) | N.4.28 |
| B10060 | (I.X) | N.4.29 |
| B10061 | (I.X) | N.4.30 |
| B10062 | (I.X) | N.4.31 |
| B10063 | (I.X) | N.4.32 |
| B10064 | (I.X) | N.4.33 |
| B10065 | (I.X) | N.4.34 |
| B10066 | (I.X) | N.4.35 |
| B10067 | (I.X) | N.4.36 |
| B10068 | (I.X) | N.4.37 |
| B10069 | (I.X) | N.4.38 |
| B10070 | (I.X) | N.4.39 |
| B10071 | (I.X) | N.4.40 |
| B10072 | (I.X) | N.4.41 |
| B10073 | (I.X) | N.4.42 |
| B10074 | (I.X) | N.4.43 |
| B10075 | (I.X) | N.4.44 |
| B10076 | (I.X) | N.4.45 |
| B10077 | (I.X) | N.4.46 |
| B10078 | (I.X) | N.4.47 |
| B10079 | (I.X) | N.5.1 |
| B10080 | (I.X) | N.5.2 |
| B10081 | (I.X) | N.5.3 |
| B10082 | (I.X) | N.5.4 |
| B10083 | (I.X) | N.5.5 |
| B10084 | (I.X) | N.5.6 |
| B10085 | (I.X) | N.5.7 |
| B10086 | (I.X) | N.5.8 |
| B10087 | (I.X) | N.5.9 |
| B10088 | (I.X) | N.5.10 |
| B10089 | (I.X) | N.5.11 |
| B10090 | (I.X) | N.5.12 |
| B10091 | (I.X) | N.5.13 |
| B10092 | (I.X) | N.5.14 |
| B10093 | (I.X) | N.5.15 |
| B10094 | (I.X) | N.5.16 |
| B10095 | (I.X) | N.5.17 |
| B10096 | (I.X) | N.5.18 |
| B10097 | (I.X) | N.5.19 |
| B10098 | (I.X) | N.5.20 |
| B10099 | (I.X) | N.5.21 |
| B10100 | (I.X) | N.5.22 |
| B10101 | (I.X) | N.5.23 |
| B10102 | (I.X) | N.5.24 |
| B10103 | (I.X) | N.5.25 |
| B10104 | (I.X) | N.5.26 |
| B10105 | (I.X) | N.5.27 |
| B10106 | (I.X) | N.6.1 |
| B10107 | (I.X) | N.6.2 |
| B10108 | (I.X) | N.6.3 |
| B10109 | (I.X) | N.6.4 |
| B10110 | (I.X) | N.7.1 |
| B10111 | (I.X) | N.7.2 |
| B10112 | (I.X) | N.7.3 |
| B10113 | (I.X) | N.7.4 |
| B10114 | (I.X) | N.7.5 |
| B10115 | (I.X) | N.8.1 |
| B10116 | (I.X) | N.9.1 |
| B10117 | (I.X) | N.9.2 |
| B10118 | (I.X) | N.9.3 |
| B10119 | (I.X) | N.9.4 |
| B10120 | (I.X) | N.9.5 |
| B10121 | (I.X) | N.9.6 |
| B10122 | (I.X) | N.9.7 |
| B10123 | (I.X) | N.9.8 |
| B10124 | (I.X) | N.9.9 |
| B10125 | (I.X) | N.9.10 |
| B10126 | (I.X) | N.9.11 |
| B10127 | (I.X) | N.9.12 |
| B10128 | (I.X) | N.9.13 |
| B10129 | (I.X) | N.9.14 |
| B10130 | (I.X) | N.9.15 |
| B10131 | (I.X) | N.9.16 |
| B10132 | (I.X) | N.9.17 |
| B10133 | (I.X) | N.9.18 |
| B10134 | (I.X) | N.9.19 |
| B10135 | (I.X) | N.9.20 |
| B10136 | (I.X) | N.9.21 |
| B10137 | (I.X) | N.9.22 |
| B10138 | (I.X) | N.9.23 |
| B10139 | (I.X) | N.9.24 |
| B10140 | (I.X) | N.9.25 |
| B10141 | (I.X) | N.9.26 |
| B10142 | (I.X) | N.10.1 |
| B10143 | (I.X) | N.10.2 |
| B10144 | (I.X) | N.10.3 |
| B10145 | (I.X) | N.10.4 |
| B10146 | (I.X) | N.10.5 |
| B10147 | (I.X) | N.10.6 |
| B10148 | (I.X) | N.10.7 |
| B10149 | (I.X) | N.10.8 |
| B10150 | (I.X) | N.10.9 |
| B10151 | (I.X) | N.10.10 |
| B10152 | (I.X) | N.10.12 |
| B10153 | (I.X) | N.10.13 |
| B10154 | (I.X) | N.10.14 |
| B10155 | (I.X) | N.10.15 |
| B10156 | (I.X) | N.10.16 |
| B10157 | (I.X) | N.10.17 |
| B10158 | (I.X) | N.10.18 |
| B10159 | (I.X) | N.10.19 |
| B10160 | (I.X) | N.10.20 |
| B10161 | (I.X) | N.10.21 |
| B10162 | (I.X) | N.10.22 |
| B10163 | (I.X) | N.10.23 |
| B10164 | (I.X) | N.10.24 |
| B10165 | (I.X) | N.10.25 |
| B10166 | (I.X) | N.10.26 |
| B10167 | (I.X) | N.10.27 |
| B10168 | (I.X) | N.10.28 |
| B10169 | (I.X) | N.10.29 |
| B10170 | (I.X) | N.10.30 |
| B10171 | (I.X) | N.10.31 |
| B10172 | (I.X) | N.10.32 |
| B10173 | (I.X) | N.10.33 |
| B10174 | (I.X) | N.10.34 |
| B10175 | (I.X) | N.10.35 |
| B10176 | (I.X) | N.10.36 |
| B10177 | (I.X) | N.11.1 |
| B10178 | (I.X) | N.11.2 |
| B10179 | (I.X) | N.11.3 |
| B10180 | (I.X) | N.11.4 |
| B10181 | (I.X) | N.11.5 |
| B10182 | (I.X) | N.11.6 |
| B10183 | (I.X) | N.11.7 |
| B10184 | (I.X) | N.12.1 |
| B10185 | (I.X) | N.12.2 |
| B10186 | (I.X) | N.12.3 |
| B10187 | (I.X) | N.13.1 |
| B10188 | (I.X) | N.13.2 |
| B10189 | (I.X) | N.13.3 |
| B10190 | (I.X) | N.13.4 |
| B10191 | (I.X) | N.13.5 |
| B10192 | (I.X) | N.13.6 |
| B10193 | (I.X) | N.13.7 |
| B10194 | (I.X) | N.13.8 |
| B10195 | (I.X) | N.13.9 |
| B10196 | (I.X) | N.13.10 |
| B10197 | (I.X) | N.13.11 |
| B10198 | (I.X) | N.13.12 |
| B10199 | (I.X) | N.13.13 |
| B10200 | (I.X) | N.13.14 |
| B10201 | (I.X) | N.13.15 |
| B10202 | (I.X) | N.13.16 |
| B10203 | (I.X) | N.13.17 |
| B10204 | (I.X) | N.13.18 |
| B10205 | (I.X) | N.13.19 |
| B10206 | (I.X) | N.13.20 |
| B10207 | (I.X) | N.13.21 |
| B10208 | (I.X) | N.13.22 |
| B10209 | (I.X) | N.13.23 |
| B10210 | (I.X) | N.13.24 |
| B10211 | (I.X) | N.13.25 |
| B10212 | (I.X) | N.13.26 |
| B10213 | (I.X) | N.13.27 |
| B10214 | (I.X) | N.13.28 |
| B10215 | (I.X) | N.13.29 |
| B10216 | (I.X) | N.13.30 |
| B10217 | (I.X) | N.13.31 |
| B10218 | (I.X) | N.13.32 |
| B10219 | (I.X) | N.14.1 |
| B10220 | (I.X) | N.14.2 |
| B10221 | (I.X) | N.14.3 |
| B10222 | (I.X) | N.14.4 |
| B10223 | (I.X) | N.15.1 |
| B10224 | (I.X) | N.15.2 |
| B10225 | (I.X) | N.15.3 |
| B10226 | (I.X) | N.15.4 |
| B10227 | (I.X) | N.15.5 |
| B10228 | (I.X) | N.15.6 |
| B10229 | (I.X) | N.15.7 |
| B10230 | (I.X) | N.15.8 |
| B10231 | (I.X) | N.15.9 |
| B10232 | (I.X) | N.15.10 |
| B10233 | (I.X) | N.15.11 |
| B10234 | (I.X) | N.15.12 |
| B10235 | (I.X) | N.15.13 |
| B10236 | (I.X) | N.15.14 |
| B10237 | (I.X) | N.15.15 |
| B10238 | (I.X) | N.15.16 |
| B10239 | (I.X) | N.15.17 |
| B10240 | (I.X) | N.15.18 |
| B10241 | (I.X) | N.15.19 |
| B10242 | (I.X) | N.15.20 |
| B10243 | (I.X) | N.15.21 |
| B10244 | (I.X) | N.15.22 |
| B10245 | (I.X) | N.15.23 |
| B10246 | (I.X) | N.15.24 |
| B10247 | (I.X) | N.15.25 |
| B10248 | (I.X) | N.15.26 |
| B10249 | (I.X) | N.15.27 |
| B10250 | (I.X) | N.15.28 |
| B10251 | (I.X) | N.15.29 |
| B10252 | (I.X) | N.15.30 |
| B10253 | (I.X) | N.15.31 |
| B10254 | (I.X) | N.15.32 |
| B10255 | (I.X) | N.15.33 |
| B10256 | (I.X) | N.15.34 |
| B10257 | (I.X) | N.15.35 |
| B10258 | (I.X) | N.15.36 |

B = Mixture;
I = compound I;
II = compound II

TABLE 24

| B | I | II |
|---|---|---|
| B10259 | (I.Y) | N.1.1 |
| B10260 | (I.Y) | N.1.2 |
| B10261 | (I.Y) | N.1.3 |
| B10262 | (I.Y) | N.1.4 |
| B10263 | (I.Y) | N.1.5 |
| B10264 | (I.Y) | N.1.6 |
| B10265 | (I.Y) | N.1.7 |
| B10266 | (I.Y) | N.1.8 |
| B10267 | (I.Y) | N.1.9 |
| B10268 | (I.Y) | N.1.10 |
| B10269 | (I.Y) | N.1.11 |
| B10270 | (I.Y) | N.1.12 |
| B10271 | (I.Y) | N.1.13 |
| B10272 | (I.Y) | N.1.14 |
| B10273 | (I.Y) | N.1.15 |
| B10274 | (I.Y) | N.1.16 |
| B10275 | (I.Y) | N.1.17 |
| B10276 | (I.Y) | N.1.18 |
| B10277 | (I.Y) | N.1.19 |
| B10278 | (I.Y) | N.1.20 |
| B10279 | (I.Y) | N.1.21 |
| B10280 | (I.Y) | N.1.22 |
| B10281 | (I.Y) | N.1.23 |
| B10282 | (I.Y) | N.1.24 |
| B10283 | (I.Y) | N.1.25 |
| B10284 | (I.Y) | N.1.26 |
| B10285 | (I.Y) | N.1.27 |
| B10286 | (I.Y) | N.1.28 |
| B10287 | (I.Y) | N.1.29 |
| B10288 | (I.Y) | N.1.30 |
| B10289 | (I.Y) | N.1.31 |
| B10290 | (I.Y) | N.1.32 |
| B10291 | (I.Y) | N.1.33 |
| B10292 | (I.Y) | N.1.34 |
| B10293 | (I.Y) | N.1.35 |
| B10294 | (I.Y) | N.1.36 |
| B10295 | (I.Y) | N.1.37 |
| B10296 | (I.Y) | N.1.38 |
| B10297 | (I.Y) | N.1.39 |
| B10298 | (I.Y) | N.1.40 |
| B10299 | (I.Y) | N.1.41 |
| B10300 | (I.Y) | N.1.42 |
| B10301 | (I.Y) | N.1.43 |
| B10302 | (I.Y) | N.1.44 |
| B10303 | (I.Y) | N.1.45 |
| B10304 | (I.Y) | N.1.46 |
| B10305 | (I.Y) | N.1.47 |
| B10306 | (I.Y) | N.1.48 |
| B10307 | (I.Y) | N.1.49 |
| B10308 | (I.Y) | N.1.50 |
| B10309 | (I.Y) | N.1.51 |
| B10310 | (I.Y) | N.1.52 |
| B10311 | (I.Y) | N.1.53 |
| B10312 | (I.Y) | N.1.54 |
| B10313 | (I.Y) | N.1.55 |
| B10314 | (I.Y) | N.1.56 |
| B10315 | (I.Y) | N.1.57 |
| B10316 | (I.Y) | N.1.58 |
| B10317 | (I.Y) | N.1.59 |
| B10318 | (I.Y) | N.1.60 |
| B10319 | (I.Y) | N.1.61 |
| B10320 | (I.Y) | N.1.62 |
| B10321 | (I.Y) | N.1.63 |
| B10322 | (I.Y) | N.1.64 |
| B10323 | (I.Y) | N.1.65 |
| B10324 | (I.Y) | N.1.66 |
| B10325 | (I.Y) | N.2.1 |
| B10326 | (I.Y) | N.2.2 |
| B10327 | (I.Y) | N.2.3 |
| B10328 | (I.Y) | N.2.4 |
| B10329 | (I.Y) | N.2.5 |
| B10330 | (I.Y) | N.2.6 |
| B10331 | (I.Y) | N.2.7 |
| B10332 | (I.Y) | N.2.8 |
| B10333 | (I.Y) | N.2.9 |
| B10334 | (I.Y) | N.2.10 |
| B10335 | (I.Y) | N.2.11 |
| B10336 | (I.Y) | N.2.12 |
| B10337 | (I.Y) | N.2.13 |
| B10338 | (I.Y) | N.2.14 |
| B10339 | (I.Y) | N.2.15 |
| B10340 | (I.Y) | N.2.16 |
| B10341 | (I.Y) | N.2.17 |
| B10342 | (I.Y) | N.2.18 |
| B10343 | (I.Y) | N.2.19 |
| B10344 | (I.Y) | N.2.20 |
| B10345 | (I.Y) | N.2.21 |
| B10346 | (I.Y) | N.2.22 |
| B10347 | (I.Y) | N.2.23 |
| B10348 | (I.Y) | N.2.24 |
| B10349 | (I.Y) | N.2.25 |
| B10350 | (I.Y) | N.2.26 |
| B10351 | (I.Y) | N.2.27 |
| B10352 | (I.Y) | N.2.28 |
| B10353 | (I.Y) | N.2.29 |
| B10354 | (I.Y) | N.2.30 |
| B10355 | (I.Y) | N.2.31 |
| B10356 | (I.Y) | N.2.32 |
| B10357 | (I.Y) | N.2.33 |
| B10358 | (I.Y) | N.2.34 |
| B10359 | (I.Y) | N.2.35 |
| B10360 | (I.Y) | N.2.36 |
| B10361 | (I.Y) | N.2.37 |
| B10362 | (I.Y) | N.2.38 |
| B10363 | (I.Y) | N.2.39 |
| B10364 | (I.Y) | N.2.40 |
| B10365 | (I.Y) | N.2.41 |
| B10366 | (I.Y) | N.2.42 |
| B10367 | (I.Y) | N.2.43 |
| B10368 | (I.Y) | N.2.44 |
| B10369 | (I.Y) | N.2.45 |
| B10370 | (I.Y) | N.2.46 |
| B10371 | (I.Y) | N.2.47 |
| B10372 | (I.Y) | N.2.48 |
| B10373 | (I.Y) | N.2.49 |
| B10374 | (I.Y) | N.2.50 |
| B10375 | (I.Y) | N.2.51 |
| B10376 | (I.Y) | N.2.52 |
| B10377 | (I.Y) | N.2.53 |
| B10378 | (I.Y) | N.2.54 |
| B10379 | (I.Y) | N.2.55 |
| B10380 | (I.Y) | N.2.56 |
| B10381 | (I.Y) | N.2.57 |
| B10382 | (I.Y) | N.2.58 |
| B10383 | (I.Y) | N.2.59 |
| B10384 | (I.Y) | N.2.60 |
| B10385 | (I.Y) | N.2.61 |
| B10386 | (I.Y) | N.2.62 |
| B10387 | (I.Y) | N.2.63 |
| B10388 | (I.Y) | N.2.64 |
| B10389 | (I.Y) | N.2.65 |
| B10390 | (I.Y) | N.2.66 |
| B10391 | (I.Y) | N.2.67 |
| B10392 | (I.Y) | N.2.68 |
| B10393 | (I.Y) | N.2.69 |
| B10394 | (I.Y) | N.2.70 |
| B10395 | (I.Y) | N.2.71 |
| B10396 | (I.Y) | N.2.72 |
| B10397 | (I.Y) | N.2.73 |
| B10398 | (I.Y) | N.2.74 |
| B10399 | (I.Y) | N.2.75 |
| B10400 | (I.Y) | N.2.76 |
| B10401 | (I.Y) | N.2.77 |
| B10402 | (I.Y) | N.2.78 |
| B10403 | (I.Y) | N.2.79 |
| B10404 | (I.Y) | N.2.80 |
| B10405 | (I.Y) | N.2.81 |
| B10406 | (I.Y) | N.2.82 |
| B10407 | (I.Y) | N.2.83 |
| B10408 | (I.Y) | N.2.84 |
| B10409 | (I.Y) | N.3.1 |
| B10410 | (I.Y) | N.3.2 |
| B10411 | (I.Y) | N.3.3 |
| B10412 | (I.Y) | N.3.4 |
| B10413 | (I.Y) | N.3.5 |
| B10414 | (I.Y) | N.3.6 |
| B10415 | (I.Y) | N.3.7 |
| B10416 | (I.Y) | N.3.8 |
| B10417 | (I.Y) | N.3.9 |
| B10418 | (I.Y) | N.3.10 |
| B10419 | (I.Y) | N.3.11 |
| B10420 | (I.Y) | N.3.12 |
| B10421 | (I.Y) | N.3.13 |
| B10422 | (I.Y) | N.3.14 |
| B10423 | (I.Y) | N.3.15 |
| B10424 | (I.Y) | N.3.16 |
| B10425 | (I.Y) | N.3.17 |
| B10426 | (I.Y) | N.3.18 |
| B10427 | (I.Y) | N.3.19 |
| B10428 | (I.Y) | N.3.20 |
| B10429 | (I.Y) | N.3.21 |
| B10430 | (I.Y) | N.3.22 |
| B10431 | (I.Y) | N.3.23 |
| B10432 | (I.Y) | N.3.24 |
| B10433 | (I.Y) | N.3.25 |
| B10434 | (I.Y) | N.3.26 |
| B10435 | (I.Y) | N.3.27 |
| B10436 | (I.Y) | N.3.28 |
| B10437 | (I.Y) | N.3.29 |
| B10438 | (I.Y) | N.3.30 |
| B10439 | (I.Y) | N.3.31 |
| B10440 | (I.Y) | N.3.32 |
| B10441 | (I.Y) | N.3.33 |
| B10442 | (I.Y) | N.3.34 |
| B10443 | (I.Y) | N.3.35 |
| B10444 | (I.Y) | N.3.36 |
| B10445 | (I.Y) | N.3.37 |
| B10446 | (I.Y) | N.3.38 |
| B10447 | (I.Y) | N.3.39 |
| B10448 | (I.Y) | N.3.40 |
| B10449 | (I.Y) | N.3.41 |
| B10450 | (I.Y) | N.3.42 |
| B10451 | (I.Y) | N.3.43 |
| B10452 | (I.Y) | N.3.44 |
| B10453 | (I.Y) | N.3.45 |
| B10454 | (I.Y) | N.3.46 |
| B10455 | (I.Y) | N.3.47 |
| B10456 | (I.Y) | N.3.48 |
| B10457 | (I.Y) | N.3.49 |
| B10458 | (I.Y) | N.3.50 |
| B10459 | (I.Y) | N.3.51 |
| B10460 | (I.Y) | N.3.52 |
| B10461 | (I.Y) | N.3.53 |
| B10462 | (I.Y) | N.3.54 |
| B10463 | (I.Y) | N.3.55 |
| B10464 | (I.Y) | N.3.56 |
| B10465 | (I.Y) | N.3.57 |
| B10466 | (I.Y) | N.3.58 |
| B10467 | (I.Y) | N.3.59 |
| B10468 | (I.Y) | N.3.60 |
| B10469 | (I.Y) | N.3.61 |
| B10470 | (I.Y) | N.3.62 |
| B10471 | (I.Y) | N.3.63 |
| B10472 | (I.Y) | N.3.64 |
| B10473 | (I.Y) | N.3.65 |
| B10474 | (I.Y) | N.3.66 |
| B10475 | (I.Y) | N.3.67 |
| B10476 | (I.Y) | N.3.68 |
| B10477 | (I.Y) | N.3.69 |
| B10478 | (I.Y) | N.4.1 |
| B10479 | (I.Y) | N.4.2 |
| B10480 | (I.Y) | N.4.3 |
| B10481 | (I.Y) | N.4.4 |
| B10482 | (I.Y) | N.4.5 |
| B10483 | (I.Y) | N.4.6 |
| B10484 | (I.Y) | N.4.7 |
| B10485 | (I.Y) | N.4.8 |
| B10486 | (I.Y) | N.4.9 |
| B10487 | (I.Y) | N.4.10 |
| B10488 | (I.Y) | N.4.11 |
| B10489 | (I.Y) | N.4.12 |
| B10490 | (I.Y) | N.4.13 |
| B10491 | (I.Y) | N.4.14 |
| B10492 | (I.Y) | N.4.15 |
| B10493 | (I.Y) | N.4.16 |
| B10494 | (I.Y) | N.4.17 |
| B10495 | (I.Y) | N.4.18 |
| B10496 | (I.Y) | N.4.19 |
| B10497 | (I.Y) | N.4.20 |
| B10498 | (I.Y) | N.4.21 |
| B10499 | (I.Y) | N.4.22 |
| B10500 | (I.Y) | N.4.23 |
| B10501 | (I.Y) | N.4.24 |
| B10502 | (I.Y) | N.4.25 |
| B10503 | (I.Y) | N.4.26 |
| B10504 | (I.Y) | N.4.27 |
| B10505 | (I.Y) | N.4.28 |
| B10506 | (I.Y) | N.4.29 |
| B10507 | (I.Y) | N.4.30 |
| B10508 | (I.Y) | N.4.31 |
| B10509 | (I.Y) | N.4.32 |
| B10510 | (I.Y) | N.4.33 |
| B10511 | (I.Y) | N.4.34 |
| B10512 | (I.Y) | N.4.35 |
| B10513 | (I.Y) | N.4.36 |
| B10514 | (I.Y) | N.4.37 |
| B10515 | (I.Y) | N.4.38 |
| B10516 | (I.Y) | N.4.39 |
| B10517 | (I.Y) | N.4.40 |
| B10518 | (I.Y) | N.4.41 |
| B10519 | (I.Y) | N.4.42 |
| B10520 | (I.Y) | N.4.43 |
| B10521 | (I.Y) | N.4.44 |
| B10522 | (I.Y) | N.4.45 |
| B10523 | (I.Y) | N.4.46 |
| B10524 | (I.Y) | N.4.47 |
| B10525 | (I.Y) | N.5.1 |
| B10526 | (I.Y) | N.5.2 |
| B10527 | (I.Y) | N.5.3 |
| B10528 | (I.Y) | N.5.4 |
| B10529 | (I.Y) | N.5.5 |
| B10530 | (I.Y) | N.5.6 |
| B10531 | (I.Y) | N.5.7 |
| B10532 | (I.Y) | N.5.8 |
| B10533 | (I.Y) | N.5.9 |
| B10534 | (I.Y) | N.5.10 |
| B10535 | (I.Y) | N.5.11 |
| B10536 | (I.Y) | N.5.12 |
| B10537 | (I.Y) | N.5.13 |
| B10538 | (I.Y) | N.5.14 |
| B10539 | (I.Y) | N.5.15 |
| B10540 | (I.Y) | N.5.16 |
| B10541 | (I.Y) | N.5.17 |
| B10542 | (I.Y) | N.5.18 |
| B10543 | (I.Y) | N.5.19 |
| B10544 | (I.Y) | N.5.20 |
| B10545 | (I.Y) | N.5.21 |
| B10546 | (I.Y) | N.5.22 |
| B10547 | (I.Y) | N.5.23 |
| B10548 | (I.Y) | N.5.24 |
| B10549 | (I.Y) | N.5.25 |
| B10550 | (I.Y) | N.5.26 |
| B10551 | (I.Y) | N.5.27 |
| B10552 | (I.Y) | N.6.1 |
| B10553 | (I.Y) | N.6.2 |
| B10554 | (I.Y) | N.6.3 |
| B10555 | (I.Y) | N.6.4 |
| B10556 | (I.Y) | N.7.1 |
| B10557 | (I.Y) | N.7.2 |
| B10558 | (I.Y) | N.7.3 |
| B10559 | (I.Y) | N.7.4 |
| B10560 | (I.Y) | N.7.5 |
| B10561 | (I.Y) | N.8.1 |
| B10562 | (I.Y) | N.9.1 |
| B10563 | (I.Y) | N.9.2 |
| B10564 | (I.Y) | N.9.3 |
| B10565 | (I.Y) | N.9.4 |
| B10566 | (I.Y) | N.9.5 |
| B10567 | (I.Y) | N.9.6 |
| B10568 | (I.Y) | N.9.7 |
| B10569 | (I.Y) | N.9.8 |
| B10570 | (I.Y) | N.9.9 |
| B10571 | (I.Y) | N.9.10 |
| B10572 | (I.Y) | N.9.11 |
| B10573 | (I.Y) | N.9.12 |
| B10574 | (I.Y) | N.9.13 |
| B10575 | (I.Y) | N.9.14 |
| B10576 | (I.Y) | N.9.15 |
| B10577 | (I.Y) | N.9.16 |
| B10578 | (I.Y) | N.9.17 |
| B10579 | (I.Y) | N.9.18 |
| B10580 | (I.Y) | N.9.19 |
| B10581 | (I.Y) | N.9.20 |
| B10582 | (I.Y) | N.9.21 |
| B10583 | (I.Y) | N.9.22 |
| B10584 | (I.Y) | N.9.23 |
| B10585 | (I.Y) | N.9.24 |
| B10586 | (I.Y) | N.9.25 |
| B10587 | (I.Y) | N.9.26 |
| B10588 | (I.Y) | N.10.1 |
| B10589 | (I.Y) | N.10.2 |
| B10590 | (I.Y) | N.10.3 |
| B10591 | (I.Y) | N.10.4 |
| B10592 | (I.Y) | N.10.5 |
| B10593 | (I.Y) | N.10.6 |
| B10594 | (I.Y) | N.10.7 |
| B10595 | (I.Y) | N.10.8 |
| B10596 | (I.Y) | N.10.9 |
| B10597 | (I.Y) | N.10.10 |
| B10598 | (I.Y) | N.10.12 |
| B10599 | (I.Y) | N.10.13 |
| B10600 | (I.Y) | N.10.14 |
| B10601 | (I.Y) | N.10.15 |
| B10602 | (I.Y) | N.10.16 |
| B10603 | (I.Y) | N.10.17 |
| B10604 | (I.Y) | N.10.18 |
| B10605 | (I.Y) | N.10.19 |
| B10606 | (I.Y) | N.10.20 |
| B10607 | (I.Y) | N.10.21 |
| B10608 | (I.Y) | N.10.22 |
| B10609 | (I.Y) | N.10.23 |
| B10610 | (I.Y) | N.10.24 |
| B10611 | (I.Y) | N.10.25 |
| B10612 | (I.Y) | N.10.26 |
| B10613 | (I.Y) | N.10.27 |
| B10614 | (I.Y) | N.10.28 |
| B10615 | (I.Y) | N.10.29 |
| B10616 | (I.Y) | N.10.30 |
| B10617 | (I.Y) | N.10.31 |
| B10618 | (I.Y) | N.10.32 |
| B10619 | (I.Y) | N.10.33 |
| B10620 | (I.Y) | N.10.34 |
| B10621 | (I.Y) | N.10.35 |
| B10622 | (I.Y) | N.10.36 |
| B10623 | (I.Y) | N.11.1 |
| B10624 | (I.Y) | N.11.2 |
| B10625 | (I.Y) | N.11.3 |
| B10626 | (I.Y) | N.11.4 |
| B10627 | (I.Y) | N.11.5 |
| B10628 | (I.Y) | N.11.6 |
| B10629 | (I.Y) | N.11.7 |
| B10630 | (I.Y) | N.12.1 |
| B10631 | (I.Y) | N.12.2 |
| B10632 | (I.Y) | N.12.3 |
| B10633 | (I.Y) | N.13.1 |
| B10634 | (I.Y) | N.13.2 |
| B10635 | (I.Y) | N.13.3 |
| B10636 | (I.Y) | N.13.4 |
| B10637 | (I.Y) | N.13.5 |
| B10638 | (I.Y) | N.13.6 |
| B10639 | (I.Y) | N.13.7 |
| B10640 | (I.Y) | N.13.8 |
| B10641 | (I.Y) | N.13.9 |
| B10642 | (I.Y) | N.13.10 |
| B10643 | (I.Y) | N.13.11 |
| B10644 | (I.Y) | N.13.12 |
| B10645 | (I.Y) | N.13.13 |
| B10646 | (I.Y) | N.13.14 |
| B10647 | (I.Y) | N.13.15 |
| B10648 | (I.Y) | N.13.16 |
| B10649 | (I.Y) | N.13.17 |
| B10650 | (I.Y) | N.13.18 |
| B10651 | (I.Y) | N.13.19 |
| B10652 | (I.Y) | N.13.20 |
| B10653 | (I.Y) | N.13.21 |
| B10654 | (I.Y) | N.13.22 |
| B10655 | (I.Y) | N.13.23 |
| B10656 | (I.Y) | N.13.24 |
| B10657 | (I.Y) | N.13.25 |
| B10658 | (I.Y) | N.13.26 |
| B10659 | (I.Y) | N.13.27 |
| B10660 | (I.Y) | N.13.28 |
| B10661 | (I.Y) | N.13.29 |
| B10662 | (I.Y) | N.13.30 |
| B10663 | (I.Y) | N.13.31 |
| B10664 | (I.Y) | N.13.32 |
| B10665 | (I.Y) | N.14.1 |
| B10666 | (I.Y) | N.14.2 |
| B10667 | (I.Y) | N.14.3 |
| B10668 | (I.Y) | N.14.4 |
| B10669 | (I.Y) | N.15.1 |
| B10670 | (I.Y) | N.15.2 |
| B10671 | (I.Y) | N.15.3 |
| B10672 | (I.Y) | N.15.4 |
| B10673 | (I.Y) | N.15.5 |
| B10674 | (I.Y) | N.15.6 |
| B10675 | (I.Y) | N.15.7 |
| B10676 | (I.Y) | N.15.8 |
| B10677 | (I.Y) | N.15.9 |
| B10678 | (I.Y) | N.15.10 |
| B10679 | (I.Y) | N.15.11 |
| B10680 | (I.Y) | N.15.12 |
| B10681 | (I.Y) | N.15.13 |
| B10682 | (I.Y) | N.15.14 |
| B10683 | (I.Y) | N.15.15 |
| B10684 | (I.Y) | N.15.16 |
| B10685 | (I.Y) | N.15.17 |
| B10686 | (I.Y) | N.15.18 |
| B10687 | (I.Y) | N.15.19 |
| B10688 | (I.Y) | N.15.20 |
| B10689 | (I.Y) | N.15.21 |
| B10690 | (I.Y) | N.15.22 |
| B10691 | (I.Y) | N.15.23 |
| B10692 | (I.Y) | N.15.24 |
| B10693 | (I.Y) | N.15.25 |
| B10694 | (I.Y) | N.15.26 |
| B10695 | (I.Y) | N.15.27 |
| B10696 | (I.Y) | N.15.28 |
| B10697 | (I.Y) | N.15.29 |
| B10698 | (I.Y) | N.15.30 |
| B10699 | (I.Y) | N.15.31 |
| B10700 | (I.Y) | N.15.32 |
| B10701 | (I.Y) | N.15.33 |
| B10702 | (I.Y) | N.15.34 |
| B10703 | (I.Y) | N.15.35 |
| B10704 | (I.Y) | N.15.36 |

B = Mixture;
I = compound I;
II = compound II

TABLE 25

| B | I | II |
|---|---|---|
| B10705 | (I.Z) | N.1.1 |
| B10706 | (I.Z) | N.1.2 |
| B10707 | (I.Z) | N.1.3 |
| B10708 | (I.Z) | N.1.4 |
| B10709 | (I.Z) | N.1.5 |
| B10710 | (I.Z) | N.1.6 |
| B10711 | (I.Z) | N.1.7 |
| B10712 | (I.Z) | N.1.8 |
| B10713 | (I.Z) | N.1.9 |
| B10714 | (I.Z) | N.1.10 |
| B10715 | (I.Z) | N.1.11 |
| B10716 | (I.Z) | N.1.12 |
| B10717 | (I.Z) | N.1.13 |
| B10718 | (I.Z) | N.1.14 |
| B10719 | (I.Z) | N.1.15 |
| B10720 | (I.Z) | N.1.16 |
| B10721 | (I.Z) | N.1.17 |
| B10722 | (I.Z) | N.1.18 |
| B10723 | (I.Z) | N.1.19 |
| B10724 | (I.Z) | N.1.20 |
| B10725 | (I.Z) | N.1.21 |
| B10726 | (I.Z) | N.1.22 |
| B10727 | (I.Z) | N.1.23 |
| B10728 | (I.Z) | N.1.24 |
| B10729 | (I.Z) | N.1.25 |
| B10730 | (I.Z) | N.1.26 |
| B10731 | (I.Z) | N.1.27 |
| B10732 | (I.Z) | N.1.28 |
| B10733 | (I.Z) | N.1.29 |
| B10734 | (I.Z) | N.1.30 |
| B10735 | (I.Z) | N.1.31 |
| B10736 | (I.Z) | N.1.32 |
| B10737 | (I.Z) | N.1.33 |
| B10738 | (I.Z) | N.1.34 |
| B10739 | (I.Z) | N.1.35 |
| B10740 | (I.Z) | N.1.36 |
| B10741 | (I.Z) | N.1.37 |
| B10742 | (I.Z) | N.1.38 |
| B10743 | (I.Z) | N.1.39 |
| B10744 | (I.Z) | N.1.40 |
| B10745 | (I.Z) | N.1.41 |
| B10746 | (I.Z) | N.1.42 |
| B10747 | (I.Z) | N.1.43 |
| B10748 | (I.Z) | N.1.44 |
| B10749 | (I.Z) | N.1.45 |
| B10750 | (I.Z) | N.1.46 |
| B10751 | (I.Z) | N.1.47 |
| B10752 | (I.Z) | N.1.48 |
| B10753 | (I.Z) | N.1.49 |
| B10754 | (I.Z) | N.1.50 |
| B10755 | (I.Z) | N.1.51 |
| B10756 | (I.Z) | N.1.52 |
| B10757 | (I.Z) | N.1.53 |
| B10758 | (I.Z) | N.1.54 |
| B10759 | (I.Z) | N.1.55 |
| B10760 | (I.Z) | N.1.56 |
| B10761 | (I.Z) | N.1.57 |
| B10762 | (I.Z) | N.1.58 |
| B10763 | (I.Z) | N.1.59 |
| B10764 | (I.Z) | N.1.60 |
| B10765 | (I.Z) | N.1.61 |
| B10766 | (I.Z) | N.1.62 |
| B10767 | (I.Z) | N.1.63 |
| B10768 | (I.Z) | N.1.64 |
| B10769 | (I.Z) | N.1.65 |
| B10770 | (I.Z) | N.1.66 |
| B10771 | (I.Z) | N.2.1 |
| B10772 | (I.Z) | N.2.2 |
| B10773 | (I.Z) | N.2.3 |
| B10774 | (I.Z) | N.2.4 |
| B10775 | (I.Z) | N.2.5 |
| B10776 | (I.Z) | N.2.6 |
| B10777 | (I.Z) | N.2.7 |
| B10778 | (I.Z) | N.2.8 |
| B10779 | (I.Z) | N.2.9 |
| B10780 | (I.Z) | N.2.10 |
| B10781 | (I.Z) | N.2.11 |
| B10782 | (I.Z) | N.2.12 |
| B10783 | (I.Z) | N.2.13 |
| B10784 | (I.Z) | N.2.14 |
| B10785 | (I.Z) | N.2.15 |
| B10786 | (I.Z) | N.2.16 |
| B10787 | (I.Z) | N.2.17 |
| B10788 | (I.Z) | N.2.18 |
| B10789 | (I.Z) | N.2.19 |
| B10790 | (I.Z) | N.2.20 |
| B10791 | (I.Z) | N.2.21 |
| B10792 | (I.Z) | N.2.22 |
| B10793 | (I.Z) | N.2.23 |
| B10794 | (I.Z) | N.2.24 |
| B10795 | (I.Z) | N.2.25 |
| B10796 | (I.Z) | N.2.26 |
| B10797 | (I.Z) | N.2.27 |
| B10798 | (I.Z) | N.2.28 |
| B10799 | (I.Z) | N.2.29 |
| B10800 | (I.Z) | N.2.30 |
| B10801 | (I.Z) | N.2.31 |
| B10802 | (I.Z) | N.2.32 |
| B10803 | (I.Z) | N.2.33 |
| B10804 | (I.Z) | N.2.34 |
| B10805 | (I.Z) | N.2.35 |
| B10806 | (I.Z) | N.2.36 |
| B10807 | (I.Z) | N.2.37 |
| B10808 | (I.Z) | N.2.38 |
| B10809 | (I.Z) | N.2.39 |
| B10810 | (I.Z) | N.2.40 |
| B10811 | (I.Z) | N.2.41 |
| B10812 | (I.Z) | N.2.42 |
| B10813 | (I.Z) | N.2.43 |
| B10814 | (I.Z) | N.2.44 |
| B10815 | (I.Z) | N.2.45 |
| B10816 | (I.Z) | N.2.46 |
| B10817 | (I.Z) | N.2.47 |
| B10818 | (I.Z) | N.2.48 |
| B10819 | (I.Z) | N.2.49 |
| B10820 | (I.Z) | N.2.50 |
| B10821 | (I.Z) | N.2.51 |
| B10822 | (I.Z) | N.2.52 |
| B10823 | (I.Z) | N.2.53 |
| B10824 | (I.Z) | N.2.54 |
| B10825 | (I.Z) | N.2.55 |
| B10826 | (I.Z) | N.2.56 |
| B10827 | (I.Z) | N.2.57 |
| B10828 | (I.Z) | N.2.58 |
| B10829 | (I.Z) | N.2.59 |
| B10830 | (I.Z) | N.2.60 |
| B10831 | (I.Z) | N.2.61 |
| B10832 | (I.Z) | N.2.62 |
| B10833 | (I.Z) | N.2.63 |
| B10834 | (I.Z) | N.2.64 |
| B10835 | (I.Z) | N.2.65 |
| B10836 | (I.Z) | N.2.66 |
| B10837 | (I.Z) | N.2.67 |
| B10838 | (I.Z) | N.2.68 |
| B10839 | (I.Z) | N.2.69 |
| B10840 | (I.Z) | N.2.70 |
| B10841 | (I.Z) | N.2.71 |
| B10842 | (I.Z) | N.2.72 |
| B10843 | (I.Z) | N.2.73 |
| B10844 | (I.Z) | N.2.74 |
| B10845 | (I.Z) | N.2.75 |
| B10846 | (I.Z) | N.2.76 |
| B10847 | (I.Z) | N.2.77 |
| B10848 | (I.Z) | N.2.78 |
| B10849 | (I.Z) | N.2.79 |
| B10850 | (I.Z) | N.2.80 |
| B10851 | (I.Z) | N.2.81 |
| B10852 | (I.Z) | N.2.82 |
| B10853 | (I.Z) | N.2.83 |
| B10854 | (I.Z) | N.2.84 |
| B10855 | (I.Z) | N.3.1 |
| B10856 | (I.Z) | N.3.2 |
| B10857 | (I.Z) | N.3.3 |
| B10858 | (I.Z) | N.3.4 |
| B10859 | (I.Z) | N.3.5 |
| B10860 | (I.Z) | N.3.6 |
| B10861 | (I.Z) | N.3.7 |
| B10862 | (I.Z) | N.3.8 |
| B10863 | (I.Z) | N.3.9 |
| B10864 | (I.Z) | N.3.10 |
| B10865 | (I.Z) | N.3.11 |
| B10866 | (I.Z) | N.3.12 |
| B10867 | (I.Z) | N.3.13 |
| B10868 | (I.Z) | N.3.14 |
| B10869 | (I.Z) | N.3.15 |
| B10870 | (I.Z) | N.3.16 |
| B10871 | (I.Z) | N.3.17 |
| B10872 | (I.Z) | N.3.18 |
| B10873 | (I.Z) | N.3.19 |
| B10874 | (I.Z) | N.3.20 |
| B10875 | (I.Z) | N.3.21 |
| B10876 | (I.Z) | N.3.22 |
| B10877 | (I.Z) | N.3.23 |
| B10878 | (I.Z) | N.3.24 |
| B10879 | (I.Z) | N.3.25 |
| B10880 | (I.Z) | N.3.26 |
| B10881 | (I.Z) | N.3.27 |
| B10882 | (I.Z) | N.3.28 |
| B10883 | (I.Z) | N.3.29 |
| B10884 | (I.Z) | N.3.30 |
| B10885 | (I.Z) | N.3.31 |
| B10886 | (I.Z) | N.3.32 |
| B10887 | (I.Z) | N.3.33 |
| B10888 | (I.Z) | N.3.34 |
| B10889 | (I.Z) | N.3.35 |
| B10890 | (I.Z) | N.3.36 |
| B10891 | (I.Z) | N.3.37 |
| B10892 | (I.Z) | N.3.38 |
| B10893 | (I.Z) | N.3.39 |
| B10894 | (I.Z) | N.3.40 |
| B10895 | (I.Z) | N.3.41 |
| B10896 | (I.Z) | N.3.42 |
| B10897 | (I.Z) | N.3.43 |
| B10898 | (I.Z) | N.3.44 |
| B10899 | (I.Z) | N.3.45 |
| B10900 | (I.Z) | N.3.46 |
| B10901 | (I.Z) | N.3.47 |
| B10902 | (I.Z) | N.3.48 |
| B10903 | (I.Z) | N.3.49 |
| B10904 | (I.Z) | N.3.50 |
| B10905 | (I.Z) | N.3.51 |
| B10906 | (I.Z) | N.3.52 |
| B10907 | (I.Z) | N.3.53 |
| B10908 | (I.Z) | N.3.54 |
| B10909 | (I.Z) | N.3.55 |
| B10910 | (I.Z) | N.3.56 |
| B10911 | (I.Z) | N.3.57 |
| B10912 | (I.Z) | N.3.58 |
| B10913 | (I.Z) | N.3.59 |
| B10914 | (I.Z) | N.3.60 |
| B10915 | (I.Z) | N.3.61 |
| B10916 | (I.Z) | N.3.62 |
| B10917 | (I.Z) | N.3.63 |
| B10918 | (I.Z) | N.3.64 |
| B10919 | (I.Z) | N.3.65 |
| B10920 | (I.Z) | N.3.66 |
| B10921 | (I.Z) | N.3.67 |
| B10922 | (I.Z) | N.3.68 |
| B10923 | (I.Z) | N.3.69 |
| B10924 | (I.Z) | N.4.1 |
| B10925 | (I.Z) | N.4.2 |
| B10926 | (I.Z) | N.4.3 |
| B10927 | (I.Z) | N.4.4 |
| B10928 | (I.Z) | N.4.5 |
| B10929 | (I.Z) | N.4.6 |
| B10930 | (I.Z) | N.4.7 |
| B10931 | (I.Z) | N.4.8 |
| B10932 | (I.Z) | N.4.9 |
| B10933 | (I.Z) | N.4.10 |
| B10934 | (I.Z) | N.4.11 |
| B10935 | (I.Z) | N.4.12 |
| B10936 | (I.Z) | N.4.13 |
| B10937 | (I.Z) | N.4.14 |
| B10938 | (I.Z) | N.4.15 |
| B10939 | (I.Z) | N.4.16 |
| B10940 | (I.Z) | N.4.17 |
| B10941 | (I.Z) | N.4.18 |
| B10942 | (I.Z) | N.4.19 |
| B10943 | (I.Z) | N.4.20 |
| B10944 | (I.Z) | N.4.21 |
| B10945 | (I.Z) | N.4.22 |
| B10946 | (I.Z) | N.4.23 |
| B10947 | (I.Z) | N.4.24 |
| B10948 | (I.Z) | N.4.25 |
| B10949 | (I.Z) | N.4.26 |
| B10950 | (I.Z) | N.4.27 |
| B10951 | (I.Z) | N.4.28 |
| B10952 | (I.Z) | N.4.29 |
| B10953 | (I.Z) | N.4.30 |
| B10954 | (I.Z) | N.4.31 |
| B10955 | (I.Z) | N.4.32 |
| B10956 | (I.Z) | N.4.33 |
| B10957 | (I.Z) | N.4.34 |
| B10958 | (I.Z) | N.4.35 |
| B10959 | (I.Z) | N.4.36 |
| B10960 | (I.Z) | N.4.37 |
| B10961 | (I.Z) | N.4.38 |
| B10962 | (I.Z) | N.4.39 |
| B10963 | (I.Z) | N.4.40 |
| B10964 | (I.Z) | N.4.41 |
| B10965 | (I.Z) | N.4.42 |
| B10966 | (I.Z) | N.4.43 |
| B10967 | (I.Z) | N.4.44 |
| B10968 | (I.Z) | N.4.45 |
| B10969 | (I.Z) | N.4.46 |
| B10970 | (I.Z) | N.4.47 |
| B10971 | (I.Z) | N.5.1 |
| B10972 | (I.Z) | N.5.2 |
| B10973 | (I.Z) | N.5.3 |
| B10974 | (I.Z) | N.5.4 |
| B10975 | (I.Z) | N.5.5 |
| B10976 | (I.Z) | N.5.6 |
| B10977 | (I.Z) | N.5.7 |
| B10978 | (I.Z) | N.5.8 |
| B10979 | (I.Z) | N.5.9 |
| B10980 | (I.Z) | N.5.10 |
| B10981 | (I.Z) | N.5.11 |
| B10982 | (I.Z) | N.5.12 |
| B10983 | (I.Z) | N.5.13 |
| B10984 | (I.Z) | N.5.14 |
| B10985 | (I.Z) | N.5.15 |
| B10986 | (I.Z) | N.5.16 |
| B10987 | (I.Z) | N.5.17 |
| B10988 | (I.Z) | N.5.18 |
| B10989 | (I.Z) | N.5.19 |
| B10990 | (I.Z) | N.5.20 |
| B10991 | (I.Z) | N.5.21 |
| B10992 | (I.Z) | N.5.22 |
| B10993 | (I.Z) | N.5.23 |
| B10994 | (I.Z) | N.5.24 |
| B10995 | (I.Z) | N.5.25 |
| B10996 | (I.Z) | N.5.26 |
| B10997 | (I.Z) | N.5.27 |
| B10998 | (I.Z) | N.6.1 |
| B10999 | (I.Z) | N.6.2 |
| B11000 | (I.Z) | N.6.3 |
| B11001 | (I.Z) | N.6.4 |
| B11002 | (I.Z) | N.7.1 |
| B11003 | (I.Z) | N.7.2 |
| B11004 | (I.Z) | N.7.3 |
| B11005 | (I.Z) | N.7.4 |
| B11006 | (I.Z) | N.7.5 |
| B11007 | (I.Z) | N.8.1 |
| B11008 | (I.Z) | N.9.1 |
| B11009 | (I.Z) | N.9.2 |
| B11010 | (I.Z) | N.9.3 |
| B11011 | (I.Z) | N.9.4 |
| B11012 | (I.Z) | N.9.5 |
| B11013 | (I.Z) | N.9.6 |
| B11014 | (I.Z) | N.9.7 |
| B11015 | (I.Z) | N.9.8 |
| B11016 | (I.Z) | N.9.9 |
| B11017 | (I.Z) | N.9.10 |
| B11018 | (I.Z) | N.9.11 |
| B11019 | (I.Z) | N.9.12 |
| B11020 | (I.Z) | N.9.13 |
| B11021 | (I.Z) | N.9.14 |
| B11022 | (I.Z) | N.9.15 |
| B11023 | (I.Z) | N.9.16 |
| B11024 | (I.Z) | N.9.17 |
| B11025 | (I.Z) | N.9.18 |
| B11026 | (I.Z) | N.9.19 |
| B11027 | (I.Z) | N.9.20 |
| B11028 | (I.Z) | N.9.21 |
| B11029 | (I.Z) | N.9.22 |
| B11030 | (I.Z) | N.9.23 |
| B11031 | (I.Z) | N.9.24 |
| B11032 | (I.Z) | N.9.25 |
| B11033 | (I.Z) | N.9.26 |
| B11034 | (I.Z) | N.10.1 |
| B11035 | (I.Z) | N.10.2 |
| B11036 | (I.Z) | N.10.3 |
| B11037 | (I.Z) | N.10.4 |
| B11038 | (I.Z) | N.10.5 |
| B11039 | (I.Z) | N.10.6 |
| B11040 | (I.Z) | N.10.7 |
| B11041 | (I.Z) | N.10.8 |
| B11042 | (I.Z) | N.10.9 |
| B11043 | (I.Z) | N.10.10 |
| B11044 | (I.Z) | N.10.12 |
| B11045 | (I.Z) | N.10.13 |
| B11046 | (I.Z) | N.10.14 |
| B11047 | (I.Z) | N.10.15 |
| B11048 | (I.Z) | N.10.16 |
| B11049 | (I.Z) | N.10.17 |
| B11050 | (I.Z) | N.10.18 |
| B11051 | (I.Z) | N.10.19 |
| B11052 | (I.Z) | N.10.20 |
| B11053 | (I.Z) | N.10.21 |
| B11054 | (I.Z) | N.10.22 |
| B11055 | (I.Z) | N.10.23 |
| B11056 | (I.Z) | N.10.24 |
| B11057 | (I.Z) | N.10.25 |
| B11058 | (I.Z) | N.10.26 |
| B11059 | (I.Z) | N.10.27 |
| B11060 | (I.Z) | N.10.28 |
| B11061 | (I.Z) | N.10.29 |
| B11062 | (I.Z) | N.10.30 |
| B11063 | (I.Z) | N.10.31 |
| B11064 | (I.Z) | N.10.32 |
| B11065 | (I.Z) | N.10.33 |
| B11066 | (I.Z) | N.10.34 |
| B11067 | (I.Z) | N.10.35 |
| B11068 | (I.Z) | N.10.36 |
| B11069 | (I.Z) | N.11.1 |
| B11070 | (I.Z) | N.11.2 |
| B11071 | (I.Z) | N.11.3 |
| B11072 | (I.Z) | N.11.4 |
| B11073 | (I.Z) | N.11.5 |
| B11074 | (I.Z) | N.11.6 |
| B11075 | (I.Z) | N.11.7 |
| B11076 | (I.Z) | N.12.1 |
| B11077 | (I.Z) | N.12.2 |
| B11078 | (I.Z) | N.12.3 |
| B11079 | (I.Z) | N.13.1 |
| B11080 | (I.Z) | N.13.2 |
| B11081 | (I.Z) | N.13.3 |
| B11082 | (I.Z) | N.13.4 |
| B11083 | (I.Z) | N.13.5 |
| B11084 | (I.Z) | N.13.6 |
| B11085 | (I.Z) | N.13.7 |
| B11086 | (I.Z) | N.13.8 |
| B11087 | (I.Z) | N.13.9 |
| B11088 | (I.Z) | N.13.10 |
| B11089 | (I.Z) | N.13.11 |
| B11090 | (I.Z) | N.13.12 |
| B11091 | (I.Z) | N.13.13 |
| B11092 | (I.Z) | N.13.14 |
| B11093 | (I.Z) | N.13.15 |
| B11094 | (I.Z) | N.13.16 |
| B11095 | (I.Z) | N.13.17 |
| B11096 | (I.Z) | N.13.18 |
| B11097 | (I.Z) | N.13.19 |
| B11098 | (I.Z) | N.13.20 |
| B11099 | (I.Z) | N.13.21 |
| B11100 | (I.Z) | N.13.22 |
| B11101 | (I.Z) | N.13.23 |
| B11102 | (I.Z) | N.13.24 |
| B11103 | (I.Z) | N.13.25 |
| B11104 | (I.Z) | N.13.26 |
| B11105 | (I.Z) | N.13.27 |
| B11106 | (I.Z) | N.13.28 |
| B11107 | (I.Z) | N.13.29 |
| B11108 | (I.Z) | N.13.30 |
| B11109 | (I.Z) | N.13.31 |
| B11110 | (I.Z) | N.13.32 |
| B11111 | (I.Z) | N.14.1 |
| B11112 | (I.Z) | N.14.2 |
| B11113 | (I.Z) | N.14.3 |
| B11114 | (I.Z) | N.14.4 |
| B11115 | (I.Z) | N.15.1 |
| B11116 | (I.Z) | N.15.2 |
| B11117 | (I.Z) | N.15.3 |
| B11118 | (I.Z) | N.15.4 |
| B11119 | (I.Z) | N.15.5 |
| B11120 | (I.Z) | N.15.6 |
| B11121 | (I.Z) | N.15.7 |
| B11122 | (I.Z) | N.15.8 |
| B11123 | (I.Z) | N.15.9 |
| B11124 | (I.Z) | N.15.10 |
| B11125 | (I.Z) | N.15.11 |
| B11126 | (I.Z) | N.15.12 |
| B11127 | (I.Z) | N.15.13 |
| B11128 | (I.Z) | N.15.14 |
| B11129 | (I.Z) | N.15.15 |
| B11130 | (I.Z) | N.15.16 |
| B11131 | (I.Z) | N.15.17 |
| B11132 | (I.Z) | N.15.18 |
| B11133 | (I.Z) | N.15.19 |
| B11134 | (I.Z) | N.15.20 |
| B11135 | (I.Z) | N.15.21 |
| B11136 | (I.Z) | N.15.22 |
| B11137 | (I.Z) | N.15.23 |
| B11138 | (I.Z) | N.15.24 |
| B11139 | (I.Z) | N.15.25 |
| B11140 | (I.Z) | N.15.26 |
| B11141 | (I.Z) | N.15.27 |
| B11142 | (I.Z) | N.15.28 |
| B11143 | (I.Z) | N.15.29 |
| B11144 | (I.Z) | N.15.30 |
| B11145 | (I.Z) | N.15.31 |
| B11146 | (I.Z) | N.15.32 |
| B11147 | (I.Z) | N.15.33 |
| B11148 | (I.Z) | N.15.34 |
| B11149 | (I.Z) | N.15.35 |
| B11150 | (I.Z) | N.15.36 |

B = Mixture;
I = compound I;
II = compound II

Table 26: The binary mixtures B11151 to B11596 correspond to the mixtures B1 to B446, wherein compound I.A is replaced by compound I.AA.

Table 27: The binary mixtures B11597 to B12042 correspond to the mixtures B1 to B446, wherein compound I.A is replaced by compound I.AB.

Table 28: The binary mixtures B12043 to B12488 correspond to the mixtures B1 to B446, wherein compound I.A is replaced by compound I.AC.

Table 29: The binary mixtures B12489 to B12934 correspond to the mixtures B1 to B446, wherein compound I.A is replaced by compound I.AD.

Table 30: The binary mixtures B12935 to B13380 correspond to the mixtures B1 to B446, wherein compound I.A is replaced by compound I.AE.

Table 31: The binary mixtures B13381 to B13826 correspond to the mixtures B1 to B446, wherein compound I.A is replaced by compound I.AF.

Table 32: The binary mixtures B13827 to B14272 correspond to the mixtures B1 to B446, wherein compound I.A is replaced by compound I.AG.

Table 33: The binary mixtures B14273 to B14718 correspond to the mixtures B1 to B446, wherein compound I.A is replaced by compound I.AH.

Table 34: The binary mixtures B14719 to B15164 correspond to the mixtures B1 to B446, wherein compound I.A is replaced by compound I.AI.

Table 35: The binary mixtures B15165 to B15610 correspond to the mixtures B1 to B446, wherein compound I.A is replaced by compound I.AJ.

Table 36: The binary mixtures B15611 to B16056 correspond to the mixtures B1 to B446, wherein compound I.A is replaced by compound I.AK.

Table 37: The binary mixtures B16057 to B16502 correspond to the mixtures B1 to B446, wherein compound I.A is replaced by compound I.AL.

Table 38: The binary mixtures B16503 to B16948 correspond to the mixtures B1 to B446, wherein compound I.A is replaced by compound I.AM.

Table 39: The binary mixtures B16949 to B17394 correspond to the mixtures B1 to B446, wherein compound I.A is replaced by compound I.AN.

Table 40: The binary mixtures B17395 to B17840 correspond to the mixtures B1 to B446, wherein compound I.A is replaced by compound I.AO.

Table 41: The binary mixtures B17841 to B18286 correspond to the mixtures B1 to B446, wherein compound I.A is replaced by compound I.AP.

Table 42: The binary mixtures B18287 to B18732 correspond to the mixtures B1 to B446, wherein compound I.A is replaced by compound I.AQ.

Table 43: The binary mixtures B18733 to B19178 correspond to the mixtures B1 to B446, wherein compound I.A is replaced by compound I.AR.

Table 44: The binary mixtures B19179 to B19624 correspond to the mixtures B1 to B446, wherein compound I.A is replaced by compound I.AS.

Table 45: The binary mixtures B19625 to B20070 correspond to the mixtures B1 to B446, wherein compound I.A is replaced by compound I.AT.

Table 46: The binary mixtures B20071 to B20516 correspond to the mixtures B1 to B446, wherein compound I.A is replaced by compound I.AU.

Table 47: The binary mixtures B20517 to B20962 correspond to the mixtures B1 to B446, wherein compound I.A is replaced by compound I.AV.

Table 48: The binary mixtures B20963 to B21408 correspond to the mixtures B1 to B446, wherein compound I.A is replaced by compound I.AW.

Table 49: The binary mixtures B21409 to B21854 correspond to the mixtures B1 to B446, wherein compound I.A is replaced by compound I.AX.

The compounds II (herbicides) may also have fungicidal, insecticidal, acaricidal, molluscidal, pheromone, nematicidal, plant stress reducing, plant growth regulator, plant growth promoting and/or yield enhancing activity.

The present invention furthermore relates to agrochemical compositions comprising a mixture of at least one compound I and at least one compound II (herbicide) as described above, and if desired at least one suitable auxiliary.

The mixtures and compositions according to the invention can also be present together with further pesticides, e.g. with herbicides, insecticides, growth regulators, fungicides; or else with fertilizers, as pre-mix or, if appropriate, not until immeadiately prior to use (tank mix).

In one embodiment, the mixture according to the invention comprises as active components one active compound I (nitrification inhibitor), or an agriculturally useful salt thereof, and one active compound II and one active compound III selected from group of insecticides, fungicides, growth regulators, biopesticides, urease inhibitors, nitrification inhibitors, and denitrification inhibitors.

Mixing a composition comprising at least one compound I and at least one compound II with further herbicides results in many cases in an improvement of the nitrification inhibition effect and/or an improvement of the health of a plant and/or an improvement of the plant growth regulation. Furthermore, in many cases, synergistic effects are obtained.

Mixing a composition comprising at least one compound I and at least one compound II with further herbicides results in many cases in an expansion of the herbicidal spectrum of activity or in a prevention of herbicide resistance development. Furthermore, in many cases, synergistic effects are obtained.

The mixtures and compositions according to the invention are suitable as nitrification inhibitors, improvers for the plant yield, or improvers for the plant health.

The term “plant propagation material” is to be understood to denote all the generative parts of the plant such as seeds and vegetative plant material such as cuttings and tubers (e.g. potatoes), which can be used for the multiplication of the plant. This includes seeds, roots, fruits, tubers, bulbs, rhizomes, shoots, sprouts and other parts of plants, including seedlings and young plants, which are to be transplanted after germination or after emergence from soil.

These young plants may also be protected before transplantation by a total or partial treatment by immersion or pouring.

Preferably, treatment of plant propagation materials with the inventive mixtures and compositions thereof, respectively, is used for controlling a multitude of weeds.

The term “cultivated plants” is to be understood as including plants which have been modified by breeding, mutagenesis or genetic engineering including but not limiting to agricultural biotech products on the market or in development (cf. http://cera-gmc.org/, see GM crop database therein). Genetically modified plants are plants, which genetic material has been so modified by the use of recombinant DNA techniques that under natural circumstances cannot readily be obtained by cross breeding, mutations or natural recombination. Typically, one or more genes have been integrated into the genetic material of a genetically modified plant in order to improve certain properties of the plant. Such genetic modifications also include but are not limited to targeted post-transtional modification of protein(s), oligo- or polypeptides e.g. by glycosylation or polymer additions such as prenylated, acetylated or farnesylated moieties or PEG moieties.

Plants that have been modified by breeding, mutagenesis or genetic engineering, e.g. have been rendered tolerant to applications of specific classes of herbicides, such as hydroxyphenylpyruvate dioxygenase (HPPD) inhibitors; acetolactate synthase (ALS) inhibitors, such as sulfonyl ureas (see e.g. U.S. Pat. No. 6,222,100, WO 01/82685, WO 00/26390, WO 97/41218, WO 98/02526, WO 98/02527, WO 04/106529, WO 05/20673, WO 03/14357, WO 03/13225, WO 03/14356, WO 04/16073) or imidazolinones (see e.g. U.S. Pat. No. 6,222,100, WO 01/82685, WO 00/026390, WO 97/41218, WO 98/002526, WO 98/02527, WO 04/106529, WO 05/20673, WO 03/014357, WO 03/13225, WO 03/14356, WO 04/16073); enolpyruvylshikimate-3-phosphate synthase (EPSPS) inhibitors, such as glyphosate (see e.g. WO 92/00377); glutamine synthetase (GS) inhibitors, such as glufosinate (see e.g. EP-A 242 236, EP-A 242 246) or oxynil herbicides (see e.g. U.S. Pat. No. 5,559,024) as a result of conventional methods of breeding or genetic engineering. Several cultivated plants have been rendered tolerant to herbicides by conventional methods of breeding (mutagenesis), e.g. Clearfield® summer rape (Canola, BASF SE, Germany) being tolerant to imidazolinones, e.g. imazamox. Genetic engineering methods have been used to render cultivated plants such as soybean, cotton, corn, beets and rape, tolerant to herbicides such as glyphosate and glufosinate, some of which are commercially available under the trade names RoundupReady® (glyphosate-tolerant, Monsanto, U.S.A.) and LibertyLink® (glufosinate-tolerant, Bayer CropScience, Germany).

Furthermore, plants are also covered that are by the use of recombinant DNA techniques capable to synthesize one or more insecticidal proteins, especially those known from the bacterial genus Bacillus, particularly from Bacillus thuringiensis, such as δ-endotoxins, e.g. CryIA(b), CryIA(c), CryIF, CryIF(a2), CryIIA(b), CryIIIA, CryIIIB(b1) or Cry9c; vegetative insecticidal proteins (VIP), e.g. VIP1, VIP2, VIP3 or VIP3A; insecticidal proteins of bacteria colonizing nematodes, e.g. Photorhabdus spp. or Xenorhabdus spp.; toxins produced by animals, such as scorpion toxins, arachnid toxins, wasp toxins, or other insect-specific neurotoxins; toxins produced by fungi, such Streptomycetes toxins, plant lectins, such as pea or barley lectins; agglutinins; proteinase inhibitors, such as trypsin inhibitors, serine protease inhibitors, patatin, cystatin or papain inhibitors; ribosome-inactivating proteins (RIP), such as ricin, maize-RIP, abrin, luffin, saporin or bryodin; steroid metabolism enzymes, such as 3-hydroxysteroid oxidase, ecdysteroid-IDP-glycosyl-transferase, cholesterol oxidases, ecdysone inhibitors or HMG-CoA-reductase; ion channel blockers, such as blockers of sodium or calcium channels; juvenile hormone esterase; diuretic hormone receptors (helicokinin receptors); stilben synthase, bibenzyl synthase, chitinases or glucanases. In the context of the present invention these insecticidal proteins or toxins are to be understood expressly also as pre-toxins, hybrid proteins, truncated or otherwise modified proteins. Hybrid proteins are characterized by a new combination of protein domains, (see, e.g. WO02/015701). Further examples of such toxins or genetically modified plants capable of synthesizing such toxins are disclosed, e.g., in EP-A374753, WO93/007278, WO95/34656, EP-A427529, EP-A451 878, WO03/18810 and WO03/52073. The methods for producing such genetically modified plants are generally known to the person skilled in the art and are described, e.g. in the publications mentioned above. These insecticidal proteins contained in the genetically modified plants impart to the plants producing these proteins tolerance to harmful pests from all taxonomic groups of athropods, especially to beetles (Coeloptera), two-winged insects (Diptera), and moths (Lepidoptera) and to nematodes (Nematoda). Genetically modified plants capable to synthesize one or more insecticidal proteins are, e.g., described in the publications mentioned above, and some of which are commercially available such as YieldGard® (corn cultivars producing the Cry1Ab toxin), YieldGard® Plus (corn cultivars producing Cry1Ab and Cry3Bb1 toxins), Starlink® (corn cultivars producing the Cry9c toxin), Herculex® RW (corn cultivars producing Cry34Ab1, Cry35Ab1 and the enzyme Phosphinothricin-N-Acetyltransferase [PAT]); NuCOTN® 33B (cotton cultivars producing the Cry1Ac toxin), Bollgard® I (cotton cultivars producing the Cry1Ac toxin), Bollgard® II (cotton cultivars producing Cry1Ac and Cry2Ab2 toxins); VIPCOT® (cotton cultivars producing a VIP-toxin); NewLeaf® (potato cultivars producing the Cry3A toxin); Bt-Xtra®, NatureGard®, KnockOut®, BiteGard®, Protects®, Bt11 (e.g. Agrisure® CB) and Bt176 from Syngenta Seeds SAS, France, (corn cultivars producing the Cry1Ab toxin and PAT enyzme), MIR604 from Syngenta Seeds SAS, France (corn cultivars producing a modified version of the Cry3A toxin, c.f. WO 03/018810), MON 863 from Monsanto Europe S.A., Belgium (corn cultivars producing the Cry3Bb1 toxin), IPC 531 from Monsanto Europe S.A., Belgium (cotton cultivars producing a modified version of the Cry1Ac toxin) and 1507 from Pioneer Overseas Corporation, Belgium (corn cultivars producing the Cry1F toxin and PAT enzyme).

Furthermore, plants are also covered that are by the use of recombinant DNA techniques capable to synthesize one or more proteins to increase the resistance or tolerance of those plants to bacterial, viral or fungal pathogens. Examples of such proteins are the so-called “pathogenesis-related proteins” (PR proteins, see, e.g. EP-A 392 225), plant disease resistance genes (e.g. potato cultivars, which express resistance genes acting against Phytophthora infestans derived from the mexican wild potato Solanum bulbocastanum) or T4-lysozym (e.g. potato cultivars capable of synthesizing these proteins with increased resistance against bacteria such as Erwinia amylvora). The methods for producing such genetically modified plants are generally known to the person skilled in the art and are described, e.g. in the publications mentioned above.

Furthermore, plants are also covered that are by the use of recombinant DNA techniques capable to synthesize one or more proteins to increase the productivity (e.g. bio mass production, grain yield, starch content, oil content or protein content), tolerance to drought, salinity or other growth-limiting environmental factors or tolerance to pests and fungal, bacterial or viral pathogens of those plants.

Furthermore, plants are also covered that contain by the use of recombinant DNA techniques a modified amount of substances of content or new substances of content, specifically to improve human or animal nutrition, e.g. oil crops that produce health-promoting long-chain omega-3 fatty acids or unsaturated omega-9 fatty acids (e.g. Nexera® rape, DOW Agro Sciences, Canada).

Furthermore, plants are also covered that contain by the use of recombinant DNA techniques a modified amount of substances of content or new substances of content, specifically to improve raw material production, e.g. potatoes that produce increased amounts of amylopectin (e.g. Amflora® potato, BASF SE, Germany).

The method of treatment according to the invention can also be used in the field of protecting stored products or harvest against attack of fungi and microorganisms. According to the present invention, the term “stored products” is understood to denote natural substances of plant or animal origin and their processed forms, which have been taken from the natural life cycle and for which long-term protection is desired. Stored products of crop plant origin, such as plants or parts thereof, for example stalks, leafs, tubers, seeds, fruits or grains, can be protected in the freshly harvested state or in processed form, such as pre-dried, moistened, comminuted, ground, pressed or roasted, which process is also known as post-harvest treatment. Also falling under the definition of stored products is timber, whether in the form of crude timber, such as construction timber, electricity pylons and barriers, or in the form of finished articles, such as furniture or objects made from wood. Stored products of animal origin are hides, leather, furs, hairs and the like. The combinations according the present invention can prevent disadvantageous effects such as decay, discoloration or mold. Preferably “stored products” is understood to denote natural substances of plant origin and their processed forms, more preferably fruits and their processed forms, such as pomes, stone fruits, soft fruits and citrus fruits and their processed forms.

Preferably the inventive mixtures and compositions are used for controlling a multitude of pests on field crops, such as potatoes sugar beets, tobacco, wheat, rye, barley, oats, rice, corn, cotton, soybeans, rape, legumes, sunflowers, coffee or sugar cane; fruits; vines; ornamentals; or vegetables, such as cucumbers, tomatoes, beans or squashes.

Plant propagation materials may be treated with the mixtures and compositions of the invention prophylactically either at or before planting or transplanting.

In particular, the present invention relates to a method for protection of plant propagation material from pests, wherein the plant propagation material is treated with an effective amount of an inventive mixture.

Depending on the application method in question, the mixtures or compositions according to the invention can additionally be employed in a further number of crop plants for eliminating undesirable plants. Examples of suitable crops are the following: Allium cepa, Ananas comosus, Arachis hypogaea, Asparagus officinalis, Avena sativa, Beta vulgaris spec. altissima, Beta vulgaris spec. rapa, Brassica napus var. napus, Brassica napus var. napobrassica, Brassica rapa var. silvestris, Brassica oleracea, Brassica nigra, Camellia sinensis, Carthamus tinctorius, Carya illinoinensis, Citrus limon, Citrus sinensis, Coffea arabica (Coffea canephora, Coffea liberica), Cucumis sativus, Cynodon dactylon, Daucus carota, Elaeis guineensis, Fragaria vesca, Glycine max, Gossypium hirsutum, (Gossypium arboreum, Gossypium herbaceum, Gossypium vitifolium), Helianthus annuus, Hevea brasiliensis, Hordeum vulgare, Humulus lupulus, Ipomoea batatas, Juglans regia, Lens culinaris, Linum usitatissimum, Lycopersicon lycopersicum, Malus spec., Manihot esculenta, Medicago sativa, Musa spec., Nicotiana tabacum (N. rustica), Olea europaea, Oryza sativa, Phaseolus lunatus, Phaseolus vulgaris, Picea abies, Pinus spec., Pistacia vera, Pisum sativum, Prunus avium, Prunus persica, Pyrus communis, Prunus armeniaca, Prunus cerasus, Prunus dulcis and prunus domestica, Ribes sylvestre, Ricinus communis, Saccharum officinarum, Secale cereale, Sinapis alba, Solanum tuberosum, Sorghum bicolor (s. vulgare), Theobroma cacao, Trifolium pratense, Triticum aestivum, Triticale, Triticum durum, Vicia faba, Vitis vinifera, Zea mays.

Preferred crops are Arachis hypogaea, Beta vulgaris spec. altissima, Brassica napus var. napus, Brassica oleracea, Citrus limon, Citrus sinensis, Coffea arabica (Coffea canephora, Coffea liberica), Cynodon dactylon, Glycine max, Gossypium hirsutum, (Gossypium arboreum, Gossypium herbaceum, Gossypium vitifolium), Helianthus annuus, Hordeum vulgare, Juglans regia, Lens culinaris, Linum usitatissimum, Lycopersicon lycopersicum, Malus spec., Medicago sativa, Nicotiana tabacum (N. rustica), Olea europaea, Oryza sativa, Phaseolus lunatus, Phaseolus vulgaris, Pistacia vera, Pisum sativum, Prunus dulcis, Saccharum officinarum, Secale cereale, Solanum tuberosum, Sorghum bicolor (s. vulgare), Triticale, Triticum aestivum, Triticum durum, Vicia faba, Vitis vinifera and Zea mays

Especially preferred crops are crops of cereals, corn, soybeans, rice, oilseed rape, cotton, potatoes, peanuts or permanent crops.

The mixtures or compositions according to the invention can also be used in crops which have been modified by mutagenesis or genetic engineering in order to provide a new trait to a plant or to modify an already present trait.

The term “crops” as used herein includes also (crop) plants which have been modified by mutagenesis or genetic engineering in order to provide a new trait to a plant or to modify an already present trait.

Mutagenesis includes techniques of random mutagenesis using X-rays or mutagenic chemicals, but also techniques of targeted mutagenesis, in order to create mutations at a specific locus of a plant genome. Targeted mutagenesis techniques frequently use oligonucleotides or proteins like CRISPR/Cas, zinc-finger nucleases, TALENs or meganucleases to achieve the targeting effect.

Genetic engineering usually uses recombinant DNA techniques to create modifications in a plant genome which under natural circumstances cannot readily be obtained by cross breeding, mutagenesis or natural recombination. Typically, one or more genes are integrated into the genome of a plant in order to add a trait or improve a trait. These integrated genes are also referred to as transgenes in the art, while plant comprising such transgenes are referred to as transgenic plants. The process of plant transformation usually produces several transformation events, wich differ in the genomic locus in which a transgene has been integrated. Plants comprising a specific transgene on a specific genomic locus are usually described as comprising a specific “event”, which is referred to by a specific event name. Traits which have been introduced in plants or hae been modified include in particular herbicide tolerance, insect resistance, increased yield and tolerance to abiotic conditions, like drought.

Herbicide tolerance has been created by using mutagenesis as well as using genetic engineering. Plants which have been rendered tolerant to acetolactate synthase (ALS) inhibitor herbicides by conventional methods of mutagenesis and breeding comprise plant varieties commercially available under the name Clearfield®. However, most of the herbicide tolerance traits have been created via the use of transgenes.

Herbicide tolerance has been created to glyphosate, glufosinate, 2,4-D, dicamba, oxynil herbicides, like bromoxynil and ioxynil, sulfonylurea herbicides, ALS inhibitor herbicides and 4-hydroxyphenylpyruvate dioxygenase (HPPD) inhibitors, like isoxaflutole and mesotrione.

Transgenes wich have been used to provide herbicide tolerance traits comprise: for tolerance to glyphosate: cp4 epsps, epsps grg23ace5, mepsps, 2mepsps, gat4601, gat4621 and goxv247, for tolerance to glufosinate: pat and bar, for tolerance to 2,4-D: aad-1 and aad-12, for tolerance to dicamba: dmo, for tolerance to oxynil herbicies: bxn, for tolerance to sulfonylurea herbicides: zm-hra, csr1-2, gm-hra, S4-HrA, for tolerance to ALS inhibitor herbicides: csr1-2, for tolerance to HPPD inhibitor herbicides: hppdPF, W336 and avhppd-03.

Transgenic corn events comprising herbicide tolerance genes are for example, but not excluding others, DAS40278, MON801, MON802, MON809, MON810, MON832, MON87411, MON87419, MON87427, MON88017, MON89034, NK603, GA21, MZHGOJG, HCEM485, VCO-01981-5, 676, 678, 680, 33121, 4114, 59122, 98140, Bt10, Bt176, CBH-351, DBT418, DLL25, MS3, MS6, MZIR098, T25, TC1507 and TC6275.

Transgenic soybean events comprising herbicide tolerance genes are for example, but not excluding others, GTS 40-3-2, MON87705, MON87708, MON87712, MON87769, MON89788, A2704-12, A2704-21, A5547-127, A5547-35, DP356043, DAS44406-6, DAS68416-4, DAS-81419-2, GU262, SYHTØH2, W62, W98, FG72 and CV127.

Transgenic cotton events comprising herbicide tolerance genes are for example, but not excluding others, 19-51a, 31707, 42317, 81910, 281-24-236, 3006-210-23, BXN10211, BXN10215, BXN10222, BXN10224, MON1445, MON1698, MON88701, MON88913, GHB119, GHB614, LLCotton25, T303-3 and T304-40.

Transgenic canola events comprising herbicide tolerance genes are for example, but not excluding others, MON88302, HCR-1, HCN10, HCN28, HCN92, MS1, MS8, PHY14, PHY23, PHY35, PHY36, RF1, RF2 and RF3.

Insect resistance has mainly been created by transferring bacterial genes for insecticidal proteins to plants. Transgenes which have most frequently been used are toxin genes of Bacillus spec. and synthetic variants thereof, like cry1A, cry1Ab, cry1Ab-Ac, cry1Ac, cry1A.105, cry1F, cry1Fa2, cry2Ab2, cry2Ae, mcry3A, ecry3.1Ab, cry3Bb1, cry34Ab1, cry35Ab1, cry9C, vip3A(a), vip3Aa20. However, also genes of plant origin have been transferred to other plants. In particular genes coding for protease inhibitors, like CpTI and pinll. A further approach uses transgenes in order to produce double stranded RNA in plants to target and downregulate insect genes. An example for such a transgene is dvsnf7.

Transgenic corn events comprising genes for insecticidal proteins or double stranded RNA are for example, but not excluding others, Bt10, Bt11, Bt176, MON801, MON802, MON809, MON810, MON863, MON87411, MON88017, MON89034, 33121, 4114, 5307, 59122, TC1507, TC6275, CBH-351, MIR162, DBT418 and MZIR098.

Transgenic soybean events comprising genes for insecticidal proteins are for example, but not excluding others, MON87701, MON87751 and DAS-81419.

Transgenic cotton events comprising genes for insecticidal proteins are for example, but not excluding others, SGK321, MON531, MON757, MON1076, MON15985, 31707, 31803, 31807, 31808, 42317, BNLA-601, Event1, COT67B, COT102, T303-3, T304-40, GFM Cry1A, GK12, MLS 9124, 281-24-236, 3006-210-23, GHB119 and SGK321.

Increased yield has been created by increasing ear biomass using the transgene athbl7, being present in corn event MON87403, or by enhancing photosynthesis using the transgene bbx32, being present in the soybean event MON87712.

Crops comprising a modified oil content have been created by using the transgenes: gm-fad2-1, Pj.D6D, Nc.Fad3, fad2-1A and fatbl-A. Soybean events comprising at least one of these genes are: 260-05, MON87705 and MON87769.

Tolerance to abiotic conditions, in particular to tolerance to drought, has been created by using the transgene cspB, comprised by the corn event MON87460 and by using the transgene Hahb-4, comprised by soybean event IND-00410-5.

Traits are frequently combined by combining genes in a transformation event or by combining different events during the breeding process. Preferred combination of traits are herbicide tolerance to different groups of herbicides, insect tolerance to different kind of insects, in particular tolerance to lepidopteran and coleopteran insects, herbicide tolerance with one or several types of insect resistance, herbicide tolerance with increased yield as well as a combination of herbicide tolerance and tolerance to abiotic conditions.

Plants comprising singular or stacked traits as well as the genes and events providing these traits are well known in the art. For example, detailed information as to the mutagenized or integrated genes and the respective events are available from websites of the organizations “International Service for the Acquisition of Agri-biotech Applications (ISAAA)” (http://www.isaaa.org/gmapprovaldatabase) and the “Center for Environmental Risk Assessment (CERA)” (http://cera-gmc.org/GMCropDatabase), as well as in patent applications, like EP3028573 and WO2017/011288.

The use of compositions according to the invention on crops may result in effects which are specific to a crop comprising a certain gene or event. These effects might involve changes in growth behavior or changed resistance to biotic or abiotic stress factors. Such effects may in particular comprise enhanced yield, enhanced resistance or tolerance to insects, nematodes, fungal, bacterial, mycoplasma, viral or viroid pathogens as well as early vigour, early or delayed ripening, cold or heat tolerance as well as changed amino acid or fatty acid spectrum or content.

Furthermore, plants are also covered that contain by the use of recombinant DNA techniques a modified amount of ingredients or new ingredients, specifically to improve raw material production, e.g., potatoes that produce increased amounts of amylopectin (e.g. Amflora® potato, BASF SE, Germany).

Furthermore, it has been found that the mixtures or compositions according to the invention are also suitable for the defoliation and/or desiccation of plant parts, for which crop plants such as cotton, potato, oilseed rape, sunflower, soybean or field beans, in particular cotton, are suitable. In this regard compositions have been found for the desiccation and/or defoliation of plants, processes for preparing these compositions, and methods for desiccating and/or defoliating plants using the mixtures or compositions according to the invention.

As desiccants, the mixtures or compositions according to the invention are suitable in particular for desiccating the above-ground parts of crop plants such as potato, oilseed rape, sunflower and soybean, but also cereals. This makes possible the fully mechanical harvesting of these important crop plants.

Also of economic interest is the facilitation of harvesting, which is made possible by concentrating within a certain period of time the dehiscence, or reduction of adhesion to the tree, in citrus fruit, olives and other species and varieties of pomaceous fruit, stone fruit and nuts. The same mechanism, i.e. the promotion of the development of abscission tissue between fruit part or leaf part and shoot part of the plants is also essential for the controlled defoliation of useful plants, in particular cotton.

Moreover, a shortening of the time interval in which the individual cotton plants mature leads to an increased fiber quality after harvesting.

In general, “pesticidally effective amount” means the amount of the inventive mixtures or of compositions comprising the mixtures needed to achieve an observable effect on growth, including the effects of necrosis, death, retardation, prevention, and removal, destruction, or otherwise diminishing the occurrence and activity of the target organism. The pesticidally effective amount can vary for the various mixtures/compositions used in the invention. A pesticidally effective amount of the mixtures/compositions will also vary according to the prevailing conditions such as desired pesticidal effect and duration, weather, target species, locus, mode of application, and the like.

In an equally preferred embodiment, the present invention relates to a method for improving the nitrification-inhibiting effect, wherein the seeds, the plants or the soil are treated with a NI effective amount of an inventive mixture.

The term “NI effective amount” denotes an amount of the inventive mixtures, which is sufficient for achieving nitrification-inhibiting effects as defined herein below. More exemplary information about amounts, ways of application and suitable ratios to be used is given below. Anyway, the skilled artisan is well aware of the fact that such an amount can vary in a broad range and is dependent on various factors, e.g. weather, target species, locus, mode of application, soil type, the treated cultivated plant or material and the climatic conditions.

According to the present invention, the nitrification-inhibiting effect is increased by at least 2%, more preferably by at least 4%, most preferably at least 7%, particularly preferably at least 10%, more particularly preferably by at least 15%, most particularly preferably by at least 20%, particularly more preferably by at least 25%, particularly most preferably by at least 30%, particularly by at least 35%, especially more preferably by at least 40%, especially most preferably by at least 45%, especially by at least 50%, in particular preferably by at least 55%, in particular more preferably by at least 60%, in particular most preferably by at least 65%, in particular by at least 70%, for example by at least 75%. In general, the increase of the nitrification-inhibiting effect may be for example 5 to 10%, more preferably 10 to 20%, most preferably 20 to 30%. The nitrification-inhibiting effect can be measured according to the Example 1 and Example 2 as shown below:

### EXAMPLE 1

The compositions and mixtures of the invention have been tested as follows in terms of the inhibition of nitrification:

Soil was sampled fresh from a field (e.g. Limburgerhof), dried and sieved through a 500 μm sieve. Approximately 200 mg of soil were placed into each well of a 48 well plate. The compositions or mixtures of the invention, or DMSO alone, were added at a concentration of 10 ppm, dissolved in 1% DMSO. 6 μmol ammonium sulfate was added per well as well as 4.8 mg NaClO₃.

Subsequently, the samples were incubated at room temperature for up to 72 hrs. After the incubation period 64 mg KCl were added and mixed. 25 μl of the supernatant were placed into a fresh plate and 260 μl of a color reaction solution (from Merck Nr 1.11799.0100) were added.

Measurements were taken with a Tecan plate Reader at 540 nm wavelength.

### EXAMPLE 2: (FOR THOSE RESULTS WITH A % INHIBITION AND NOT RESULTS IN PPM)

100 g soil is filled into 500 ml plastic bottles (e.g. soil sampled from the field) and is moistened to 50% water holding capacity. The soil is incubated at 20° C. for two weeks to activate the microbial biomass. 1 ml test solution, containing the compositions and mixtures of the invention in the appropriate concentration (usually 0.3 or 1% of nitrogen N), or DMSO and 10 mg nitrogen in the form of ammoniumsulfate-N is added to the soil and everything mixed well. Bottles are capped but loosely to allow air exchange. The bottles are then incubated at 20° C. for 0 and 14 days.

For analysis, 300 ml of a 1% K2SO4-solution is added to the bottle containing the soil and shaken for 2 hrs in a horizontal shaker at 150 rpm. Then the whole solution is filtered through a Macherey-Nagel Filter MN 807 ¼. Ammonium and nitrate content is then analyzed in the filtrate in an autoanalyzer at 550 nm (Merck, AA11).

### Calculations:

$$inhibition in \% = \frac{( \begin{matrix}NO3 - N without NI at end of incubation - \\ NO3 - N with NI at end of incubation\end{matrix} )}{( \begin{matrix}NO3 - N without NI at end of incubation - \\ NO3 - N at beginning\end{matrix} )} \times 100$$

In an equally preferred embodiment, the present invention relates to a method for improving the health of plants, wherein the plants are treated with a plant health effective amount of an inventive mixture.

The term “plant health effective amount” denotes an amount of the inventive mixtures, which is sufficient for achieving plant health effects as defined herein below. More exemplary information about amounts, ways of application and suitable ratios to be used is given below. Anyway, the skilled artisan is well aware of the fact that such an amount can vary in a broad range and is dependent on various factors, e.g. the treated cultivated plant or material and the climatic conditions.

Healthier plants are desirable since they result among others in better yields and/or a better quality of the plants or crops, specifically better quality of the harvested plant parts. Healthier plants also better resist to biotic and/or abiotic stress. A high resistance against biotic stresses in turn allows the person skilled in the art to reduce the quantity of pesticides applied and consequently to slow down the development of resistances against the respective pesticides.

It has to be emphasized that the above mentioned effects of the inventive mixtures, i.e. enhanced health of the plant, are also present when the plant is not under biotic stress and in particular when the plant is not under pest pressure.

For example, for seed treatment and soil applications, it is evident that a plant suffering from fungal or insecticidal attack shows reduced germination and emergence leading to poorer plant or crop establishment and vigor, and consequently, to a reduced yield as compared to a plant propagation material which has been subjected to curative or preventive treatment against the relevant pest and which can grow without the damage caused by the biotic stress factor.

However, the methods according to the invention lead to an enhanced plant health even in the absence of any biotic stress. This means that the positive effects of the mixtures of the invention cannot be explained just by the pesticidal activities of the compounds I and compounds II, but are based on further activity profiles. Accordingly, the application of the inventive mixtures can also be carried out in the absence of pest pressure.

In an equally preferred embodiment, the present invention relates to a method for improving the health of plants grown from said plant propagation material, wherein the plant propagation material is treated with an effective amount of an inventive mixture.

Each plant health indicator listed below, which is selected from the groups consisting of yield, plant vigor, quality and tolerance of the plant to abiotic and/or biotic stress, is to be understood as a preferred embodiment of the present invention either each on its own or preferably in combination with each other.

According to the present invention, “increased yield” of a plant means that the yield of a product of the respective plant is increased by a measurable amount over the yield of the same product of the plant produced under the same conditions, but without the application of the inventive mixture.

For seed treatment e.g. as inoculant and/or foliar application forms, increased yield can be characterized, among others, by the following improved properties of the plant: increased plant weight; and/or increased plant height; and/or increased biomass such as higher overall fresh weight (FW) or dry weight (DW); and/or increased number of flowers per plant; and/or higher grain and/or fruit yield; and/or more tillers or side shoots (branches); and/or larger leaves; and/or increased shoot growth; and/or increased protein content; and/or increased oil content; and/or increased starch content; and/or increased pigment content; and/or increased chlorophyll content (chlorophyll content has a positive correlation with the plant's photosynthesis rate and accordingly, the higher the chlorophyll content the higher the yield of a plant) and/or increased quality of a plant; and/or better nitrogen uptake (N uptake).

“Grain” and “fruit” are to be understood as any plant product which is further utilized after harvesting, e.g. fruits in the proper sense, vegetables, nuts, grains, seeds, wood (e.g. in the case of silviculture plants), flowers (e.g. in the case of gardening plants, ornamentals) etc., that is anything of economic value that is produced by the plant.

According to the present invention, the yield is increased by at least 2%, more preferably by at least 4%, most preferably at least 7%, particularly preferably at least 10%, more particularly preferably by at least 15%, most particularly preferably by at least 20%, particularly more preferably by at least 25%, particularly most preferably by at least 30%, particularly by at least 35%, especially more preferably by at least 40%, especially most preferably by at least 45%, especially by at least 50%, in particular preferably by at least 55%, in particular more preferably by at least 60%, in particular most preferably by at least 65%, in particular by at least 70%, for example by at least 75%.

According to the present invention, the yield—if measured in the absence of pest pressure—is increased by at least 2%, more preferably by at least 4%, most preferably at least 7%, particularly preferably at least 10%, more particularly preferably by at least 15%, most particularly preferably by at least 20%, particularly more preferably by at least 25%, particularly most preferably by at least 30%, particularly by at least 35%, especially more preferably by at least 40%, especially most preferably by at least 45%, especially by at least 50%, in particular preferably by at least 55%, in particular more preferably by at least 60%, in particular most preferably by at least 65%, in particular by at least 70%, for example by at least 75%.

Another indicator for the condition of the plant is the plant vigor. The plant vigor becomes manifest in several aspects such as the general visual appearance.

For foliar applications, improved plant vigor can be characterized, among others, by the following improved properties of the plant: improved vitality of the plant; and/or improved plant growth; and/or improved plant development; and/or improved visual appearance; and/or improved plant stand (less plant verse/lodging and/or bigger leaf blade; and/or bigger size; and/or increased plant height; and/or increased tiller number; and/or increased number of side shoots; and/or increased number of flowers per plant; and/or increased shoot growth; and/or enhanced photosynthetic activity (e.g. based on increased stomatal conductance and/or increased CO₂ assimilation rate)); and/or earlier flowering; and/or earlier fruiting; and/or earlier grain maturity; and/or less non-productive tillers; and/or less dead basal leaves; and/or less input needed (such as fertilizers or water); and/or greener leaves; and/or complete maturation under shortened vegetation periods; and/or easier harvesting; and/or faster and more uniform ripening; and/or longer shelf-life; and/or longer panicles; and/or delay of senescence; and/or stronger and/or more productive tillers; and/or better extractability of ingredients; and/or improved quality of seeds (for being seeded in the following seasons for seed production); and/or reduced production of ethylene and/or the inhibition of its reception by the plant.

Another indicator for the condition of the plant is the “quality” of a plant and/or its products. According to the present invention, enhanced quality means that certain plant characteristics such as the content or composition of certain ingredients are increased or improved by a measurable or noticeable amount over the same factor of the plant produced under the same conditions, but without the application of the mixtures of the present invention. Enhanced quality can be characterized, among others, by following improved properties of the plant or its product: increased nutrient content; and/or increased protein content; and/or increased oil content; and/or increased starch content; and/or increased content of fatty acids; and/or increased metabolite content; and/or increased carotenoid content; and/or increased sugar content; and/or increased amount of essential amino acids; and/or improved nutrient composition; and/or improved protein composition; and/or improved composition of fatty acids; and/or improved metabolite composition; and/or improved carotenoid composition; and/or improved sugar composition; and/or improved amino acids composition; and/or improved or optimal fruit color; and/or improved leaf color; and/or higher storage capacity; and/or better processability of the harvested products.

Another indicator for the condition of the plant is the plant's tolerance or resistance to biotic and/or abiotic stress factors. Biotic and abiotic stress, especially over longer terms, can have harmful effects on plants.

Biotic stress is caused by living organisms while abiotic stress is caused for example by environmental extremes. According to the present invention, “enhanced tolerance or resistance to biotic and/or abiotic stress factors” means (1) that certain negative factors caused by biotic and/or abiotic stress are diminished in a measurable or noticeable amount as compared to plants exposed to the same conditions, but without being treated with an inventive mixture and (2) that the negative effects are not diminished by a direct action of the inventive mixture on the stress factors, e.g. by its fungicidal or insecticidal action which directly destroys the microorganisms or pests, but rather by a stimulation of the plants' own defensive reactions against said stress factors.

Negative factors caused by biotic stress such as pathogens and pests are widely known and are caused by living organisms, such as competing plants (for example weeds), microorganisms (such as phythopathogenic fungi and/or bacteria) and/or viruses.

Negative factors caused by abiotic stress are also well-known and can often be observed as reduced plant vigor (see above), for example:

less yield and/or less vigor, for both effects examples can be burned leaves, less flowers, pre-mature ripening, later crop maturity, reduced nutritional value amongst others.

Abiotic stress can be caused for example by: extremes in temperature such as heat or cold (heat stress/cold stress); and/or strong variations in temperature; and/or temperatures unusual for the specific season; and/or drought (drought stress); and/or extreme wetness; and/or high salinity (salt stress); and/or radiation (for example by increased UV radiation due to the decreasing ozone layer); and/or increased ozone levels (ozone stress); and/or organic pollution (for example by phythotoxic amounts of pesticides); and/or inorganic pollution (for example by heavy metal contaminants).

As a result of biotic and/or abiotic stress factors, the quantity and the quality of the stressed plants decrease. As far as quality (as defined above) is concerned, reproductive development is usually severely affected with consequences on the crops which are important for fruits or seeds. Synthesis, accumulation and storage of proteins are mostly affected by temperature; growth is slowed by almost all types of stress; polysaccharide synthesis, both structural and storage is reduced or modified: these effects result in a decrease in biomass (yield) and in changes in the nutritional value of the product.

As pointed out above, the above identified indicators for the health condition of a plant may be interdependent and may result from each other. For example, an increased resistance to biotic and/or abiotic stress may lead to a better plant vigor, e.g. to better and bigger crops, and thus to an increased yield. Inversely, a more developed root system may result in an increased resistance to biotic and/or abiotic stress. However, these interdependencies and interactions are neither all known nor fully understood and therefore the different indicators are described separately.

In one embodiment the inventive mixtures effectuate an increased yield of a plant or its product. In another embodiment the inventive mixtures effectuate an increased vigor of a plant or its product. In another embodiment the inventive mixtures effectuate in an increased quality of a plant or its product. In yet another embodiment the inventive mixtures effectuate an increased tolerance and/or resistance of a plant or its product against biotic stress. In yet another embodiment the inventive mixtures effectuate an increased tolerance and/or resistance of a plant or its product against abiotic stress.

The invention also relates to agrochemical compositions comprising an auxiliary and at least one compound I and at least one compound II, or a cell-free extract of compound II or at least one metabolite thereof having pesticidal activity, and/or a mutant of compound II having pesticidal activity and producing at least one pesticidal metabolite as defined herein, or a pesticidal metabolite or extract of the mutant, and at least one pesticide II according to the invention.

An agrochemical composition comprises a NI effective amount or plant health effective amount of compound I. Such an amount can vary in a broad range and is dependent on various factors, e.g. weather, target species, locus, mode of application, soil type, the treated cultivated plant or material and the climatic conditions.

An agrochemical composition comprises a herbicidally or plant health effective amount of compound II, or a cell-free extract thereof or at least one metabolite thereof having pesticidal activity, and/or a mutant of compound II having pesticidal activity and producing at least one pesticidal metabolite as defined herein, or a pesticidal metabolite or extract of the mutant, and at least one pesticide II. Such an amount can vary in a broad range and is dependent on various factors, such as the fungal or pest species to be controlled, the treated cultivated plant or material, the climatic conditions.

According to one embodiment, individual components of the composition according to the invention such as parts of a kit or parts of a binary or ternary mixture may be mixed by the user himself in a spray tank or any other kind of vessel used for applications (e.g seed treater drums, seed pelleting machinery, knapsack sprayer) and further auxiliaries may be added, if appropriate. When living microorganisms form part of such kit, it must be taken care that choice and amounts of the other parts of the kit (e.g. chemical pesticidal agents) and of the further auxiliaries should not influence the viability of the microbial pesticides in the composition mixed by the user. Especially for bactericides and solvents, compatibility with the respective microbial pesticide has to be taken into account.

Consequently, one embodiment of the invention is a kit for preparing a usable pesticidal composition, the kit comprising a) a composition comprising compound I as defined herein and at least one auxiliary; and b) a composition comprising compound II as defined herein and at least one auxiliary; and optionally c) a composition comprising at least one auxiliary and optionally a further active component III as defined herein.

The compounds or mixtures or compositions according to the invention can be converted into customary types of agrochemical compositions, e.g. solutions, emulsions, suspensions, dusts, powders, pastes, granules, pressings, capsules, and mixtures thereof. Examples for composition types are suspensions (e.g. SC, OD, FS), emulsifiable concentrates (e.g. EC), emulsions (e.g. EW, EO, ES, ME), capsules (e.g. CS, ZC), pastes, pastilles, wettable powders or dusts (e.g. WP, SP, WS, DP, DS), pressings (e.g. BR, TB, DT), granules (e.g. WG, SG, GR, FG, GG, MG), insecticidal articles (e.g. LN), as well as gel formulations for the treatment of plant propagation materials such as seeds (e.g. GF). These and further compositions types are defined in the “Catalogue of pesticide formulation types and international coding system”, Technical Monograph No. 2, 6^{th} Ed. May 2008, CropLife International.

The compositions are prepared in a known manner, such as described by Mollet and Grubemann, Formulation technology, Wiley VCH, Weinheim, 2001; or Knowles, New developments in crop protection product formulation, Agrow Reports DS243, T&F Informa, London, 2005.

Suitable auxiliaries are solvents, liquid carriers, solid carriers or fillers, surfactants, dispersants, emulsifiers, wetters, adjuvants, solubilizers, penetration enhancers, protective colloids, adhesion agents, thickeners, humectants, repellents, attractants, feeding stimulants, compatibilizers, bactericides, anti-freezing agents, anti-foaming agents, colorants, tackifiers and binders.

Suitable solvents and liquid carriers are water and organic solvents, such as mineral oil fractions of medium to high boiling point, e.g. kerosene, diesel oil; oils of vegetable or animal origin; aliphatic, cyclic and aromatic hydrocarbons, e.g. toluene, paraffin, tetrahydronaphthalene, alkylated naphthalenes; alcohols, e.g. ethanol, propanol, butanol, benzylalcohol, cyclohexanol; glycols; DMSO; ketones, e.g. cyclohexanone; esters, e.g. lactates, carbonates, fatty acid esters, gamma-butyrolactone; fatty acids; phosphonates; amines; amides, e.g. N-methylpyrrolidone, fatty acid dimethylamides; and mixtures thereof.

Suitable solid carriers or fillers are mineral earths, e.g. silicates, silica gels, talc, kaolins, limestone, lime, chalk, clays, dolomite, diatomaceous earth, bentonite, calcium sulfate, magnesium sulfate, magnesium oxide; polysaccharides, e.g. cellulose, starch; fertilizers, e.g. ammonium sulfate, ammonium phosphate, ammonium nitrate, ureas; products of vegetable origin, e.g. cereal meal, tree bark meal, wood meal, nutshell meal, and mixtures thereof.

Suitable surfactants are surface-active compounds, such as anionic, cationic, nonionic and amphoteric surfactants, block polymers, polyelectrolytes, and mixtures thereof. Such surfactants can be used as emusifier, dispersant, solubilizer, wetter, penetration enhancer, protective colloid, or adjuvant. Examples of surfactants are listed in McCutcheon's, Vol. 1: Emulsifiers & Detergents, McCutcheon's Directories, Glen Rock, USA, 2008 (International Ed. or North American Ed.).

Suitable anionic surfactants are alkali, alkaline earth or ammonium salts of sulfonates, sulfates, phosphates, carboxylates, and mixtures thereof. Examples of sulfonates are alkylarylsulfonates, diphenylsulfonates, alpha-olefin sulfonates, lignine sulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and alkylnaphthalenes, sulfosuccinates or sulfosuccinamates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl carboxylates, and carboxylated alcohol or alkylphenol ethoxylates.

Suitable nonionic surfactants are alkoxylates, N-subsituted fatty acid amides, amine oxides, esters, sugar-based surfactants, polymeric surfactants, and mixtures thereof. Examples of alkoxylates are compounds such as alcohols, alkylphenols, amines, amides, arylphenols, fatty acids or fatty acid esters which have been alkoxylated with 1 to 50 equivalents. Ethylene oxide and/or propylene oxide may be employed for the alkoxylation, preferably ethylene oxide. Examples of N-subsititued fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or alkylpolyglucosides. Examples of polymeric surfactants are home- or copolymers of vinylpyrrolidone, vinylalcohols, or vinylacetate.

Suitable cationic surfactants are quaternary surfactants, for example quaternary ammonium compounds with one or two hydrophobic groups, or salts of long-chain primary amines. Suitable amphoteric surfactants are alkylbetains and imidazolines. Suitable block polymers are block polymers of the A-B or A-B-A type comprising blocks of polyethylene oxide and polypropylene oxide, or of the A-B-C type comprising alkanol, polyethylene oxide and polypropylene oxide. Suitable polyelectrolytes are polyacids or polybases. Examples of polyacids are alkali salts of polyacrylic acid or polyacid comb polymers. Examples of polybases are polyvinylamines or polyethyleneamines.

Suitable adjuvants are compounds, which have a neglectable or even no pesticidal activity themselves, and which improve the biological performance of the compound I on the target. Examples are surfactants, mineral or vegetable oils, and other auxilaries. Further examples are listed by Knowles, Adjuvants and additives, Agrow Reports DS256, T&F Informa UK, 2006, chapter 5.

Suitable thickeners are polysaccharides (e.g. xanthan gum, carboxymethylcellulose), anorganic clays (organically modified or unmodified), polycarboxylates, and silicates.

Suitable bactericides are bronopol and isothiazolinone derivatives such as alkylisothiazolinones and benzisothiazolinones. Suitable anti-freezing agents are ethylene glycol, propylene glycol, urea and glycerin. Suitable anti-foaming agents are silicones, long chain alcohols, and salts of fatty acids. Suitable colorants (e.g. in red, blue, or green) are pigments of low water solubility and water-soluble dyes. Examples are inorganic colorants (e.g. iron oxide, titan oxide, iron hexacyanoferrate) and organic colorants (e.g. alizarin-, azo- and phthalocyanine colorants). Suitable tackifiers or binders are polyvinylpyrrolidons, polyvinylacetates, polyvinyl alcohols, polyacrylates, biological or synthetic waxes, and cellulose ethers.

When living microorganisms form part of the compositions, such compositions can be prepared as compositions comprising besides the active ingredients at least one auxiliary (inert ingredient) by usual means (see e.g. H. D. Burges: Formulation of Micobial Biopesticides, Springer, 1998). Suitable customary types of such compositions are suspensions, dusts, powders, pastes, granules, pressings, capsules, and mixtures thereof. Examples for composition types are suspensions (e.g. SC, OD, FS), capsules (e.g. CS, ZC), pastes, pastilles, wettable powders or dusts (e.g. WP, SP, WS, DP, DS), pressings (e.g. BR, TB, DT), granules (e.g. WG, SG, GR, FG, GG, MG), insecticidal articles (e.g. LN), as well as gel formulations for the treatment of plant propagation materials such as seeds (e.g. GF). Herein, it has to be taken into account that each formulation type or choice of auxiliary should not influence the viability of the microorganism during storage of thecomposition and when finally applied to the soil, plant or plant propagation material. Suitable formulations are e.g. mentioned in WO2008/002371, U.S. Pat. Nos. 6,955,912, 5,422,107.

Examples for suitable auxiliaries are those mentioned earlier herein, wherein it must be taken care that choice and amounts of such auxiliaries should not influence the viability of the microbial pesticides in the composition. Especially for bactericides and solvents, compatibility with the respective microorganism of the respective microbial pesticide has to be taken into account. In addition, compositions with microbial pesticides may further contain stabilizers or nutrients and UV protectants. Suitable stabilzers or nutrients are e.g. alpha-tocopherol, trehalose, glutamate, potassium sorbate, various sugars like glucose, sucrose, lactose and maltodextrine (H. D. Burges: Formulation of Micobial Biopesticides, Springer, 1998). Suitable UV protectants are e.g. inorganic compouns like titan dioxide, zinc oxide and iron oxide pigments or organic compounds like benzophenones, benzotriazoles and phenyltriazines. The compositions may in addition to auxiliaries mentioned for compositions comprising compounds I herein optionally comprise 0.1-80% stabilizers or nutrients and 0.1-10% UV protectants.

Examples for composition types and their preparation are:

### i) Water-Soluble Concentrates (SL, LS)

10-60 wt % of a compound I and 5-15 wt % wetting agent (e.g. alcohol alkoxylates) are dissolved in water and/or in a water-soluble solvent (e.g. alcohols) ad 100 wt %. The active substance dissolves upon dilution with water.

### ii) Dispersible Concentrates (DC)

5-25 wt % of a compound I and 1-10 wt % dispersant (e.g. polyvinylpyrrolidone) are dissolved in organic solvent (e.g. cyclohexanone) ad 100 wt %. Dilution with water gives a dispersion.

iii) Emulsifiable Concentrates (EC)

15-70 wt % of a compound I and 5-10 wt % emulsifiers (e.g. calcium dodecylbenzenesulfonate and castor oil ethoxylate) are dissolved in water-insoluble organic solvent (e.g. aromatic hydrocarbon) ad 100 wt %. Dilution with water gives an emulsion.

### iv) Emulsions (EW, EO, ES)

5-40 wt % of a compound I and 1-10 wt % emulsifiers (e.g. calcium dodecylbenzenesulfonate and castor oil ethoxylate) are dissolved in 20-40 wt % water-insoluble organic solvent (e.g. aromatic hydrocarbon). This mixture is introduced into water ad 100 wt % by means of an emulsifying machine and made into a homogeneous emulsion. Dilution with water gives an emulsion.

### v) Suspensions (SC, OD, FS)

In an agitated ball mill, 20-60 wt % of a compound I are comminuted with addition of 2-10 wt % dispersants and wetting agents (e.g. sodium lignosulfonate and alcohol ethoxylate), 0.1-2 wt % thickener (e.g. xanthan gum) and water ad 100 wt % to give a fine active substance suspension. Dilution with water gives a stable suspension of the active substance. For FS type composition up to 40 wt % binder (e.g. polyvinylalcohol) is added.

### vi) Water-Dispersible Granules and Water-Soluble Granules (WG, SG)

50-80 wt % of a compound I are ground finely with addition of dispersants and wetting agents (e.g. sodium lignosulfonate and alcohol ethoxylate) ad 100 wt % and prepared as water-dispersible or water-soluble granules by means of technical appliances (e.g. extrusion, spray tower, fluidized bed). Dilution with water gives a stable dispersion or solution of the active substance.

vii) Water-Dispersible Powders and Water-Soluble Powders (WP, SP, WS)

50-80 wt % of a compound I are ground in a rotor-stator mill with addition of 1-5 wt % dispersants (e.g. sodium lignosulfonate), 1-3 wt % wetting agents (e.g. alcohol ethoxylate) and solid carrier (e.g. silica gel) ad 100 wt %. Dilution with water gives a stable dispersion or solution of the active substance.

viii) Gel (GW, GF)

In an agitated ball mill, 5-25 wt % of a compound I are comminuted with addition of 3-10 wt % dispersants (e.g. sodium lignosulfonate), 1-5 wt % thickener (e.g. carboxymethylcellulose) and water ad 100 wt % to give a fine suspension of the active substance. Dilution with water gives a stable suspension of the active substance.

### ix) Microemulsion (ME)

5-20 wt % of a compound I are added to 5-30 wt % organic solvent blend (e.g. fatty acid dimethylamide and cyclohexanone), 10-25 wt % surfactant blend (e.g. alcohol ethoxylate and arylphenol ethoxylate), and water ad 100%. This mixture is stirred for 1 h to produce spontaneously a thermodynamically stable microemulsion.

### x) Microcapsules (CS)

An oil phase comprising 5-50 wt % of a compound I, 0-40 wt % water insoluble organic solvent (e.g. aromatic hydrocarbon), 2-15 wt % acrylic monomers (e.g. methylmethacrylate, methacrylic acid and a di- or triacrylate) are dispersed into an aqueous solution of a protective colloid (e.g. polyvinyl alcohol). Radical polymerization initiated by a radical initiator results in the formation of poly(meth)acrylate microcapsules. Alternatively, an oil phase comprising 5-50 wt % of a compound I according to the invention, 0-40 wt % water insoluble organic solvent (e.g. aromatic hydrocarbon), and an isocyanate monomer (e.g. diphenylmethene-4,4′-diisocyanatae) are dispersed into an aqueous solution of a protective colloid (e.g. polyvinyl alcohol). The addition of a polyamine (e.g. hexamethylenediamine) results in the formation of polyurea microcapsules. The monomers amount to 1-10 wt %. The wt % relate to the total CS composition.

### xi) Dustable Powders (DP, DS)

1-10 wt % of a compound I are ground finely and mixed intimately with solid carrier (e.g. finely divided kaolin) ad 100 wt %.

xii) Granules (GR, FG)

0.5-30 wt % of a compound I is ground finely and associated with solid carrier (e.g. silicate) ad 100 wt %. Granulation is achieved by extrusion, spray-drying or fluidized bed.

xiii) Ultra-Low Volume Liquids (UL)

1-50 wt % of a compound I are dissolved in organic solvent (e.g. aromatic hydrocarbon) ad 100 wt %.

The compositions types i) to xiii) may optionally comprise further auxiliaries, such as 0.1-1 wt % bactericides, 5-15 wt % anti-freezing agents, 0.1-1 wt % anti-foaming agents, and 0.1-1 wt % colorants.

The compositions types i) to vii) may optionally comprise further auxiliaries, such as 0.1-1 wt % bactericides, 5-15 wt % anti-freezing agents, 0.1-1 wt % anti-foaming agents, 0.1-80% stabilizers or nutrients, 0.1-10% UV protectants and 0.1-1 wt % colorants.

The compositions types i) to xi) may optionally comprise further auxiliaries, such as 0.1-1 wt % bactericides, 5-15 wt % anti-freezing agents, 0.1-1 wt % anti-foaming agents, and 0.1-1 wt % colorants.

The agrochemical compositions generally are characterized in that they contain an effective quantity of the active components as defined above. Generally, they contain between 0.01 and 95%, preferably between 0.1 and 90%, and in particular between 0.5 and 75%, by weight of active components, in particular active substances.

Solutions for seed treatment (LS), suspoemulsions (SE), flowable concentrates (FS), powders for dry treatment (DS), water-dispersible powders for slurry treatment (WS), water-soluble powders (SS), emulsions (ES), emulsifiable concentrates (EC) and gels (GF) are usually employed for the purposes of treatment of plant propagation materials, particularly seeds.

Preferred examples of seed treatment formulation types or soil application for pre-mix compositions are of WS, LS, ES, FS, WG or CS-type.

The compositions in question give, after two-to-tenfold dilution, active components concentrations of from 0.01 to 60% by weight, preferably from 0.1 to 40%, in the ready-to-use preparations. Application can be carried out before or during sowing. Methods for applying or treating compound I and compound II and compositions thereof, respectively, on to plant propagation material, especially seeds include dressing, coating, pelleting, dusting, soaking and in-furrow application methods of the propagation material. Preferably, compound I and compound II or the compositions thereof, respectively, are applied on to the plant propagation material by a method such that germination is not induced, e.g. by seed dressing, pelleting, coating and dusting.

Typically, a pre-mix formulation for seed treatment application comprises 0.5 to 99.9 percent, especially 1 to 95 percent, of the desired ingredients, and 99.5 to 0.1 percent, especially 99 to 5 percent, of a solid or liquid adjuvant (including, for example, a solvent such as water), where the auxiliaries can be a surfactant in an amount of 0 to 50 percent, especially 0.5 to 40 percent, based on the pre-mix formulation. Whereas commercial products will preferably be formulated as concentrates (e.g., pre-mix composition (formulation)), the end user will normally employ dilute formulations (e.g., tank mix composition).

Seed treatment methods for applying or treating inventive mixtures and compositions thereof to plant propagation material, especially seeds, are known in the art, and include dressing, coating, filmcoating, pelleting and soaking application methods of the propagation material. Such methods are also applicable to the combinations according to the invention. In a preferred embodiment, the inventive mixture is applied or treated on to the plant propagation material by a method such that the germination is not negatively impacted. Accordingly, examples of suitable methods for applying (or treating) a plant propagation material, such as a seed, is seed dressing, seed coating or seed pelleting and alike.

It is preferred that the plant propagation material is a seed, seed piece (i.e. stalk) or seed bulb.

Although it is believed that the present method can be applied to a seed in any physiological state, it is preferred that the seed be in a sufficiently durable state that it incurs no damage during the treatment process. Typically, the seed would be a seed that had been harvested from the field; removed from the plant; and separated from any cob, stalk, outer husk, and surrounding pulp or other non-seed plant material. The seed would preferably also be biologically stable to the extent that the treatment would cause no biological damage to the seed. It is believed that the treatment can be applied to the seed at any time between harvest of the seed and sowing of the seed or during the sowing process (seed directed applications). The seed may also be primed either before or after the treatment.

Even distribution of the ingredients in inventive mixtures and adherence thereof to the seeds is desired during propagation material treatment. Treatment could vary from a thin film (dressing) of the formulation containing the combination, for example, a mixture of active ingredient(s), on a plant propagation material, such as a seed, where the original size and/or shape are recognizable to an intermediary state (such as a coating) and then to a thicker film (such as pelleting with many layers of different materials (such as carriers, for example, clays; different formulations, such as of other active ingredients; polymers; and colourants) where the original shape and/or size of the seed is no longer recognizable.

An aspect of the present invention includes application of the inventive mixtures onto the plant propagation material in a targeted fashion, including positioning the ingredients in the combination onto the entire plant propagation material or on only parts thereof, including on only a single side or a portion of a single side. One of ordinary skill in the art would understand these application methods from the description provided in EP954213B1 and WO06/112700.

The inventive mixtures can also be used in form of a “pill” or “pellet” or a suitable substrate and placing, or sowing, the treated pill, or substrate, next to a plant propagation material. Such techniques are known in the art, particularly in EP1124414, WO07/67042, and WO07/67044. Application of the combinations described herein onto plant propagation material also includes protecting the plant propagation material treated with the combination of the present invention by placing one or more pesticide-containing particles next to a pesticide-treated seed, wherein the amount of pesticide is such that the pesticide-treated seed and the pesticide-containing particles together contain an Effective Dose of the pesticide and the pesticide dose contained in the pesticide-treated seed is less than or equal to the Maximal Non-Phytotoxic Dose of the pesticide. Such techniques are known in the art, particularly in WO2005/120226.

Application of the combinations onto the seed also includes controlled release coatings on the seeds, wherein the ingredients of the combinations are incorporated into materials that release the ingredients over time. Examples of controlled release seed treatment technologies are generally known in the art and include polymer films, waxes, or other seed coatings, wherein the ingredients may be incorporated into the controlled release material or applied between layers of materials, or both.

Seed can be treated by applying thereto the compound s present in the inventive mixtures in any desired sequence or simultaneously.

The seed treatment occurs to an unsown seed, and the term “unsown seed” is meant to include seed at any period between the harvest of the seed and the sowing of the seed in the ground for the purpose of germination and growth of the plant.

Treatment to an unsown seed is not meant to include those practices in which the active ingredient is applied to the soil but would include any application practice that would target the seed during the planting process.

Preferably, the treatment occurs before sowing of the seed so that the sown seed has been pretreated with the combination. In particular, seed coating or seed pelleting are preferred in the treatment of the combinations according to the invention. As a result of the treatment, the ingredients in each combination are adhered on to the seed and therefore available for pest control.

The treated seeds can be stored, handled, sowed and tilled in the same manner as any other active ingredient treated seed.

In particular, the present invention relates to a method for protection of plant propagation material from pests and/or improving the health of plants grown from said plant propagation material, wherein the soil, wherein plant propagation material is sown, is treated with an effective amount of an inventive mixture.

In particular, the present invention relates to a method for protection of plant propagation material from pests, wherein the soil, wherein plant propagation material is sown, is treated with an effective amount of an inventive mixture.

In particular, the present invention relates to a method for protection of plant propagation material from harmful fungi, wherein the soil, wherein plant propagation material is sown, is treated with an effective amount of an inventive mixture.

In particular, the present invention relates to a method for protection of plant propagation material from animal pests (insects, acarids or nematodes), wherein the soil, wherein plant propagation material is sown, is treated with an effective amount of an inventive mixture.

In one embodiment, the treatment(s) are carried out as foliar application.

In another embodiment, the treatment(s) are carried out as soil application.

In one embodiment, the treatment(s) are carried out as seed treatment.

When employed in plant protection, the total amounts of active components applied are, depending on the kind of effect desired, from 0.001 to 10 kg per ha, preferably from 0.005 to 2 kg per ha, more preferably from 0.05 to 0.9 kg per ha, in particular from 0.1 to 0.75 kg per ha. In the case of compounds II, the application rates preferably range from about 1×10⁶ to 5×10¹⁵ (or more) CFU/ha. Preferably, the spore concentration is about 1×10⁷ to about 1×10¹² CFU/ha. In the case of (entomopathogenic) nematodes as microbial pesticides (e.g. Steinernema feltiae), the application rates preferably range inform about 1×10⁵ to 1×10¹² (or more), more preferably from 1×10⁸ to 1×10¹¹, even more preferably from 5×10⁸ to 1×10¹⁰ individuals (e.g. in the form of eggs, juvenile or any other live stages, preferably in an infetive juvenile stage) per ha.

When employed in plant protection by seed treatment, the amount of the inventive mixtures (based on total weight of active components) is in the range from 0.01-10 kg, preferably from 0.1-1000 g, more preferably from 1-100 g per 100 kg of plant propagation material (preferably seeds). In the case of compounds II, the application rates with respect to plant propagation material preferably range from about 1×10⁸ to 1×10¹² (or more) CFU/seed. Preferably, the concentration is about 1×10⁸ to about 1×10⁹ CFU/seed. In the case of compounds II, the application rates with respect to plant propagation material also preferably range from about 1×10⁷ to 1×10¹⁴ (or more) CFU per 100 kg of seed, preferably from 1×10⁹ to about 1×10¹² CFU per 100 kg of seed.

When used in the protection of materials or stored products, the amount of active components applied depends on the kind of application area and on the desired effect. Amounts customarily applied in the protection of materials are 0.001 g to 2 kg, preferably 0.005 g to 1 kg, of active components per cubic meter of treated material.

Various types of oils, wetters, adjuvants, fertilizer, or micronutrients, and further pesticides (e.g. herbicides, insecticides, fungicides, growth regulators, safeners, biopesticides) may be added to the mictures or compositions comprising them as premix or, if appropriate not until immediately prior to use (tank mix). These agents can be admixed with the mixtures or compositions according to the invention in a weight ratio of 1:100 to 100:1, preferably 1:10 to 10:1.

Preferably, the mixtures or compositions of the present invention further comprises at least one safener.

Safeners are chemical compounds which prevent or reduce damage on useful plants without having a major impact on the herbicidal action of the herbicidal active components of the present compositions towards unwanted plants. They can be applied either before sowings (e.g. on seed treatments, shoots or seedlings) or in the pre-emergence application or post-emergence application of the useful plant. The safeners and the compound I (nitrification inhibitor) and/or the compound II (herbicide) can be applied simultaneously or in succession.

Preferred safeners are e.g. (quinolin-8-oxy)acetic acids, 1-phenyl-5-haloalkyl-1H-1,2,4-triazol-3-carboxylic acids, 1-phenyl-4,5-dihydro-5-alkyl-1H-pyrazol-3,5-dicarboxylic acids, 4,5-dihydro-5,5-diaryl-3-isoxazol carboxylic acids, dichloroacetamides, alpha-oximinophenylacetonitriles, acetophenonoximes, 4,6-dihalo-2-phenylpyrimidines, N-[[4-(aminocarbonyl)phenyl]sulfonyl]-2-benzoic amides, 1,8-naphthalic anhydride, 2-halo-4-(haloalkyl)-5-thiazol carboxylic acids, phosphorthiolates and N-alkyl-O-phenylcarbamates and their agriculturally useful salts and their agriculturally acceptable derivatives such amides, esters, and thioesters, provided they have an acid group.

Particularly preferred safeners are benoxacor, cloquintocet, cyprosulfamide, dichlormid, fenchlorazole, fenclorim, furilazole, isoxadifen, mefenpyr, naphtalic anhydride, 4-(dichloroacetyl)-1-oxa-4-azaspiro[4.5]decane (MON4660, CAS 71526-07-3), 2,2,5-trimethyl-3-(dichloroacetyl)-1,3-oxazolidine (R-29148, CAS 52836-31-4) and N-(2-Methoxybenzoyl)-4-[(methylaminocarbonyl)amino]benzenesulfonamide (CAS 129531-12-0).

These further useful active compounds can be fertilizers or micronutrient donors (such as Mo, Zn and/or Co), especially when applied to plant propagation materials.

According to one embodiment, a polyether polymethylsiloxane copolymer may be added to the mixture or composition according to the invention, preferably in a weight ratio of 1:100 to 100:1, more preferably in a weight ratio of 1:10 to 10:1, in particular in a weight ratio of 1:5 to 5:1 based on the total weight of the compound I and compound II.

According to a further embodiment, a mineral oil or a vegetable oil may be added to the mixture or composition according to the invention, preferably in a weight ratio of 1:100 to 100:1, more preferably in a weight ratio of 1:10 to 10:1, in particular in a weight ratio of 1:5 to 5:1 based on the total weight of compound I and compound II.

The user applies the mixture or composition according to the invention usually from a predosage device, a knapsack sprayer, a spray tank, a spray plane, or an irrigation system. Usually, the agrochemical composition is made up with water, buffer, and/or further auxiliaries to the desired application concentration and the ready-to-use spray liquor or the agrochemical composition according to the invention is thus obtained. Usually, 20 to 2000 liters, preferably 50 to 400 liters, of the ready-to-use spray liquor are applied per hectare of agricultural useful area.

In one embodiment, the at least one compound I and the at least one compound II are applied simultaneously, either as a mixture or separately, or subsequently to the soil, the plant or the plant propagules.

Moreover, we have found that simultaneous, that is joint or separate, application of at least one active compound I and at least one active compound II or the successive application of at least one active compound I and at least one active compound II synergistically increase the efficacy for controlling pests or for improving the health of a plant or for inhibiting nitrification compared to the application of the individual components alone.

In one embodiment, compound I and compound II are present in a synergistically effective amount.

When applying at least one compound I and at least one comound II sequentially the time between both applications may vary e.g. between 2 hours to 7 days. Also a broader range is possible ranging from 0.25 hour to 30 days, preferably from 0.5 hour to 14 days, particularly from 1 hour to 7 days or from 1.5 hours to 5 days, even more preferred from 2 hours to 1 day.

In the mixtures and compositions, the compound ratios are advantageously chosen so as to produce a synergistic effect.

The term “synergstic effect” is understood to refer in particular to that defined by Colby's formula (Colby, S. R., “Calculating synergistic and antagonistic responses of herbicide combinations”, Weeds, 15, pp. 20-22, 1967).

The term “synergistic effect” is also understood to refer to that defined by application of the Tammes method, (Tammes, P. M. L., “Isoboles, a graphic representation of synergism in pesticides”, Netherl. J. Plant Pathol. 70, 1964).

According to the invention, the solid material (dry matter) of the herbicides (with the exception of oils) are considered as active components (e.g. to be obtained after drying or evaporation of the extraction medium or the suspension medium in case of liquid formulations of the microbial pesticides).

In accordance with the present invention, the weight ratios and percentages used herein for a biological extract such as Quillay extract are based on the total weight of the dry content (solid material) of the respective extract(s).

For mixtures according to the invention comprising compound I (nitrification inhibitor) and compound II (herbicide), the weight ratio of compound I and compound II generally depends from the properties of the active substances used, usually it is in the range of from 1:1000 to 1000:1, regularly in the range of from 1:500 to 500:1, preferably in the range of from 1:250 to 250:1, more preferably in the range of from 1:100 to 100:1, most preferably in the range of from 1:70 to 70:1, particularly preferably in the range of from 1:50 to 50:1, particularly more preferably in the range of from 1:30 to 30:1, particularly most preferably in the range from 1:20 to 20:1, particularly in the range of from 1:15 to 15:1, especially preferably in the range of from 1:10 to 10:1, especially more preferably in the range of from 1:8 to 8:1, especially most preferably in the range of from 1:6.5 to 6.5:1, especially in the range of from 1:5 to 5:1, in particular preferably in the range of 1:4 to 4:1, in particular more preferably in the range of from 1:3 to 3:1, in particular most preferably in the range of from 2.5:1 to 1:2.5, in particular in the range of from 1:2 to 2:1, for example in the range of from 1:1.5 to 1.5:1. For mixtures according to the invention, the weight ratio of compound I and compound II generally depends from the properties of the active substances used, usually it is not more than 1000:1, regularly not more than 250:1, preferably not more than 100:1, more preferably not more than 50:1, most preferably not more than 30:1, particularly preferably not more than 15:1, particularly more preferably not more than 8:1, particularly most preferably not more than 4:1, particularly not more than 2:1, especially preferably not more than 1:1, especially more preferably not more than 1:2, especially most preferably not more than 1:4, especially not more than 1:8, in particular preferably not more than 1:15, in particular more preferably not more than 1:30, in particular most preferably not more than 1:50, in particular not more than 1:100, for example preferably not more than 1:250, for example not more than 1:1000. For mixtures according to the invention, the weight ratio of compound I and compound II generally depends from the properties of the active substances used, usually it is at least 1000:1, regularly at least 250:1, preferably at least 100:1, more preferably at least 50:1, most preferably at least 30:1, particularly preferably at least 15:1, particularly more preferably at least 8:1, particularly most preferably at least 4:1, particularly at least 2:1, especially preferably at least 1:1, especially more preferably at least 1:2, especially most preferably at least 1:4, especially at least 1:8, in particular preferably at least 1:15, in particular more preferably at least 1:30, in particular most preferably at least 1:50, in particular at least 1:100, for example preferably at least 1:250, for example at least 1:1000.

In one preferred embodiment, compound I and compound II are present in a weight ratio of from 250:1 to 1:250, preferably in a weight ratio of from 100:1 to 1:100, more preferably in a weight ratio of from 50:1 to 1:50, more preferably in a weight ratio of from 30:1 to 1:30, most preferably in a weight ratio of from 15:1 to 1:15, particularly in a weight ratio of from 8:1 to 1:8, particularly preferably in a weight ratio of from 4:1 to 1:4, particularly more preferably in a weight ratio of from 2:1 to 1:2, particularly most preferably in a weight ratio of from 1.5:1 to 1:1.5.

In another preferred embodiment, compound I and compound II are present in a weight ratio of from 200:1 to 1:25, more preferably in a weight ratio of from 120:1 to 1:15, most preferably in a weight ratio of from 70:1 to 1:8, particularly preferably in a weight ratio of from 45:1 to 1:4, particularly more preferably in a weight ratio of from 30:1 to 1:2, particularly most preferably in a weight ratio of from 28:1 to 1:1, particularly in a weight ratio of from 20:1 to 3:1, for instance preferably in a weight ratio of from 16:1 to 5:1, for instance in a weight ratio of from 12:1 to 6:1.

In another preferred embodiment, compound I and compound II are present in a weight ratio of from 1000:1 to 1:20, more preferably in a weight ratio of from 800:1 to 1:10, most preferably in a weight ratio of from 600:1 to 1:1, particularly preferably in a weight ratio of from 400:1 to 10:1, particularly more preferably in a weight ratio of from 300:1 to 30:1, particularly most preferably in a weight ratio of from 250:1 to 50:1, particularly in a weight ratio of from 200:1 to 70:1, for instance preferably in a weight ratio of from 170:1 to 90:1, for instance in a weight ratio of from 150:1 to 100:1.

In one preferred embodiment, compound I and compound II are present in a weight ratio of from 250:1 to 1:250, preferably in a weight ratio of from 100:1 to 1:100, more preferably in a weight ratio of from 50:1 to 1:50, more preferably in a weight ratio of from 30:1 to 1:30, most preferably in a weight ratio of from 15:1 to 1:15, particularly in a weight ratio of from 8:1 to 1:8, particularly preferably in a weight ratio of from 4:1 to 1:4, particularly more preferably in a weight ratio of from 2:1 to 1:2, particularly most preferably in a weight ratio of from 1.5:1 to 1:1.5, wherein the total weight of compound II is based on the amount of the solid material (dry matter) of compound II.

In one preferred embodiment, compound I and compound II are present in a weight ratio of from 250:1 to 1:250, preferably in a weight ratio of from 100:1 to 1:100, more preferably in a weight ratio of from 50:1 to 1:50, more preferably in a weight ratio of from 30:1 to 1:30, most preferably in a weight ratio of from 15:1 to 1:15, particularly in a weight ratio of from 8:1 to 1:8, particularly preferably in a weight ratio of from 4:1 to 1:4, particularly more preferably in a weight ratio of from 2:1 to 1:2, particularly most preferably in a weight ratio of from 1.5:1 to 1:1.5, wherein the total weight of compound II is calculated on the basis of the amount of CFU of compound II, wherein 1×10⁹ CFU equals one gram of total weight of compound II.

According to a further embodiments of the binary mixtures and compositions, the weight ratio of the compound I and the compound II usually is in the range of from 1000:1 to 1:1, often in the range of from 100:1 to 1:1, regularly in the range of from 50:1 to 1:1, preferably in the range of from 20:1 to 1:1, more preferably in the range of from 10:1 to 1:1, even more preferably in the range of from 4:1 to 1:1 and in particular in the range of from 2:1 to 1:1.

According to a further embodiments of the binary mixtures and compositions, the weight ratio of the compound I and the compound II usually is in the range of from 1:1 to 1:1000, often in the range of from 1:1 to 1:100, regularly in the range of from 1:1 to 1:50, preferably in the range of from 1:1 to 1:20, more preferably in the range of from 1:1 to 1:10, even more preferably in the range of from 1:1 to 1:4 and in particular in the range of from 1:1 to 1:2.

According to further embodiments of the mixtures and compositions, the weight ratio of the compound I and the compound II generally depends from the properties of the active components used, usually it is in the range of from 1:10,000 to 10,000:1, regularly in the range of from 1:100 to 10,000:1, preferably in the range of from 1:100 to 5,000:1, more preferably in the range of from 1:1 to 1,000:1, even more preferably in the range of from 1:1 to 500:1 and in particular in the range of from 10:1 to 300:1.

According to further embodiments of the mixtures and compositions, the weight ratio of the compound I and the compound II usually is in the range of from 20,000:1 to 1:10, often in the range of from 10,000:1 to 1:1, regularly in the range of from 5,000:1 to 5:1, preferably in the range of from 5,000:1 to 10:1, more preferably in the range of from 2,000:1 to 30:1, even more preferably in the range of from 2,000:1 to 100:1 and in particular in the range of from 1,000:1 to 100:1.

According to further embodiments of the mixtures and compositions, the weight ratio of the compound I and the compound II usually is in the range of from 1:20,000 to 10:1, often in the range of from 1:10,000 to 1:1, regularly in the range of from 1:5,000 to 1:5, preferably in the range of from 1:5,000 to 1:10, more preferably in the range of from 1:2,000 to 1:30, even more preferably in the range of from 1:2,000 to 1:100 and in particular in the range of from 1:1,000 to 1.100.

In the ternary mixtures, i.e. compositions according to the invention comprising the compound I and compound II and a compound III, the weight ratio of compound I and compound II depends from the properties of the active substances used, usually it is in the range of from 1:100 to 100:1, regularly in the range of from 1:50 to 50:1, preferably in the range of from 1:20 to 20:1, more preferably in the range of from 1:10 to 10:1 and in particular in the range of from 1:4 to 4:1, and the weight ratio of compound I and compound III usually it is in the range of from 1:100 to 100:1, regularly in the range of from 1:50 to 50:1, preferably in the range of from 1:20 to 20:1, more preferably in the range of from 1:10 to 10:1 and in particular in the range of from 1:4 to 4:1.

Any further active compounds are, if desired, added in a ratio of from 20:1 to 1:20 to the compound I.

These ratios are also suitable for inventive mixtures applied by seed treatment.

In further specific embodiments, the mixture or composition or kit-of-parts according to the present invention may additionally comprise a fertilizer. In case the mixture or kit-or-parts comprising compound I (nitrification inhibitor) and compound II (herbicides) is used together with a fertilizer, or when a mixture is provided in combination with a fertilizer, such mixtures may be provided or used as agrochemical mixtures.

In the terms of the present invention “agrochemical mixture” means a combination of at least three or more compounds. The term is, however, not restricted to a physical mixture comprising three or more compounds, but refers to any preparation form of said compounds, the use of which many be time- and/or locus-related.

The agrochemical mixtures may, for example, be formulated separately but applied in a temporal relationship, i.e. simultaneously or subsequently, the subsequent application having a time interval which allows a combined action of the compounds.

Furthermore, the individual compounds of the agrochemical mixtures according to the invention such as parts of a kit or parts of the mixture may be mixed by the user himself in a suitable mixing device. In specific embodiments further auxiliaries may be added, if appropriate.

The term “fertilizers” is to be understood as chemical compounds applied to promote plant and fruit growth. Fertilizers are typically applied either through the soil (for uptake by plant roots), through soil substituents (also for uptake by plant roots), or by foliar feeding (for uptake through leaves). The term also includes mixtures of one or more different types of fertilizers as mentioned below.

The term “fertilizers” can be subdivided into several categories including: a) organic fertilizers (composed of plant/animal matter), b) inorganic fertilizers (composed of chemicals and minerals) and c) urea-containing fertilizers.

Organic fertilizers include manure, e.g. liquid manure, semi-liquid manure, biogas manure, stable manure or straw manure, slurry, liquid dungwater, sewage sludge, worm castings, peat, seaweed, compost, sewage, and guano. Green manure crops (cover crops) are also regularly grown to add nutrients (especially nitrogen) to the soil. Manufactured organic fertilizers include e.g. compost, blood meal, bone meal and seaweed extracts. Further examples are enzyme digested proteins, fish meal, and feather meal. The decomposing crop residue from prior years is another source of fertility.

Inorganic fertilizers are usually manufactured through chemical processes (such as e.g. the Haber-Bosch process), also using naturally occurring deposits, while chemically altering them (e.g. concentrated triple superphosphate). Naturally occurring inorganic fertilizers include Chilean sodium nitrate, mine rock phosphate, limestone, sulfate of potash, muriate of potash, and raw potash fertilizers.

Typical solid fertilizers are in a crystalline, prilled or granulated form. Typical nitrogen containing inorganic fertilizers are ammonium nitrate, calcium ammonium nitrate, ammonium sulfate, ammonium sulfate nitrate, calcium nitrate, diammonium phosphate, monoammonium phosphate, ammonium thio sulfate and calcium cyanamide.

The inorganic fertilizer may be an NPK fertilizer. “NPK fertilizers” are inorganic fertilizers formulated in appropriate concentrations and combinations comprising the three main nutrients nitrogen (N), phosphorus (P) and potassium (K) as well as typically S, Mg, Ca, and trace elements. “NK fertilizers” comprise the two main nutrients nitrogen (N) and potassium (K) as well as typically S, Mg, Ca, and trace elements. “NP fertilizers” comprise the two main nutrients nitrogen (N) and phosphorus (P) as well as typically S, Mg, Ca, and trace elements.

Urea-containing fertilizer may, in specific embodiments, be formaldehyde urea, UAN, urea sulfur, stabilized urea, urea based NPK-fertilizers, or urea ammonium sulfate. Also envisaged is the use of urea as fertilizer. In case urea-containing fertilizers or urea are used or provided, it is particularly preferred that urease inhibitors as defined herein above may be added or additionally be present, or be used at the same time or in connection with the urea-containing fertilizers.

Fertilizers may be provided in any suitable form, e.g. as coated or uncoated granules, in liquid or semi-liquid form, as sprayable fertilizer, or via fertigation etc.

Coated fertilizers may be provided with a wide range of materials. Coatings may, for example, be applied to granular or prilled nitrogen (N) fertilizer or to multi-nutrient fertilizers. Typically, urea is used as base material for most coated fertilizers. The present invention, however, also envisages the use of other base materials for coated fertilizers, any one of the fertilizer materials defined herein. In certain embodiments, elemental sulfur may be used as fertilizer coating. The coating may be performed by spraying molten S over urea granules, followed by an application of sealant wax to close fissures in the coating. In a further embodiment, the S layer may be covered with a layer of organic polymers, preferably a thin layer of organic polymers. In another embodiment, the coated fertilizers are preferably physical mixtures of coated and non-coated fertilizers.

Further envisaged coated fertilizers may be provided by reacting resin-based polymers on the surface of the fertilizer granule. A further example of providing coated fertilizers includes the use of low permeability polyethylene polymers in combination with high permeability coatings.

In specific embodiments the composition and/or thickness of the fertilizer coating may be adjusted to control, for example, the nutrient release rate for specific applications. The duration of nutrient release from specific fertilizers may vary, e.g. from several weeks to many months. The presence of nitrification inhibitors and herbicides in a mixture with coated fertilizers may accordingly be adapted. It is, in particular, envisaged that the nutrient release involves or is accompanied by the release of an nitrification inhibitor and herbicide according to the present invention.

Coated fertilizers may be provided as controlled release fertilizers (CRFs). In specific embodiments these controlled release fertilizers are fully coated N—P—K fertilizers, which are homogeneous and which typically show a pre-defined longevity of release. In further embodiments, the CRFs may be provided as blended controlled release fertilizer products which may contain coated, uncoated and/or slow release components. In certain embodiments, these coated fertilizers may additionally comprise micronutrients. In specific embodiments these fertilizers may show a pre-defined longevity, e.g. in case of N—P—K fertilizers.

Additionally envisaged examples of CRFs include patterned release fertilizers. These fertilizers typically show a pre-defined release patterns (e.g. hi/standard/lo) and a pre-defined longevity. In exemplary embodiments fully coated N—P—K, Mg and micronutrients may be delivered in a patterned release manner.

Also envisaged are double coating approaches or coated fertilizers based on a programmed release.

In further embodiments the fertilizer mixture may be provided as, or may comprise or contain a slow release fertilizer. The fertilizer may, for example, be released over any suitable period of time, e.g. over a period of 1 to 5 months, preferably up to 3 months. Typical examples of ingredients of slow release fertilizers are IBDU (isobutylidenediurea), e.g. containing about 31-32% nitrogen, of which 90% is water insoluble; or UF, i.e. an urea-formaldehyde product which contains about 38% nitrogen of which about 70% may be provided as water insoluble nitrogen; or CDU (crotonylidene diurea) containing about 32% nitrogen; or MU (methylene urea) containing about 38 to 40% nitrogen, of which 25-60% is typically cold water insoluble nitrogen; or MDU (methylene diurea) containing about 40% nitrogen, of which less than 25% is cold water insoluble nitrogen; or MO (methylol urea) containing about 30% nitrogen, which may typically be used in solutions; or DMTU (diimethylene triurea) containing about 40% nitrogen, of which less than 25% is cold water insoluble nitrogen; or TMTU (tri methylene tetraurea), which may be provided as component of UF products; or TMPU (tri methylene pentaurea), which may also be provided as component of UF products; or UT (urea triazone solution) which typically contains about 28% nitrogen. The fertilizer mixture may also be long-term nitrogen-bearing fertiliser containing a mixture of acetylene diurea and at least one other organic nitrogen-bearing fertiliser selected from methylene urea, isobutylidene diurea, crotonylidene diurea, substituted triazones, triuret or mixtures thereof.

Any of the above mentioned fertilizers or fertilizer forms may suitably be combined. For instance, slow release fertilizers may be provided as coated fertilizers. They may also be combined with other fertilizers or fertilizer types. The same applies to the presence of a nitrification inhibitor or herbicide according to the present invention, which may be adapted to the form and chemical nature of the fertilizer and accordingly be provided such that its release accompanies the release of the fertilizer, e.g. is released at the same time or with the same frequency. The present invention further envisages fertilizer or fertilizer forms as defined herein above in combination with nitrification inhibitors as defined herein above and herbicides and further in combination with urease inhibitors as defined herein above. Such combinations may be provided as coated or uncoated forms and/or as slow or fast release forms. Preferred are combinations with slow release fertilizers including a coating. In further embodiments, also different release schemes are envisaged, e.g. a slower or a faster release.

The term “fertigation” as used herein refers to the application of fertilizers, optionally soil amendments, and optionally other water-soluble products together with water through an irrigation system to a plant or to the locus where a plant is growing or is intended to grow, or to a soil substituent as defined herein below. For example, liquid fertilizers or dissolved fertilizers may be provided via fertigation directly to a plant or a locus where a plant is growing or is intended to grow. Likewise, nitrification inhibitors according to the present invention, or in combination with additional nitrification inhibitors, may be provided via fertigation to plants or to a locus where a plant is growing or is intended to grow. Fertilizers and nitrification inhibitors according to the present invention, or in combination with additional nitrification inhibitors, may be provided together, e.g. dissolved in the same charge or load of material (typically water) to be irrigated. In further embodiments, fertilizers and nitrification inhibitors may be provided at different points in time. For example, the fertilizer may be fertigated first, followed by the nitrification inhibitor, or preferably, the nitrification inhibitor may be fertigated first, followed by the fertilizer. The time intervals for these activities follow the herein above outlined time intervals for the application of fertilizers and nitrification inhibitors. Also envisaged is a repeated fertigation of fertilizers and nitrification inhibitors according to the present invention, either together or intermittently, e.g. every 2 hours, 6 hours, 12 hours, 24 hours, 2 days, 3 days, 4 days, 5 days, 6 days or more.

In particularly preferred embodiments, the fertilizer is an ammonium-containing fertilizer.

The agrochemical mixture according to the present invention may comprise one fertilizer as defined herein above and one nitrification inhibitor as defined herein above and one herbicide as defined herein above. In further embodiments, the agrochemical mixture according to the present invention may comprise at least one or more than one fertilizer as defined herein above, e.g. 2, 3, 4, 5, 6, 6, 7, 8, 9, 10 or more different fertilizers (including inorganic, organic and urea-containing fertilizers) and at least one nitrification inhibitor as defined above and at least one herbicide as defined herein above, preferably a combination as defined in the Tables 1 to 49.

In another group of embodiments the agrochemical mixture according to the present invention may comprise at least one or more than one nitrification inhibitor as defined herein above, preferably more than one nitrification inhibitor as defined above and at least one fertilizer as defined herein above and at least one herbicide as defined herein above.

The term “at least one” is to be understood as 1, 2, 3 or more of the respective compound selected from the group consisting of fertilizers as defined herein above, and nitrification inhibitors as defined herein above (also designated as compound I), and herbicides (also designated as compound II).

In addition to at least one fertilizer and at least one nitrification inhibitor as defined herein above and at least one herbicide, an agrochemical mixture may comprise further ingredients, compounds, active compounds or compositions or the like. For example, the agrochemical mixture may additionally comprise or composed with or on the basis of a carrier, e.g. an agrochemical carrier, preferably as defined herein. In further embodiments, the agrochemical mixture may further comprise at least one additional pesticidal compound. For example, the agrochemical mixture may additionally comprise at least one further compound selected from herbicides, insecticides, fungicides, growth regulators, biopesticides, urease inhibitors, nitrification inhibitors, and denitrification inhibitors.

In specific embodiments, the treatment may be carried out during all suitable growth stages of a plant as defined herein. For example, the treatment may be carried out during the BBCH principle growth stages.

The term “BBCH principal growth stage” refers to the extended BBCH-scale which is a system for a uniform coding of phenologically similar growth stages of all mono- and dicotyledonous plant species in which the entire developmental cycle of the plants is subdivided into clearly recognizable and distinguishable longer-lasting developmental phases. The BBCH-scale uses a decimal code system, which is divided into principal and secondary growth stages. The abbreviation BBCH derives from the Federal Biological Research Centre for Agriculture and Forestry (Germany), the Bundessortenamt (Germany) and the chemical industry.

In one embodiment the invention relates to a method for reducing nitrification comprising treating a plant growing on soil or soil substituents and/or the locus where the plant is growing or is intended to grow with a mixture or composition of the invention at a growth stage (GS) between GS 00 and GS>BBCH 99 of the plant (e.g. when fertilizing in fall after harvesting apples) and preferably between GS 00 and GS 65 BBCH of the plant.

In one embodiment the invention relates to a method for reducing nitrification comprising treating a plant growing on soil or soil substituents and/or the locus where the plant is growing or is intended to grow with a mixture or composition of the invention (referred to as mixture (Q) in the following) at a growth stage (GS) between GS 00 to GS 45, preferably between GS 00 and GS 40 BBCH of the plant.

In a preferred embodiment the invention relates to a method for reducing nitrification comprising treating a plant growing on soil or soil substituents and/or the locus where the plant is growing or is intended to grow with a mixture or composition of the invention at an early growth stage (GS), in particular a GS 00 to GS 05, or GS 00 to GS 10, or GS 00 to GS 15, or GS 00 to GS 20, or GS 00 to GS 25 or GS 00 to GS 33 BBCH of the plant. In particularly preferred embodiments, the method for reducing nitrification comprises treating a plant growing on soil or soil substituents and/or the locus where the plant is growing or is intended to grow with a mixture or composition of the invention during growth stages including GS 00.

In a further, specific embodiment of the invention, a mixture or composition of the invention is applied to a plant growing on soil or soil substituents and/or the locus where the plant is growing or is intended to grow at a growth stage between GS 00 and GS 55 BBCH, or of the plant.

In a further embodiment of the invention, a mixture or composition of the invention is applied to a plant growing on soil or soil substituents and/or the locus where the plant is growing or is intended to grow at the growth stage between GS 00 and GS 47 BBCH of the plant.

In one embodiment of the invention, a mixture or composition of the invention is applied to a plant growing on soil or soil substituents and/or the locus where the plant is growing or is intended to grow before and at sowing, before emergence, and until harvest (GS 00 to GS 89 BBCH), or at a growth stage (GS) between GS 00 and GS 65 BBCH of the plant.

### EXPERIMENTAL DETAILS

Regarding the isomer ratio of DMPSA, the DMPSA used in the experiments was the free acid of DMPSA containing 70 to 90 wt.-% 2-(3,4-dimethyl-1H-pyrazol-1-yl)succinic acid (“DMPSA1”) and 10 to 30 wt.-% 2-(4,5-dimethyl-1H-pyrazol-1-yl)succinic acid (“DMPSA2”). “Wt.-%” means “percent by weight”.

### Measurement of the Nitrification-Inhibiting Effect:

100 g soil (incubated at 20° C. for two weeks to activate the microbial biomass) is filled into 500 ml plastic bottles (e.g. soil sampled from the field) and is moistened to 50% water holding capacity. 1 ml test solution, containing the compositions and mixtures of the invention in the appropriate concentration or DMSO and 10 mg nitrogen in the form of urea is added to the soil and everything mixed well. Bottles are capped but loosely to allow air exchange. The bottles are then incubated at 20 C for 0, 14 and/or 28 days.

For analysis, 300 ml of a 1% K₂SO₄-solution is added to the bottle containing the soil and shaken for 2 hrs in a horizontal shaker at 150 rpm. Then the whole solution is filtered through a Macherey-Nagel Filter MN 807 ¼. Ammonium and nitrate content is then analyzed in the filtrate in an autoanalyzer at 550 nm (Merck, AA11).

Calculations (DMPSA+UI trials only):

$$inhibition in \% = \frac{( \begin{matrix}NO3 - N without NI at end of incubation - \\ NO3 - N with NI at end of incubation\end{matrix} )}{( \begin{matrix}NO3 - N without NI at end of incubation - \\ NO3 - N at beginning\end{matrix} )} \times 100 \qquad ( B \ddot{o} hland equation )$$

The Böhland equation is described in Böhland, H., et al. (1973) “Mittel zur Hemmung bzw. Regelung der Nitrifikation von Ammoniumstickstoff in Kulturböden”. DDR-Wirtschaftspatent (Economic patent of the German Democratic Republic) C 05c 169 727. Cited by: Peschke, H. (1985) “Zur Bewertung der inhibierenden Wirkung von Nitrifiziden im Boden”, Zbl. Mikrobiol. 140, pp. 583-588.

### Plant Growth Conditions

Plants were generally grown under standard green house conditions (20° C. and 60% humidity) using standard greenhouse soil (mixture of peat, loam and sand). Therefore, 0.4 g of ryegrass seeds (Lolium perenne ‘Chagall’), 1 soybean seed (Glycine max ‘Sultana’) or 1 grape vine live stack (Vitis vinifer ssp. ‘Sativa’) were grown per pot (8.4 cm for ryegrass, soybean; 13 cm for grape vine) in a completely randomized set-up. Following a growth period of ten days (ryegrass), 14 days (soybean) or approx. 21 days, until the main shoot reached a length of 20 cm (grape vine), plants were designated for experimental usage.

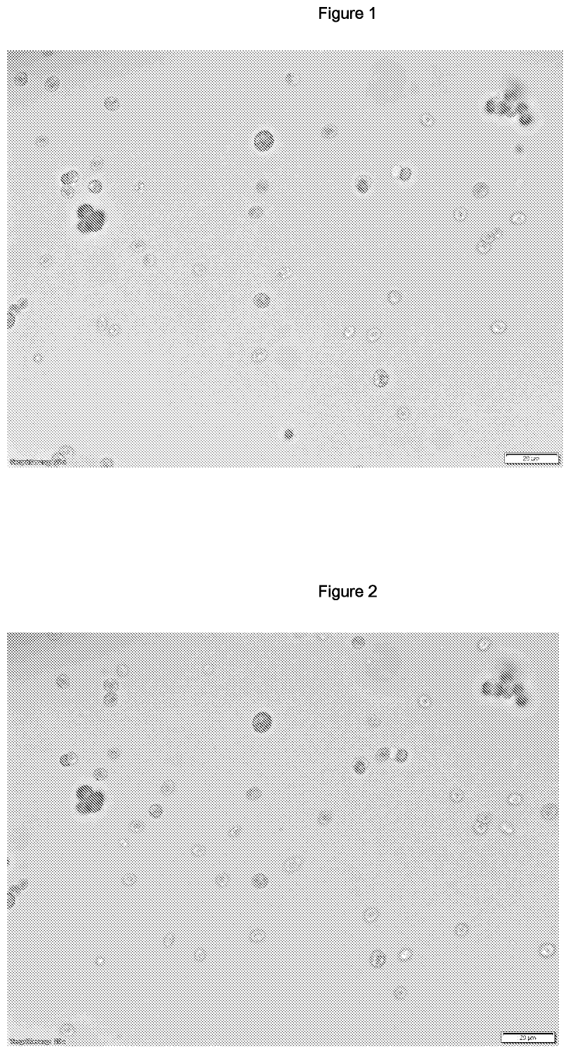

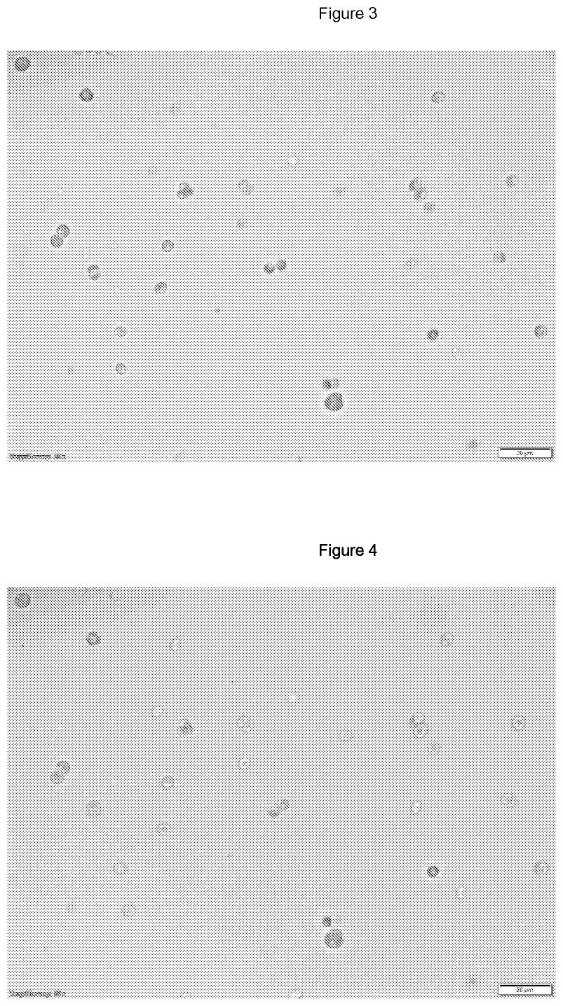

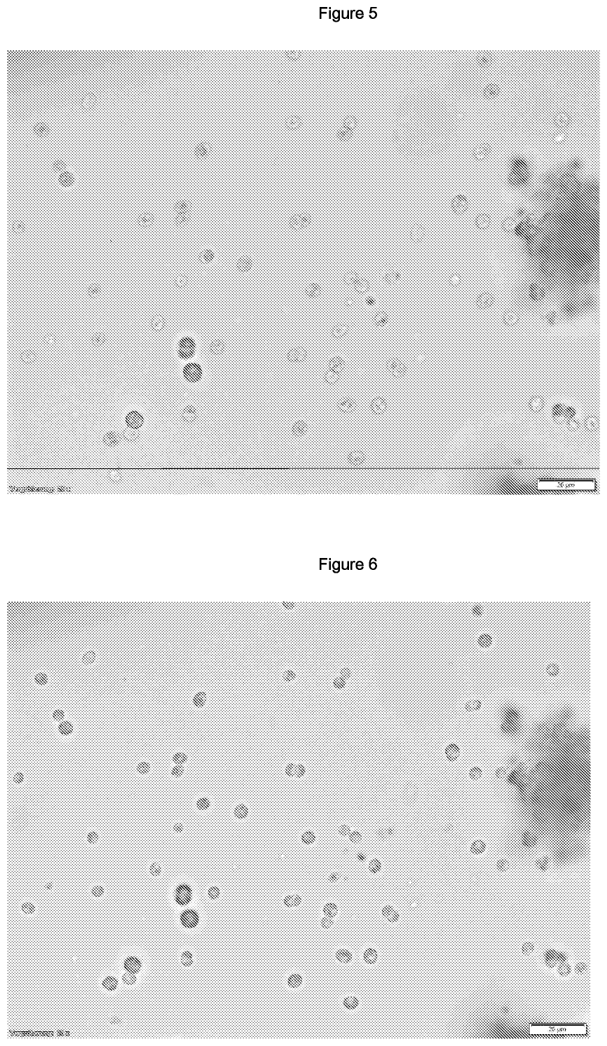

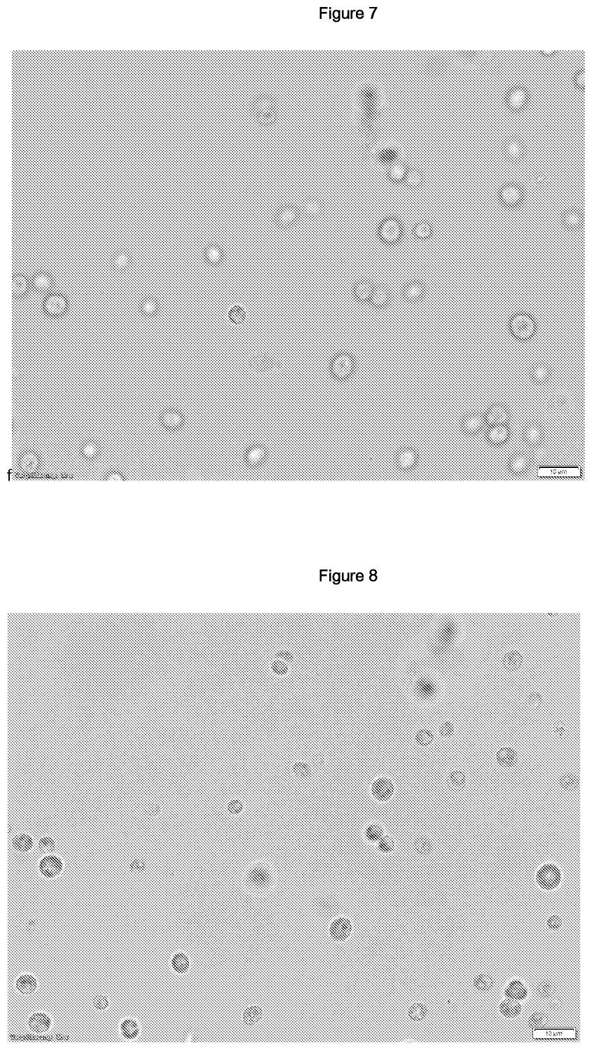

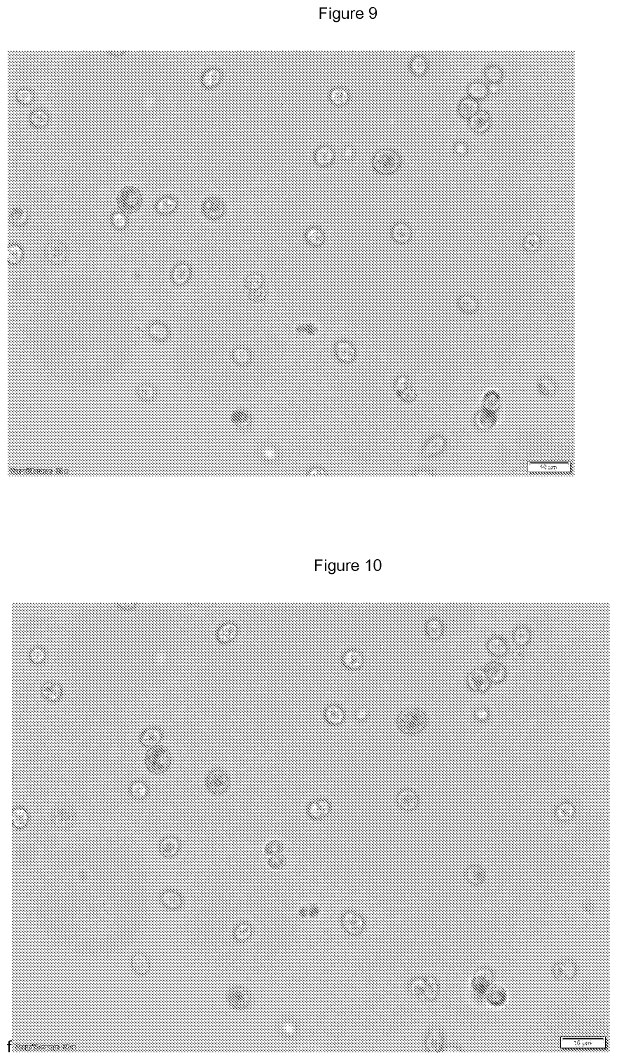

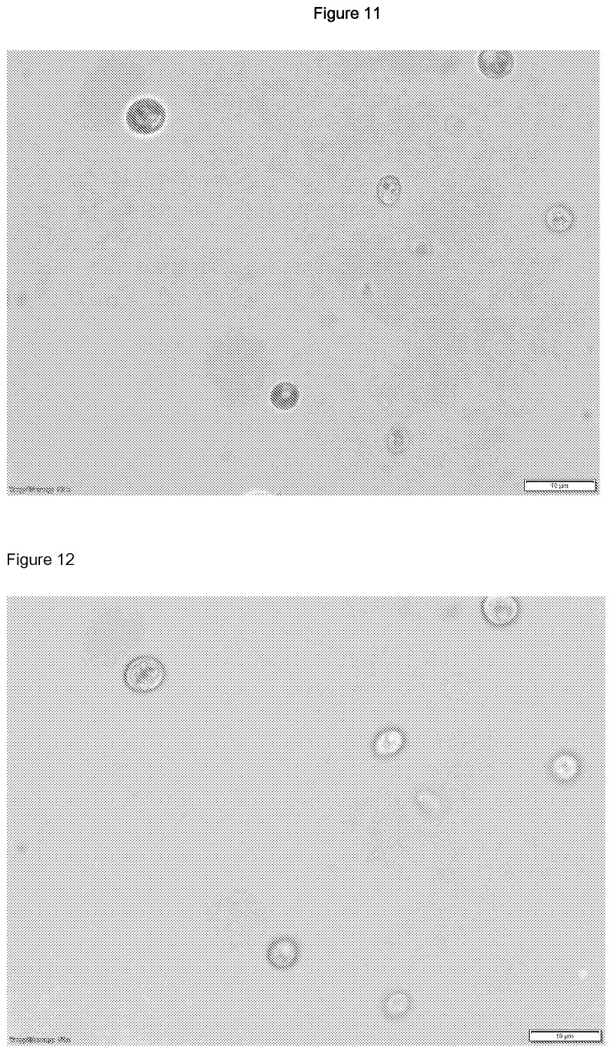

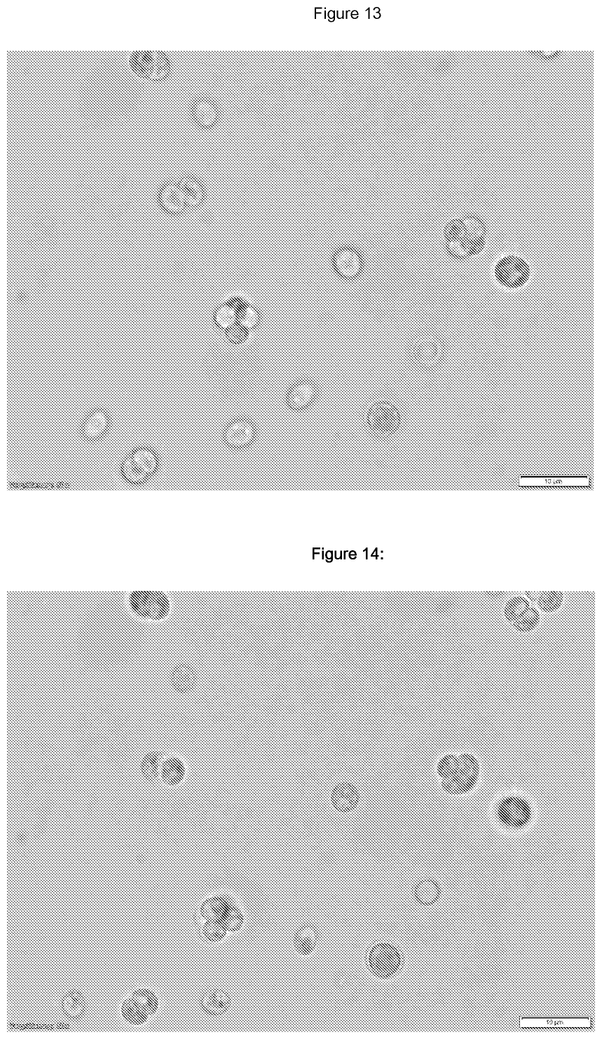

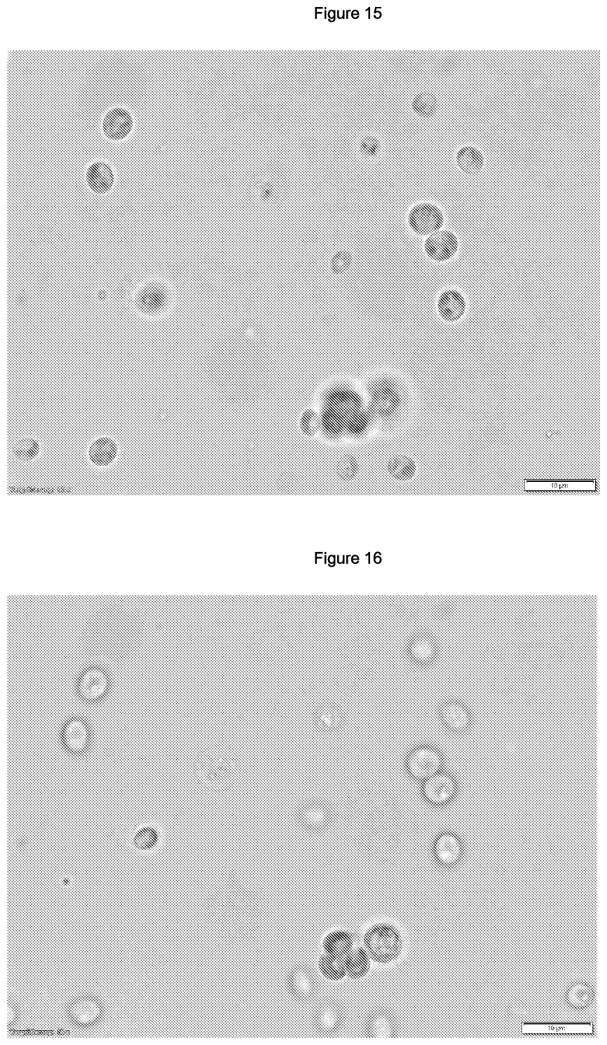

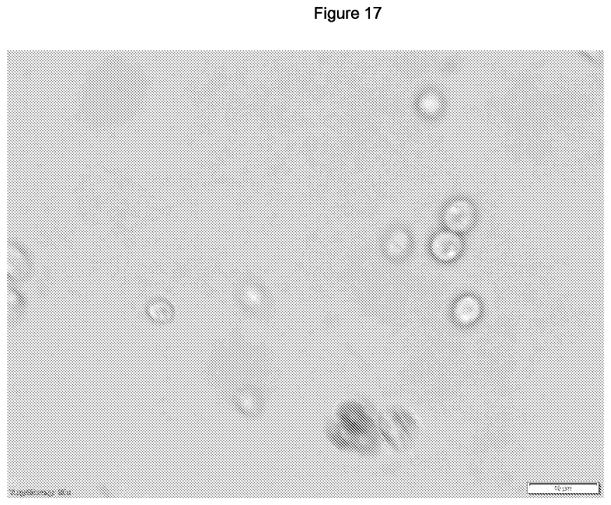

For trials as shown below (trials with saflufenacil or glyphosate), an algae solution consisting of a mixture of field relevant species was used (10 mL per 8.4 cm pot; OD₆₀₀ 4). Microscopic images of the algae species used are shown in FIGS. 1 to 17. These microscopic images were taken using the microscope Olympus BX61, the magnification was 1000×.

The experimental details regarding the detection of nitrous oxide losses are shown in Table N1 and Table N2.

TABLE N1
Application rates of the different compounds for N2O emission tests

| | | | a.i. | | |
|---|---|---|---|---|---|
| | | | application | | |
| | | application | rate [% of | | |
| Compound | a.i. | rate [g/ha] | NH4—N] | Crop | Parameter |
| AS liquid | — | 106000 | | — | N₂O |
| | | (NH4—N) | | | |
| DMPSA | DMPSA | | 1.0 | | |
| Roundup | Glyphosate | 125 | | | |
| Kixor | Saflufenacil | 8 | | | |

(AS = ammonium sulfate; Compounds were provided by BASF SE)

TABLE N2
N2O loss detection data of the different compounds and mixtures

| | | N2O | | |
|---|---|---|---|---|
| | N2O | emission | | |
| | emission | ppb net | % | |
| | ppb | emission | inhibition | Colby |
| Water | 774 | | | (A + B) − (A*B/100) |
| AS liquid | 3103 | 2329 | 0 | |
| AS liquid + 1% DMPSA | 1083 | 309 | 65 | |
| AS liquid + Glyphosate | 2454 | 1680 | 21 | |
| AS liquid + Saflufenacil | 2751 | 1977 | 11 | |
| AS liquid + Glyphosate + DMPSA | 732 | −42 | 76 | 72 |
| (1%) | | | | |
| AS liquid + Saflufenacil + DMPSA | 678 | −96 | 78 | 69 |
| (1%) | | | | |

(AS = ammonium sulfate; Details and application rates regarding the compounds see Table N1)

The experimental data as described in the Table N1 and the Table N2 show that the mixtures comprising DMPSA and the herbicides selected from the group consisting of saflufenacil and glyphosate have a synergistic effect in reducing the N2O emissions from soils.

1. A mixture comprising as active components
1) at least one active compound I (nitrification inhibitor) selected from the group consisting of:
a) 2-(3,4-dimethyl-1H-pyrazol-1-yl)succinic acid and/or 2-(4,5-dimethyl-1H-pyrazol-1-yl)succinic acid, and/or a derivative thereof, and/or a salt thereof,
b) glycolic acid addition salt of 3,4-dimethyl pyrazole (3,4-dimethyl pyrazolium glycolate), and/or an isomer thereof, and/or a derivative thereof,
c) citric acid addition salt of 3,4-dimethyl pyrazole (3,4-dimethyl pyrazolium citrate), and/or an isomer thereof, and/or a derivative thereof,
d) lactic acid addition salt of 3,4-dimethyl pyrazole (3,4-dimethyl pyrazolium lactate), and/or an isomer thereof, and/or a derivative thereof,
e) mandelic acid addition salt of 3,4-dimethyl pyrazole (3,4-dimethyl pyrazolium mandelate), and/or an isomer thereof, and/or a derivative thereof,
f) 1,2,4-triazole, and/or a derivative thereof, and/or a salt thereof,
g) 4-Chloro-3-methylpyrazole, and/or an isomer thereof, and/or a derivative thereof, and/or a salt thereof,
h) N-((3(5)-methyl-1H-pyrazole-1-yl)methyl)acetamide, and/or an isomer thereof, and/or a derivative thereof, and/or a salt thereof,
i) N-((3(5)-methyl-1H-pyrazole-1-yl)methyl)formamide, and/or an isomer thereof, and/or a derivative thereof, and/or a salt thereof,
j) N-((3(5),4-dimethylpyrazole-1-yl)methyl)formamide, and/or an isomer thereof, and/or a derivative thereof, and/or a salt thereof,
k) N-((4-chloro-3(5)-methyl-pyrazole-1-yl)methyl)formamide, and/or an isomer thereof, and/or a derivative thereof, and/or a salt thereof,
l) a reaction adduct of dicyandiamide, urea and formaldehyde, or a triazonyl-formaldehyde-dicyandiamide adduct
m) 2-cyano-1-((4-oxo-1,3,5-triazinan-1-yl)methyl)guanidine,
n) 1-((2-cyanoguanidino)methyl)urea, and
o) 2-cyano-1-((2-cyanoguanidino)methyl)guanidine,
p) 2-chloro-6-(trichloromethyl)-pyridine (nitrapyrin or N-serve),
q) dicyandiamide (DCD, DIDIN),
r) 3,4-dimethyl pyrazole phosphate, and/or 4,5-dimethyl pyrazole phosphate (DMPP, ENTEC), and/or an isomer thereof, and/or a derivative thereof,
s) 3,4-dimethylpyrazole, and/or 4,5-dimethylpyrazole (DMP), and/or an isomer thereof, and/or a derivative thereof, and/or a salt thereof, and/or an acid addition salt thereof,
t) ammoniumthiosulfate (ATU),
u) neem, and/or products based on ingredients of neem,
v) linoleic acid,
w) alpha-linolenic acid,
x) methyl p-coumarate,
y) methyl ferulate,
z) methyl 3-(4-hydroxyphenyl) propionate (MHPP),
aa) Karanjin,
bb) brachialacton,
cc) p-benzoquinone sorgoleone,
dd) 4-amino-1,2,4-triazole hydrochloride (ATC),
ee) 1-amido-2-thiourea (ASU),
ff) 2-amino-4-chloro-6-methylpyrim idine (AM),
gg) 2-mercapto-benzothiazole (MBT),
hh) 5-ethoxy-3-trichloromethyl-1,2,4-thiodiazole (terrazole, etridiazole),
ii) 2-sulfanilamidothiazole (ST),
jj) 3-methylpyrazol (3-MP),
kk) 1,2,4-triazol thiourea (TU),
ll) cyan amide,
mm) melamine,
nn) zeolite powder,
oo) catechol,
pp) benzoquinone,
qq) sodium tetra borate,
rr) allylthiourea,
ss) chlorate salts, and
tt) zinc sulfate;
and
2) at least one active compound II (herbicide) selected from the groups N.1 to N.15:
N.1 Lipid biosynthesis inhibitors: alloxydim (N.1.1), alloxydim-sodium (N.1.2), butroxydim (N.1.3), clethodim (N.1.4), clodinafop (N.1.5), clodinafop-propargyl (N.1.6), cycloxydim (N.1.7), cyhalofop (N.1.8), cyhalofop-butyl (N.1.9), diclofop (N.1.10), diclofop-methyl (N.1.11), fenoxaprop (N.1.12), fenoxaprop-ethyl (N.1.13), fenoxaprop-P (N.1.14), fenoxaprop-P-ethyl (N.1.15), fluazifop (N.1.16), fluazifop-butyl (N.1.17), fluazifop-P (N.1.18), fluazifop-P-butyl (N.1.19), haloxyfop (N.1.20), haloxyfop-methyl (N.1.21), haloxyfop-P (N.1.22), haloxyfop-P-methyl (N.1.23), metamifop (N.1.24), pinoxaden (N.1.25), profoxydim (N.1.26), propaquizafop (N.1.27), quizalofop (N.1.28), quizalofop-ethyl (N.1.29), quizalofop-tefuryl (N.1.30), quizalofop-P (N.1.31), quizalofop-P-ethyl (N.1.32), quizalofop-P-tefuryl (N.1.33), sethoxydim (N.1.34), tepraloxydim (N.1.35), tralkoxydim (N.1.36), 4-(4′-chloro-4-cyclo¬propyl-2′-fluoro[1,1′-biphenyl]-3-yl)-5-hydroxy-2,2,6,6-tetramethyl-2H-pyran-3(6H)-one ((N.1.37) CAS 1312337-72-6); 4-(2′,4′-dichloro-4-cyclopropyl[1,1′-biphenyl]-3-yl)-5-hydroxy-2,2,6,6-tetramethyl-2H-pyran-3(6H)-one ((N.1.38) CAS 1312337-45-3); 4-(4′-chloro-4-ethyl-2′-fluoro[1,1′-biphenyl]-3-yl)-5-hydroxy-2,2,6,6-tetramethyl-2H-pyran-3(6H)-one ((N.1.39) CAS 1033757-93-5); 4-(2′,4′-Dichloro-4-ethyl[1,1′-biphenyl]-3-yl)-2,2,6,6-tetramethyl-2H-pyran-3,5(4H,6H)-dione ((N.1.40) CAS 1312340-84-3); 5-(acetyloxy)-4-(4′-chloro-4-cyclopropyl-2′-fluoro[1,1′-biphenyl]-3-yl)-3,6-dihydro-2,2,6,6-tetramethyl-2H-pyran-3-one ((N.1.41) CAS 1312337-48-6); 5-(acetyloxy)-4-(2″,4′-dichloro-4-cyclopropyl-[1,1′-biphenyl]-3-yl)-3,6-dihydro-2,2,6,6-tetramethyl-2H-pyran-3-one (N.1.42); 5-(acetyloxy)-4-(4′-chloro-4-ethyl-2′-fluoro[1,1′-biphenyl]-3-yl)-3,6-dihydro-2,2,6,6-tetramethyl-2H-pyran-3-one ((N.1.43) CAS 1312340-82-1); 5-(acetyloxy)-4-(2′,4′-dichloro-4-ethyl[1,1′-biphenyl]-3-yl)-3,6-dihydro-2,2,6,6-tetramethyl-2H-pyran-3-one ((N.1.44) CAS 1033760-55-2); 4-(4′-chloro-4-cyclopropyl-2′-fluoro[1,1′-biphenyl]-3-yl)-5,6-dihydro-2,2,6,6-tetramethyl-5-oxo-2H-pyran-3-yl carbonic acid methyl ester ((N.1.45) CAS 1312337-51-1); 4-(2″,4′-dichloro-4-cyclopropyl-[1,1′-biphenyl]-3-yl)-5,6-dihydro-2,2,6,6-tetramethyl-5-oxo-2H-pyran-3-yl carbonic acid methyl ester (N.1.46); 4-(4′-chloro-4-ethyl-2′-fluoro[1,1′-biphenyl]-3-yl)-5,6-dihydro-2,2,6,6-tetramethyl-5-oxo-2H-pyran-3-yl carbonic acid methyl ester ((N.1.47) CAS 1312340-83-2); 4-(2′,4′-dichloro-4-ethyl¬[1,1′-biphenyl]-3-yl)-5,6-dihydro-2,2,6,6-tetramethyl-5-oxo-2H-pyran-3-yl carbonic acid methyl ester ((N.1.48) CAS 1033760-58-5); benfuresate (N.1.49), butylate (N.1.50), cycloate (N.1.51), dalapon (N.1.52), dimepiperate (N.1.53), EPTC (N.1.54), esprocarb (N.1.55), ethofumesate (N.1.56), flupropanate (N.1.57), molinate (N.1.58), orbencarb (N.1.59), pebulate (N.1.60), prosulfocarb (N.1.61), TCA (N.1.62), thiobencarb (N.1.63), tiocarbazil (N.1.64), triallate (N.1.65) and vernolate (N.1.66);
N.2 Acetolactate synthase inhibitors (ALS inhibitors): amidosulfuron (N.2.1), azimsulfuron (N.2.2), bensulfuron (N.2.3), bensulfuron-methyl (N.2.4), chlorimuron (N.2.5), chlorimuron-ethyl (N.2.6), chlorsulfuron (N.2.7), cinosulfuron (N.2.8), cyclosulfamuron (N.2.9), ethametsulfuron (N.2.10), ethametsulfuron-methyl (N.2.11), ethoxysulfuron (N.2.12), flazasulfuron (N.2.13), flucetosulfuron (N.2.14), flupyrsulfuron (N.2.15), flupyrsulfuron-methyl-sodium (N.2.16), foramsulfuron (N.2.17), halosulfuron (N.2.18), halosulfuron-methyl (N.2.19), imazosulfuron (N.2.20), iodosulfuron (N.2.21), iodosulfuron-methyl-sodium (N.2.22), iofensulfuron (N.2.23), iofensulfuron-sodium (N.2.24), mesosulfuron (N.2.25), metazosulfuron (N.2.26), metsulfuron (N.2.27), metsulfuron-methyl (N.2.28), nicosulfuron (N.2.29), orthosulfamuron (N.2.30), oxasulfuron (N.2.31), primisulfuron (N.2.32), primisulfuron-methyl (N.2.33), propyrisulfuron (N.2.34), prosulfuron (N.2.35), pyrazosulfuron (N.2.36), pyrazosulfuron-ethyl (N.2.37), rimsulfuron (N.2.38), sulfometuron (N.2.39), sulfometuron-methyl (N.2.40), sulfosulfuron (N.2.41), thifensulfuron (N.2.42), thifensulfuron-methyl (N.2.43), triasulfuron (N.2.44), tribenuron (N.2.45), tribenuron-methyl (N.2.46), trifloxysulfuron (N.2.47), triflusulfuron (N.2.48), triflusulfuron-methyl (N.2.49), tritosulfuron (N.2.50), imazamethabenz (N.2.51), imazamethabenz-methyl (N.2.52), imazamox (N.2.53), imazapic (N.2.54), imazapyr (N.2.55), imazaquin (N.2.56), imazethapyr (N.2.57); cloransulam (N.2.58), cloransulam-methyl (N.2.59), diclosulam (N.2.60), flumetsulam (N.2.61), florasulam (N.2.62), metosulam (N.2.63), penoxsulam (N.2.64), pyrimisulfan (N.2.65) and pyroxsulam (N.2.66); bispyribac (N.2.67), bispyribac-sodium (N.2.68), pyribenzoxim (N.2.69), pyriftalid (N.2.70), pyriminobac (N.2.71), pyriminobac-methyl (N.2.72), pyrithiobac (N.2.73), pyrithiobac-sodium (N.2.74), 4-[[[2-[(4,6-dimethoxy-2-pyrimidinyl)oxy]phenyl]methyl]amino]-benzoic acid-1-methyhethyl ester ((N.2.75) CAS 420138-41-6), 4-[[[2-[(4,6-dimethoxy-2-pyrimidinyl)oxy]phenyl]¬methyl]amino]-benzoic acid propyl ester ((N.2.76) CAS 420138-40-5), N-(4-bromophenyl)-2-[(4,6-dimethoxy-2-pyrimidinyl)oxy]benzenemethanamine ((N.2.77) CAS 420138-01-8); flucarbazone (N.2.78), flucarbazone-sodium (N.2.79), propoxycarbazone (N.2.80), propoxycarbazone-sodium (N.2.81), thiencarbazone (N.2.82), thiencarbazone-methyl (N.2.83), triafamone (N.2.84);
N.3 Photosynthesis inhibitors: amicarbazone (N.3.1); chlorotriazine (N.3.2); ametryn (N.3.3), atrazine (N.3.4), chloridazone (N.3.5), cyanazine (N.3.6), desmetryn (N.3.7), dimethametryn (N.3.8), hexazinone (N.3.9), metribuzin (N.3.10), prometon (N.3.11), prometryn (N.3.12), propazine (N.3.13), simazine (N.3.14), simetryn (N.3.15), terbumeton (N.3.16), terbuthylazin (N.3.17), terbutryn (N.3.18), trietazin (N.3.19); chlorobromuron (N.3.20), chlorotoluron (N.3.21), chloroxuron (N.3.22), dimefuron (N.3.23), diuron (N.3.24), fluometuron (N.3.25), isoproturon (N.3.26), isouron (N.3.27), linuron (N.3.28), metamitron (N.3.29), methabenzthiazuron (N.3.30), metobenzuron (N.3.31), metoxuron (N.3.32), monolinuron (N.3.33), neburon (N.3.34), siduron (N.3.35), tebuthiuron (N.3.36), thiadiazuron (N.3.37), desmedipham (N.3.38), karbutilat (N.3.39), phenmedipham (N.3.40), phenmedipham-ethyl (N.3.41), bromofenoxim (N.3.42), bromoxynil (N.3.43) and its salts and esters, ioxynil (N.3.44) and its salts and esters, bromacil (N.3.45), lenacil (N.3.46), terbacil (N.3.47), bentazon (N.3.48), bentazon-sodium (N.3.49), pyridate (N.3.50), pyridafol (N.3.51), pentanochlor (N.3.52), propanil (N.3.53); diquat (N.3.54), diquat-dibromide (N.3.55), paraquat (N.3.56), paraquat-dichloride (N.3.57), paraquat-dimetilsulfate (N.3.58); 1-(6-tert-butylpyrimidin-4-yl)-2-hydroxy-4-methoxy-3-methyl-2H-pyrrol-5-one (CAS 1654744-66-7) (N.3.59); 1-(5-tert-butylisoxazol-3-yl)-2-hydroxy-4-methoxy-3-methyl-2H-pyrrol-5-one (CAS 1637455-12-9) (N.3.60); 1-(5-tert-butylisoxazol-3-yl)-4-chloro-2-hydroxy-3-methyl-2H-pyrrol-5-one (CAS 1637453-94-1) (N.3.61); 1-(5-tert-butyl-1-methyl-pyrazol-3-yl)-4-chloro-2-hydroxy-3-methyl-2H-pyrrol-5-one (CAS 1654057-29-0) (N.3.62); 1-(5-tert-butyl-1-methyl-pyrazol-3-yl)-3-chloro-2-hydroxy-4-methyl-2H-pyrrol-5-one (CAS 1654747-80-4) (N.3.63); 4-hydroxy-1-methoxy-5-methyl-3-[4-(trifluoromethyl)-2-pyridyl]imidazolidin-2-one; (CAS 2023785-78-4) (N.3.64); 4-hydroxy-1,5-dimethyl-3-[4-(trifluoromethyl)-2-pyridyl]imidazolidin-2-one (CAS 2023785-79-5) (N.3.65); 5-ethoxy-4-hydroxy-1-methyl-3-[4-(trifluoromethyl)-2-pyridyl]imidazolidin-2-one (CAS 1701416-69-4) (N.3.66); 4-hydroxy-1-methyl-3-[4-(trifluoromethyl)-2-pyridyl]imidazolidin-2-one (CAS 1708087-22-2) (N.3.67); 4-hydroxy-1,5-dimethyl-3-[1-methyl-5-(trifluoromethyl)pyrazol-3-yl]imidazolidin-2-one (CAS 2023785-80-8) (N.3.68); 1-(5-tert-butylisoxazol-3-yl)-4-ethoxy-5-hydroxy-3-methyl-imidazolidin-2-one (CAS 1844836-64-1) (N.3.69);
N.4 Protoporphyrinogen-IX oxidase inhibitors: acifluorfen (N.4.1), acifluorfen-sodium (N.4.2), azafenidin (N.4.3), bencarbazone (N.4.4), benzfendizone (N.4.5), bifenox (N.4.6), butafenacil (N.4.7), carfentrazone (N.4.8), carfentrazone-ethyl (N.4.9), chlormethoxyfen (N.4.10), cinidon-ethyl (N.4.11), fluazolate (N.4.12), flufenpyr (N.4.13), flufenpyr-ethyl (N.4.14), flumiclorac (N.4.15), flumiclorac-pentyl (N.4.16), flumioxazin (N.4.17), fluoroglycofen (N.4.18), fluoroglycofen-ethyl (N.4.19), fluthiacet (N.4.20), fluthiacet-methyl (N.4.21), fomesafen (N.4.22), halosafen (N.4.23), lactofen (N.4.24), oxadiargyl (N.4.25), oxadiazon (N.4.26), oxyfluorfen (N.4.27), pentoxazone (N.4.28), profluazol (N.4.29), pyraclonil (N.4.30), pyraflufen (N.4.31), pyraflufen-ethyl (N.4.32), saflufenacil (N.4.33), sulfentrazone (N.4.34), thidiazimin (N.4.35), tiafenacil (N.4.36), trifludimoxazin (N.4.37), ethyl [3-[2-chloro-4-fluoro-5-(1-methyl-6-trifluorom ethyl-2,4-dioxo-1,2,3,4-tetrahydropyrimidin-3-yl)phenoxy]-2-pyridyloxy]acetate ((N.4.38) CAS 353292-31-6), N-ethyl-3-(2,6-dichloro-4-trifluoro-methylphenoxy)-5-methyl-1H-pyrazole-1-carboxamide ((N.4.39) CAS 452098-92-9), N tetrahydrofurfuryl-3-(2,6-dichloro-4-trifluoromethylphenoxy)-5-methyl-1H-pyrazole-1-carboxamide ((N.4.40) CAS 915396-43-9), N-ethyl-3-(2-chloro-6-fluoro-4-trifluoromethyl¬phenoxy)-5-methyl-1H-pyrazole-1-carboxamide ((N.4.41) CAS 452099-05-7), N tetrahydro¬furfuryl-3-(2-chloro-6-fluoro-4-trifluoro¬methylphenoxy)-5-methyl-1H-pyrazole-1-carboxamide ((N.4.42) CAS 452100-03-7), 3-[7-fluoro-3-oxo-4-(prop-2-ynyl)-3,4-dihydro-2H-benzo[1,4]oxazin-6-yl]-1,5-dimethyl-6-thioxo-[1,3,5]triazinan-2,4-dione ((N.4.43) CAS 451484-50-7), 2-(2,2,7-trifluoro-3-oxo-4-prop-2-ynyl-3,4-dihydro-2H-benzo[1,4]oxazin-6-yl)-4,5,6,7-tetrahydro-isoindole-1,3-dione ((N.4.44) CAS 1300118-96-0), 1-methyl-6-trifluoro¬methyl-3-(2,2,7-tri-fluoro-3-oxo-4-prop-2-ynyl-3,4-dihydro-2H-benzo[1,4]oxazin-6-yl)-1H-pyrimidine-2,4-dione ((N.4.45) CAS 1304113-05-0), methyl (E)-4-[2-chloro-5-[4-chloro-5-(difluoromethoxy)-1H-methyl-pyrazol-3-yl]-4-fluoro-phenoxy]-3-methoxy-but-2-enoate ((N.4.46) CAS 948893-00-3), 3-[7-chloro-5-fluoro-2-(trifluoromethyl)-1H-benzimidazol-4-yl]-1-methyl-6-(trifluoromethyl)-1H-pyrimidine-2,4-dione ((N.4.47) CAS 212754-02-4);
N.5 Bleacher herbicides: beflubutamid (N.5.1), diflufenican (N.5.2), fluridone (N.5.3), flurochloridone (N.5.4), flurtamone (N.5.5), norflurazon (N.5.6), picolinafen (N.5.7), 4-(3-trifluoromethyl¬phenoxy)-2-(4-trifluoromethylphenyl)pyrimidine ((N.5.8) CAS 180608-33-7); benzobicyclon (N.5.9), benzofenap (N.5.10), bicyclopyrone (N.5.11), clomazone (N.5.12), fenquintrione (N.5.13), isoxaflutole (N.5.14), mesotrione (N.5.15), pyrasulfotole (N.5.16), pyrazolynate (N.5.17), pyrazoxyfen (N.5.18), sulcotrione (N.5.19), tefuryltrione (N.5.20), tembotrione (N.5.21), tolpyralate (N.5.22), topramezone (N.5.23); aclonifen (N.5.24), amitrole (N.5.25), flumeturon (N.5.26), 2-chloro-3-methylsulfanyl-N-(1-methyltetrazol-5-yl)-4-(trifluoromethyl)benzamide (CAS 1361139-71-0) (N.5.27);
N.6 Enolpyruvyl shikimate 3-phosphate synthase inhibitors (EPSP inhibitors): glyphosate (N.6.1), glyphosate-isopropylammonium (N.6.2), glyposate-potassium (N.6.3), glyphosate-trimesium (sulfosate) (N.6.4);
N.7 Glutamine synthase inhibitors: bilanaphos (bialaphos) (N.7.1), bilanaphos-sodium (N.7.2), glufosinate (N.7.3), glufosinate-P (N.7.4), glufosinate-ammonium (N.7.5);
N.8 7,8-dihydropteroate synthase inhibitors (DHP inhibitors): asulam (N.8.1);
N.9 Mitosis inhibitors: benfluralin (N.9.1), butralin (N.9.2), dinitramine (N.9.3), ethalfluralin (N.9.4), fluchloralin (N.9.5), oryzalin (N.9.6), pendimethalin (N.9.7), prodiamine (N.9.8), trifluralin (N.9.9); amiprophos (N.9.10), amiprophos-methyl (N.9.11), butamiphos (N.9.12); chlorthal (N.9.13), chlorthal-dimethyl (N.9.14), dithiopyr (N.9.15), thiazopyr (N.9.16), propyzamide (N.9.17), tebutam (N.9.18); carbetamide (N.9.19), chlorpropham (N.9.20), flamprop (N.9.21), flamprop-isopropyl (N.9.22), flamprop-methyl (N.9.23), flamprop-M-isopropyl (N.9.24), flamprop-M-methyl (N.9.25), propham (N.9.26);
N.10 Inhibitors of the synthesis of very long chain fatty acids (VLCFA inhibitors): acetochlor (N.10.1), alachlor (N.10.2), butachlor (N.10.3), dimethachlor (N.10.4), dimethenamid (N.10.5), dimethenamid-P (N.10.6), metazachlor (N.10.7), metolachlor (N.10.8), metolachlor-S(N.10.9), pethoxamid (N.10.10), pretilachlor (N.10.11), propachlor (N.10.12), propisochlor (N.10.13), thenylchlor (N.10.14), flufenacet (N.10.15), mefenacet (N.10.16), diphenamid (N.10.17), naproanilide (N.10.18), napropamide (N.10.19), napropamide-M (N.10.20), fentrazamide (N.10.21), anilofos (N.10.22), cafenstrole (N.10.23), fenoxasulfone (N.10.24), ipfencarbazone (N.10.25), piperophos (N.10.26), pyroxasulfone (N.10.27), isoxazoline compounds of the formulae II.1 (N.10.28), II.2 (N.10.29), II.3 (N.10.30), II.4 (N.10.31), II.5 (N.10.32), II.6 (N.10.33), II.7 (N.10.34), II.8 (N.10.35) and II.9 (N.10.36) 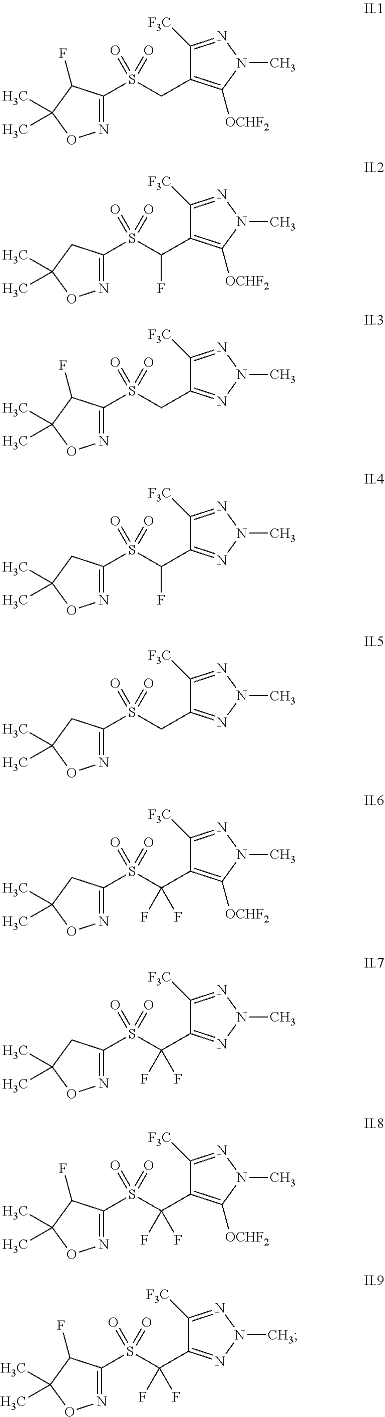
N.11 Cellulose biosynthesis inhibitors: chlorthiamid (N.11.1), dichlobenil (N.11.2), flupoxam (N.11.3), indaziflam (N.11.4), isoxaben (N.11.5), triaziflam (N.11.6), 1-cyclohexyl-5-pentafluorphenyloxy-14-[1,2,4,6]thiatriazin-3-ylamine ((N.11.7) CAS 175899-01-1);
N.12 Decoupler herbicides: dinoseb (N.12.1), dinoterb (N.12.2), DNOC (N.12.3) and its salts;
N.13 Auxinic herbicides: 2,4-D (N.13.1) and its salts and esters, clacyfos (N.13.2), 2,4-DB (N.13.3) and its salts and esters, aminocyclopyrachlor (N.13.4) and its salts and esters, aminopyralid (N.13.5) and its salts such as aminopyralid-dimethylammonium (N.13.6), aminopyralid-tris(2-hydroxypropyl)ammonium (N.13.7) and its esters, benazolin (N.13.8), benazolin-ethyl (N.13.9), chloramben (N.13.10) and its salts and esters, clomeprop (N.13.11), clopyralid (N.13.12) and its salts and esters, dicamba (N.13.13) and its salts and esters, dichlorprop (N.13.14) and its salts and esters, dichlorprop-P (N.13.15) and its salts and esters, fluroxypyr (N.13.16), fluroxypyr-butometyl (N.13.17), fluroxypyr-meptyl (N.13.18), halauxifen (N.13.19) and its salts and esters (CAS 943832-60-8); MCPA (N.13.20) and its salts and esters, MCPA-thioethyl (N.13.21), MCPB (N.13.22) and its salts and esters, mecoprop (N.13.23) and its salts and esters, mecoprop-P (N.13.24) and its salts and esters, picloram (N.13.25) and its salts and esters, quinclorac (N.13.26), quinmerac (N.13.27), TBA (2,3,6) (N.13.28) and its salts and esters, triclopyr (N.13.29) and its salts and esters, florpyrauxifen (N.13.30), florpyrauxifen-benzyl ((N.13.31) CAS 1390661-72-9), 4-amino-3-chloro-5-fluoro-6-(7-fluoro-1H-indol-6-yl)picolinic acid ((N.13.32) CAS 1629965-65-6);
N.14 Auxin transport inhibitors: diflufenzopyr (N.14.1), diflufenzopyr-sodium (N.14.2), naptalam (N.14.3) and naptalam-sodium (N.14.4);
N.15 Other herbicides: bromobutide (N.15.1), chlorflurenol (N.15.2), chlorflurenol-methyl (N.15.3), cinmethylin (N.15.4), cumyluron (N.15.5), cyclopyrimorate ((N.15.6) CAS 499223-49-3) and its salts and esters, dalapon (N.15.7), dazomet (N.15.8), difenzoquat (N.15.9), difenzoquat-metilsulfate (N.15.10), dimethipin (N.15.11), DSMA (N.15.12), dymron (N.15.13), endothal (N.15.14) and its salts, etobenzanid (N.15.15), flurenol (N.15.16), flurenol-butyl (N.15.17), flurprimidol (N.15.18), fosamine (N.15.19), fosamine-ammonium (N.15.20), indanofan (N.15.21), maleic hydrazide (N.15.22), mefluidide (N.15.23), metam (N.15.24), methiozolin ((N.15.25) CAS 403640-27-7), methyl azide (N.15.26), methyl bromide (N.15.27), methyl-dymron (N.15.28), methyl iodide (N.15.29), MSMA (N.15.30), oleic acid (N.15.31), oxaziclomefone (N.15.32), pelargonic acid (N.15.33), pyributicarb (N.15.34), quinoclamine (N.15.35), tridiphane (N.15.36),
including their agriculturally useful salts or their agriculturally acceptable derivatives.

2. The mixture according to claim 1, wherein compound I is selected from the group consisting of compounds I.A to I.Z:
I.A: 2-(3,4-dimethyl-1H-pyrazol-1-yl)succinic acid and/or 2-(4,5-dimethyl-1H-pyrazol-1-yl)succinic acid,
I.B: a salt of 2-(3,4-dimethyl-1H-pyrazol-1-yl)succinic acid and/or 2-(4,5-dimethyl-1H-pyrazol-1-yl)succinic acid,
I.C: a potassium salt of 2-(3,4-dimethyl-1H-pyrazol-1-yl)succinic acid and/or 2-(4,5-dimethyl-1H-pyrazol-1-yl)succinic acid,
I.D: an ammonium salt of 2-(3,4-dimethyl-1H-pyrazol-1-yl)succinic acid and/or 2-(4,5-dimethyl-1H-pyrazol-1-yl)succinic acid,
I.E: a sodium salt of 2-(3,4-dimethyl-1H-pyrazol-1-yl)succinic acid and/or 2-(4,5-dimethyl-1H-pyrazol-1-yl)succinic acid,
I.F: 3,4-dimethyl pyrazolium glycolate (DMPG),
I.G: 3,4-dimethyl pyrazolium citrate (DMPC),
I.H: 3,4-dimethyl pyrazolium lactate (DMPL),
I.J: 3,4-dimethyl pyrazolium lactate (DMPM),
I.K: 1,2,4-triazole (TZ),
I.L: 4-Chloro-3-methylpyrazole (CIMP),
I.M: N-((3(5)-methyl-1H-pyrazole-1-yl)methyl)acetamide,
I.N: N-((3(5)-methyl-1H-pyrazole-1-yl)methyl)formamide,
I.O: N-((3(5),4-dimethylpyrazole-1-yl)methyl)formamide,
I. P: N-((4-chloro-3(5)-methyl-pyrazole-1-yl)methyl)formamide,
I.Q: reaction adduct of dicyandiamide, urea and formaldehyde, or a triazonyl-formaldehyde-dicyandiamide adduct
I.R: 2-cyano-1-((4-oxo-1,3,5-triazinan-1-yl)methyl)guanidine,
I.S: 1-((2-cyanoguanidino)methyl)urea,
I.T: 2-cyano-1-((2-cyanoguanidino)methyl)guanidine,
I.U: 2-chloro-6-(trichloromethyl)-pyridine (nitrapyrin or N-serve),
I.V: dicyandiamide (DCD, DIDIN),
I.W: 3,4-dimethyl pyrazole phosphate, and/or 4,5-dimethyl pyrazole phosphate (DMPP, ENTEC), and/or an isomer thereof, and/or a derivative thereof,
I.X: 3,4-dimethylpyrazole, and/or 4,5-dimethylpyrazole (DMP), and/or an isomer thereof, and/or a derivative thereof, and/or a salt thereof, and/or an acid addition salt thereof,
I.Y: ammoniumthiosulfate (ATU), and
I.Z: neem.

3. The mixture according to claim 1, wherein compound I is 2-(3,4-dimethyl-1H-pyrazol-1-yl)succinic acid and/or 2-(4,5-dimethyl-1H-pyrazol-1-yl)succinic acid.

4. The mixture according to claim 1, wherein compound II is selected from the group consisting of bensulfuron-methyl, bispyribac-sodium, cyclosulfamuron, diclosulam, flumetsulam, flupyrsulfuron-methyl-sodium, foramsulfuron, imazamox, imazapic, imazapyr, imazaquin, imazethapyr, imazosulfuron, iodosulfuron, iodosulfuron-methyl-sodium, iofensulfuron, iofensulfuron-sodium, mesosulfuron, metazosulfuron, nicosulfuron, penoxsulam, propoxycarbazon-sodium, propyrisulfuron, pyrazosulfuron-ethyl, pyroxsulam, rimsulfuron, sulfosulfuron, thiencarbazon-methyl, tritosulfuron and triafamone.

5. The mixture according to claim 1, wherein compound II is selected from the group consisting of amitrole, bicyclopyrone, clomazone, diflufenican, fenquinotrione, flumeturon, flurochloridone, isoxaflutole, mesotrione, oxotrione (CAS 1486617-21-3), picolinafen, sulcotrione, tefuryltrione, tembotrione, tolpyralate, topramezone and 2-chloro-3-methylsulfanyl-N-(1-methyltetrazol-5-yl)-4-(trifluoromethyl)benzamide (CAS 1361139-71-0).

6. The mixture according to claim 1, wherein compound II is selected from the group consisting of: 2,4-D and its salts and esters such as clacyfos, and aminocyclopyrachlor and its salts and esters, aminopyralid and its salts and its esters, clopyralid and its salts and esters, dicamba and its salts and esters, flopyrauxifen, fluroxypyr-meptyl, halauxifen, halauxifen-methyl, quinclorac, quinmerac, florpyrauxifen, florpyrauxifen-benzyl (CAS 1390661-72-9) and 4-amino-3-chloro-5-fluoro-6-(7-fluoro-1H-indol-6-yl)picolinic acid (CAS 1629965-65-6).

7. The mixture according to claim 1, wherein compound II is selected from the group consisting of: saflufenacil, and glyphosate.

8. The mixture according to claim 1, wherein compound I and compound II are present in a synergistically effective amount, and/or in a synergistically NI effective amount, and/or in a synergistically pesticidally effective amount, and/or in a synergistically plant health effective amount.

9. The mixture according to claim 1, wherein compound I and compound II are present in a weight ratio of from 100:1 to 1:100.

10. The mixture according to claim 1, further comprising a fertilizer.

11. An agrochemical composition, comprising an auxiliary and a mixture according to claim 1.

12. A method for nitrification inhibition, for controlling vegetation on non-crop areas, for controlling vegetation of broad-leafed weeds and grass weeds, or for increasing the health of a plant, said method comprising use of the mixture as defined in claim 1.

13. A method for controlling vegetation on non-crop areas or for controlling vegetation of broad-leafed weeds and grass weeds, comprising treating the weeds, or the seed, or the soil or the plants to be protected against weeds with an effective amount of the mixture as defined in claim 1.

14. A method for increasing the health of a plant, comprising treating the plant or the plant propagation material or the soil where the plants are to grow with an effective amount of the mixture as defined in claim 1.

15. The method as claimed in claim 13, wherein the at least one compound I and the at least one compound II are applied simultaneously, either as a mixture or separately, or subsequently to the plant propagules.

16. A plant propagation material, comprising a mixture as defined in claim 1, in an amount of from 0.1 to 10 kg active substances per 100 kg of seed.

17. A method for nitrification inhibition, for controlling vegetation on non-crop areas, for controlling vegetation of broad-leafed weeds and grass weeds, or for increasing the health of a plant, said method comprising use of the agrochemical composition as defined in claim 11.

18. A method for controlling vegetation on non-crop areas or for controlling vegetation of broad-leafed weeds and grass weeds, comprising treating the weeds, or the seed, or the soil or the plants to be protected against weeds with an effective amount of the agrochemical composition as defined in claim 11.

19. A method for increasing the health of a plant, comprising treating the plant or the plant propagation material or the soil where the plants are to grow with an effective amount of the agrochemical composition as defined in claim 11.

20. The method as claimed in claim 14, wherein the at least one compound I and the at least one compound II are applied simultaneously, either as a mixture or separately, or subsequently to the plant propagules.
